(19) United States
(12) Patent Application Publication
(10) Pub. No.: US 2024/0193160 A1
(43) Pub. Date: Jun. 13, 2024

(54) Computer-operative records having subject-related structure

(71) Applicant: Dean Truby, Salt Lake City, UT (US)

(72) Inventor: Dean Truby, Salt Lake City, UT (US)

(21) Appl. No.: 18/063,484

(22) Filed: Dec. 8, 2022

(51) Int. Cl. G06F 16/2452; G06F 16/28

(52) U.S. Cl. CPC G06F 16/2452; G06F 16/288

(57) ABSTRACT

Computer-operative records, computer-based systems that operate on those records, and improvements to computer-systems. Need for a permanent universal simple means for representing the subjects of those records and for enabling their storage and processing in a wide variety of computer-systems. Resolution of that need through I-models and I-systems. I-systems (FIG. 4) are computer-based systems that operate on I-models. I-models (FIG. 5) are records representing any combination of aspects of any one or more subjects. Primary components of I-models are combinations of I-units (FIG. 6). I-units are combinations of E-elements and I-indicator-elements. E-elements represent entities, including events and types. I-indicator-elements indicate information about those entities or about aspects of the I-units or I-models containing them. Primary types of I-units are ERT-units (FIG. 8), EVTR-units (FIG. 9), EVIR-units (FIG. 10), co-relationship-indicator-units (FIG. 11), EVS-units (FIG. 12), TSR-units (FIG. 15), and TEVS-units (FIG. 19).

### FIELD OF THE INVENTION

The present invention generally relates to records constructed, and operated upon, by computer-systems. More particularly, it relates to the structural form of those records and the scope, efficiency, and effectiveness of subject-related operations that may be performed on them by those systems.

### BACKGROUND OF THE INVENTION—PRIOR ART

The following is a tabulation of some prior art that presently appears relevant:

### U.S. Patents

| U.S. Pat. No. | Kind Code | Issue date | Patentee |
|---|---|---|---|
| 11,132,610 | B2 | 2021 Sep. 28 | Amazon Technologies |
| 11,468,342 | B2 | 2022 Oct. 11 | JPMorgan Chase Bank |

### U.S. Patent Application Publications

| Publication No. | Kind Code | Publ. Date | Applicant |
|---|---|---|---|
| 20220067750 | A1 | 2022 Mar. 3 | Hubspot Inc |

### Foreign Patent Documents

Foreign Doc. No. Cntry Code Kind Code Pub. Date App or Patentee

### Nonpatent Literature Documents

Reichgelt, H., Knowledge Representation: An AI Perspective, Ablex Publishing (1991)
Essig, G., ‘Naturalware’, in Leebaert, D. (Ed.), The Future of Software, MIT Press (1996)
Sowa, J. F., Knowledge Representation, Brooks Cole Publishing (2000)
Van Harmelen, F., et al., Handbook of Knowledge Representation, Elsevier (2005-2008)
Noy, N., et al., Research Challenges and Opportunities in Knowledge Representation, CORE SCHOLAR, Wright State University (February 2013)
‘Conceptual graph’, in Wikipedia (November 2021)
‘Turtle (syntax)’, in Wikipedia (January 2022)
‘First-order logic’, in Wikipedia (February 2022)
‘Knowledge representation and reasoning’, in Wikipedia (March 2022)
‘Semantic Web’, in Wikipedia (April 2022)

### BACKGROUND

Throughout history, information has been stored in records of many different types. In modern times, advances in technology have resulted in the use of computer systems to construct, store, and operate on records that specify information of a potentially unlimited range of types and subjects. Such computer-based record-systems permit an enormous expansion of the quantity of information that can be easily stored and quickly searched compared to non-computer-based record-systems such as conventional libraries.

Computer-based record-systems also provide for greatly-expedited processing of records, compared to human capabilities. That processing includes both subject-related operations that are concerned with the information stored in those records, and operations that are not subject-related. An example of a subject-related operation is that of searching records for particular information that is, or may be, specified in those records. Another example is that of translating a record to a record of a different configurational type that specifies the same information as the original record in a different form; for example, translating an English-language document to a Spanish-language document.

In contrast, non-subject-related operations on records are those that are not affected by the information in those records but, instead, consist of operations such as, for example, determining the locations and sizes of records in the record-system, and copying records from one location in the system to another location in the same, or a different, system.

The records constructed in various computer-systems are of many different configurational types that are, in most cases, incompatible with each other. A computer-system that operates on computer-operative records of one or more particular configurational types has operative-components constructed in such a way that they enable that computer-system to perform those operations on records of those specific types.

In the aggregate, modern computing technology can potentially accomodate an unlimited variety of such types of configurations and the challenge has been to find those forms that are most efficient and effective for various uses within computing systems. A wide variety of such forms have been developed. Some forms have been completely or partially standardized for some purposes, while others are idiosyncratic and non-standardized. Many groups of such records have a standardized general type of configuration but specific details of that configuration are determined separately for each individual record, or group of records, in a specific computer-system. The problem is that even minor variations between the specific forms of the configurations of the same general type results in incompatibilities within, and between, the records and the systems that operate on them. The modern technological systems do not have the inherent flexibility that humans do in adjusting to such minor variations.

Those incompatibilities between computer-operative records vary greatly in their magnitude and scope, but, due to the way that computers operate, even seemingly very minor differences are enough to render such computer-operative records of different specific types to be incompatible, at least in the first instance. For example, it means that such records cannot be directly combined to form a single larger uniform integrated record. It also means that many operative-components in a computer system that perform subject-related operations on records cannot perform such operations of the same type on other records in that system.

Consequently, accommodating those differences results in much complexity in the construction and operation of computer-based record-systems, particularly in the subject-related processing of the records, such as combining parts of some records to form a single record that can be operated on in a simple uniform manner.

Those incompatibilities are a consequence of a more fundamental problem, namely, that computers are not people. They cannot identify and process the information specified in records; they can only recognize and operate on the superficial configurations of those records. That is not generally a problem for many supporting operations performed on those records, but is a major problem for subject-related operations such as searching records to find information and translating records between configurational forms of different types.

The problem is particularly acute for records whose configurations correspond directly to human natural language, but is also a fundamental problem for records whose configurations have a more simple structured form such as those employed in databases of various types. In the case of natural languages, there are several factors that contribute to the problem, including the complexity and range of the basic grammatical structures, ambiguities in the information specified by any one structure, very many alternative structures of different forms that specify the same information, and the existence of many different natural languages that may be employed in specifying information in computer-operative records.

Those factors, when combined with the fact that, when operating on such records, computers cannot directly take into account the information specified in those records in order to detect and resolve problems such as ambiguities and possible alternative meanings of various language structures of those records result in a fundamental problem for the performance of such operations. An example is the case of a computer-system that receives a natural-language specification of a request for information where the structural form of that specification does not exactly match the structural form of some part of the specification of that information, even if that information is recorded in the system. Furthermore, due to the language-ambiguity problem, even if there is an exact match between the request and a language structure in a record in the system, there is, in the first instance, no certainty that that second structure indicates the requested information.

At the other extreme, where information is specified in computer systems in very simple standardized structural forms that are restricted to one specific form for each structural type of information specified in records in a database in that system, there still remains the problem of the correspondence between those records and the structural forms of requests for information from those records. Also, the problem of ambiguity still exists, although usually to a lesser extent than for natural-language-based records. Nevertheless, it means that natural-language terms employed in those records cannot be automatically treated as referring to exactly the same things as the same terms employed in another database. Moreover, unlike natural-language-based records, such databases are extremely restricted in the range of structural types of information that can be stored in them.

In addition to the above-described problem of finding requested information in computer-based records, there are closely related problems of automatically indexing such records, performing logic operations on such records, identifying evidence in such records for the occurrence of events of specified types, and translating between records having different types of structural forms, such as those corresponding to different natural-languages. Such problems all arise in the context of the basic language-related problems described earlier.

Some of the consequences of those problems include incorrect information-search results, incomplete search results, insufficient specificity resulting in too many different search results, and many limitations on the ability of computer systems to efficiently perform subject-related operations of various types on such records.

The problems are compounded for computer systems that operate on records of multiple different configurational types in performing functions such as combining multiple records to form a single integrated record, identifying components of multiple records that specify the same information in different forms, identifying inconsistencies between items of information indicated by the same or different records, and integrating the functioning of different systems so that they can function as a single system.

A related problem is that the various types of configurations are so varied in nature and scope, and so rapidly increasing in number, that it has been completely impractical to attempt to specify automatic translation processes between all of them. That greatly limits the interoperability of the computer-based record-systems containing such records.

Another problem is that all information is directly or indirectly related in various ways. By segregating various types of information in separate records with different types of configurations, inter-relationships between items of information indicated by components of those different records are not accounted for, at least not in any simple way. Also, the search processes are made much more complicated by that segregation.

Since almost the beginning of computer-systems, a continuing objective has been to develop better ways to structure the configurations of computer-operative records in those systems, in order to integrate, simplify, accelerate, and expand the range of possible subject-related operations on those records. Such improvement is based on having, to the extent feasible, a simple, single, uniform type of structural form that can be used to specify all types of information.

At least since the 1960's there have been concerted efforts in the computing community to achieve that ideal. The results of those efforts include structural types such as logic-based forms, semantic networks, production rules, frames, object-oriented systems, relational databases, and, more recently, the ‘Semantic Web’. There are also alternative approaches to the problem that are based on artificial intelligence/machine-learning techniques. However, while each of the approaches thus far developed may at least partially resolve some of the problems, they have major limitations with respect to the other problems. Moreover, in some cases, combinations of various methods are employed in an attempt to account for different forms of information in the same record-system. However, that has the drawback of greatly increasing the complexity and inefficiency of such records and systems.

A related problem is that automatic suject-indexing for such very large systems that attempt to handle very large quantities of information of many different structural types is that automatic subject-indexing is very imprecise, often yielding very large quantities of search results that are irrelevant.

Achieving the potential of modern computing technology, including computer-based record-systems in particular, has been held back by the inadequacy of the prior-art structural-configurational types of computer-operative records.

### SUMMARY OF THE INVENTION

Embodiments of the present invention comprise computer-operative records of a particular type, computer-based systems for operating on those records, and improvements to computer-systems accomplished by the incorporation of records and systems of those types in those computer-systems. Those computer-operative records are I-models.

The primary component of an I-model represents one or more aspects of one or more subjects. That primary component is comprised of a combination of I-components. I-components are comprised of combinations of primary I-units and secondary I-units. I-units are comprised of combinations of E-elements and I-indicator-elements. E-elements represent entities and I-indicator-elements indicate information about those entities or about aspects of the I-units or I-models containing them.

The following are some types of primary I-units: ERT-units, EVTR-units, EVIR-units, EVS-units, co-relationship-indicator-units, TSR-units, and TEVS-units. Combinations of primary I-units represent aspects of the subject of the I-model containing them. An I-model may also contain secondary I-units, of which the following are several types: RT-specification-units, T-specification-status-units, INST-completeness-status-units, and record-indicator-units. Secondary I-units indicate information about the I-model containing them or about particular I-components in that I-model.

If an I-model contains different E-elements that represent the same entity, then that I-model may include secondary records that specify those equivalences between those different E-elements.

Other embodiments include I-systems and I-improvements to computer-systems. I-systems are computer-systems, or subsystems, that include one or more I-models and one or more operative-components that operate on those I-models to perform functions such as constructing and searching those I-models. I-improvements to computer-systems comprise adding I-systems to those computer-systems, or converting those computer-systems to I-systems, to improve the functioning of those systems.

### BRIEF DESCRIPTION OF THE DRAWINGS

The drawings are numbered consecutively with two-digit numbers. The first two digits of the reference numerals in the drawings are the same as a drawing number, and the last two digits distinguish the referenced components within that drawing.

The embodiments are illustrated in the drawing figures by means of box diagrams. The boxes in each figure represent components of the item illustrated in that figure. Each box contains a name that indicates the type of component represented by that box. Boxes represent records, operative-components, computer-systems, record-systems, and components of things of those types. A component may be shown in simplified form in, or omitted from, a later drawing if a component of the same type is illustrated in previous drawings and is not directly relevant to the purpose of that later drawing. In addition, components of the same named general type in different drawings are identified by different reference numerals in those drawings if the specific forms of those components may differ, and, hence, those components are not the same component.

In the figures, I-components are referred to as ‘COMPONENT’, ‘COMPT’, or ‘C’. I-units are referred to as ‘UNIT’ or ‘U’. The three primary components of an I-unit may be referred to as ‘P1’, ‘P2’, or ‘P3’, as applicable. I-elements are referred to as ‘ELEMENT’ or ‘E’. The name of such an entity-type may be abbreviated, as in ‘E-element’ being indicated by ‘E’, ‘T-element’ being indicated by ‘T’, and ‘IEV-element’ being indicated by ‘IEV’. ‘INDICATOR’ may be abbreviated as ‘I’ or ‘IND’.

In some cases such names and abbreviated names are followed by a colon and a name of the entity or type of entity represented by that component. In other cases, a colon may be followed by an indication of a particular component of the component preceding the colon, such as a P1-component of an I-unit, or an I-unit contained in a larger I-component.

The containment of one box within another indicates that the component represented by that inner box is a component of the component represented by that outer box. The relative structural relationships between separate boxes within a box may or may not correspond directly to the relative structural relationships of the components represented by those boxes and is not significant for the embodiments described here. The relative structural relationships of those components may vary between embodiments without affecting the functioning of those embodiments. Such relative structural relationships may include physical connections not described in this specification.

An operative-coupling between two or more components is shown by means of a box and arrows linking that box to the boxes representing the components that are operatively-coupled thereby. The name of that first box indicates that it represents an operative coupling between the components represented by those other two boxes. The direction of each arrow indicates the direction of that operative activity. In some cases, the arrow lines have arrows at both ends, indicating that the components represented by those boxes may operate on each other.

A box with a double border represents a secondary record that indicates a relationship between the structures of the components represented by boxes linked to that first box by arrows. Such a record may be an indicator of the applicable type of relationship between the components at the other end of those arrows. The arrow-heads indicate the directions of those relationships. In some cases, such as equivalence, the arrows are bi-directional. The name in such a double-border box indicates the type of that relationship.

‘EQUIVALENCE’ and ‘EQ’ indicate equivalent components that represent the same thing. In some I-models, such an indication of an EQ-relationship between some E-elements may be comprised of multiple EQ indications of EQ-relationships between various combinations of E-elements such that that combination indicates that all those E-elements are equivalent. ‘SUBTYPE’ indicates that the component at the end of the arrow line from the box represents a subtype of the type-entity represented by the component at the beginning of the arrow line into that box. ‘SPECNSUBTYPE’ indicates that the component at the end of the arrow line from the box represents a specialization-subtype of the type-entity represented by the component at the beginning of the arrow line into that box. ‘PROTO-INST’ indicates that the component at the end of the arrow line from the box has a proto-INST structure relative to the component at the component at the beginning of the arrow line into that box. ‘SUBTYPE’ and ‘PROTO-INST’ indications may be replaced by REV1-components, as described later. ‘EV-DEP’ indicates that the entity represented at the beginning of the arrow line is EV-dependent on the entity represented at the bend of the arrow line. ‘LOGCON’ indicates that the EV-element at the end of the arrow is a logical-consequence of the EV-element at the beginning of that arrow. ‘TM-M’ indicates that the I-component at the end of the arrow matches the I-template at the beginning of that arrow. ‘TM:EQ’ indicates that the templates at that ends of the arrow are equivalent.

If an arrow links two boxes without an intermediate double-border box indicating either an operative-coupling or a type of structural relationship between the components represented by those boxes, then that arrow indicates a transfer of a copy of part or all of a record between those components in the direction indicated by that arrow. Alternatively, such a sequence of boxes and arrows may represent alternating records and operations on those records. In a figure that illustrates a process, the arrows indicate the sequence of the steps in that process.

In some figures, in order to reduce the complexity of those figures, some components of types that are as illustrated in previous figures are omitted, or are present only in abbreviated form. In particular, since the IEV-elements in the EVTR- and EVIR-units in an IEV-component are E-equivalent, if another E-element is E-equivalent to one of those IEV-elements, then it is also E-equivalent to the other; in such cases, that second E-equivalence may be omitted from a figure.

FIG. 1 illustrates the general structure of a record, both prior-art records and those described in this specification.

FIG. 2 illustrates the general structure of a computer-system, both prior-art systems and those described in this specification.

FIG. 3 illustrates the general structure of a computer-based record-system, both prior-art systems and those described in this specification.

FIG. 4 illustrates the general structure of an I-system according to some embodiments.

FIG. 5 illustrates the general structure of an I-model according to some embodiments.

FIG. 6 illustrates the general structure of an I-unit according to some embodiments.

FIG. 7 illustrates the general structure of an SR-unit according to some embodiments.

FIG. 8 illustrates the general structure of an ERT-unit according to some embodiments.

FIG. 9 illustrates the general structure of an EVTR-unit according to some embodiments.

FIG. 10 illustrates the general structure of an EVIR-unit according to some embodiments.

FIG. 11 illustrates the general structure of a co-relationship-indicator-unit according to some embodiments.

FIG. 12 illustrates the general structure of an EVS-unit according to some embodiments.

FIG. 13 illustrates the general structure of an EVS0-unit according to some embodiments.

FIG. 14 illustrates the general structure of an EVS1-unit according to some embodiments.

FIG. 15 illustrates the general structure of a TSR-unit according to some embodiments.

FIG. 16 illustrates the general structure of a TJSR-unit according to some embodiments.

FIG. 17 illustrates the general structure of a T10SR-unit according to some embodiments.

FIG. 18 illustrates the general structure of a T01SR-unit according to some embodiments.

FIG. 19 illustrates the general structure of a TEVS-unit according to some embodiments.

FIG. 20 illustrates the general structure of a proto-TJSR/INST-unit-pair according to some embodiments.

FIG. 21 illustrates the general structure of a proto-T10SR/INST-unit-pair according to some embodiments.

FIG. 22 illustrates the general structure of a proto-T01SR/INST-unit-pair according to some embodiments.

FIG. 23 illustrates the general structure of a proto-TEVS/INST-unit-pair according to some embodiments.

FIG. 24 illustrates the general structure of an RT-specification-unit according to some embodiments.

FIG. 25 illustrates the general structure of a T-specification-status-unit according to some embodiments.

FIG. 26 illustrates the general structure of an INST-completeness-status-unit according to some embodiments.

FIG. 27 illustrates the general structure of a record-indicator-unit according to some embodiments.

FIG. 28 illustrates the general structure of an IEVB-component according to some embodiments.

FIG. 29 illustrates the general structure of an IEVB-component in a physical-network-type computer-based record according to some embodiments.

FIG. 30 illustrates the general structure of an IEV-component according to some embodiments.

FIG. 31 illustrates the general structure of an IEV0-component according to some embodiments.

FIG. 32 illustrates the general structure of an IEV1-component according to some embodiments.

FIG. 33 illustrates the general structure of an REVB-component according to some embodiments.

FIG. 34 illustrates the general structure of an REV-component according to some embodiments.

FIG. 35 illustrates the general structure of an REV0-component according to some embodiments.

FIG. 36 illustrates the general structure of an REV1-component according to some embodiments.

FIG. 37 illustrates the general structure of an REV1-11-event-occurrence-implication-component according to some embodiments.

FIG. 38 illustrates the general structure of an REV1-name-component according to some embodiments.

FIG. 39 illustrates the general structure of a combination of a record-indicator-unit and an REV1-name-component according to some embodiments.

FIG. 40 illustrates the general structure of an REV1-subtype-component according to some embodiments.

FIG. 41 illustrates an example of a type of I-component according to some embodiments.

FIG. 42 illustrates an example of a type of I-component according to some embodiments.

FIG. 43 illustrates an example of a type of I-component according to some embodiments.

FIG. 44 illustrates an example of a type of I-component according to some embodiments.

FIG. 45 illustrates an example of a type of I-component according to some embodiments.

FIG. 46 illustrates an example of a type of I-component according to some embodiments.

FIG. 47 illustrates an example of a type of I-component according to some embodiments.

FIG. 48 illustrates a TEVTR-unit according to some embodiments.

FIG. 49 illustrates a TEVIR-unit according to some embodiments.

FIG. 50 illustrates a TIEVB-component according to some embodiments.

FIG. 51 illustrates a TIEVB-component according to some embodiments.

FIG. 52 illustrates a TERT-unit according to some embodiments.

FIG. 53 illustrates a TREVB-component according to some embodiments.

FIG. 54 illustrates a TREV-component according to some embodiments.

FIG. 55 illustrates a T11REV1-I11-component according to some embodiments.

FIG. 56 illustrates a T11REV1-event-occurrence-time-component according to some embodiments.

FIG. 57 illustrates a T01REV1-event-occurrence-time-component according to some embodiments.

FIG. 58 illustrates a T10REV1-event-occurrence-time-component according to some embodiments.

FIG. 59 illustrates one type of EV-dependence pair according to some embodiments.

FIG. 60 illustrates one type of EV-dependence pair according to some embodiments.

FIG. 61 illustrates one type of EV-dependence pair according to some embodiments.

FIG. 62 illustrates one type of EV-dependence pair according to some embodiments.

FIG. 63 illustrates one type of EV-dependence pair according to some embodiments.

FIG. 64 illustrates a circular-EV-dependence pair according to some embodiments.

FIG. 65 illustrates an example of a proto-T/INST-component-relationship according to some embodiments.

FIG. 66 illustrates a standard-CONTRATYPE-specification for a T-element with two secondary-terminal-E-elements according to some embodiments.

FIG. 67 illustrates an example of standard-DISJT-specification according to some embodiments.

FIG. 68 illustrates an example of two co-related COMPADDNSUBT-relationships according to some embodiments.

FIG. 69 illustrates an example of a standard-CONTRASUBT-relationship according to some embodiments.

FIG. 70 illustrates an example of a LOGCON-relationship-pair for an event-occurrence-implication-LOGCON-relationship according to some embodiments.

FIG. 71 illustrates an example of a LOGCON-relationship-pair for an EV-dependence-relationship according to some embodiments.

FIG. 72 illustrates a simple-primitive RT-specification according to some embodiments.

FIG. 73 illustrates a partial-primitive RT-specification according to some embodiments.

FIG. 74 illustrates an example of a non-primitive RT-specification according to some embodiments.

FIG. 75 illustrates an example of a very simple T-network according to some embodiments.

FIG. 76 illustrates the relationship between a non-primitive RT-specification for a contratype-relationship and the corresponding RT-specification-unit according to some embodiments.

FIG. 77 illustrates an RT-specification-unit and a T-specification for a contratype-relationship ERT-element derived from the RT-element in that RT-specification-unit according to some embodiments.

FIG. 78 illustrates the T-specification for an ERT-element and a T-specification that represents an instance of that ERT-specification according to some embodiments.

FIG. 79 illustrates the essential elements of an I-system that distinguish it from other computer-based record-systems according to some embodiments.

FIG. 80 illustrates the action-specification interface-component for an I-system according to some embodiments.

FIG. 81 illustrates an I-system with the indication of input-records that are components of action-specifications received in the action-specification interface-component according to some embodiments.

FIG. 82 illustrates an I-system with the indication in the action-specification interface-component of adjustments to be made to previous output-records according to some embodiments.

FIG. 83 illustrates an I-system with the indication in the action-specification interface-component of adjustments to be made to previous output-records according to some embodiments.

FIG. 84 illustrates an example of an example of an I-template match with an REVB-component according to some embodiments.

FIG. 85 illustrates a general translation process in an I-system according to some embodiments.

FIG. 86 illustrates a bidirectional-translation process in an I-system according to some embodiments.

FIG. 87 illustrates a combination of an I-system operatively-coupled with one other computer-based record-system according to some embodiments.

FIG. 88 illustrates an I-improvement to a computer-based record-system according to some embodiments.

FIG. 89 illustrates an I-improvement to a computer-based record-system including translating one or more of the records in that record-system to one or more I-models according to some embodiments.

### DETAILED DESCRIPTION OF SPECIFIC EMBODIMENTS

Note re glossary of terms: The description set forth in the various sections of this document includes the definitions of certain terms. For the convenience of the reader, a glossary of those terms is provided in the last section of the description. The description also includes definitions of other technical terms that relate to terms in common use and are not defined in the main part of the description, such as ‘record’ and ‘computer-system). Such terms are indicated in the description by ‘(GLOSS.)’.

### 1.0 INTRODUCTION TO THE EMBODIMENTS

The embodiments of the present invention are I-models, I-systems, I-improvements to computer-based record-systems, and I-improvements to computer-systems.

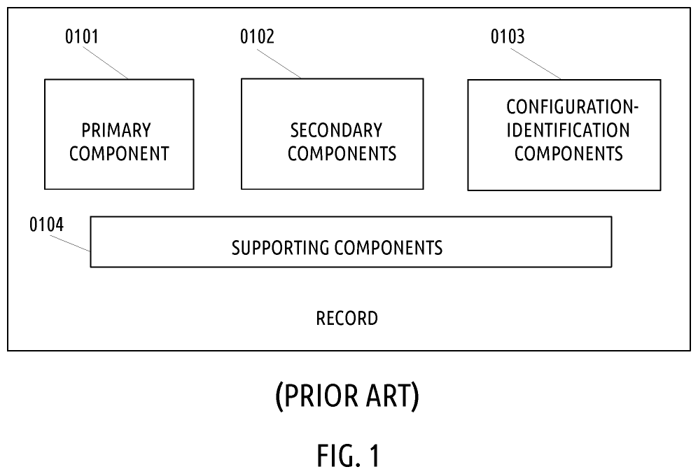

An I-model is a computer-operative record of the particular type described in this specification. FIG. 1 illustrates the basic functional composition of a record (GLOSS.), including computer-operative records. The primary component 0101 constitutes the specification of the information that is the reason for the construction and use of the record.

The secondary components 0102 are records that specify information about the record, such as its author and date. The configuration-identification components 0103 indicate components of the primary and secondary components, such as section numbers in a document. Configuration-identification components are employed by the computer-system to distinguish and identify different components of the specification in that record. The supporting components 0104 provide structural support to the other components of the record, such as the binding of a book.

The primary component of an I-model is a record that is a representational, or semi-representational, model of various aspects of one or more subjects. A semi-representational model is fundamentally representational (GLOSS.), but, in many embodiments, also includes descriptive components. In a purely representational I-model, each entity in the subject of that record is represented in that I-model by one and only one E-element.

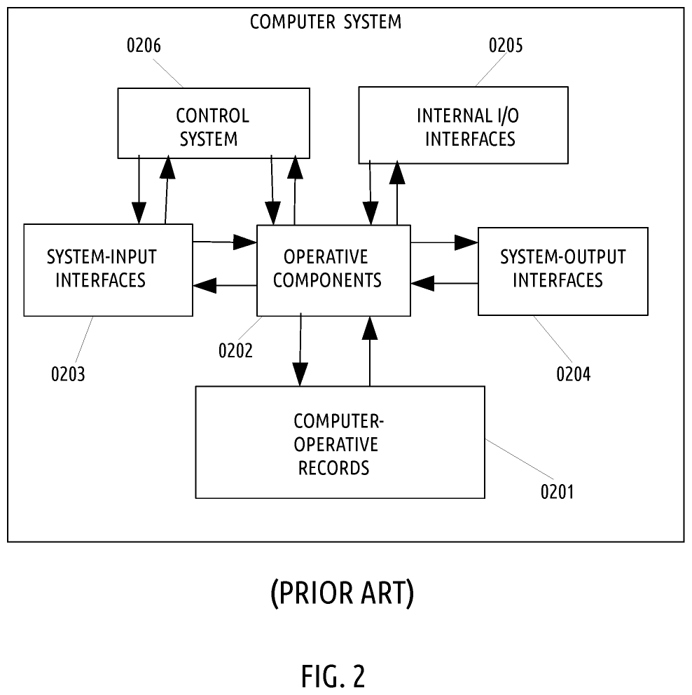

A computer-based record-system comprises all or part of a computer-system (GLOSS.). FIG. 2 illustrates the basic functional composition of a computer-system. The records 0201 are operated upon by one or more operative-components 0202. Copies of records are input to the system from external sources by means of the system-input interfaces 0203 of the system and copies of records are output to external destinations by means of the system-output interfaces 0204 of the system. The internal input/output interfaces 0205 of the system are employed by the operative-components to specify intermediate outputs of operations to be used by the same or other operative-components. The control system 0206 controls the functioning of various operative-components.

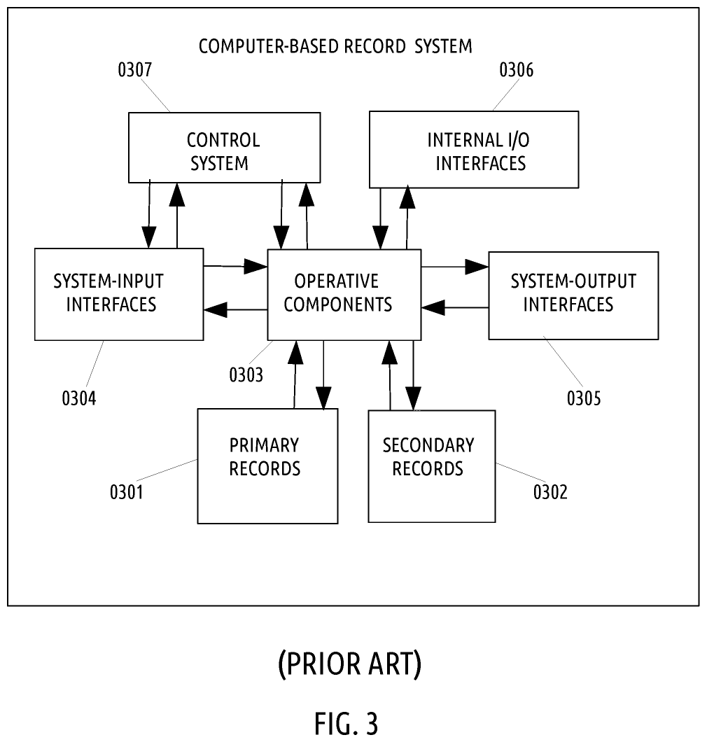

An I-system is a computer-based record-system (GLOSS.) in which the primary component comprises one or more I-models. The system also includes one or more operative-components that may operate on those I-models. FIG. 3 illustrates the basic functional composition of a computer-based record-system. The primary records 0301 are the records that constitute the specifications that are the reason for the construction and use of the record-system. The secondary records 0302 are the records that specify information about the primary records. Components 0303, 0304, 0305, 0306, and 0307 have the same general functions as the corresponding components 0202, 0203, 0204, 0205, and 0206, respectively, of the computer-system in FIG. 2.

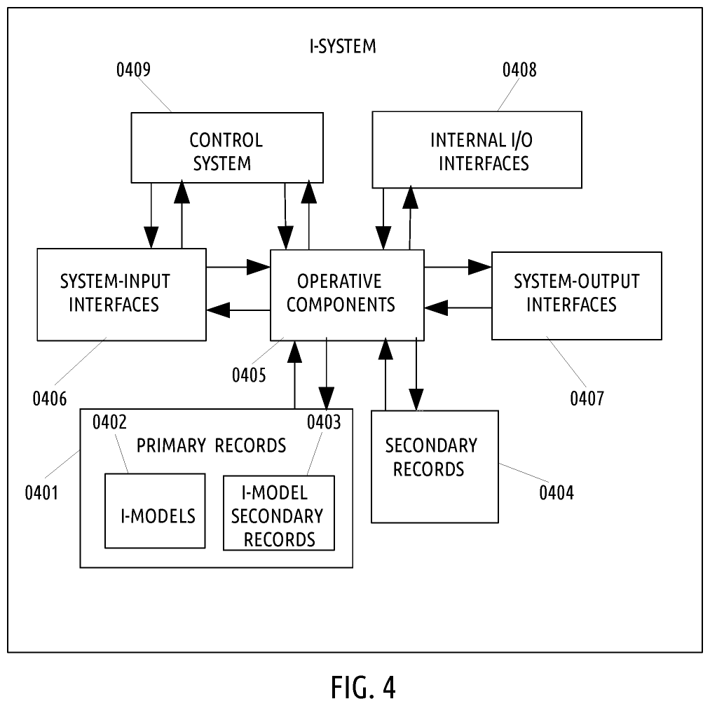

FIG. 4 illustrates the basic functional composition of an I-system. The primary records 0401 consist of I-models 0402 and secondary records 0403 for those I-models. Components 0404, 0405, 0406, 0407, 0408, and 0409 have the same general functions as the corresponding components 0302, 0303, 0304, 0305, 0306, and 0307, respectively, of the computer-based record-system shown in FIG. 3.

An I-improvement to a computer-based record-system consists of the inclusion in that record-system of one or more I-systems containing I-models that supplement or replace existing primary records in that record-system. An I-improvement to a computer-system consists of the inclusion in that computer-system of one or more I-systems that supplement or replace the entire computer-system or one or more sub-systems of that computer-system.

I-models and I-systems improve those aspects of the functioning of computer-systems and computer-based record-systems that are concerned with the processing and use of records in those systems.

### 1.1 Components of I-Models

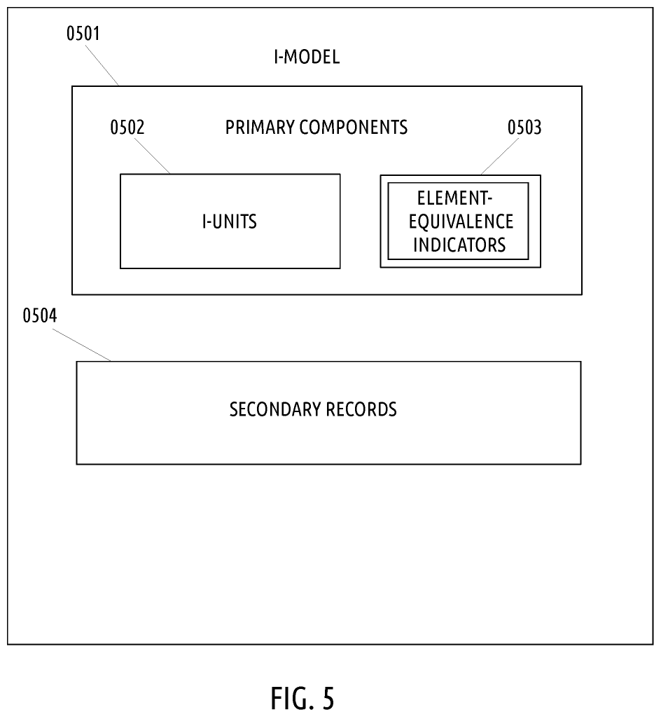

As shown in the illustration of an I-model in FIG. 5, the primary component 0501 of an I-model consists of a combination of one or more I-components 0502 and, in some embodiments, one or more configuration-identification components as previously described for records in general. I-components are, in turn, computer-operative records whose primary components are combinations of one or more I-units that are inter-related by means of E-equivalence-indicators 0503 that are secondary-records in the I-model containing them. An I-unit in an I-model is a computer-operative record whose primary component consists of several I-elements. In some embodiments, an I-model may also include secondary records 0504.

### 1.2 I-Elements

I-elements are the basic primary components of I-models. Each I-element is a computer-operative record. There are two general types of I-elements: E-elements and I-indicators.

The specific configurational forms of the various types of I-elements in I-models may differ in different embodiments, as determined by practical considerations such as efficiency, processing and storage. In some I-models, the configurational forms of I-elements of some types may be translationally-equivalent to names represented by those I-elements, or to entities that are identified by those names.

### 1.2.1 E-Elements

In an I-model, an E-element (‘entity-element’) is the representative of an entity in the subject of that I-model. There are three general types of entities: basic-entities, type-entities, and events. A basic-entity is any entity other than a type-entity or an event. Within an I-model, each E-element represents an entity of one of those three types.

Corresponding to those types of entities there are three types of E-elements: EB-elements (‘basic-entity-elements’), T-elements (‘type-elements’), and IEV-elements (‘instance-event-elements’). EB-elements represent basic-entities (GLOSS.), including groups and collections of entities and all entities other than type-entities and instance-events. T-elements represent type-entities (GLOSS.) and type-events (GLOSS.). IEV-elements represent instance-events. T-elements and IEV-elements are EV-elements (‘event-elements’).

In particular, a record is a physical entity that is represented in an I-model by an EB-element. By contrast, what is specified in a record about the subject of that record, when considered separately from any particular record of that specification, is a type-entity that is represented by a T-element. An example of that difference between a record and what it specifies by means of its primary-configuration is the difference between a record of a particular name and that name per se considered in isolation from any particular record of that name. A name that is per se represented as an entity in an I-model is represented by a T-element in that I-model. Alternatively, a name that is not represented by an E-element in an I-model but is the name of an entity that is represented by an E-element in that I-model may be translationally-equivalent to the primary component of that E-element. Alternatively, that E-element may be an ID-code and that I-model may include a secondary-record that indicates the correspondence between those ID-codes and the names that those codes indicate. Other methods of indicating names of entities are described in sections 1.3.1.4.4, 1.3.1.4.5, and 1.4.2.4.

Although an E-element in an I-model represents an entity of one of the types described above, various aspects of that entity, including its composition or structure, are represented separately in that I-model by means of I-components of which that E-element is a component.

No E-element in an I-model represents itself in that I-model. For each E-element in that I-model, operative-components that operate on those E-elements may determine which of the three basic types a particular E-element belongs to, as determined by the structure of that E-element, or by its structural context within an I-component containing it.

In an I-model, E-elements that represent different entities are identifiable and distinguishable by the operative-components that may operate on that I-model in the I-system containing that I-model.

### 1.2.2 E-Equivalence-Indicators

In a purely representational I-model, each entity is represented in that I-model by one and only one E-element. In I-models whose primary configurations are not fully representational, two or more separate E-elements may indicate or represent exactly the same entity or event. Such E-elements are E-equivalent. Also, every E-element is E-equivalent to itself. In I-models, E-equivalences between separate E-elements are indicated by E-equivalence-indicators.

The specific forms of the E-equivalence-indicators in different I-models may differ on the basis of practical considerations, as determined by the system-developers. For example, an E-equivalence between two separate E-elements may be indicated by those E-elements having exactly the same configurational form, such as an ID code or a name. In other I-models the E-elements may include components that indicate one or more other E-elements that are E-equivalent to those E-elements. In other embodiments, an I-model may include a sequence of links between the various E-elements that represent the same entity and those links are traced by operative-components in the I-system to identify those E-equivalent E-elements. Such a link may, for example, consist of one E-element containing an indicator of another E-element that is E-equivalent to that first E-element. Configurations of other types may be employed in other I-models to indicate E-equivalence.

E-equivalence-records are secondary-records in I-models. For example, they may be included in the E-elements indicated by those E-equivalences. They may be included in the I-units containing the E-elements indicated by those E-equivalences. They may be contained in secondary records in the I-model containing those E-elements.

### 1.2.3 I-Indicators

I-indicators are components of I-units that indicate particular things about particular aspects of those I-units, or about particular I-elements or I-components in the I-model containing them. There are three general types of I-indicators in I-models: I-primary-indicators, I-secondary-indicators, and I-unit-type-indicators.

An I-primary-indicator is a component of an I-unit that indicates information about one or more entities represented by E-elements in that I-unit.

An I-secondary-indicator is a secondary component of an I-unit that indicates information about aspects of the I-model containing that I-unit.

An I-unit-type-indicator is a component of an I-unit that indicates the type, or nature, of that I-unit. I-unit-type-indicators are employed by the I-system to identify the types of various I-units; those indications enable that system to operate correctly on those I-units.

The specific types and functions in I-models of I-indicators of various types are described in subsequent sections. All I-indicators of any one of those specified types are I-equivalent; that is, they all indicate the same thing, such as a type of relationship. Every I-indicator is I-equivalent to itself. No I-indicator is I-equivalent to any E-element. No I-indicator of any of the types described in this specification is I-equivalent to any I-indicator of any of the other types.

The specific configurational forms of the I-indicators of various types are determined on the basis of practical considerations for each I-model and I-system.

### 1.3 I-Units

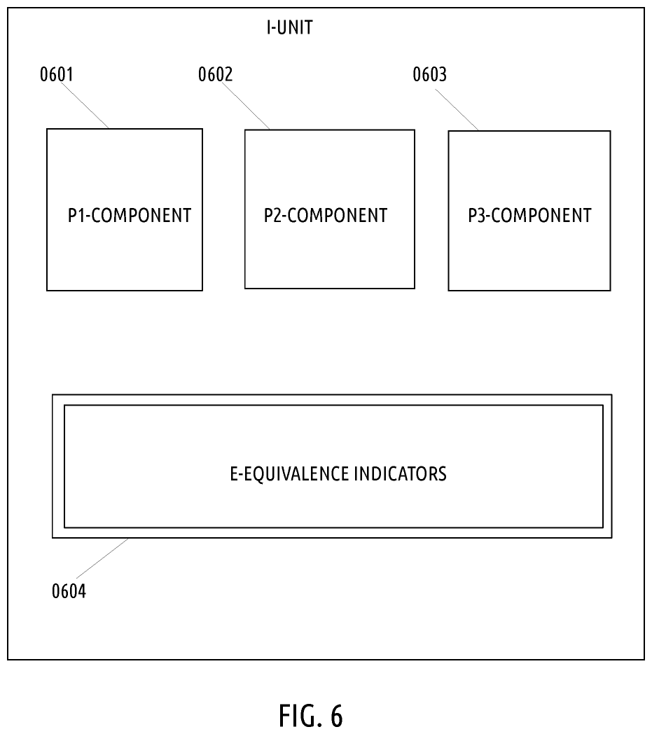

The primary component of an I-unit consists of a particular type of combination of I-elements. As shown in the illustration of an I-unit in FIG. 6, in many embodiments, the primary component of each I-unit consists of three primary components: a P1-component (‘first-primary-component’) 0601, a P2-component (‘second-primary-component’) 0602, and a P3-component (‘third-primary-component’) 0603. In an I-unit that contains two or more E-elements that represent the same entity, then that I-unit may also contain E-equivalence-indicators 0604 for those equivalent E-elements. It should be understood that, although I-units are described here in terms of three primary-components, in some embodiments some I-units may have additional components that indicate aspects of the I-units of which they are a part; for example, an I-unit may include a separate component that indicates the type of that I-unit. Also, some I-units may have fewer primary-components, as described later for EVS-units, for example. Also, the relative sequencing of the primary-components of I-units of some types may be different.

As explained below, each of those three primary components is a combination of one or more I-elements. Two or more I-units are I-equivalent if their P1-components are I-equivalent or E-equivalent, their P2-components are I-equivalent or E-equivalent, and their P3-components are I-equivalent or E-equivalent. Every I-unit is I-equivalent to itself. The functions within I-models of I-units that are not described below in this subsection are described in subsequent sections.

As previously described for records in general, in some embodiments, an I-unit may also include one or more configuration-identification components. Those indicate such things as the type and internal structure of that I-unit. For example, they may indicate the identities of the P1-, P2-, and P3-components in that I-unit.

The specific forms of the various types of I-units in various I-models may differ in different embodiments, as determined on the basis of practical considerations such as efficiency, processing and storage.

There are two general types of I-units that may be present in I-models: primary I-units and secondary I-units.

### 1.3.1 Primary I-Units

A primary I-unit in an I-model represents an aspect of the subject of that I-model. Each primary I-unit is a specification either of a state of an entity represented by an E-element in a primary component of that unit, or of a relationship between the entities represented by E-elements in two primary components in that unit. In some I-models, the primary I-units may include an additional component that indicates the types of those I-units.

There are two general types of primary I-units: base-primary I-units and T-units (‘type-structure-units’). A T-unit represents a component of a type-structure (GLOSS.) for a particular type-entity. Thus, a type-structure for a type-entity is represented in an I-model by a combination of one or more T-units. A base-primary I-unit directly indicates a state or relationship (GLOSS.) of a particular entity in the subject of the I-model containing it.

### 1.3.1.1 Base-Primary I-Units

There two general types of base-primary I-units: SR-units (‘structural-relationship-units)’ and EVS-units (‘event-occurrence-state-units’).

### 1.3.1.1.1 SR-Units

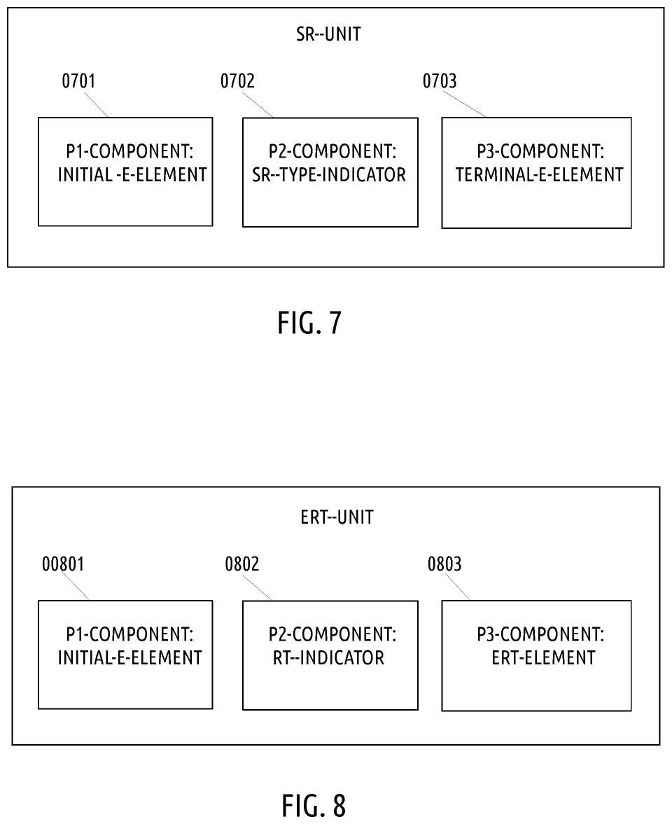

As shown in the illustration of an SR-unit in FIG. 7, the P2-component 0702 of an SR-unit is an SR-type-indicator, and the P1-component 0701 and the P3-component 0703 are E-elements. The P1-component is the initial-E-element in that unit, and the P3-component is the terminal-E-element in that unit. An SR-type-indicator (‘structural-relationship-type-indicator’) is an I-indicator that indicates a particular type of structural relationship between the entities represented by the P1- and P3-components. SR-type-indicators include RT-indicators and co-relationship-type-indicators of various types, as described in the following four subsections.

The following are four general types of SR-unit described in the following subsections: ERT-units, EVTR-units, EVIR-units, and co-relationship-indicator-units.

### 1.3.1.1.1.1 ERT-Units

An ERT-unit (‘entity-relationship-type-unit’) indicates a structural-relationship of a particular type between a particular type-entity and a particular fixed-entity (GLOSS.) in the type-structure (GLOSS.) for that type-entity. For example, in the type-structure indicated by ‘companies located in Michigan’, ‘companies’ indicates a type-entity in that type-structure, ‘Michigan’ indicates a fixed-entity in that type-structure, and ‘located in’ indicates the type of relationship linking that fixed-entity with that type-entity.

Specifically, as shown in the illustration of an ERT-unit in FIG. 8, the P1-component 0801 of each ERT-unit is an E-element; the P2-component 0802 is an SR-indicator that is an RT-indicator (‘relationship-type-indicator’); and the P3-component 0803 is a T-element that represents a type-entity within whose type-structure the entity represented by the P1-component is a fixed-entity. Each relationship between that fixed-entity and an instance (GLOSS.) of that type-entity is an instance of the type-structure for that type-entity. All those relationships are of the same structural type, as determined by that type-structure.

The RT-indicator that comprises that P2-component indicates, or identifies, that relationship-type (GLOSS.). In some embodiments, that RT-indicator may be translationally-equivalent to a name for that relationship-type. Different types of such relationships are indicated by RT-indicators of different types; that is, those RT-indicators are not I-equivalent. All RT-indicators that indicate the same type of relationship are I-equivalent.

The terminal-E-element in that ERT-unit is the ERT-element in that unit and represents a type-entity whose type-structure consists of a type-relationship between the fixed-entity represented by the initial-E-element in that ERT-unit and that type-entity.

Thus, in the example, ‘manufacturing companies located in Michigan’, the relationship between the fixed-entity identified by ‘Michigan’ and the type-entity indicated by ‘manufacturing companies’ is indicated, or identified, by ‘located in”. Similarly, in the example, ‘manufacturing companies located in California’, the same type of relationship indicated by ‘located in’ exists between the fixed-entity identified by ‘California’ and the type-entity indicated by ‘manufacturing companies’. Thus, there is the same type of relationship in both examples.

In that first example, in the ERT-unit that represents the type-relationship, ‘manufacturing companies located in Michigan’, the P1-component represents the fixed-entity, ‘Michigan’; the terminal-E-element represents the type-entity, ‘manufacturing companies’; and the RT-indicator indicates the relationship-type, ‘is the location of’.

In that second example, in the ERT-unit that represents the type-relationship, ‘manufacturing companies located in California’, the initial-E-element represents the fixed-entity, ‘California’; the terminal-E-element represents the type-entity, ‘manufacturing companies’; and the RT-indicator indicates the relationship-type, ‘is the location of’.

No initial-E-element of any ERT-unit in an I-model is E-equivalent to the ERT-element in that ERT-unit. No ERT-element in any ERT-unit is E-equivalent to the IEV-element in any EVTR-unit or EVIR-unit. If the initial-E-elements in any two ERT-units are E-equivalent, and the RT-indicators in those ERT-units are I-equivalent, then the ERT-elements in those ERT-units are E-equivalent. If the ERT-elements in any two ERT-units are E-equivalent, and the RT-indicators in those ERT-units are I-equivalent, then the initial-E-elements in those units are E-equivalent.

### 1.3.1.1.1.2 EVTR- and EVIR-Units

EVTR-units and EVTI-units are ERT-units that indicate the type-entities and instance-entities for instance-events. An instance-event is an event consisting of a specified entity either being, or not being, an instance of a specified type-entity. An instance-event may have multiple separate occurrences under different conditions, such as different times.

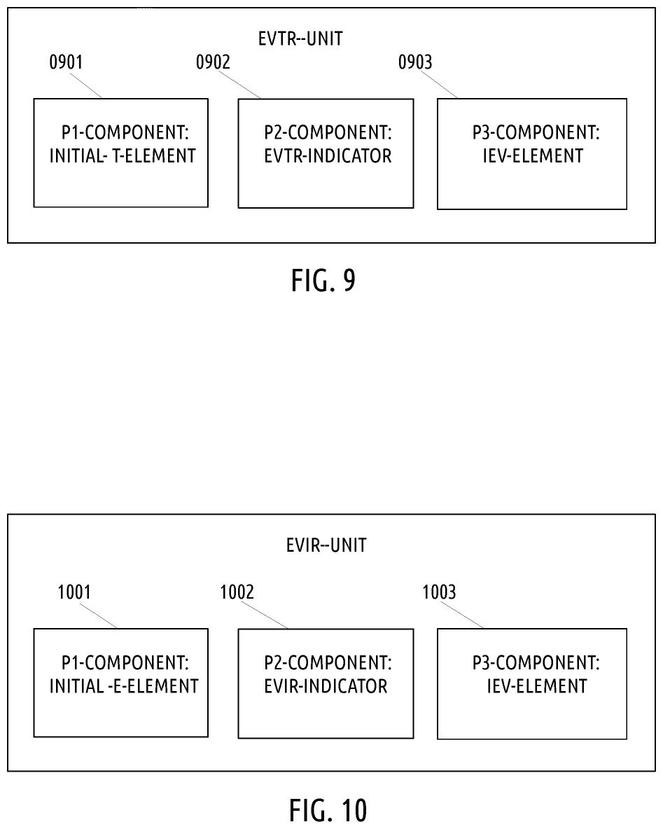

An EVTR-unit (‘instance-event/type-entity-relationship unit’) represents the relationship between an instance-event and the type-entity for that instance-event. Specifically, as shown in the illustration of an EVTR-unit in FIG. 9, the initial-E-element 0901 is a T-element, the RT-indicator 0902 in that unit is an EVTR-indicator, and the terminal-E-element 0903 is an IEV-element (‘instance-event-element’). The initial- and terminal-E-elements are not E-equivalent. The EVTR-indicator in an EVTR-unit indicates that the IEV-element represents an instance-event for the type-entity represented by the initial-E-element in that unit.

An EVIR-unit (‘instance-event/instance-entity-relationship unit’) represents the relationship between an instance-event and an instance-entity (or non-instance-entity) for that instance-event. Specifically, as shown in the illustration of an EVIR-unit in FIG. 10, the initial-E-element 1001 is an E-element, the RT-indicator 1002 is an EVIR-indicator, and the terminal-E-element 1003 is an IEV-element. The initial- and terminal-E-elements are not E-equivalent. No initial-E-element in any EVTR-unit is E-equivalent to the IEV-element in any EVIR-unit. The EVIR-indicator in an EVIR-unit indicates that the terminal-E-element represents an instance-event of which the entity represented by the initial-E-element is an instance, or non-instance, of the type-entity for that instance-event.

When two EVTR-units in an I-model have IEV-elements that are E-equivalent, then the initial-E-elements in those two I-units are E-equivalent; the same applies to EVIR-units.

In some embodiments, the EVTR-units and EVIR-units in those I-models exist only in pairs. Each such pair consists of the combination of an EVTR-unit and an EVIR-unit whose IEV-elements are E-equivalent. If the initial-E-element in that EVIR-unit is E-equivalent to the initial-E-element in another EVIR-unit in a second such pair of units, and, if the initial-E-element in the EVTR-unit in that first pair is E-equivalent to the initial-E-element in the EVTR-unit in that second pair, then the IEV-elements in all those units are E-equivalent.

### 1.3.1.1.1.3 Co-Relationship-Indicator-Units

As further described in section 1.4.6, some relationships involving particular combinations of entities may be co-related (GLOSS.). For example, some joint type-entities (GLOSS.) in a type-structure may have instance-entities that are co-related joint-instances of those joint type-entities. Such co-relationships exist because there are particular relationships between those instance-entities that are instances of the type-relationships between the corresponding joint-type-entities within that type-structure. Those corresponding type-instance relationships between those joint type-entities and their joint-instances are co-related.

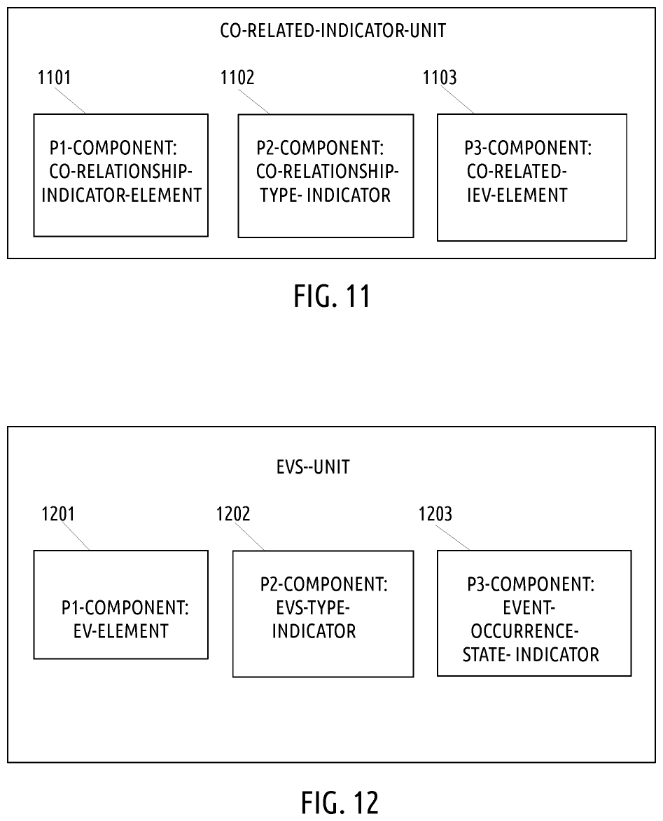

Such co-relationships are indicated by base-primary units that are co-relationship-indicator-units. As shown in the illustration of a co-relationship-indicator-unit in FIG. 11, the P1-component 1101 of each co-relationship-indicator-unit is a T-element that is a co-relationship-indicator-element; the P2-component 1102 is a co-relationship-type-indicator; and the P3-component 1103 is an IEV-element that represents an event constituting one of those co-related events. Some particular types of co-relationships are described in section 1.4.6.

There is a different type of co-relationship-type-indicator for each such type of co-relationship. All co-relationship-type-indicators for the same type of relationship are I-equivalent, and are not I-equivalent to any I-indicator of any other type. In some cases, the co-relatedness of the relationships in a particular combination of relationships may not be invariant under all conditions, and, instead, exists only under particular conditions. In that case, those conditions may be indicated by I-components such as, for example, as described in section 1.4.6.

### 1.3.1.1.1.4 EVS-Units

EVS-units (‘event-occurrence-state-units’) indicate the occurrence-states of type-events and instance-events. A type-event consists of either the occurrence or non-occurrence of a particular type-entity. A type-entity is occurrent if it has at least one instance. It is non-occurrent if it has no instances. An instance-event consists of a specified instance-event being occurrent or non-occurrent.

Specifically, as shown in the illustration of an EVS-unit in FIG. 12, the P1-component 1201 is an EV-element; the P2-component 1202 is an I-indicator that is an event-state-determinant-indicator; and the P3-component 1203 is an I-indicator that is an event-occurrence-state-indicator.

### 1.3.1.1.1.4.1 Event-Occurrence-State-Indicators

The following are four examples of general types of event-occurrence-state-indicators that may be specified as P3-components in EVS-units: event-occurrence-indicators, event-non-occurrence-indicators, event-probability-indicators, and event-included-occurrence-indicators.

In an I-model, an EVS-unit in which the EV-element 1201 is a T-element indicates the occurrence-state of the type-event represented by that T-element. If the event-occurrence-state-indicator 1203 in that unit is an event-occurrence-indicator, then that unit indicates that the type-entity represented by that T-element has one or more instances in the subject of that I-model, whether or not those instances are represented in that I-model. If that event-occurrence-state-indicator is an event-non-occurrence-indicator, then that unit indicates that that type-entity has no instances in the subject of that I-model.

In an I-model, an EVS-unit in which the EV-element 1201 is an IEV-element indicates the occurrence-state of the instance-event represented by that IEV-element. If the event-occurrence-state-indicator 1203 in that unit is an event-occurrence-indicator, then that unit indicates that the instance-event represented by that IEV-element is occurrent in the subject of that I-model. If that is an event-non-occurrence-indicator, then that unit indicates that that instance-event is non-occurrent in the subject of that I-model.

Corresponding to the above four types of event-occurrence-state-indicators, there are four types of EVS-units: EVS1-units (‘event-occurrence-units’), EVS0-units (‘event-non-occurrence-units’), EVSP-units (‘event-probability-units’), and EVSIN-units (‘event-included-occurrence-units’).

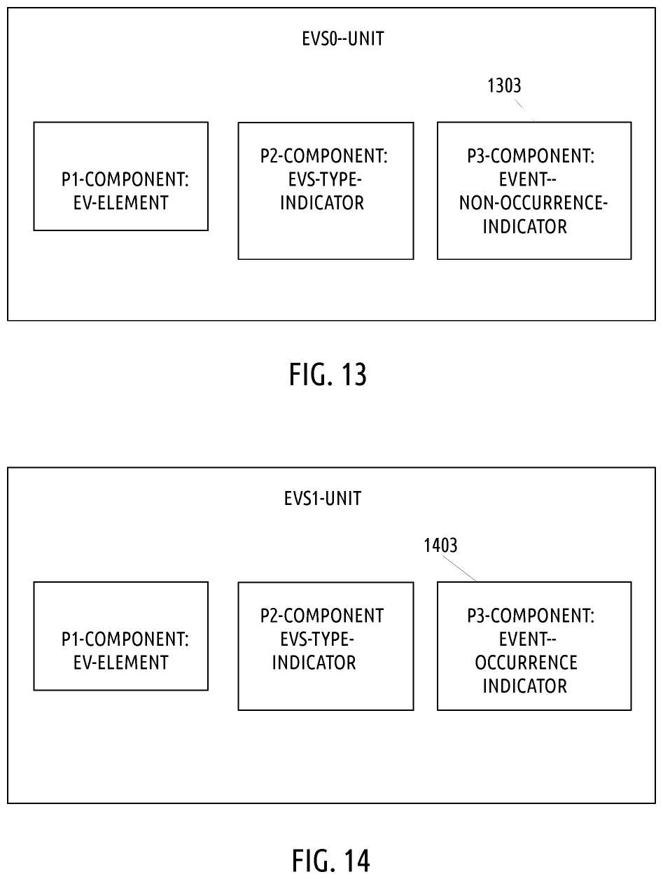

As shown in the illustration of an EVS0-unit in FIG. 13, an EVS0-unit is an EVS-unit in which the event-occurrence-state-indicator 1303 is an event-non-occurrence-indicator.

As shown in the illustration of an EVS1-unit in FIG. 14, an EVS1-unit is an EVS-unit in which the event-occurrence-state-indicator 1403 is an event-occurrence-indicator.

An EVSP-unit is an EVS-unit in which the event-occurrence-state-indicator 1203 is an event-probability-indicator. That event-probability-indicator may indicate a numerical or nominal probability of the occurrence of the event represented by the P1-component in that EVS-unit. For example, likelihoods and possibilities are nominal probabilities.

An EVSIN-unit is an EVS-unit in which the event-occurrence-state-indicator 1203 is an event-included-occurrence-indicator. That indicates that the event represented by the P1-component of that EVS-unit occurs partially or completely within the combination of circumstantial-conditions specified for that I-model. Type-events and instance-events may have different occurrence-states under different circumstantial-conditions, such as different times. For example, the type-event, ‘rain’, may occur at many different times in a given location.

Some I-models may not include any EVSP-units or EVSIN-units. An I-model may include some T-elements and IEV-elements that are not E-equivalent to the P1-components of any EVS-units in that I-model.

If an I-model contains two or more EVS-units whose P1-components are E-equivalent while the P3-components indicate different occurrence-states for the event represented by those P1-components, then that difference is an inconsistency, or contradiction. As described in section 1.4.6.6, such inconsistencies have to be resolved before that I-model can function as a consistent source of information.

### 1.3.1.1.1.4.2 Event-State-Determinant-Indicators

The following are examples of four types of event-state-determinant-indicators that may be specified as the P2-components of EVS-units: invariant-occurrence-indicators, primary-circumstantial-condition-indicators, external-source-indicators, and LOGCON-indicators. The event-state-determinant-indicator in an EVS-unit indicates the type of factor that determined the occurrence-state indicated by the P3-component of that EVS-unit.

In an I-model, if the event-state-determinant-indicator in an EVS-unit is an invariant-occurrence-indicator, then that indicates that the occurrence-state indicated by the event-occurrence-state-indicator in that EVS-unit is invariant. An occurrence-state of an event is invariant if that occurrence-state is permanent and cannot change under any conditions or circumstances. Thus, it is independent of the occurrence-state of any other events represented in that I-model, or in any other I-model that includes a representation of that event. The invariance in that occurrence-state is due to that occurrence-state being determined only by the type-structures of one or more type-entities specified in that I-model, and, therefore, is not affected by any variations in circumstantial-conditions or in the properties of any base-entities in that, or any other, I-model, since the type-structure of each type-entity is itself invariant in every I-model where that type-entity is represented. For example, subtype-relationships between type-entities are invariant. Such invariance may be determined by the I-system containing that I-model or it may be specified by an external source. All EVS-units whose event-state-determinant-indicators are invariant-occurrence-indicators are EVS1-units or EVSO-units.

If the event-state-determinant-indicator in an EVS-unit is a primary-circumstantial-condition-indicator, then that EVS-unit represents a primary-circumstantial-condition in the subject of that I-model. The primary-circumstantial-conditions are events relative to which the occurrence-states of all other events indicated by EVS-units in that I-model are determined and fixed; that is, those other occurrence-states are the same throughout the combination of primary-circumstantial-conditions indicated in that I-model. Thus, the primary-circumstantial-conditions are events that partially or completely determine the extent or scope of the subject of that I-model. A primary-circumstantial-condition for an I-model is indicated by the P2-components of one or more EVS-units in that I-model.

A primary-circumstantial-condition in the subject of that I-model is co-related with all other events indicated by EVS1-units, EVS0-units, and EVSP-units in that I-model. For example, a specific time and location may be specified as a primary-circumstantial-condition in an I-model. An example is the subject indicated by ‘major weather events in the US in 2020’ in which the locations and times of the relevant events are restricted to those occurring in the US during 2020. Some events indicated by EVS-units in that I-model may be occurrent throughout that time, while the others are non-occurrent, and yet others may be occurrent for only part of that time.

A particular time-period that is specified as a primary-circumstantial-condition in an I-model is a primary-circumstantial-time-period. Such times are actually time-periods, rather than time-instants. For example, a clock-time of ‘2:48 PM’ actually indicates a time-period, not an instant of time. Depending on the type of clock, that time-period may be from 2:48 up to, but not including, 2:49, or it may be the time-period from 2:47:30 up to, but not including, 2:48:30.

If the event-state-determinant-indicator in an EVS-unit is an external-source-indicator, then that indicates that the occurrence-state of the event represented by the P1-component of that EVS-unit was not determined by the I-system, but, instead, by some other source. That indicator may indicate the type of that source, such as, for example, that that source is a human, another computer-based record-system, or a sensing device. In some I-models the external-source-indicators in EVS-units may include secondary components that indicate more-specific aspects of those external sources, such as, for example, their identities or locations. In cases where the source is of unknown or uncertain reliability and, hence, that the occurrence-states specified by that source are, or may be, unreliable, then the event-state-determinant-indicators for those EVS-units may include secondary components that indicate that actual or possible unreliability.

If the event-state-determinant-indicator in an EVS-unit is a LOGCON-indicator (‘logical-consequence-indicator’), then that indicates that the occurrence-state of the event represented by the P1-component of that EVS-unit was determined by LOGCON-construction-operations performed by one or more operative-components on one or more I-models in the I-system containing that EVS-unit. That LOGCON-indicator may include a secondary component that is a LOGCON-type-indicator. That LOGCON-type-indicator indicates the types of one or more LOGCON-relationship-pairs that were employed by those operative-components in performing that LOGCON-construction operation. (LOGCON-relationship-pairs are described in section 1.4.6.5.7). That LOGCON-type-indicator may also include a component that identifies one or more T-elements and IEV-elements that were operated upon by those operative-components in performing that LOGCON-construction operation.

An I-model may contain two or more EVS-units whose P1-components are E-equivalent while the P2-components indicate different determinants of the occurrence-state indicated by the P3-components. For example, one such P2-component may indicate an external source for the specification of the occurrence-state, while another of those P2-components may indicate that that occurrence-state is a circumstantial-condition.

Additional types of event-state-determinant-indicators may be specified in some embodiments.

### 1.3.1.1.1.4.3 Additional Aspects of EVS-Units

All invariant-occurrence-indicators are I-equivalent, as are all primary-circumstantial-condition-indicators, all LOGCON-indicators that do not include a LOGCON-type-indicator, all event-occurrence-indicators, all event-non-occurrence-indicators, all event-probability-indicators that indicate the same probability, and all event-included-occurrence-indicators that indicate the same type of included-occurrence-states. No event-occurrence-state-indicator is I-equivalent to any I-indicator of a different type.

The EVS-units in some I-models may be restricted to having only a P1-component and a P3-component. Those EVS-units do not indicate anything about the sources of the specifications of the occurrence-states represented by those EVS-units.

Additional types of event-state-determinant-indicators may be specified in I-models, as determined by the system-developers on the basis of practical considerations. The event-state-determinant-indicator in an EVS-unit may also have a component that indicates the type of event-occurrence-state-indicator in that unit.

Instead of including secondary indications of specific aspects of external sources of event-state specifications in the P2-components of EVS-units in an I-model, those additional indications may be included in I-units of a separate type in that I-model, as determined by the system-developers on the basis of practical considerations. That simplifies the structures of those EVS-units. That may also be the case with secondary components of the other types of event-state-determinant-indicators.

### 1.3.1.2 T-Units

Within an I-model, particular types of combinations of T-units constitute T-components. T-components represent components of type-structures for the type-entities that are represented by T-elements in those T-components. There is a corresponding type of T-unit for each type of base-primary I-unit.

Corresponding to the two general types of base-primary I-units, SR-units and EVS-units, there are two general types of T-units: TSR-units and TEVS-units. As further explained below, each TSR-unit includes a TSR-level-indicator.

There may be a proto-T/INST-unit-relationship (‘proto-type-instance-unit-relationship’) from a T-unit to a base-primary I-unit, as determined by the structural forms of those two units, as explained below. In addition, a proto-T/INST-unit-relationship from a T-unit to a base-primary I-unit also includes a proto-T/INST-element-relationship (‘type-instance-unit-relationship’) from each of one or more of the T-elements in that T-unit to E-elements in that base-primary I-unit. The various types of proto-T/INST-unit-relationships are explained in the following subsections.

Also as explained later, a proto-T/INST-component-relationship (‘type-instance-component-relationship’) from a T-component to an I-component may indicate that the collection of entities, and the relationships between them, that is represented by that I-component constitutes an instance of the type-structure represented by that T-component.

### 1.3.1.2.1 TSR-Units

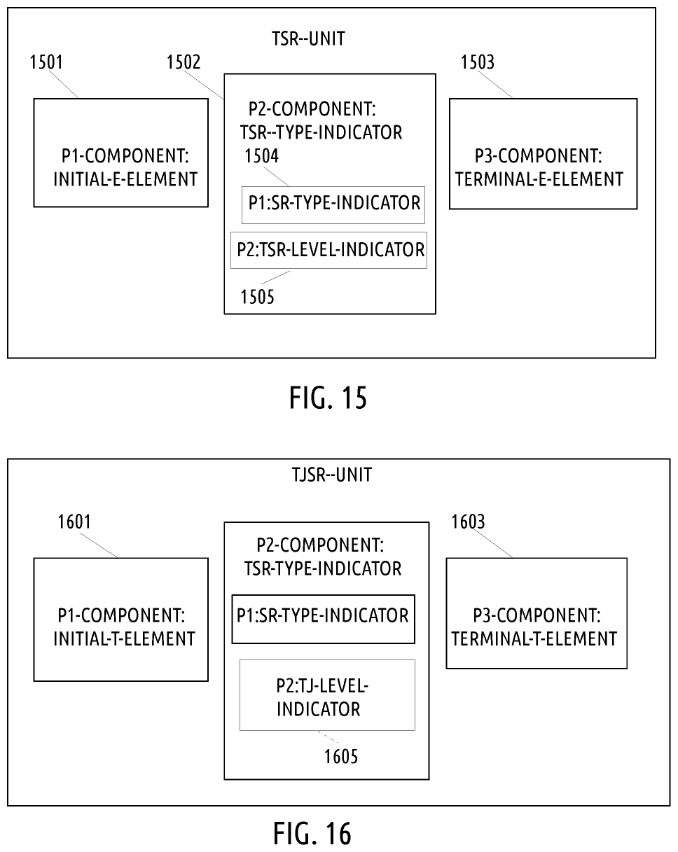

A TSR-unit (‘type-structure-relationship-unit’) is an I-unit that specifies a simple structural relationship between a T-element and another E-element. That structural relationship represents a component of a type-structure for the type-entity represented by that T-element. As shown in the illustration of a TSR-unit in FIG. 15, that T-element and that E-element are the P1-component 1501 and P3-component 1503 in that TSR-unit. The P2-component 1502 is a TSR-type-indicator, which indicates the type of that simple structural relationship. That E-element may be a T-element, but the two E-elements that comprise the P1-component and the P3-component are not E-equivalent. That P1-component is the initial-E-element in that unit, and the P3-component is the terminal-E-element in that unit. At least one of those two E-elements is a T-element.

The TSR-type-indicator has a P1-component 1504 and a P2-component 1505. That P1-component is an SR-type-indicator and that P2-component is a TSR-level-indicator. That TSR-level-indicator indicates that that TSR-unit represents a component of the type-structure for a type-entity represented by the initial-E-element or terminal-E-element in that unit. TSR-level-indicators are of three types: TJSR-level-indicators, T10SR-level-indicators, and T01SR-level-indicators.

As shown in FIG. 16, a TJSR-unit (‘joint-type-structural-relationship-unit’) is a TSR-unit in which the TSR-level-indicator 1605 is a TJSR-level-indicator. The initial-E-element 1601 and the terminal-E-element 1603 in that unit are both T-elements that represent joint type-entities in the same type-structure.

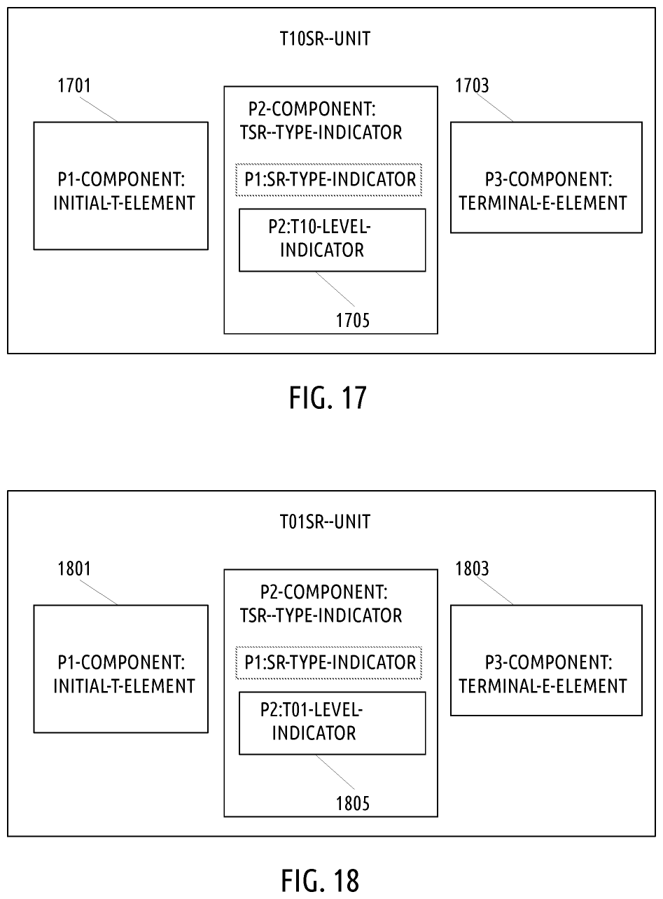

As shown in FIG. 17, a T10SR-unit (‘initial-type-structural-relationship-unit’) is a TSR-unit in which the TSR-level-indicator 1705 is a T10SR-level-indicator. The initial-E-element 1701 in that unit is a T-element. The terminal-E-element 1703 represents a fixed-entity in the type-structure for the type-entity represented by that T-element.

As shown in FIG. 18, a T01SR-unit (‘terminal-type-structural-relationship-unit’) is a TSR-unit in which the TSR-level-indicator 1805 is a T01SR-level-indicator. The terminal-E-element 1803 in that unit is a T-element. The initial-E-element 1801 represents a fixed-entity in the type-structure for the type-entity represented by that T-element.

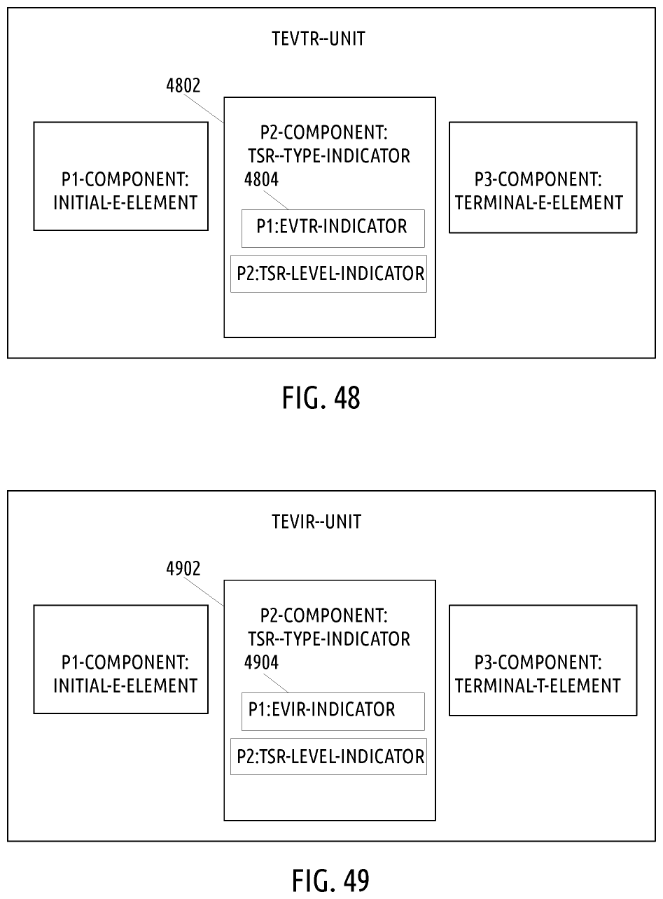

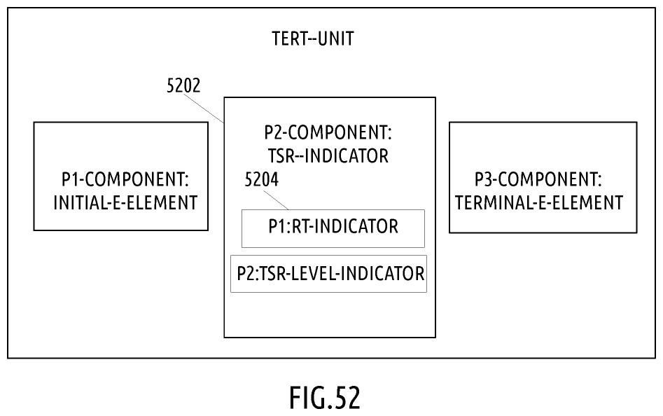

Corresponding to ERT-units, EVIR-units and EVTR-units, three very common types of TSR-units in I-models are TERT-units, TEVIR-units, and TEVTR-units. As shown in FIG. 52, a TERT-unit is a TSR-unit in which the P1-component 5204 of the TSR-type-indicator 5202 is an RT-indicator. A TJERT-unit is a TERT-unit that is a TJSR-unit. A T10ERT-unit is a TERT-unit that is a T10SR-unit. A T01ERT-unit is a TERT-unit that is a T01SR-unit. As shown in FIG. 48, a TEVTR-unit is a TSR-unit in which the P1-component 4804 of the TSR-type-indicator 4802 is an EVTR-indicator. A TJEVTR-unit is a TEVTR-unit that is a TJSR-unit. A T10EVTR-unit is a TEVTR-unit that is a T10SR-unit. A T01EVTR-unit is a TEVTR-unit that is a T01SR-unit. As shown in FIG. 49, a TEVIR-unit is a TSR-unit in which the P1-component 4904 of the TSR-type-indicator 4902 is an EVIR-indicator. A TJEVIR-unit is a TEVIR-unit that is a TJSR-unit. A T10EVIR-unit is a TEVIR-unit that is a T10SR-unit. A T01EVIR-unit is a TEVIR-unit that is a T01SR-unit.

### 1.3.1.2.2 TEVS-Units

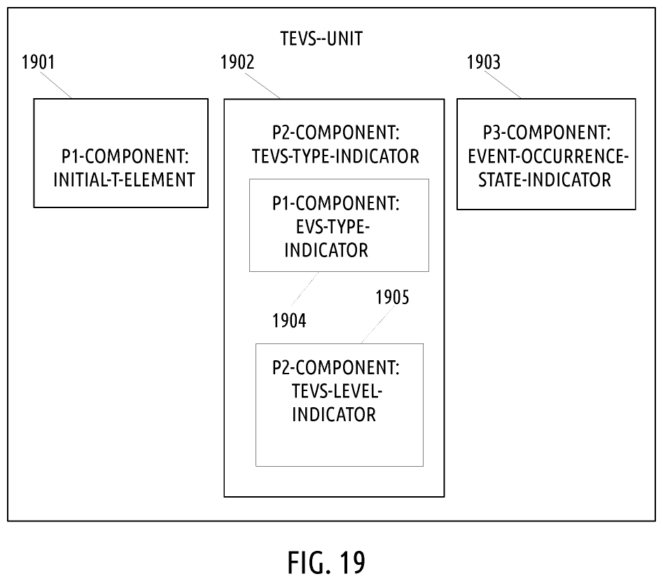

TEVS-units represent those components of type-structures whose instances indicate occurrence-states of events. As shown in FIG. 19, a TEVS-unit (‘event-state-type-unit’) is an I-unit in which the P1-component 1901 is a T-element; the P2-component 1902 is an I-indicator that is a TEVS-indicator; and the P3-component 1903 is an event-occurrence-state-indicator. That TEVS-indicator is an I-indicator that indicates that that T-unit represents a component of the type-structure for the type-entity represented by the P1-component of that T-unit. In an I-model, a TEVS-unit indicates that the instance-entities for the type-entity represented by the T-element that is the P1-component of that unit have the occurrence-state indicated by the P3-component of that unit. That TEVS-indicator may also include a component that is I-equivalent to an event-state-determinant-indicator.

### 1.3.1.2.3 Proto-T/INST-Pairs

Some I-units and some E-elements are related as proto-T/INST-pairs. As described later, a proto-T/INST-pair is a T/INST-pair under certain structural circumstances. T/INST-pairs represent (type-entity/instance) pairs. Proto-T/INST-pairs include proto-T/INST element-pairs, proto-TJSR/INST unit-pairs, proto-T10SR/INST unit-pairs, proto-T01SR/INST unit-pairs, and proto-TEVS/INST unit-pairs.

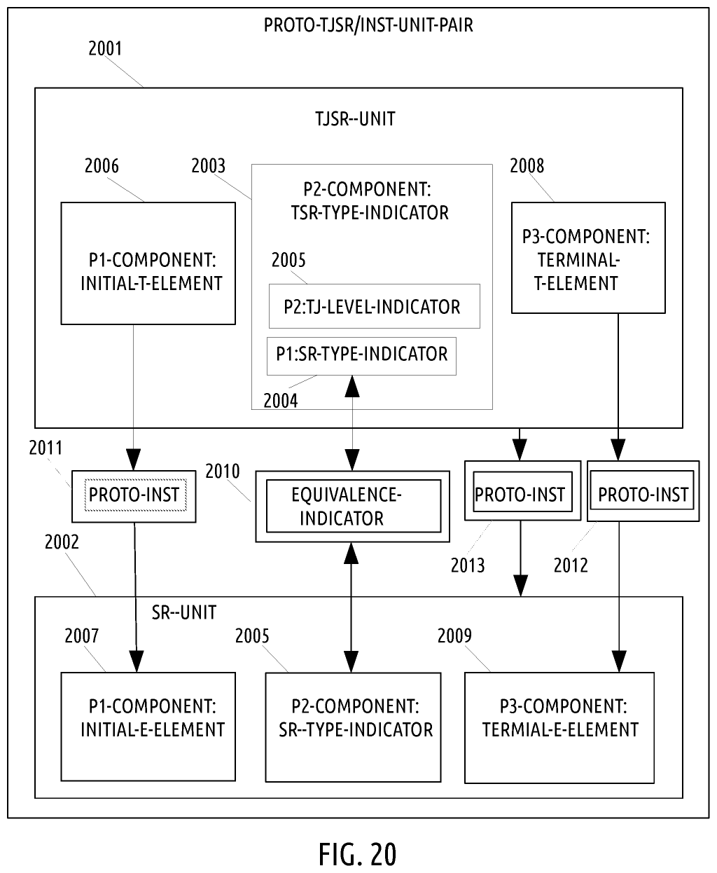

As shown in FIG. 20, a proto-TJSR/INST unit-pair is a (TJSR-unit, SR-unit) pair in which the SR-type-indicator 2004 in the P2-component 2003 in that TJSR-unit 2001 is I-equivalent 2010 to the SR-type-indicator 2005 in that SR-unit 2002. That proto-TJSR/INST unit-pair also includes proto-T/INST element-pairs (1) from the initial-T-element 2006 in that TJSR-unit to the initial-E-element 2007 in that SR-unit, and (2) from the terminal-E-element 2008 in that TJSR-unit to the terminal-E-element 2009 in that SR-unit. Those proto-T/INST element-pairs are indicated by the indicators 2011 and 2012, respectively. That proto-TJSR/INST unit-pair is indicated by the PROTO-INST indicator 2113.

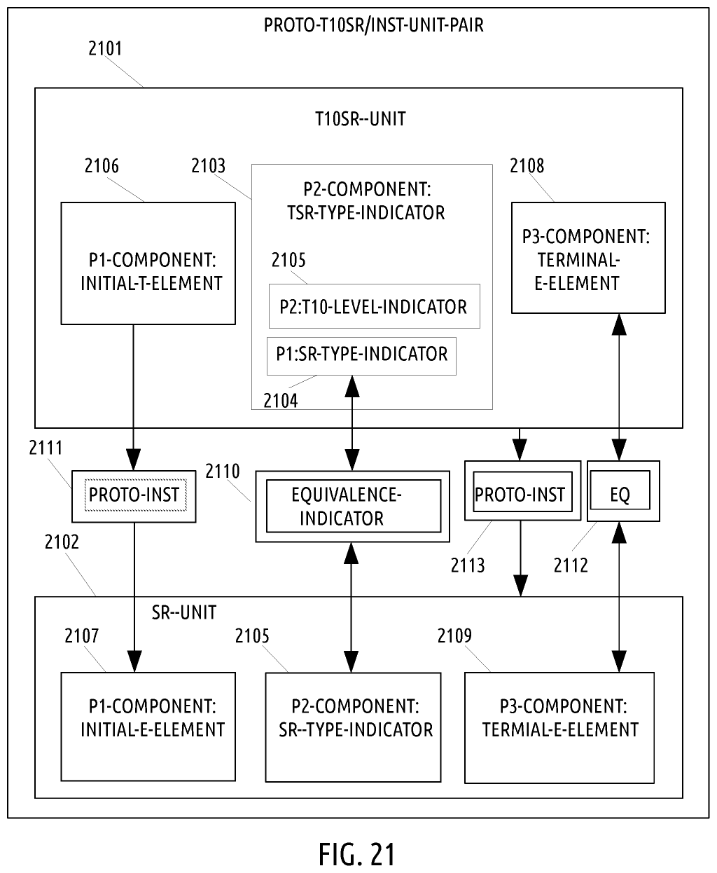

As shown in FIG. 21, a proto-T10SR/INST unit-pair is a (T10SR-unit, SR-unit) pair in which (1) the P1-component 2104 of the T10SR-type-indicator 2103 in that T10SR-unit 2101 is I-equivalent 2110 to the SR-type-indicator 2105 in that SR-unit 2202, and (2) there is an E-equivalence 2112 between the terminal-E-element 2108 in that T10SR-unit and the terminal-E-element 2109 in that SR-unit. That proto-T10SR/INS unit-pair also includes an indication 2111 of a proto-T/INST element-pair from the initial-E-element 2106 in that T10SR-unit to the initial-E-element 2107 in that SR-unit. That proto-T10SR/INST unit-pair is indicated by the PROTO-INST indicator 2113.

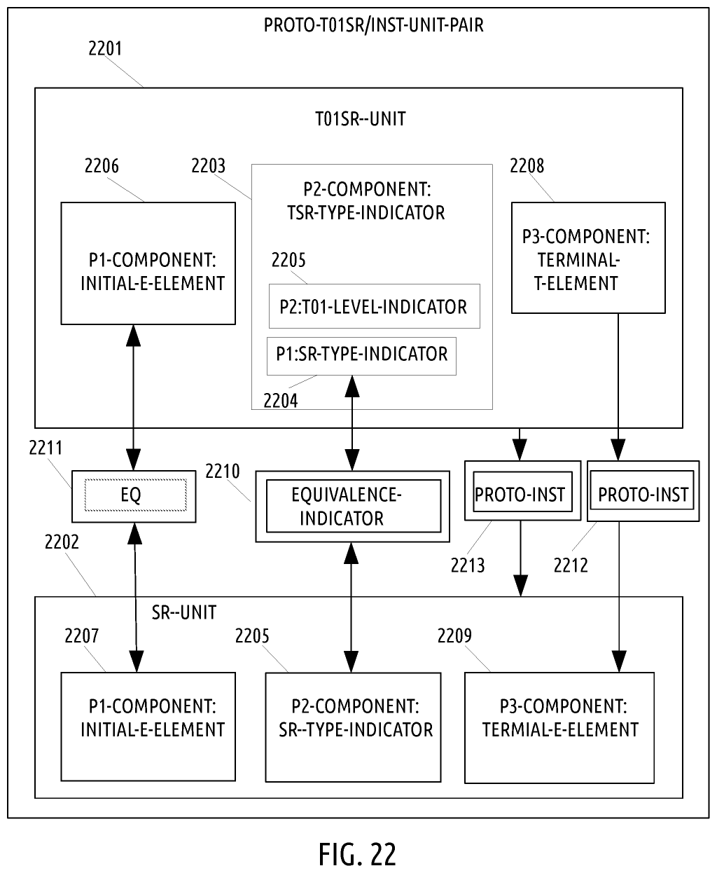

As shown in FIG. 22, a proto-T01SR/INST unit-pair is a (T01SR-unit, SR-unit) pair in which (1) the P1-component 2204 of the T01SR-type-indicator 2203 in that T01SR-unit 2201 is I-equivalent 2210 to the SR-type-indicator 2205 in that SR-unit 2202, and (2) there is an E-equivalence 2211 between the initial-E-element 2206 in that T01SR-unit and the initial-E-element 2207 in that SR-unit. That proto-T01SR/INS unit-pair also includes a proto-T/INST element-pair from the terminal-E-element 2208 in that T01SR-unit to the terminal-E-element 2209 in that SR-unit. That proto-T/INST element-pair is indicated by 2212. That proto-T01SR/INST unit-pair is indicated by the indicator 2213.

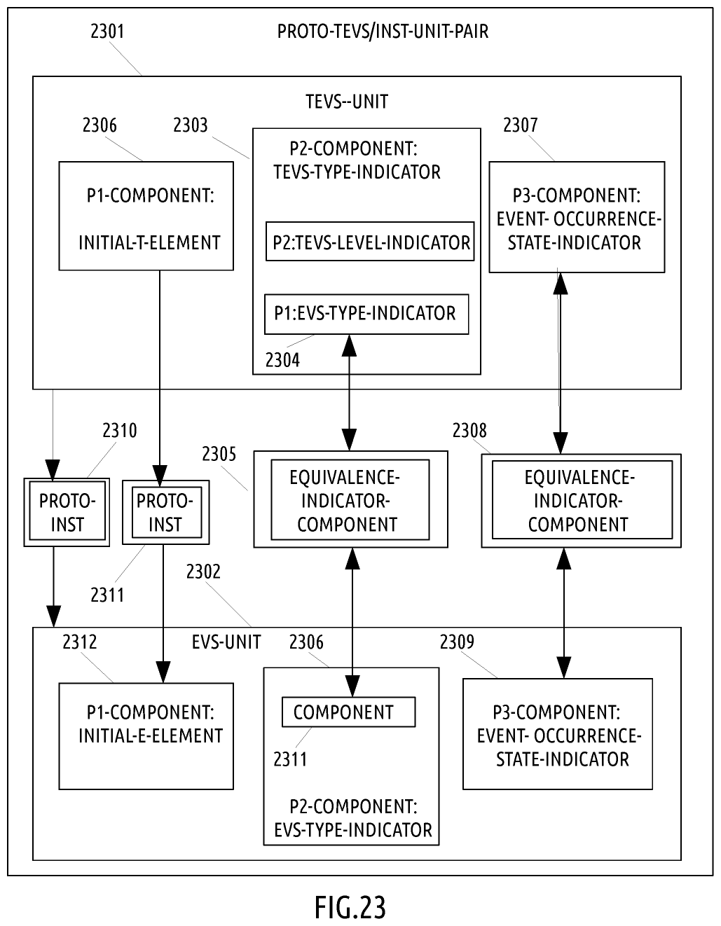

As shown in FIG. 23, a proto-TEVS/INST unit-pair is a (TEVS-unit, EVS-unit) pair in which the event-occurrence-state-indicators 2307 and 2309 that are the P3-components of those two units 2301 and 2302, respectively, are I-equivalent, as indicated by an equivalence-indicator 2308. That proto-T/INST unit-pair also includes a proto-T/INST element-pair from the P1-component 2306 of that TEVS-unit to the EV-element 2312 in that EVS-unit, as indicated by the indicator 2310. If the TEVS-indicator 2303 in that TEVS-unit 2301 also includes a component 2304 that is an event-state-determinant-indicator, then that event-state-determinant-indicator is I-equivalent 2305 to a component 2311 that is part or all of the event-state-determinant-indicator 2306 in that EVS-unit.

1.3.1.3 Comparison of Primary I-Units with Prior-Art Structures

It should be understood that any resemblance between primary I-units and other types of record units employed in prior-art computer-operative records is purely superficial. Consideration of the specific composition and representational function of each type of primary I-unit indicates that those units represent novel types of aspects of subjects that are far more specific, precise, and fundamental than those represented by prior-art representational units.

In particular, SR-units and EVS-units differ fundamentally from prior-art representational records that specify aspects of various subjects. Specifically, the terminal element in an ERT-unit represents a relationship-type-entity, and the IEV-elements in EVTR- and EVIR-units represent instance-events. Also, the P1-components in EVS-units represent type-events and instance-events. When I-units of those four types are combined to form I-components, as described in section 1.4.1.6, the resulting I-components provide for much greater specificity, precision, flexibility, and comprehensiveness in what may be represented about those subjects, as compared with prior-art structures.

### 1.3.1.4 Secondary I-Units

Secondary I-units are I-units that indicate various aspects of various components of I-models per se. The following are some general types of secondary I-units that may be present in an I-model: RT-specification-units, T-specification-status-units, INST-completeness-status-units, and record-indicator-units. In secondary I-units of each of those types, the P1-component of each of those units is an I-indicator that indicates that that unit is of that particular type.

### 1.3.1.4.1 RT-Specification-Units

An RT-specification-unit is a secondary I-unit whose P2-component and P3-component are joint-T-elements in a T-component. In that T-component, the structural relationship between those joint-T-elements represents a corresponding structural relationship between the joint type-entities in the type-structure represented by that T-component. Both of those structural relationships indicate a corresponding structural relationship that exists between the joint-instances of those two joint type-entities. The form of that structural relationship is determined by the combination of all T-components containing that T-component.

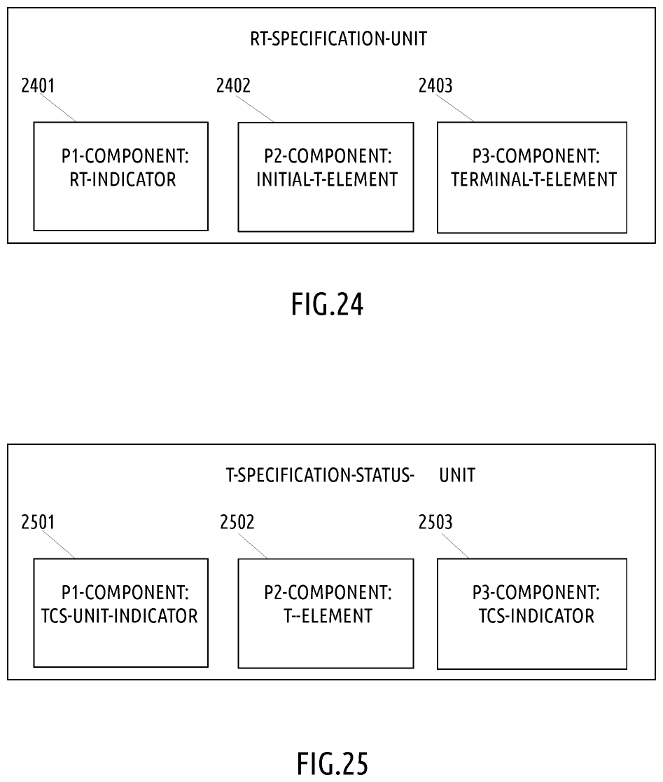

Specifically, as shown in the illustration of an RT-specification-unit in FIG. 24, the P1-component 2401 of that RT-specification-unit is an RT-indicator; the P2-component 2402 is a T-element; and the P3-component 2403 is a T-element that is not E-equivalent to that P2-component. The initial-T-element in that RT-specification-unit is the P2-component of that unit; that initial-T-element represents the initial-type-entity in that part of the type-structure represented by that RT-specification-unit. The RT-element in an RT-specification-unit is the terminal-E-element in that unit; it represents the terminal-type-entity in that type-structure.

If the RT-indicators in two RT-specification-units are I-equivalent, then their initial-T-elements are E-equivalent, and their RT-elements are also E-equivalent. If the initial-E-elements in two RT-specification-units are E-equivalent, and their RT-elements are E-equivalent, then their RT-indicators are I-equivalent. Neither the initial-T-element nor the RT-element in any RT-specification-unit is E-equivalent to the IEV-element in any EVTR-unit or EVIR-unit. For each RT-indicator in an I-model, that I-model may include an RT-specification-unit whose P1-component is I-equivalent to that RT-indicator.

There is a close relationship between RT-specification-units and ERT-units in I-models, as explained in the section on RT-specifications.

### 1.3.1.4.2 T-Specification-Status-Units

In an I-model, a T-specification-status-unit indicates whether or not the T-specification for a T-element in that I-model is either completely represented by a T-component in that I-model, or is determinable by an operative-component in the I-system containing that I-model. A T-specification for a T-element is a T-component for that T-element that represents the entirety of the type-structure for the type-entity represented by that T-element.

As shown in the illustration of a T-specification-status-unit in FIG. 25, the P1-component 2501 of that unit is a T-specification-status-unit-indicator; the P2-component 2502 is a T-element; and the P3-component 2503 is a T-specification-status-indicator that indicates the completeness status of the T-specification for the T-element that is that P2-component. The following are four types of T-specification-status-indicators: T-specification-completeness-indicators, T-specification-incompleteness-indicators, determinable-T-specification-indicators, and co-relationship-specification-completeness-indicators.

If the T-specification-status-indicator 2503 in a T-specification-status-unit is a T-specification-completeness-indicator, then that unit indicates that the complete type-structure for the type-entity represented by the P2-component of that unit is represented in that I-model by a T-specification.

If the T-specification-status-indicator 2503 in a T-specification-status-unit is a T-specification-incompleteness-indicator, then that unit indicates that the type-structure for the type-entity represented by the P2-component of that unit is not represented completely by any combination of T-components in that I-model.

If the T-specification-status-indicator 2503 in a T-specification-status-unit is a determinable-T-specification-indicator, then that unit indicates that the complete type-structure for the type-entity represented by the P2-component of that unit can be determined by means of automatic LOGCON-construction operations performed by the I-system on a combination of T-components in the I-model that contains that unit.

If the T-specification-status-indicator 2503 in a T-specification-status-unit is a co-relationship-specification-completeness-indicator, then that unit indicates that the I-model includes a combination of co-relationship-indicator-units that have P1-components that (1) are E-equivalent, and (2) are such that every instance-event that is co-related with the instance-events represented by the IEV-elements that are P3-components of those units is represented by an IEV-element that is the P3-component of one of those units.

If an I-model contains two T-specification-status-units whose P2-components are E-equivalent or are joint-T-elements, and the P3-component of one of those units is a T-specification-completeness-indicator, then the P3-component of the other unit may not be a T-specification-incompleteness-indicator. That prevents conflicting completeness-status-indications for the same T-element.

### 1.3.1.4.3 INST-Completeness-Status-Units

An INST-completeness-status-unit in an I-model indicates whether or not all the instance-entities for a type-entity represented by a specified T-element in that I-model are indicated by I-components in that I-model.

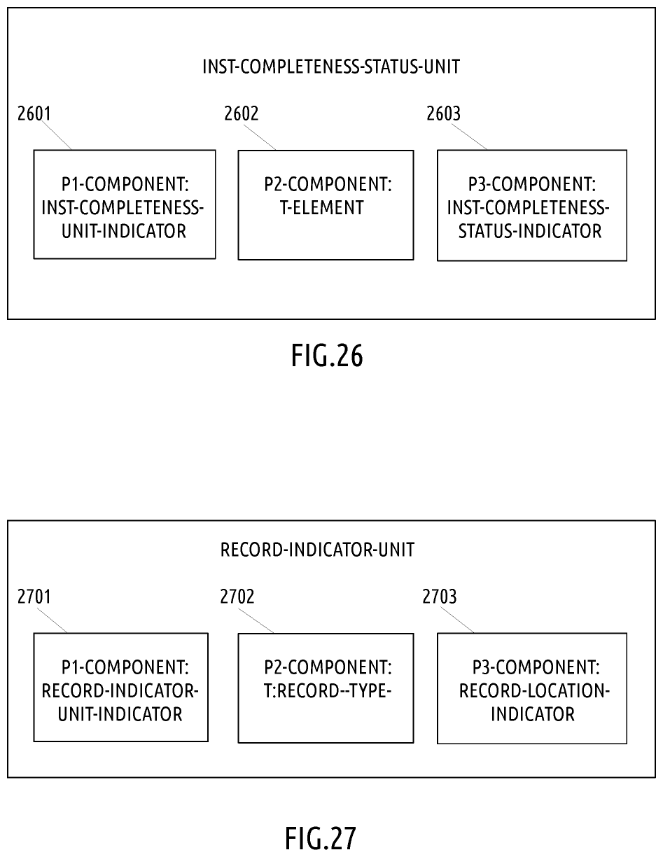

As shown in the illustration of an INST-completeness-status-unit in FIG. 26, the P1-component 2601 of that unit is an INST-completeness-status-unit-indicator; the P2-component 2602 is a T-element; and the P3-component 2603 is an INST-completeness-indicator or an INST-incompleteness-indicator. The P1-component indicates that that I-unit is an INST-completeness-status-unit. If the P3-component of that unit is an INST-completeness-indicator, then that unit indicates that all instance-entities of the type-entity represented by the P2-component of that unit are indicated as such by I-components in that I-model. If the P3-component of that unit is an INST-incompleteness-indicator, then that unit indicates that not all instance-entities for that type-entity are indicated as such by I-components in that I-model.

If the P2-components of two INST-completeness-status-units in an I-model are E-equivalent, then the P3-components are I-equivalent; that prevents conflicting INST-completeness-status indications for the same T-element.

In some I-models, the range of possible P3-components of INST-completeness-status-units may be expanded to include indicators that indicate either that all, or not all, non-instances of the type-entity represented by the P2-component of such a unit are represented as such in that I-model.

### 1.3.1.4.4 Record-Indicator-Units

A record-indicator-unit in an I-model indicates a record that is not part of the primary component of that I-model. That record may be of any type, such as, for example, a secondary-record in that I-model; another I-model in the computer-system containing that I-model; an I-model in another I-system; a record in another computer-system; or a record in an external storage system, such as a book in a library or a document in a file cabinet. Such records may range in size from a record of a name of some entity to an entire distributed database.

As shown in the illustration of a record-indicator-unit in FIG. 27, the P1-component 2701 of a record-indicator-unit is a record-indicator-unit-indicator that indicates that that I-unit is a record-indicator-unit; the P2-component 2702 is a T-element that represents a record-type; and the P3-component 2703 indicates the identity or location, or both, of a record that is an instance of that record-type. For example, if the instances of that record-type are all copies of a particular book, then the P3-component may indicate the location of a copy of that book.

In an I-model, an entity may be identified by a name that is represented in that I-model by a T-element. A record-indicator-unit may be employed in that I-model to identify a record that is a copy of an instance of that name.

### 1.3.1.4.5 Other Types of I-Units

As determined by the system-developers on the basis of practical considerations, some I-models may include other types of I-units. For example, corresponding to each SR-unit, an I-model may contain an inverse-SR-unit, in which the P1-component is E-equivalent to the P3-component of that SR-unit; the P3-component is I-equivalent to the P1-component of that SR-unit; and the P2-component is an inverse-SR-type-indicator that indicates a type of relationship that is the inverse of the type of relationship represented by the P2-component of that SR-unit. That inverse-SR-unit represents the same thing as that SR-unit, but the directionality of the relationship is reversed. Similarly, those I-models may also include inverse-TSR-units that correspond inversely to the TSR-units in those I-models. Such inverse-SR-units and inverse-TSR-units do not add to what those I-models represent, but may be represented for the purpose of facilitating search operations on those I-models.

Another example is that of secondary I-units that indicate operative-components that calculate measurements or perform LOGCON-operations of particular types to construct REV1-components or EVS-units for particular T-elements, ERT-elements, or E-elements that represent instances of such T-elements.

Another example is that of secondary I-units that indicate equivalences between specified I-components or E-elements in an I-model and specified components of other records.

Another example is that of a secondary I-unit that indicates a secondary-record of a name of the entity specified in that unit.

Another example is that of a secondary I-unit that indicates the type and identity of the source of some aspect of what is represented in an I-model. That I-unit may function as an alternative to the P2-component of an EVS-unit. In addition to events, those units may also indicate sources for other aspects of what is represented, such as particular entities and type-structures.

Another example is that of an I-unit that specifies that the type-entity represented by a specified T-element has a maximum of one instance under a specified condition, that is, the instance is unique for that condition. For example, each US citizen has a unique Social Security number under all conditions.

### 1.4 I-Components

An I-component is a record whose primary component consists of a combination of one or more inter-related I-units and, in some cases, one or more secondary-records such as configuration-identification components and E-equivalence-indicators. The I-units in that combination are inter-related by means of those E-equivalence-indicators that indicate E-equivalences between E-elements in those I-units. The specific structural forms of the various types of I-components in I-models may differ in different embodiments, as determined by the system-developers on the basis of practical considerations such as efficiency, processing, and storage.

Two I-units in an I-component in a purely-representational I-model are directly linked by the same E-element occurring as a primary component in both of those I-units. Each such E-element functions per se as an E-equivalence-indicator in that I-component.

The I-units in an I-component in an I-model that is not purely representational are directly inter-related by means of E-equivalence-indications in that I-model. Those indications may consist of E-elements that are E-equivalent having the same structural form, such as the same ID code. Alternatively, E-equivalences may be indicated by E-equivalence-indicators, that are secondary-records in that I-component or I-model that contain one or more E-equivalence-indicators that indicate E-equivalences between E-elements in I-units in that I-component or I-model. It is those E-equivalence-indicators in an I-model that inter-relate those I-units to form a single I-component. That inter-relation may not involve immediate physical proximity of those inter-related I-units.

Two I-units in an I-component that are not directly inter-related by an E-equivalence between a pair of E-elements in those two units are indirectly inter-related via a sequence of E-equivalences between two or more pairs of I-units in that I-component.

The primary component of an I-component consists of all the I-units in that I-component. An I-component may itself contain smaller I-components. An I-component may overlap with other I-components by means of E-equivalences between E-elements in those I-components. Two I-components in the same, or different I-models, are I-equivalent if every I-unit in each of those components is I-equivalent to an I-unit in the other I-component. I-equivalence of I-models is a restrictive form of the equivalence of records in general.

### 1.4.1 Basic I-Components

Some general types of basic I-components that are present in many I-models are IEVB-components, IEV-components, IEV1-components, IEV0-components, REVB-components, REV-components, REV1-components, and REV0-components.

Except as specified otherwise, in the remainder of this specification, I-components are described that are not physical networks in computer-based records that enable the construction of purely-representational I-components that are physical networks. In such physical-network records, various I-units overlap, by having in common components that represent the same entity. Instead, in systems of other types, including records in digital-computer systems, the same entity may be represented by different E-elements in an I-component. That is indicated by E-equivalence records.

### 1.4.1.1 IEVB-Components

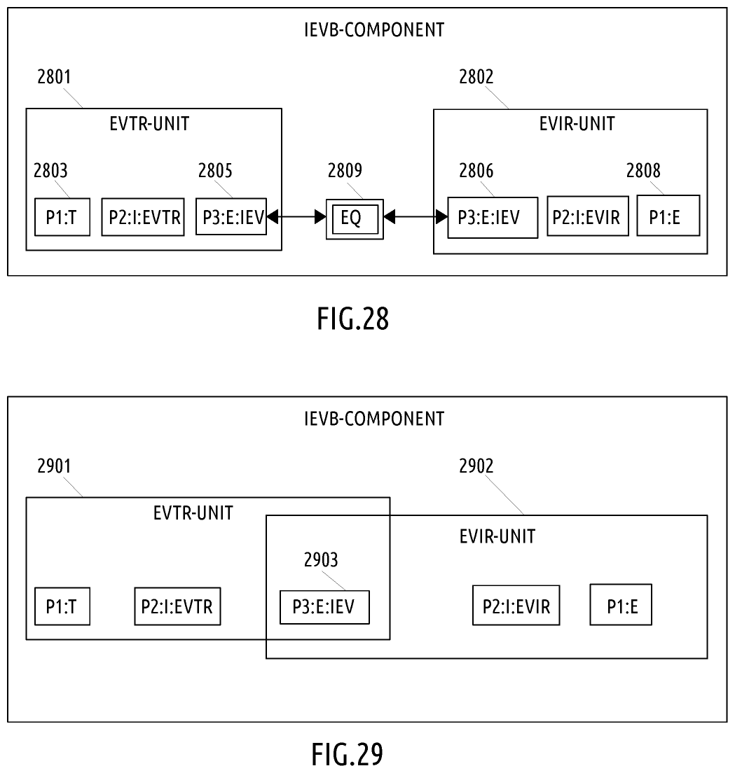

An IEVB-component (‘instance-event-base-component’) in an I-model represents a type of instance-event consisting of a specified entity that may, or may not, be an instance-entity for a specified type-entity, or may be under certain conditions. As shown in FIG. 28, the primary component of an IEVB-component is comprised of an EVTR-unit 2801 and an EVIR-unit 2802 whose P3-component 2806 is an IEV-element that is E-equivalent 2809 to the P3-component 2805 of that EVTR-unit. That IEV-element is the primary-IEV-element in that IEVB-component. That specified type-entity is represented by the P1-component 2803 in that EVTR-unit. That P1-component is the primary-T-element in that IEVB-component. That specified possible instance-entity is represented by the P1-component 2808 in that EVIR-unit. That second P1-component is the INST-element in that IEVB-component.

By comparison, FIG. 29 shows an IEVB-component in a physical-network-type computer-based record. The EVTR-unit 2901 and the EVIR-unit 2902 overlap by having the same P3-component 2903. Apart from that difference, FIGS. 28 and 29 show the same structural forms for those two versions of an IEVB-component. In the remainder of this description, only the form of non-physical-network I-components that includes E-equivalences is shown in the figures.

### 1.4.1.2 IEV-Components

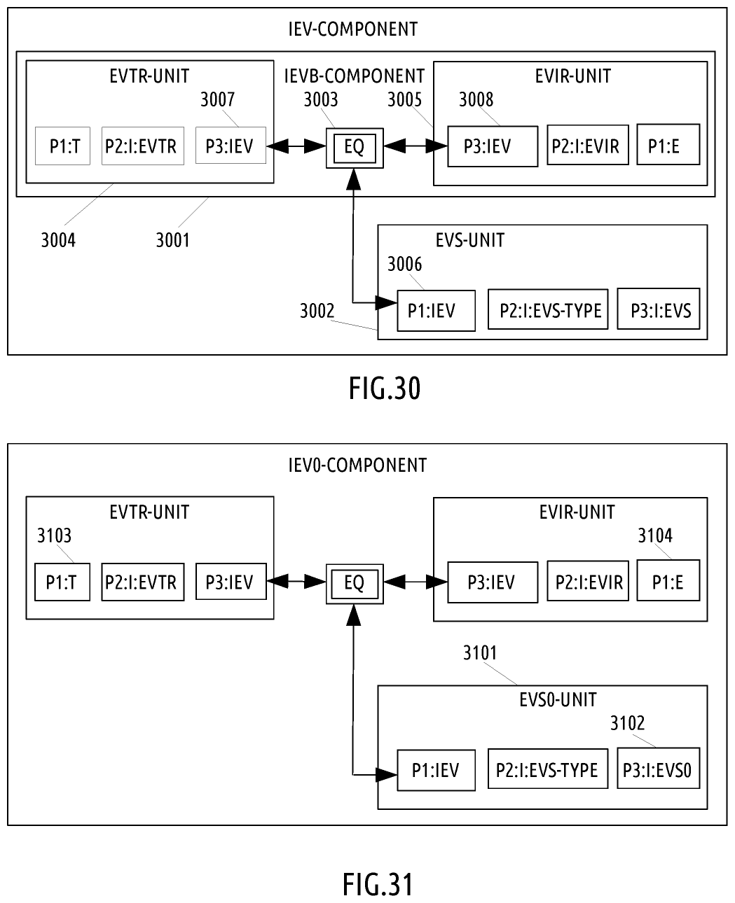

An IEV-component (‘instance-event-component’) is an I-component that represents an instance-event. As shown in FIG. 30, the primary component of that IEV-component is comprised of an IEVB-component 3001 and an EVS-unit 3002 whose EV-element 3006 is E-equivalent 3003 to both the IEV-element 3007 in the EVTR-unit 3004 and the IEV-element 3008 in the EVIR-unit 3005 in that IEVB-component.

### 1.4.1.3 IEV0-Components

As shown in FIG. 31, an IEV0-component (‘instance-event-non-occurrence-component’) is an IEV-component in which the EVS-unit 3101 is an EVS0-unit, as indicated by the event-non-occurrence-indicator in the P3-component 3102 in that unit. An IEV0-component in an I-model indicates that the entity represented by the INST-element 3104 in that component is not an instance of the type-entity represented by the primary-T-element 3103 in that component.

### 1.4.1.4 IEV1-Components

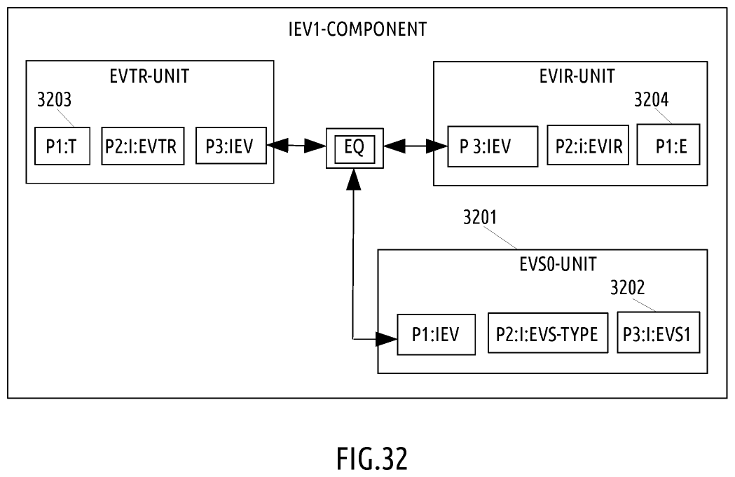

As shown in FIG. 32, an IEV1-component (‘instance-event-occurrence-component’) is an IEV-component in which the EVS-unit 3201 is an EVS0-unit, as indicated by the event-occurrence-indicator in the P3-component 3202 in that unit. An IEV1-component in an I-model indicates that the entity represented by the INST-element 3204 in that component is an instance of the type-entity represented by the primary-T-element 3203 in that component.

### 1.4.1.5 REVB-Components

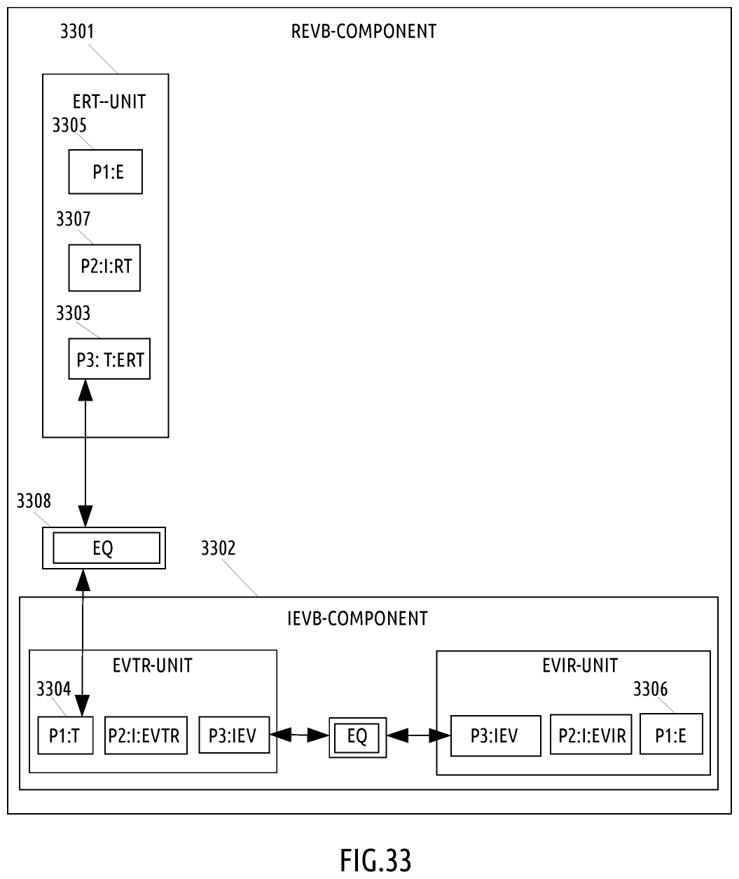

An REVB-component (‘relationship-event-base-component’) in an I-model represents a type of relationship-event consisting of a specified type of possible relationship between two specified entities that may, or may not be related in that manner, or may be under certain conditions. As shown in FIG. 33, the primary component of an REVB-component comprises an ERT-unit 3301 and an IEVB-component 3302 whose primary-T-element 3304 is E-equivalent 3308 to the ERT-element 3303 in that ERT-unit. The initial-E-element in that REVB-component is the initial-E-element 3305 in that ERT-unit. The terminal-E-element in that REVB-component is the INST-element 3306 in that IEVB-component. The primary-IEV-element in that REVB-component is the primary-IEV-element in the IEVB-component of that REVB-component. The primary-RT-indicator in that REVB-component is the RT-indicator 3307 in the ERT-unit.

The same ERT-unit may be combined with two or more different IEVB-components whose primary-T-elements are all E-equivalent to the ERT-element in that ERT-unit. In that case, the resulting component is an REVB-expansion-component.

An REVB-component in an I-model indicates a specific type of relationship that may exist between the entity represented by the initial-E-element in that component and the entity represented by the terminal-E-element. That type of relationship is indicated by the primary-RT-indicator in that REVB-component. For each RT-indicator in an I-model there may be one or more REVB-components in which the primary-RT-indicators are I-equivalent to that RT-indicator but in which the initial- and terminal-E-elements represent different pairs of entities that may be related in the manner indicated by those REVB-components. No IEV-element in an EVTR-unit or an EVIR-unit in the IEVB-component of an REVB-component is E-equivalent to the P1-component of the ERT-unit in that REVB-component.

### 1.4.1.6 REV-Components

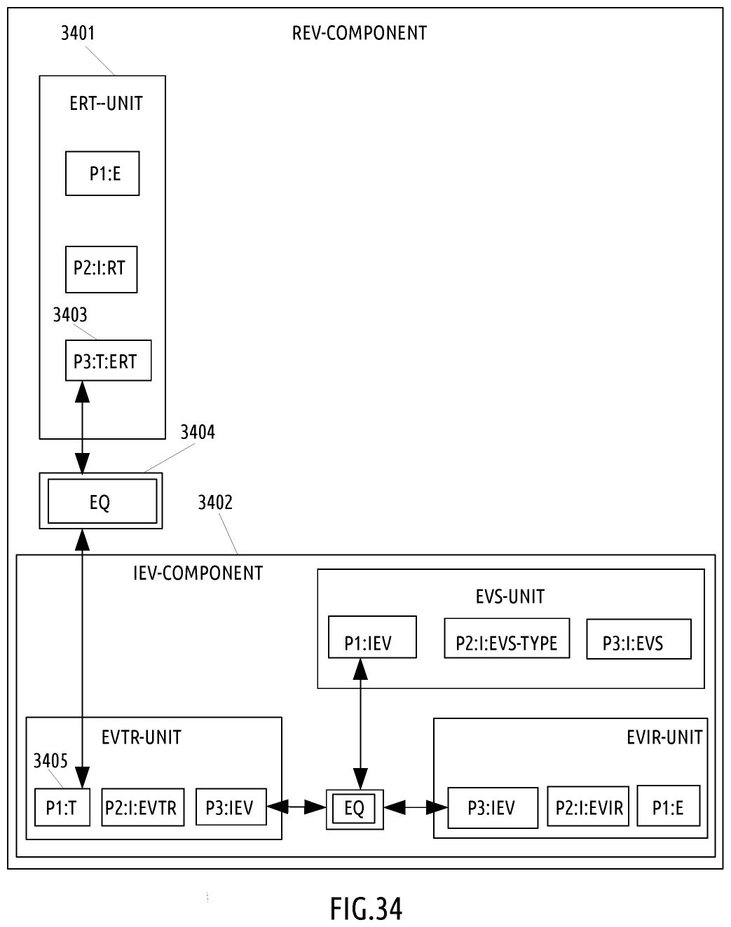

An REV-component (‘relationship-event-component’) represents a relationship-event. A relationship-event consists of the occurrence, or non-occurrence, of a relationship between two entities. As shown in FIG. 34, an REV-component is an I-component whose primary component consists of an REVB-component 3401 and an EVS-unit 3402 whose EV-element is E-equivalent to the IEV-element 3405 in the EVTR-unit 3403 and to the IEV-element in the EVIR-unit 3404 in the REVB-component. The initial-E-element in the REV-component is the initial-E-element in the REVB-component. The terminal-E-element in the REV-component is the terminal-E-element in the REVB-component. The primary-IEV-element in the REV-component is the primary-IEV-element in the REVB-component in that REV-component. The primary-RT-indicator in the REV-component is the RT-indicator in the REVB-component; it indicates the type of relationship between the entities represented by the initial- and terminal-E-elements.

Note that an REV-component may also be understood as consisting of the combination of an ERT-unit and an IEV-component whose primary-T-element is equivalent to the terminal-RT-element in that ERT-unit.

An REV-expansion-component is an REV-component in which the REVB-component is replaced by an REVB-expansion-component, described above.

There are two basic types of REV-components: REV1-components and REV0-components.

### 1.4.1.6.1 REV0-Components

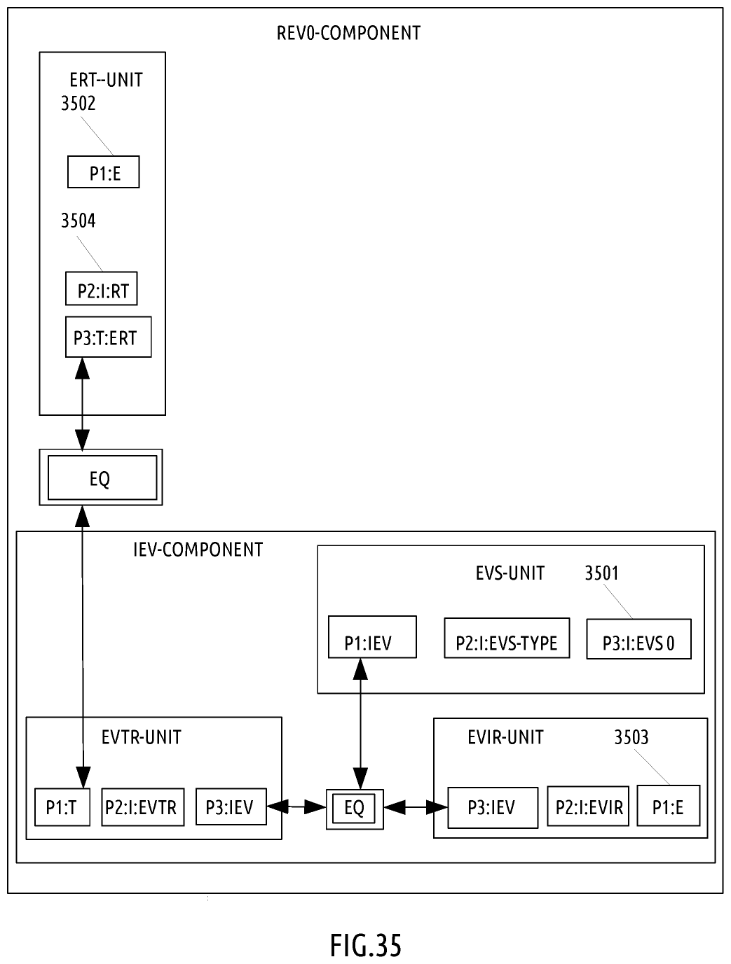

As shown in FIG. 35, an REV0-component (‘relationship-event-non-occurrence-component’) is an REV-component in which the event-occurrence-state-indicator 3501 is an event-non-occurrence-indicator. An REV0-component in an I-model indicates that the entity represented by the terminal-E-element 3503 in that component is not related to the entity represented by the initial-E-element 3502 in that component by a relationship of the specific type indicated by primary-RT-indicator 3504 in that REV0-component.

### 1.4.1.6.2 REV1-Components

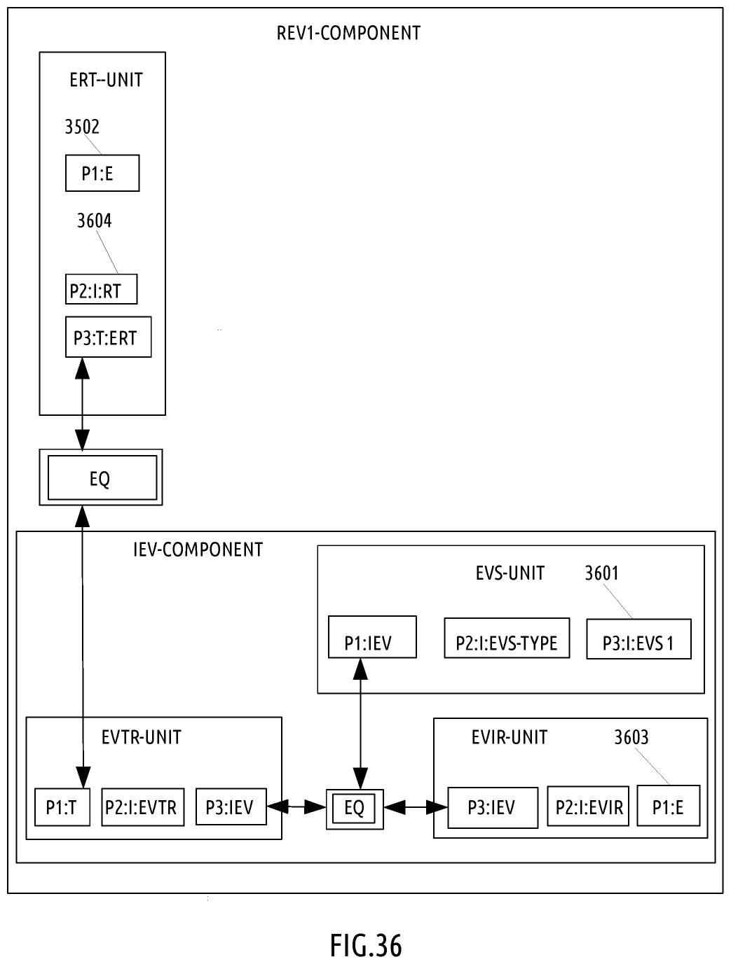

As shown in FIG. 36, an REV1-component (‘relationship-event-occurrence-component’) is an REV-component in which the event-occurrence-state-indicator 3601 is an event-occurrence-indicator. An REV1-component in an I-model indicates that the entity represented by the terminal-E-element 3603 in that component is related to the entity represented by the initial-E-element 3602 in that component by a relationship of the specific type indicated by the primary-RT-indicator 3604 in that REV1-component.

### 1.4.2 Some Specific Types of REV-Components

A relationship of any type between two entities may be represented by a combination of one or more REV-components in an I-model. The following paragraphs describe examples of some common types of REV1-components that may exist in an I-model. For each such type of REV1-component there is a corresponding type of REV0-component and a corresponding type of REVB-component, such that those three components have RT-indicators that are I-equivalent.

### 1.4.2.1 REV1-Event-Occurrence-Implication-Components

REV1-event-occurrence-implication-components represent implication-relationships between the occurrence-states for different events. There are four basic types of REV1-event-occurrence-implication-components: REV1-11-event-occurrence-implication-components, REV1-10-event-occurrence-implication-components, REV1-01-event-occurrence-implication-components, and REV1-00-event-occurrence-implication-components.

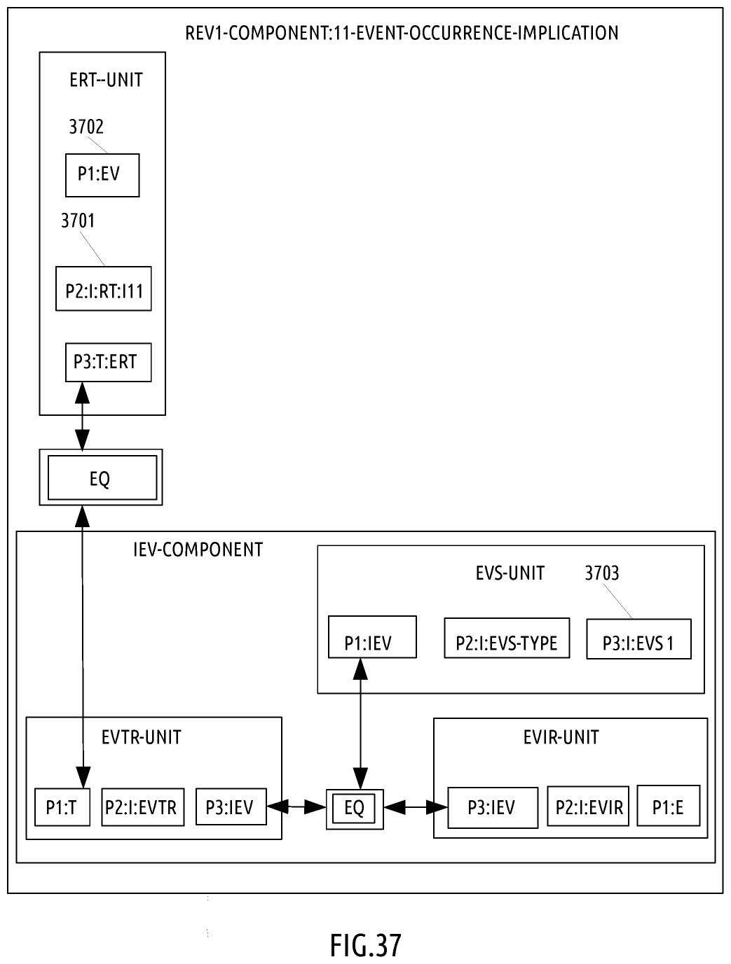

As shown in FIG. 37, an REV1-11-event-occurrence-implication-component is an REV1-component in which the primary-RT-indicator 3701 is a 11-event-occurrence-implication-RT-indicator, and the initial-E-element 3702 and the terminal-E-element 3703 are EV-elements. That component indicates that, if the event represented by the initial-E-element is occurrent, then the event represented by the terminal-E-element is also occurrent. For example, the implication-relationship, ‘if the green light is on, then the machine is operating’, may be represented by a REV1-11-event-occurrence-implication-component in which the initial-E-element represents the event consisting of the green light being on, and the terminal-E-element represents the event consisting of the machine having the operational-state, ‘operating’.

An REV1-10-event-occurrence-implication-component has the same general structure as an REV1-11-event-occurrence-implication-component except that the primary-RT-indicator 3701 is replaced by a 10-event-occurrence-implication-RT-indicator. That component indicates that, if the event represented by the initial-E-element is occurrent, then the event represented by the terminal-E-element is non-occurrent.

An REV1-01-event-occurrence-implication-component has the same general structure as an REV1-11-event-occurrence-implication-component except that the primary-RT-indicator 3701 is replaced by a 01-event-occurrence-implication-RT-indicator. That component indicates that, if the event represented by the initial-E-element is non-occurrent, then the event represented by the terminal-E-element is occurrent.

An REV1-00-event-occurrence-implication-component has the same general structure as an REV1-11-event-occurrence-implication-component except that the primary-RT-indicator 3701 is replaced by a 00-event-occurrence-implication-RT-indicator. That component indicates that, if the event represented by the initial-E-element is non-occurrent, then the event represented by the terminal-E-element is non-occurrent.

In an I-model, the occurrence-relationships between events represented by REV1-event-occurrence-implication-components may or may not involve any causal relationship between those occurrences; such relationships may be purely logical relationships or coincidental relationships. 1.4.2.2 REV1-event-occurrence-conjunction-components

REV1-event-occurrence-conjunction-components represent events consisting of conjunction-relationships between the occurrence-states for different events. There are four basic types of REV1-event-occurrence-conjunction-components: REV1-11-event-occurrence-conjunction-components, REV1-10-event-occurrence-conjunction-components, REV1-01-event-occurrence-conjunction-components, and REV1-00-event-occurrence-conjunction-components.

An REV1-11-event-occurrence-implication-component has the same general structure as an REV1-11-event-occurrence-implication-component except that the primary-RT-indicator 3701 is replaced by a 11-event-occurrence-conjunction-RT-indicator. The primary-IEV-element represents the event consisting of the occurrence of both of the events represented by the initial- and terminal-E-elements in that component.

An REV1-01-event-occurrence-conjunction-component has the same general structure as an REV1-11-event-occurrence-implication-component except that the primary-RT-indicator 3701 is replaced by a 01-event-occurrence-conjunction-RT-indicator. That component indicates that the event represented by the initial-E-element is not occurrent and the event represented by the terminal-E-element is occurrent. The primary-IEV-element represents the event consisting of the combination of the occurrence of the event represented by the initial-E-element and the non-occurrence of the event consisting of the non-occurrence of the event represented by the terminal-E-element.

An REV1-10-event-occurrence-conjunction-component has the same general structure as an REV1-11-event-occurrence-implication-component except that the primary-RT-indicator 3701 is replaced by a 10-event-occurrence-conjunction-RT-indicator. That component indicates that the event represented by the initial-E-element is occurrent and the event represented by the terminal-E-element is not occurrent. The primary-IEV-element represents the event consisting of the combination of the non-occurrence of the event represented by the initial-E-element and the occurrence of the event consisting of the non-occurrence of the event represented by the terminal-E-element.

An REV1-00-event-occurrence-conjunction-component has the same general structure as an REV1-11-event-occurrence-implication-component except that the primary-RT-indicator 3701 is replaced by a 00-event-occurrence-conjunction-RT-indicator. That component indicates that the events represented by the initial- and terminal-E-elements are both non-occurrent. The primary-IEV-element represents the event consisting of the non-occurrence of both of the events represented by the initial- and terminal-E-elements in that component.

The two E-equivalent IEV-elements in the IEVB-component in an REV1-event-occurrence-conjunction-component both represent a composite event whose primary components are the events represented by the EV-elements that are the initial- and terminal-E-elements in that REV1-event-occurrence-conjunction-component.

### 1.4.2.3 Correspondences Between Event-Occurrence-Implication-REV-Components and Event-Occurrence-Conjunction-REV-Components.

For each of the four types of REV1-event-occurrence-implication-components there is one of the four types of REV0-event-occurrence-conjunction-components that represents the same occurrence-relationships, with the initial- and terminal-EV-elements interchanged, as follows: REV0-11-event-occurrence-conjunction-components correspond to REV1-01-event-occurrence-implication-components; REV0-01-event-occurrence-conjunction-components correspond to REV1-11-event-occurrence-implication-components; REV0-10-event-occurrence-conjunction-components correspond to REV1-00-event-occurrence-implication-components; and REV0-00-event-occurrence-conjunction-components correspond to REV1-10-event-occurrence-implication-components.

Similarly, for each of the four types of REV1-event-occurrence-conjunction-components there is one of the four types of REV0-event-occurrence-implication-components that represents the same occurrence-relationships, with the initial- and terminal-EV-elements interchanged, as follows: REV0-11-event-occurrence-implication-components correspond to REV1-01-event-occurrence-conjunction-components; REV0-01-event-occurrence-implication-components correspond to REV1-11-event-occurrence-conjunction-components; REV0-10-event-occurrence-implication-components correspond to REV1-00-event-occurrence-conjunction-components; and REV0-00-event-occurrence-implication-components correspond to REV1-10-event-occurrence-conjunction-components.

An I-model may be restricted in such a manner that it has no REV0-event-occurrence-implication-components and no REV0-event-occurrence-conjunction-components. In those I-models, the corresponding REV1-components described above are sufficient to provide the same representational functions.

### 1.4.2.4 REV1-Name-Components

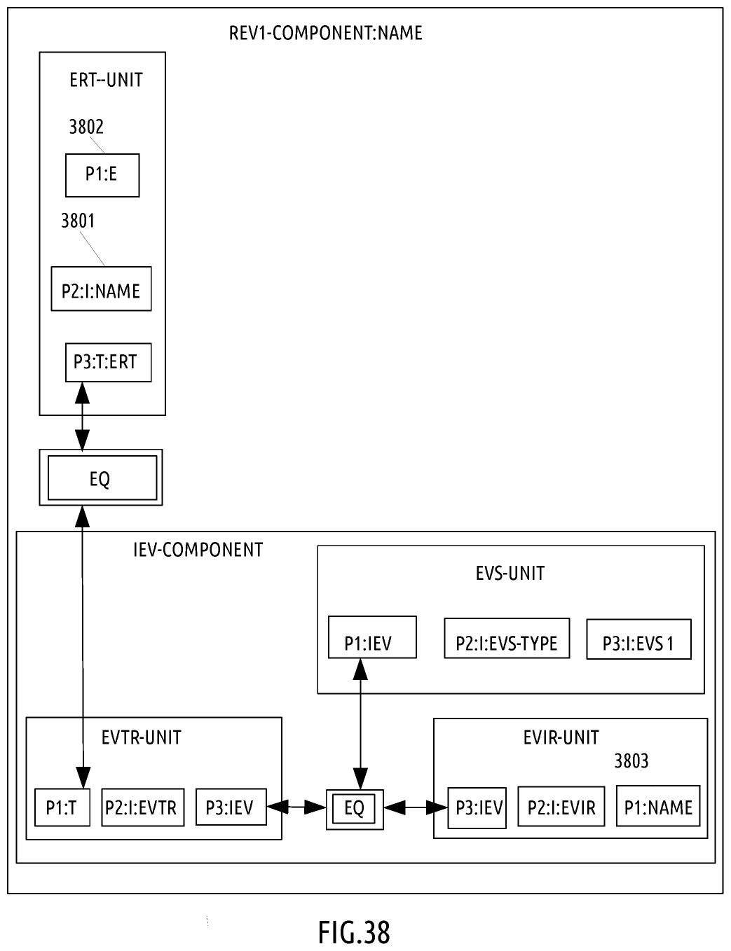

As shown in FIG. 38, an REV1-name-component is an REV1-component in which the primary-RT-indicator 3801 is an name-RT-indicator, the initial-E-element 3802 is an E-element, and the terminal-E-element 3803 is a T-element that is a record-type that is a name. That component indicates that the terminal-E-element represents a name of the entity represented by the initial-E-element in that component.

An entity-type may have a name that is specified by an REV1-name-component whose initial-E-element is a T-element that represents that type-entity. An entity-type may have more than one name specified by REV1-name-components, but different entity-types have different names specified by REV1-name-components.

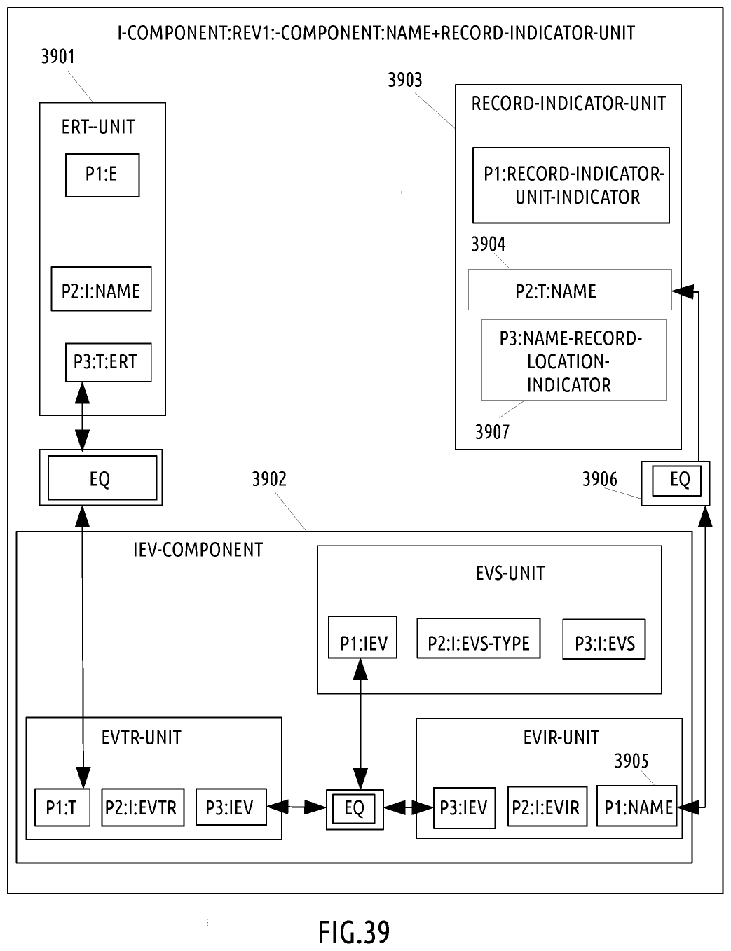

As shown in FIG. 39, a record-indicator-unit 3903 may be employed in combination with that REV1-name-component 3901 and 3902 to identify the location 3907 of a copy of an instance of that name. The P2-component 3904 of that unit is E-equivalent 3906 to the terminal-E-element 3905 in that REV1-name-component.

### 1.4.2.5 REV1-Subtype-Components

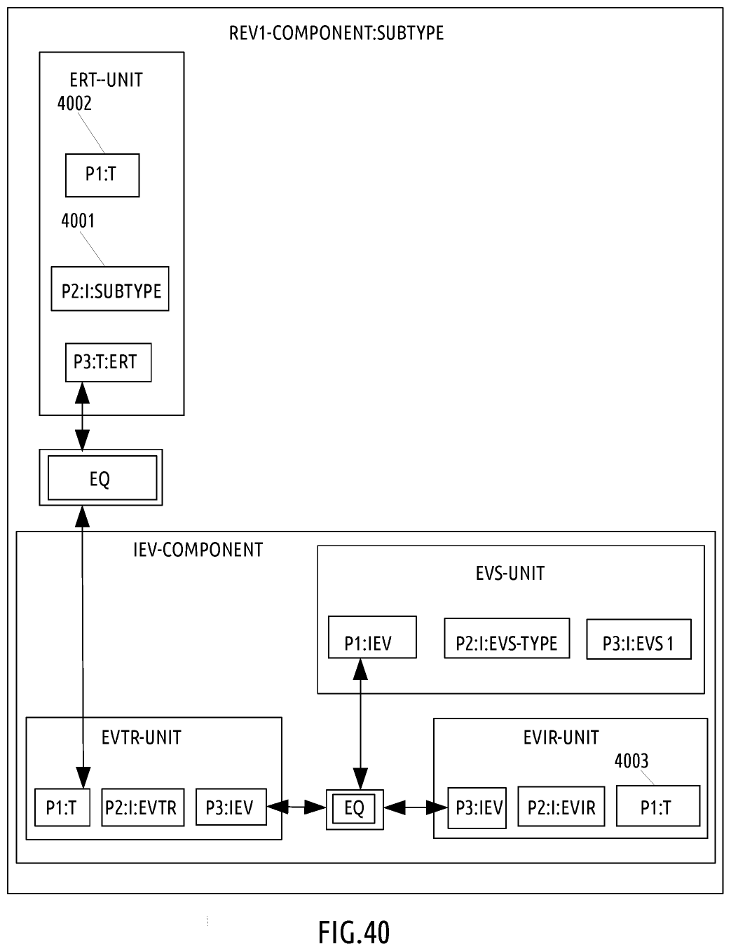

As shown in FIG. 40, an REV1-subtype-component is an REV1-component in which the primary-RT-indicator 4001 is a subtype-RT-indicator, the initial-E-element 4002 is a T-element, and the terminal-E-element 4003 is a T-element. That component indicates that that terminal-E-element represents a type-entity that is a subtype of the type-entity represented by that initial-E-element in that component.

### 1.4.2.6 REV1-Type-Instance-Number-Components

An REV1-type-instance-number-component is an REV1-component in which the primary-RT-indicator is a type-instance-number-RT-indicator, the initial-E-element is a T-element, and the terminal-E-element is a T-element that represents a non-negative integer. That component indicates that that terminal-E-element represents the number of instances of the type-entity represented by that initial-E-element in that component. When the initial-E-elements in two or more of such components are E-equivalent, then the terminal-E-elements in those components are E-equivalent. That corresponds to the fact that the same type-entity may not simultaneously have different numbers of instances.

### 1.4.2.7 REV1-Type-Contratype-Components

An REV1-type-contratype-component is an REV1-component in which the primary-RT-indicator is a type-contratype-RT-indicator, the initial-E-element is a T-element, and the terminal-E-element is a T-element. That component indicates that that terminal-E-element represents a type-entity that is a contratype of the type-entity represented by that initial-E-element in that component.

A contratype for a type-entity is a type-entity whose type-structure specifies that the instances of that contratype-entity are all those entities that are not instances of that other type-entity. A simple example of a contratype relationship is the type-entity whose type-structure indicates that that type-entity's instances are all those entities that are not longer than 12 inches; that is the contratype of the type-entity whose type-structure indicates that the instances of that type-entity are all those entities that are longer than 12 inches. In fact, each of those two type-entities is a contratype of the other. A more complex example is ‘entities that are not longer than 12 inches and weigh less than one pound’; the contratype of that type-entity is ‘entities that are longer than 12 inches or weigh one pound or more’; thus the conjunction of the two properties in the specification of that first type-structure is changed to a disjunction of the two negated properties in the type-structure of the contratype-entity.

### 1.4.2.8 REV1-Event-Probability-Components

An REV1-event-probability-component is an REV1-component in which the primary-RT-indicator is an event-probability-RT-indicator, the initial-E-element is an EV-element, and the terminal-E-element is a T-element that represents a probability value. That component indicates that the terminal-E-element represents the probability of the occurrence of the event represented by the initial-E-element in that component. If the initial-E-element in that component is a T-element, then that event consists of the type-entity represented by that T-element having at least one instance-entity containing that component. If the initial-E-element is an EV-element in an IEVB-component, then that event consists of the entity represented by the INST-element in that IEVB-component being an instance-entity for the type-entity represented by the primary-T-element in that IEVB-component.

An I-model may be restricted to having only one probability specification for a specified event. In that case, when the initial-E-elements in two or more REV1-event-probability-components are E-equivalent, then the terminal-E-elements in those components are E-equivalent. An REV1-event-probability-component may function in an I-model as an alternative to an EVS-unit that indicates a probability, particularly when additional information regarding that probability is represented in that I-model.

### 1.4.2.9 REV1-Basic-Entity-Component-Components

An REV1-basic-entity-component-component is an REV1-component in which the primary-RT-indicator is a basic-entity-component-RT-indicator, the initial-E-element is an E-element that represents a basic entity, and the terminal-E-element is an E-element that represents a basic entity. That component indicates that the basic-entity represented by the terminal-E-element is a component of the basic-entity represented by the initial-E-element. That second entity may be a collection or group of entities, or a complex entity that has relationships between its components.

### 1.4.2.10 REV1-Event-Component-Components

An REV1-event-component-component is an REV1-component in which the primary-RT-indicator is an event-component-RT-indicator, the initial-E-element is an IEV-element, and the terminal-E-element is an EV-element. That component indicates that the event represented by the terminal-E-element is a component of the composite event represented by the initial-E-element. Any set of events may be specified as the components of a composite event.

### 1.4.2.11 REV1-Clock-Time-Components

An REV1-clock-time-component is an REV1-component in which the primary-RT-indicator is a clock-time-RT-indicator, the initial-E-element represents a clock or other time-measurement device, and the terminal-E-element represents a name of a particular time-measurement indicated by that time-measurement device. That component indicates that the terminal-E-element represents a name of a time-measurement specified by the time-measurement device represented by the initial-E-element.

Different types of REV1-clock-time-components may account for different types of time-measurements; for example, some may include the date while some others may be restricted to hours, minutes, and seconds. Some may consist only of a date, or a year, or some other time-period.

### 1.4.2.12 REV1-Event-Occurrence-Time-Components

An REV1-event-occurrence-time-component is an REV1-component in which the primary-RT-indicator is an event-occurrence-time-RT-indicator, the initial-E-element is an EV-element, and the terminal-E-element is an E-element that represents a particular time-measurement name. That component indicates that the event represented by that initial-E-element occurs throughout the time period indicated by that terminal-E-element. Note that there may also be other occurrences of that same type of event at other times, with each of those being represented by a separate IEV1-component added to that REV1-component and having a terminal-E-element that is an additional terminal-E-element in that REV1-expansion-component.

An REV1-event-inclusive-occurrence-time-component is an REV1-component in which the primary-RT-indicator is an event-inclusive-occurrence-time-RT-indicator. That component indicates that the specified event occurs within the time-period indicated by the terminal-E-element, but not necessarily throughout that time-period.

### 1.4.2.13 REV1-Entity-Location-Components

An REV1-entity-location-component is an REV1-component in which the primary-RT-indicator is a location-name-RT-indicator, the initial-E-element represents a basic-entity or an event, and the terminal-E-element represents a name of a spatial location of that entity or event.

### 1.4.2.14 REV1-Event-Normative-Modality-Components

An REV1-event-normative-modality-component is an REV1-component in which the primary-RT-indicator is an event-normative-modality-RT-indicator, the initial-E-element is an event-E-element, and the terminal-E-element is a T-element or an EV-element. That terminal-E-element represents a normative modality of the event that is represented by that initial-E-element. Examples of such normative modalities include requirements, laws, regulations, and obligations.

### 1.4.2.15 REV1-Event-Existential-Modality-Components

An REV1-event-existential-modality-component is an REV1-component in which the primary-RT-indicator is an event-existential-modality-RT-indicator, the initial-E-element is an EV-element, and the terminal-E-element is a T-element or an EV-element. That terminal-E-element represents an existential modality for the event represented by that initial-E-element. Examples of existential modalities include plans, wants, and needs.

### 1.4.2.16 Other Types of REV1-Components

The preceding are some examples of types of REV1-components that may be specified in an I-model. There is no limit on the range of possible types of relationships, and the corresponding types of REV1-components, that may be specified in an I-model. Some examples include various other possible types of occurrence-times for events include non-occurrence-time, beginning-occurrence-time, ending-occurrence-time, beginning-non-occurrence-time, and ending-non-occurrence-time.

### 1.4.3 Examples of I-Components

The following are some examples of I-components that represent specific events.

### 1.4.3.1 Example 1

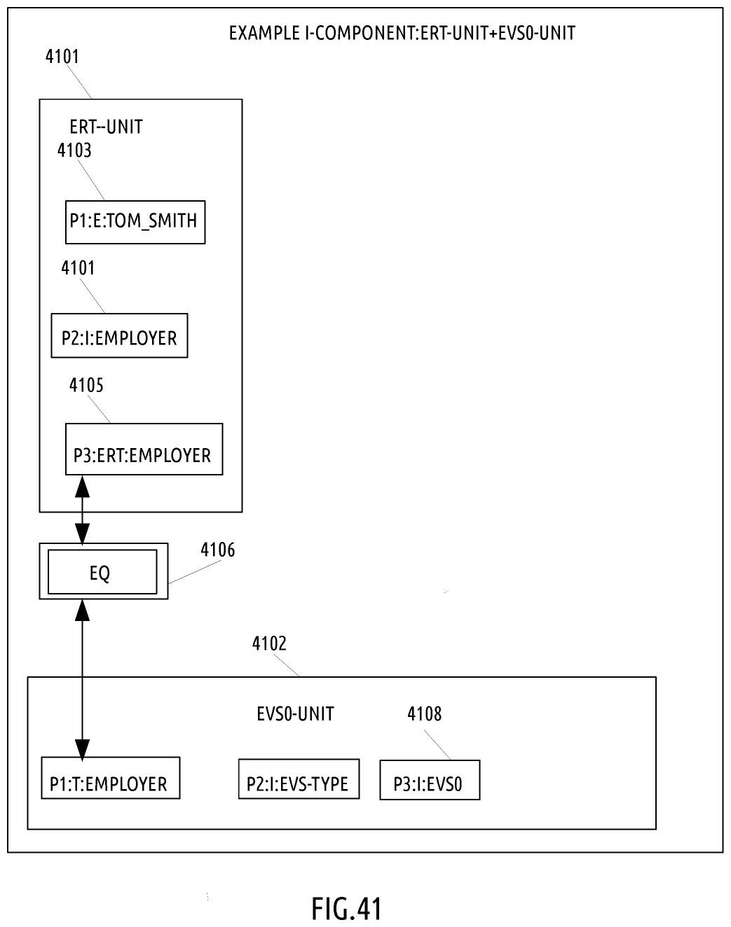

As shown in FIG. 41, the event, ‘Tom Smith is not employed’, may be represented by the combination of an ERT-unit 4101 and an EVS0-unit 4102. The initial-E-element 4103 in that ERT-unit represents Tom Smith; the primary-RT-indicator 4104 indicates the relationship-type-name, ‘employer’; and the ERT-element 4105 is E-equivalent 4106 to the EV-element 4107 in that EVS0-unit. That ERT-element represents the type-entity, ‘employer of Tom Smith’. The P3-component 4108 in that EVS0-unit indicates that that type-entity has no instances, i.e., that Tom Smith has no employer.

### 1.4.3.2 Example 2

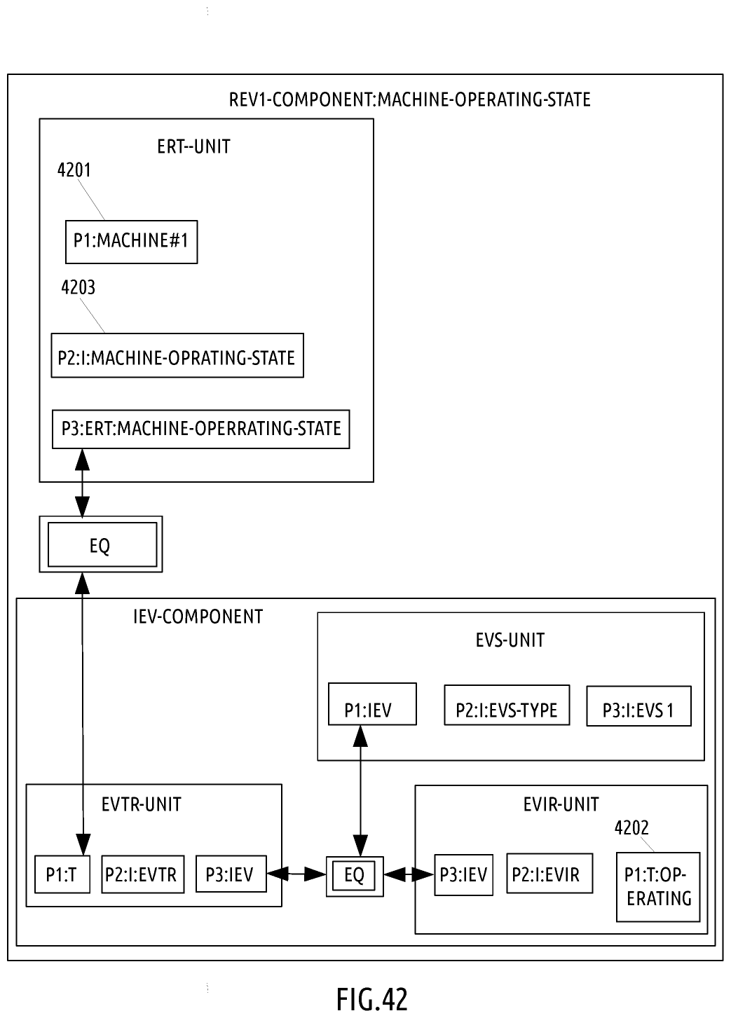

As shown in FIG. 42, the event, ‘machine #1 is operating’, may be represented by an REV1-component in which the initial-E-element 4201 represents machine #1, the terminal-E-element 4202 represents the term, ‘operating’, and the primary-RT-indicator 4203 indicates the relationship-type-name, ‘machine-operating-state’.

### 1.4.3.3 Example 3

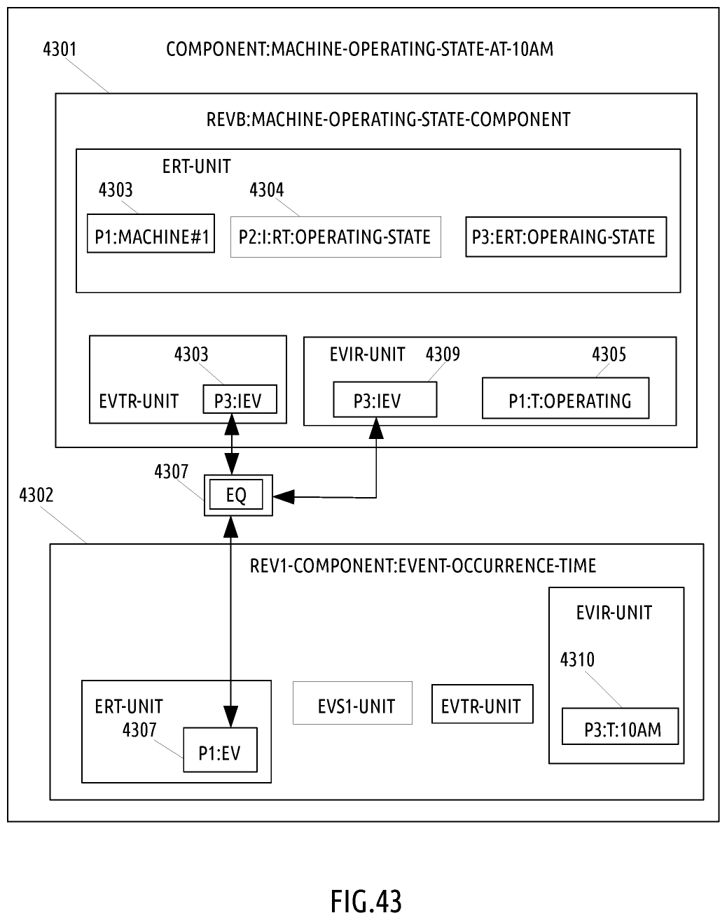

As shown in FIG. 43, the event, ‘machine #1 was operating at 10 AM’, may be represented by an I-component consisting of a combination of an REVB-component 4301 and an REV1-event-occurrence-time-component 4302. The initial-E-element 4303 in the REVB-component represents machine #1; the primary-RT-indicator 4304 indicates the relationship-type-name, ‘operating-state’, and the terminal-E-element 4305 represents the name, ‘operating’. The initial-E-element 4306 in the REV1-event-occurrence-time-component is E-equivalent 4307 to the IEV-elements 4308 and 4309 in the EVTR- and EVIR-units, respectively, in that REVB-component, and the terminal-E-element 4310 represents the name, ‘10 AM’. That REVB-component represents the event, ‘machine #1 operating’. That REV1-component represents the event ‘10 AM is a time when that event occurred’.

### 1.4.3.4 Example 4

The event, ‘machine #1 was operating at 10 AM’, may alternatively be represented by an I-component consisting of combination of REVB-clock-time-component, another REVB-component, and a REV1-11-event-occurrence-implication-component. The initial-E-element in that REVB-clock-time-component represents the relevant clock, or other time-measurement device, and the terminal-E-element represents the name, ‘10 AM’. That REVB-component represents a type of event consisting of a specified time being, or not being, a particular clock-time, or being so under specified conditions. The initial-E-element in the second REVB-component represents machine #1, the terminal-E-element indicates the name, ‘operating’, and the primary-RT-indicator indicates the relationship-type-name, ‘operating-state’. That second REVB-component represents a type of event consisting of machine #1 being, or not being, operating, or being so under specified conditions. The initial-E-element in the REV1-11-event-occurrence-implication-component is E-equivalent to the IEV-elements in the EVTR- and EVIR-units in that first REVB-component, and the terminal-E-element is E-equivalent to the IEV-elements in the EVTR- and EVIR-units in that second REVB-component. The REV1-11-event-occurrence-implication-component indicates that the machine operating-state event represented by that second REVB-component occurred when the clock-time event represented by that second REVB-component occurred. This component is more detailed than the one in example 2, although they represent the same event, since it is specified in terms of the clock-time of an event, rather than directly in terms of event-time.

### 1.4.3.5 Example 5

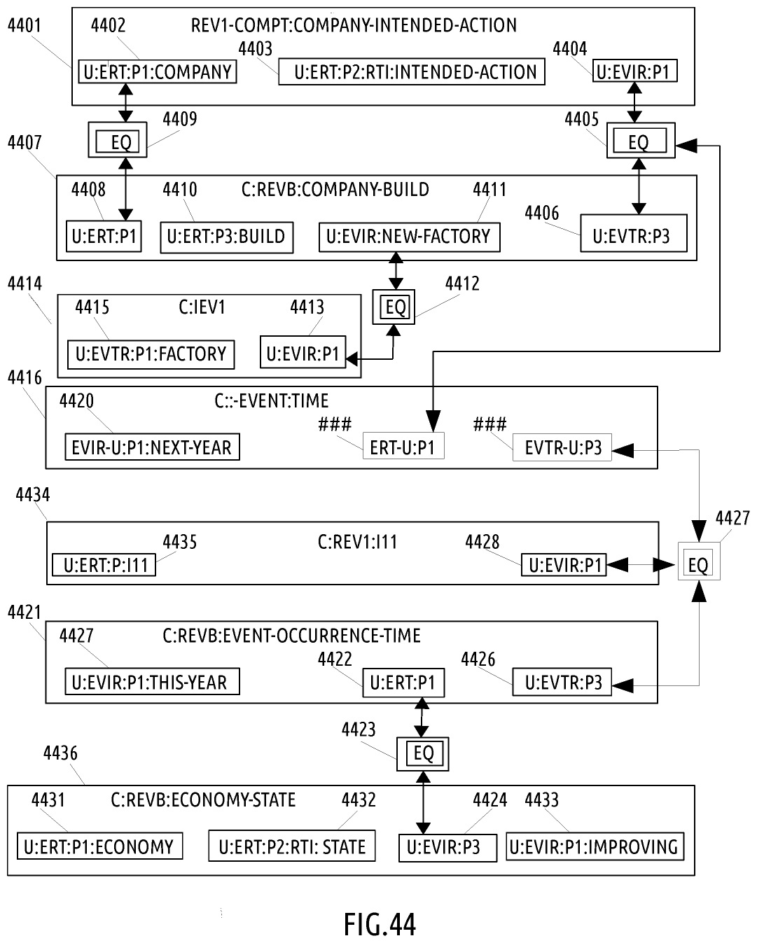

As shown in FIG. 44, the event, ‘the company plans to build a new factory next year if the state of the economy continues to improve through this year’, may be represented by an I-component consisting of a combination of a first REV1-component, four REVB-components, one IEV1-component, and a REV1-11-occurrence-implication-component. In that first REV1-component 4401, the initial-E-element 4402 represents the company, the primary-RT-indicator 4403 is equivalent to the verb, ‘plan’, and the terminal-E-element 4404 is E-equivalent 4405 to the IEV-element in the EVIR-unit 4406 in the first REVB-component 4407. In that first REVB-component, the initial-E-element 4408 is E-equivalent 4409 to the initial-E-element 4402 in that first REV1-component; the primary-RT-indicator 4410 indicates the relationship-type-name, ‘build’; and the terminal-E-element 4411 is E-equivalent 4412 to the INST-element 4413 in that IEV1-component 4414. In that IEV1-component, the primary-T-element 4415 in the EVTR-unit represents the type-entity, ‘factory’. In the second REVB-component 4416, the primary-RT-indicator 4417 indicates the relationship-type-name, ‘inclusive-occurrence-time’; the initial-E-element 4418 is E-equivalent 4419 to the IEV-element 4406 in the EVIR-unit in that first REVB-component; and the terminal-E-element 4420 represents the time-measurement, ‘next year’. The third REVB-component 4421 is an REVB-event-occurrence-time-component in which the initial-E-element 4422 is E-equivalent 4423 to the IEV-element 4424 in the EVIR-unit in the fourth REVB-component 4425; the IEV-element 4426 is E-equivalent 4427 to the terminal-E-element 4428 in the REV1-11-occurrence-implication-component 4434; and the terminal-E-element 4430 indicates the time-measurement, ‘this year’. In that fourth REVB-component, the initial-E-element 4431 represents the economy; the primary-RT-indicator 4432 indicates the relationship-type-name, ‘state (of an entity)’; and the terminal-E-element 4433 represents the state-name, ‘improving’. In the REV1-11-occurrence-implication-component 4434, the initial-E-element 4435 is E-equivalent 4423 to the IEV-element 4424 in the EVIR-unit in that fourth REVB-component 4436, and the terminal-E-element 4428 is E-equivalent 4427 to the IEV-element 4435 in the EVIR-unit in that second REVB-component 4416.

### 1.4.3.6 Example 6

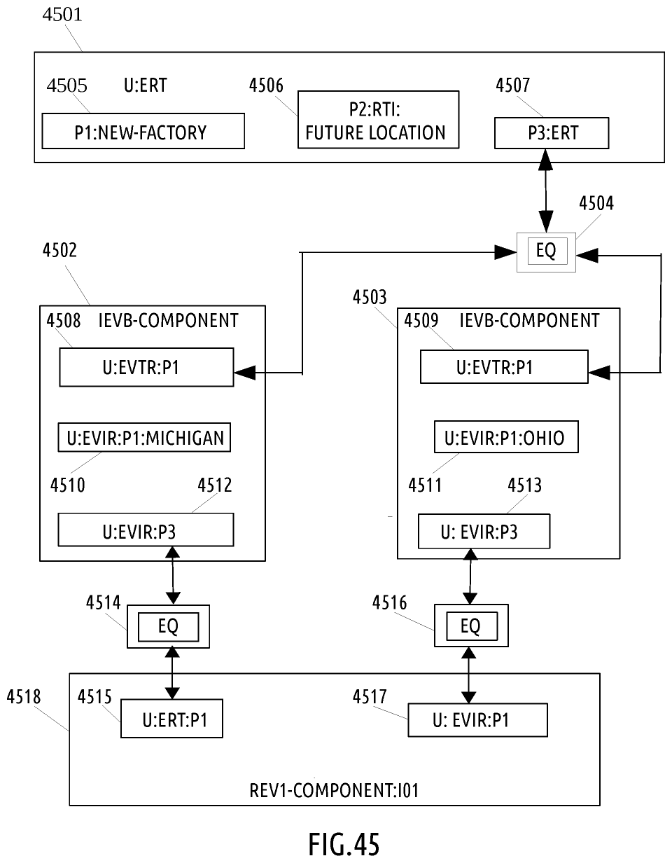

As shown in FIG. 45, the event, ‘the new factory will be located in Michigan or Ohio’ can be represented by an I-component consisting of a combination of an ERT-unit, two IEVB-future-location-components, and a REV1-01-event-occurrence-implication-component. In that ERT-unit 4501, the initial-E-element 4505 represents the new factory, the primary-RT-indicator 4506 indicates the name, ‘future location’, and the ERT-element 4507 is E-equivalent 4504 to (1) the initial-E-element 4508 in the first IEVB-component 4502, and (2) the initial-E-element 4509 in the second IEVB-component 4503. The terminal-E-element 4510 in that first IEVB-component represents the location, ‘Michigan’. The terminal-E-element 4511 in that second IEVB-component represents the location, ‘Ohio’. In the REV1-01-event-occurrence-implication-component 4518, the initial-E-element 4515 is E-equivalent 4514 to IEV-element 4512 in the first IEVB-component, and the terminal-E-element 4517 is E-equivalent 4516 to the IEV-element 4513 in that second IEVB-component. The REV1-01-event-occurrence-implication-component 4518 indicates that, if the location is not Illinois, then the location is Ohio. The combination of that ERT-unit and the two IEVB-components is an example of a REVB-expansion-component.

### 1.4.3.7 Example 7

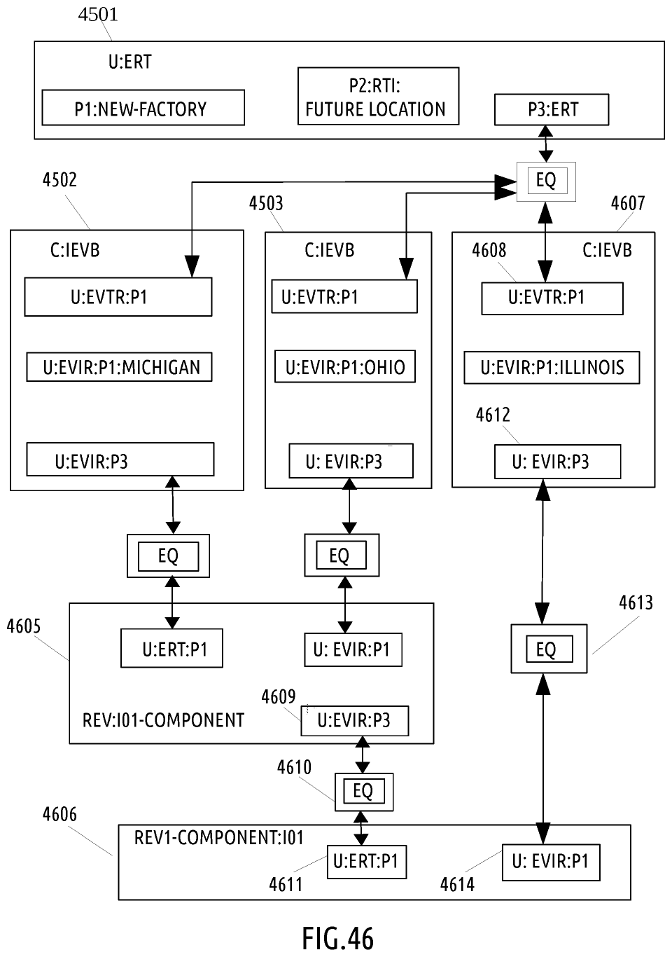

As shown in FIG. 46, the event, ‘the company will build the new factory next year in Michigan, Ohio, or Illinois’, can be represented by an I-component consisting of a combination of an ERT-unit, three IEVB-components, an REVB-01-event-occurrence-implication-component, and an REV1-01-event-occurrence-implication-component. That ERT-unit 4501 and those first two IEVB-components 4502 and 4503, and the E-equivalences between their components, are as shown in FIG. 45 for Example 6 above. Also, the REV1-01-event-occurrence-implication-component 4518 is replaced by an REVB-01-event-occurrence-implication-component 4605, but the structural relationships to those first two IEVB-components are the same in form. In the third IEVB-component 4607, the initial-E-element 4608 is E-equivalent to the ERT-element in that ERT-unit, and the terminal-E-element 4612 represents the location, ‘Illinois’. The IEV-element 4609 in that third IEVB-component is E-equivalent 4613 to the terminal-E-element 4614 in that REV1-01-event-occurrence-implication-component 4606. The initial-E-element 4611 in that REV1-01-event-occurrence-implication-component is E-equivalent 4610 to the IEV-element 4609 in the EVTR-unit in that REVB-01-event-occurrence-implication-component. The combination of the REVB-01-event-occurrence-implication-component and the REV1-01-event-occurrence-implication-component indicates that, if the location is not Michigan or Ohio, then the location is Illinois.

### 1.4.3.8 Example 8

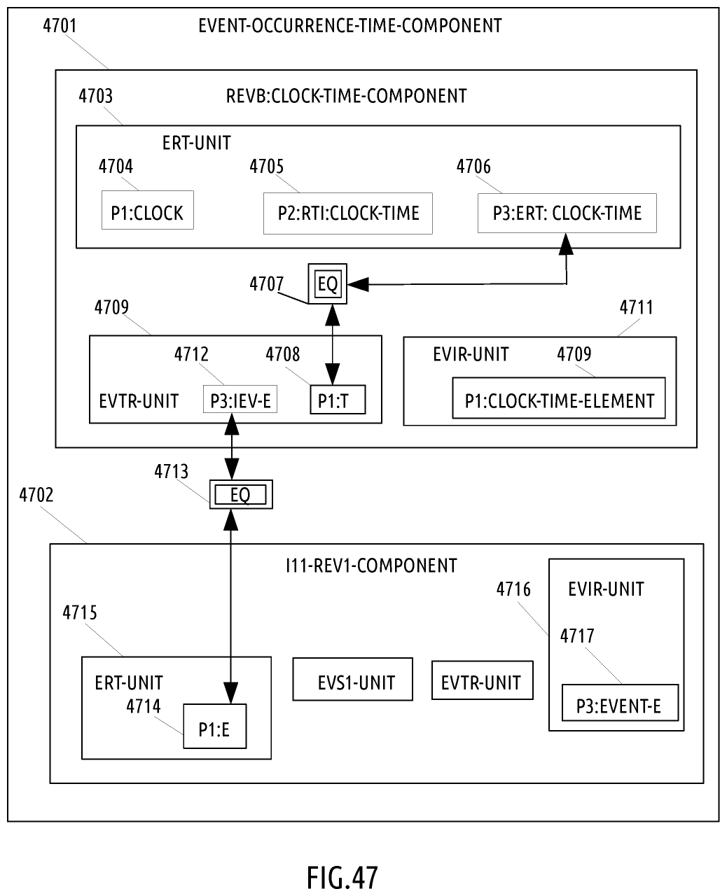

As shown in FIG. 47, the occurrence-time of an event may be specified in terms of the clock-time that is co-related with that event. That specification is shown as an event-occurrence-time-component that is comprised of an inter-related REVB-clock-time-component 4701 and an REV1-11-event-occurrence-implication-component 4702. In the ERT-unit 4703 in that REVB-component, the P1-component 4704 represents the clock; the P2-component 4705 is a clock-time RT-indicator; and the P3-component 4706 represents the clock-time-relationship type-entity. In the EVIR-unit 4711 in that REVB-component, the P1-component 4710 represents a specific clock-time. In the EVTR-unit 4709 in that REVB-component, the IEV-element 4712 is E-equivalent 4713 to the P1-component 4714 in the ERT-unit 4715 in the REV1-11-event-occurrence-implication-component. In that REV1-component, the P3-component 4717 in the EVIR-unit 4716 represents the event whose occurrence-time is indicated by the clock-time element 4710. The relationship between that event and that clock-time may be represented by an REV1-event-occurrence-time-component (not shown in the figure).

### 1.4.4 Redundant I-Components

There are many alternative structural forms for I-components that represent the same things. Inclusion of two or more such equivalent I-components in an I-model results in redundancy. A simple example of such redundancy is an I-unit that is I-equivalent to another I-unit in that I-model. A related example is the case of two different I-components that are I-equivalent.

The various general types of I-units and I-components described in this specification may allow the same events to be represented in that I-model by combinations of I-components whose primary-configurations have different structural forms and, hence, are translationally-equivalent but may not be I-equivalent. There is an unlimited number of such combinations of equivalent primary-configuration structural forms for I-components that may be identified. Some types of redundancy of T-components are described in section 1.4.5.2.8. The I-system that contains an I-model may include operative-components that detect and eliminate some redundancies.

### 1.4.5 T-Components

An I-model may contain one or more T-components. A T-component, (‘type-representation-component’), is an I-component that consists of one or more T-units that are inter-related by E-equivalence-indicators that indicate E-equivalences between T-elements in those T-units. That T-component represents part or all of a type-structure for the type-entities represented by those T-elements. If it represents all of that type-structure, it is a T-specification for each of the joint-T-elements in that T-component.

Specifically, a T-component for a T-element is an I-component of one of the following types: (a) a TJSR-unit in which the initial- or terminal-E-element is E-equivalent to that T-element; (b) a T10SR-unit in which the initial-E-element is E-equivalent to that T-element; (c) a T01SR-unit in which the terminal-E-element is E-equivalent to that T-element; (d) a TEVS-unit in which the P1-component is E-equivalent to that T-element; (e) a combination of a TJSR-unit and a T-component containing a second TJSR-unit in which the initial- or terminal-E-element is E-equivalent to the initial- or terminal-E-element in that first TJSR-unit; or (f) a combination of two or more T-components for that T-element.

Thus, a T-component consists of a combination of one or more TSR-units and TEVS-units that are indicated to be inter-related by E-equivalence-indicators between some of the T-elements in each of those units. An I-model may also include one or more secondary I-units that are inter-related via E-equivalence-indicators with a T-component, but those secondary units are not part of that T-component.

The terminal-E-element in a T10SR-unit in a T-component is a fixed-E-element in that T-component. Similarly, the initial-E-element in a T01SR-unit in a T-component is a fixed-E-element in that T-component. Fixed-E-elements in a T-component represent entities that are fixed-entities in the type-structure represented by that T-component.

All T-elements in a T-component that are not fixed-E-elements in that T-component, are primary-T-elements in that T-component and are joint-T-elements in that T-component. Those joint-T-elements represent joint type-entities in the type-structure represented by that T-component.

1.4.5.1 Examples of Types of T-Components that Occur Frequently in Many I-Models

Some general types of T-components that occur frequently in many I-models are TIEVB-components, TIEV-components, TREVB-components, TREV-components and TREV1-components.

### 1.4.5.1.1 TIEVB-Components

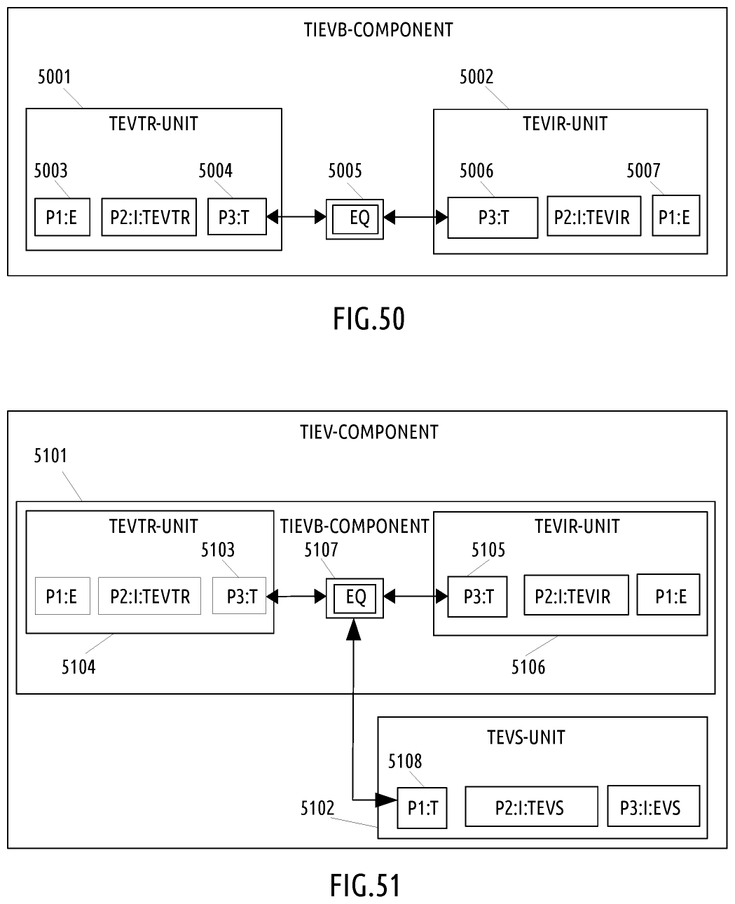

As shown in FIG. 50, a TIEVB-component (‘instance-event-type-base-component’) is a T-component whose primary component consists of a TEVTR-unit 5001 and a TEVIR-unit 5002 such that (1) that TEVIR-unit is a TJSR-unit or a T01SR-unit, (2) that TEVTR-unit is a TJSR-unit or a T01SR-unit whose terminal-E-element 5004 is E-equivalent 5005 to the terminal-E-element 5006 in that TEVIR-unit, and, (3) no other pairs of T-elements in that T-component are E-equivalent. The initial-E-element in that TIEVB-component is the initial-E-element 5003 in that TEVTR-unit. The terminal-E-element in that TIEVB-component is the initial-E-element 5007 in that TEVIR-unit. TIEVB-components represent components of type-structures whose instances are represented by IEVB-components.

### 1.4.5.1.2 TIEV-Components

As shown in FIG. 51, a TIEV-component (‘instance-event-type-component’) is an I-component whose primary component consists of a TIEVB-component 5101 and a TEVS-unit 5102 such that the terminal-E-element 5103 in the TEVTR-unit 5104 and the terminal-E-element 5105 in the TEVIR-unit 5106 in that TIEVB-component are E-equivalent 5107 to the P1-component 5108 in that TEVS-unit. The initial-E-element in that TIEV-component is the initial-E-element in that TIEVB-component. The terminal-E-element is the terminal-E-element in that TIEVB-component. The instances of the type-entities represented by initial-E-elements in TIEV-components are represented by the initial-E-elements in IEV-components.

### 1.4.5.1.3 TREVB-Components

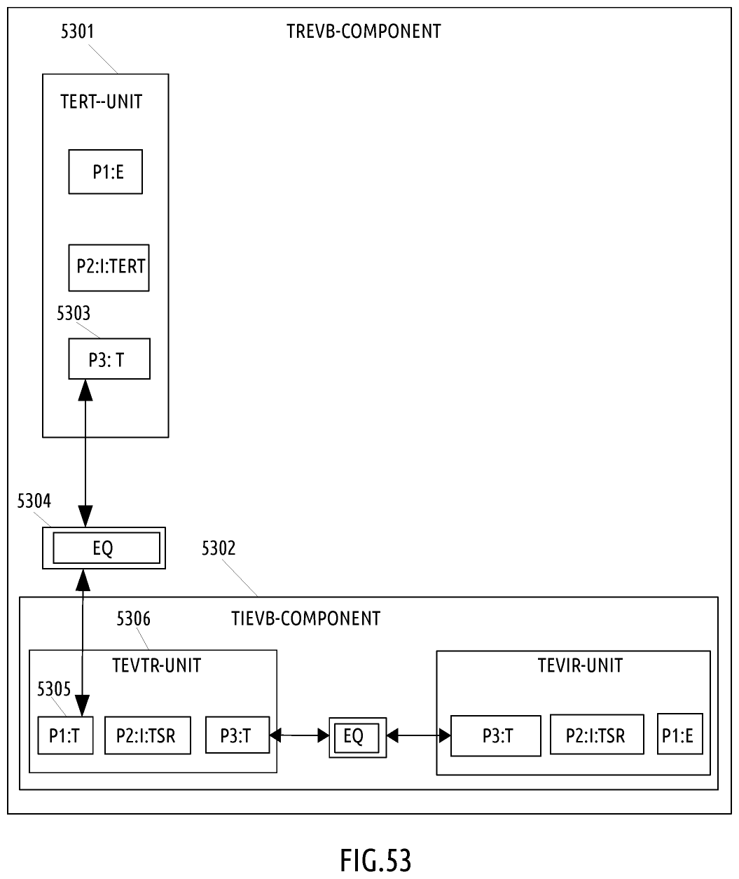

As shown in FIG. 53, a TREVB-component (‘relationship-event-base-type-component’) consists of a TERT-unit 5301 and a TIEVB-component 5302 comprised of a TEVTR-unit 5306 and a TEVIR-unit 5310. The T-element that is the P3-component 5303 of that TERT-unit is E-equivalent 5304 to the initial-E-element 5305 in that TIEVB-component.

In general, the instances of the type-structures represented by TREVB-components are relationships represented by REVB-components whose primary-RT-indicators are I-equivalent to the primary-RT-indicators in the corresponding TREVB-components.

### 1.4.5.1.4 TREV-Components

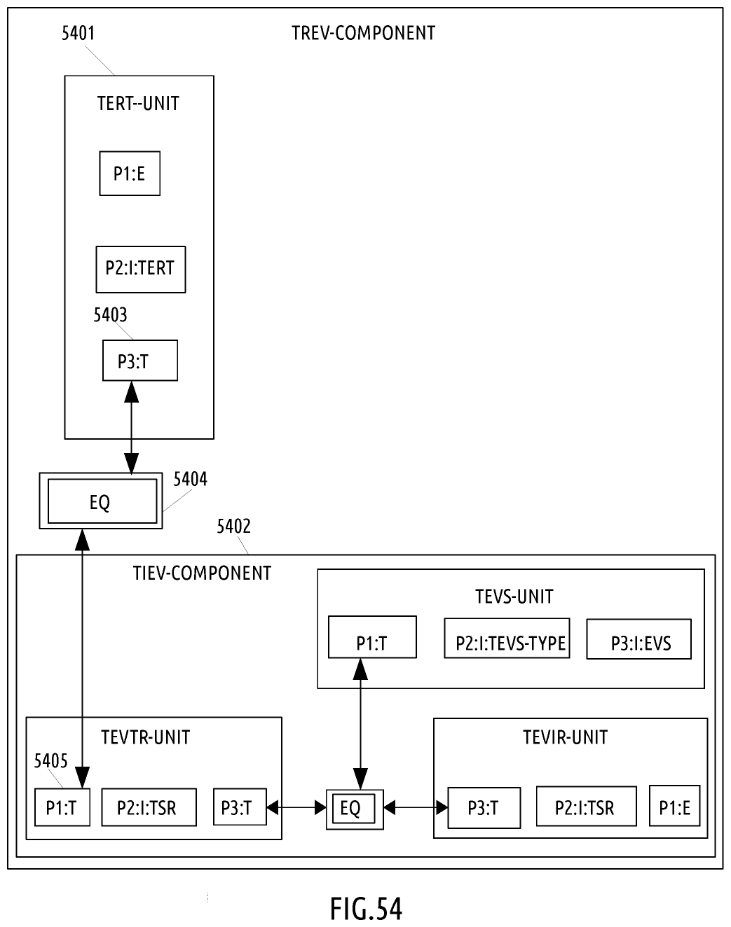

As shown in FIG. 54, a TREV-component (‘relationship-event-type-component’) consists of a TERT-unit 5401 and a TIEV-component 5402. The P1-component 5405 of that TEVTR-unit in the TIEV-component is E-equivalent 5404 to the ERT-element 5403 in that TERT-component. The initial-E-element in that TREV-component is the P1-component in that TERT-unit. The terminal-E-element in that TREV-component is the terminal-E-element in that TIEV-component. The RT-indicator in that TERT-unit is the primary-RT-indicator in that TREV-component. The instances of the type-structures represented by TREV-components are relationships represented by REV-components whose primary-RT-indicators are I-equivalent to the primary-RT-indicators in the corresponding TREV-components. Note that TREV-component can also be described as the combination of a TREVB-component and a TEVS-unit. Those two descriptions are equivalent.

### 1.4.5.1.5 TREV1-Components

A TREV1-component (‘occurrent-relationship-event-type-component’) is a TREV-component in which the P3-component in the TEVS-unit in that TREV-component is an event-occurrence-indicator. The instances of the type-structures represented by TREV1-components are the relationships represented by REV1-components whose primary-RT-indicators are I-equivalent to the primary-RT-indicators in the corresponding TREV1-components.

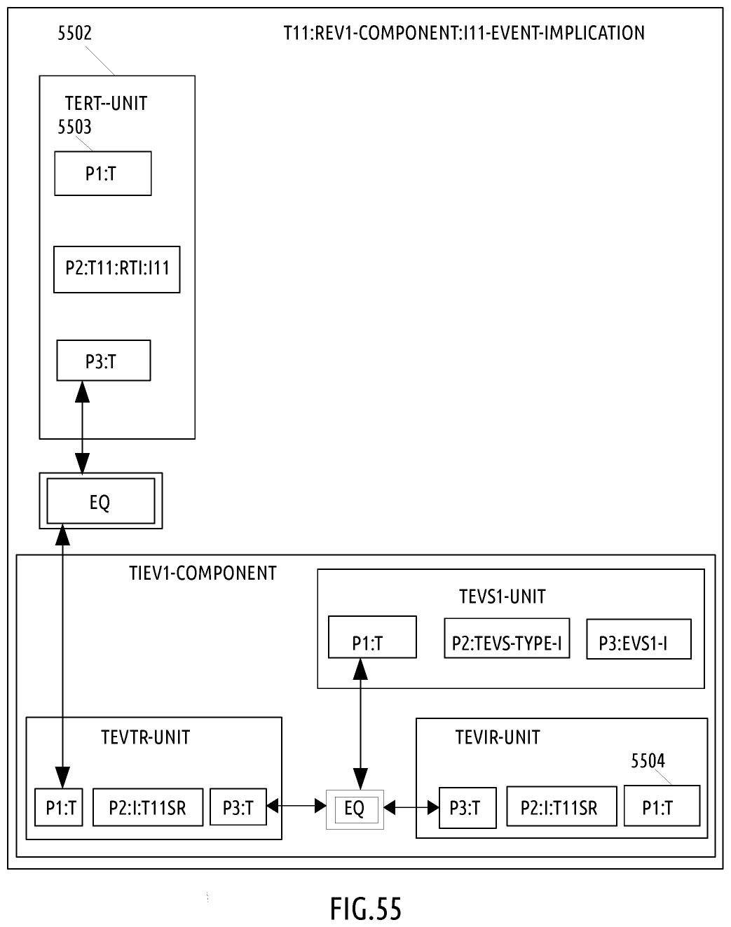

As an example of a specific TREV1-component, FIG. 55 shows a T11-REV1-I11-component that is a T-specification. The ‘11’ in ‘T11’ indicates that the initial-E-element 5502 and the terminal-E-element 5504 in that T-specification are primary-T-elements in that T-specification. The TERT-unit 5502 is a T11ERT-unit. The RT-indicator 5501 in the P2-component in that unit is an 11-event-occurrence-implication-indicator.

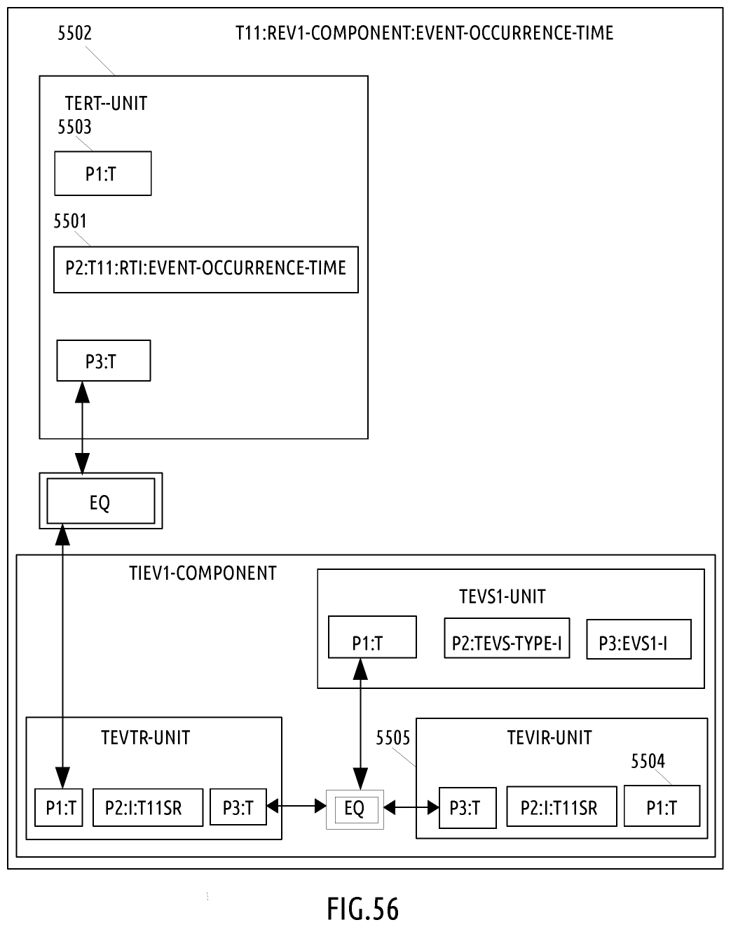

As another example of a specific TREV1-component, FIG. 56 shows a T11-REV1-event-occurrence-time-component that is a T-specification. The RT-indicator 5605 in the P2-component of the T11ERT-unit 5604 is an event-occurrence-time-indicator. The terminal-E-element 5603 in that T-specification is a T-element that represents the type-entity ‘occurrence-times of events’ in which the type-entity for those events is represented by initial-E-element 5602 in that T-specification.

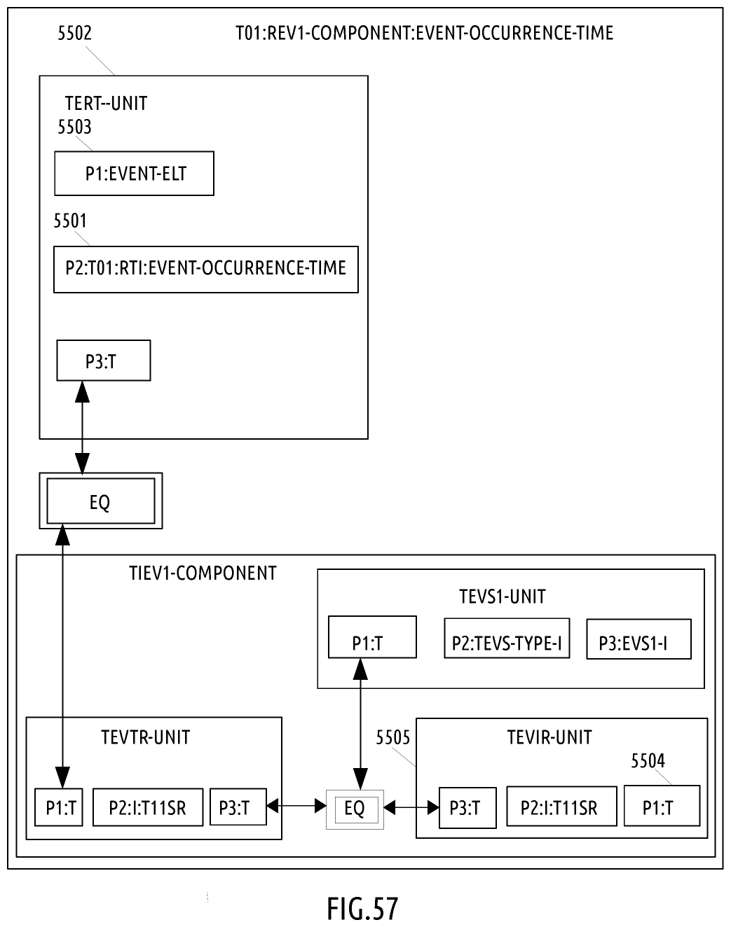

As another example of a specific TREV1-component, FIG. 57 shows a T01-REV1-event-occurrence-time-component that is a T-specification. The ‘0’ in ‘T01’ indicates that the initial-E-element 5701 in that T-specification is a fixed-E-element. The ‘1’ indicates that the terminal-E-element 5702 is a T-element that is not a fixed-E-element in that T-specification. Correspondingly, the TERT-unit 5703 is a T01ERT-unit. The RT-indicator 5704 in that TERT-unit is an event-occurrence-time-indicator. The terminal-E-element 5702 in that T-specification is a T-element that represents the type-entity ‘occurrence-times of the specific event’ represented by the initial-E-element 5701 in that T-specification.

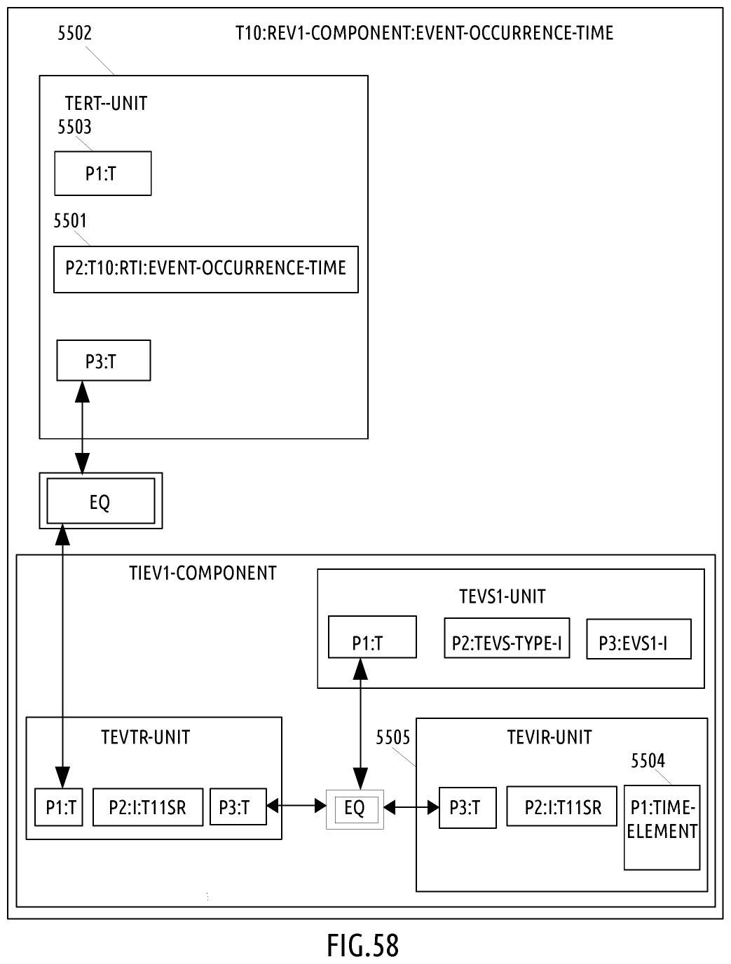

As another example of a specific TREV1-component, FIG. 58 shows a T10-REV1-event-occurrence-time-component that is a T-specification. The ‘0’ in ‘T10’ indicates that the terminal-E-element 5801 in that T-specification is a fixed-E-element. The ‘1’ indicates that the initial-E-element 5802 is a T-element that is not a fixed-E-element in that T-specification. Correspondingly, the TERT-unit 5803 is a T11ERT-unit. The RT-indicator 5804 in the P2-component of that TERT-unit is an event-occurrence-time-indicator. The P1-component 5801 in the T10EVIR-unit 5805 is a fixed EV-element in that T-specification. That terminal-E-element 5801 represents a specific event-time. The initial-E-element 5802 in the T10-REV1-event-occurrence-time-component is a T-element that represents the type-entity ‘events having occurrences at that specific time’.

### 1.4.5.2 Structural Attributes of T-Components

Structural attributes of T-components are employed by operative-components in the system in accomplishing various functions, as described in section 3.5. Those structural attributes include T-identicality, T-independence, T-maximality, EV-dependence, D-determinability, RT-dependence, and T-redundancy.

### 1.4.5.2.1 T-Identicality

Two or more T-components may be T-identical. Two T-components are T-identical if (1) the primary-configurations of those two T-components differ in structural form only in the identities of the primary-T-elements in those two components, and (2) the E-equivalence relationships between primary-T-elements in different T-units within each of those two components have the same pattern of relationships within that component as the corresponding E-equivalence relationships in that other component. If each of those T-components represents a complete type-structure for the type-entities represented by those T-elements, then those T-elements represent the same type-entity and those T-components are equivalent in that they represent the same type-structure for that type-entity.

### 1.4.5.2.2 T-Equivalence

Two or more T-specifications may be T-equivalent. Two T-specifications are T-equivalent if they represent type-structures that are equivalent, and, hence, have the same instances. T-specifications that are T-equivalent may not be T-identical. An example is that of a T-specification for a first T-element and a T-specification for a second T-element such that that second T-element represents a contratype of a contratype of that first T-element.

### 1.4.5.2.3 T-Independence

A T-specification for a T-element in an I-model may include two or more T-independent T-components for that T-element. T-independent T-components for a T-element represent independent components of the type-structure for the type-entity represented by that T-element. Those independent components of that type-structure indicate different properties that instances of that type-entity must have. For example, the type-structure indicated by ‘companies that have more than a thousand employees and that are located in rural areas’ has two independent components, ‘have more than a thousand employees’ and ‘are located in rural areas’, that are inter-related in that type-structure only via the type-entity, ‘companies’.

Specifically, two T-components for a first T-element are T-independent within a larger T-component for that T-element if no primary-T-element in either of those first two T-components is E-equivalent to a primary-T-element in the other T-component except when those two primary-T-elements are E-equivalent to that first T-element.

### 1.4.5.2.4 T-Maximality

In an I-model, a T-component for a T-element is a T-maximal T-component for that T-element if, for each T-component for a T-element that is I-equivalent to a primary-T-element in that first T-component, that first T-component includes a T-component that is I-equivalent to that second T-component. Thus, every part of the type-structure for a type-entity that is represented by a T-component in that I-model is represented by a component of that T-maximal T-component. A T-maximal T-component for a T-element is also a T-maximal T-component for each of the T-elements that are joint-T-elements with that T-element.

A T-maximal T-component for a T-element in an I-model may be a T-specification for that T-element. A T-maximal T-component for a T-element is a T-specification for a T-element if that T-maximal T-component represents a complete type-structure for the type-entity represented by that T-element. In an I-model, if a T-specification-status-unit has a P3-component that is a T-specification-completeness-indicator, then that TCS-unit indicates that a T-maximal T-component for the T-element that is the P2-component of that I-unit is a T-specification for that T-element in that I-model. A T-specification for a T-element is also a T-specification for each of the joint-T-elements represented by primary-T-elements in that T-specification.

### 1.4.5.2.5 EV-Dependence

An I-model may include one or more EV-elements that are EV-dependent on one or more other EV-elements. An EV-element is EV-dependent on a second EV-element if the I-model includes a combination of I-components that indicates that the event represented by that first EV-element is definitionally-dependent on the event represented by that second EV-element. That definitional-dependence exists if there is a sequence of one or more definitional-dependence-pairs linking those two entities. A definitional-dependence-pair consists of either (A) a type-entity and a fixed-entity in the type-structure for that type-entity if that fixed-entity is also a type-entity or an instance-event, or (B) an instance-event-entity and either (a) the type-entity for that instance-event, or (b) the instance-entity for that instance-event if that instance-entity is a type-entity or an instance-event.

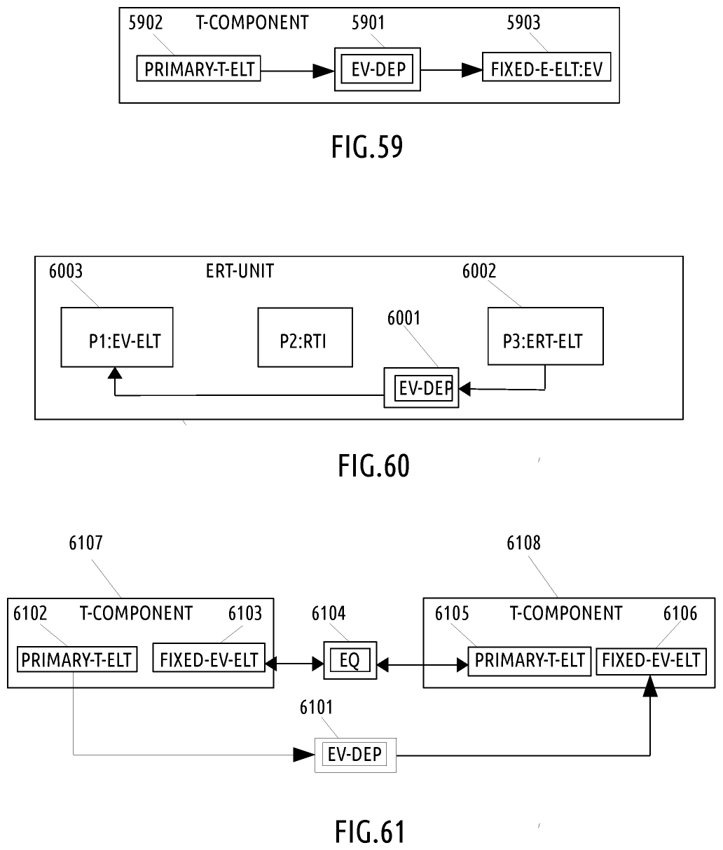

There are multiple possible types of EV-dependence of one EV-element on a second EV-element that may be present in an I-model. An example of one type of EV-dependence pair is shown in FIG. 59. As indicated by the EV-dependence-indicator 5901, the first EV-element 5902 in that pair is a primary-T-element in a T-component, and the second EV-element 5903 in that pair is a fixed-E-element in that T-component.

Another example of a EV-dependence pair is shown in FIG. 60. As indicated by the EV-dependence-indicator 6001, the first EV-element 6002 in that pair is an ERT-element in an ERT-unit and the second EV-element 6003 is the P1-component in that ERT-unit.

Another example (not shown) is that of the first E-element in a EV-dependence pair being the IEV-element in an EVTR-unit, an EVIR-unit, or a co-relationship-indicator-unit, and the second E-element in that pair being the P1-component in that unit.

Another example is shown in FIG. 61. As indicated by the EV-dependence-indicator 6101, the first EV-element 6102 in that pair is a primary-T-element in a T-component 6107. That T-component includes an EV-element 6103 that is a fixed-E-element in that T-component. That EV-element 6103 is E-equivalent 6104 to a primary-T-element 6105 in a second T-component 6108. That second T-component includes a fixed-E-element 6106 that is the second EV-element in that EV-dependence pair.

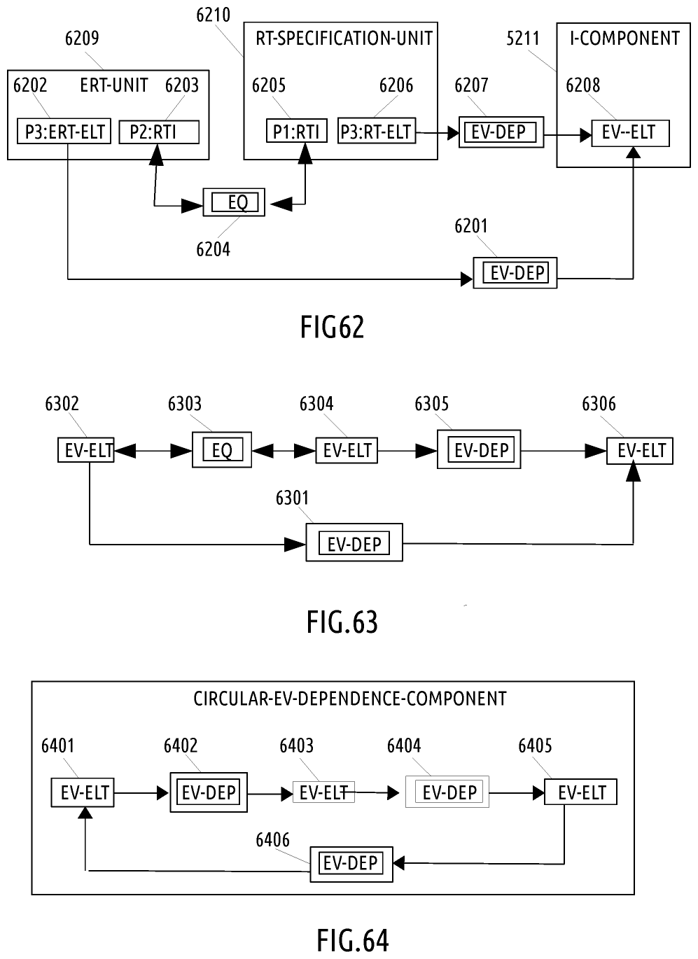

Another example is shown in FIG. 62. As indicated by the EV-dependence-indicator 6201, the first EV-element 6202 in that EV-dependence pair is the ERT-element in an ERT-unit 6209; the RT-indicator 6203 in that ERT-unit is I-equivalent 6204 to the RT-indicator 6205 in an RT-specification-unit 6210; and the RT-element 6206 in that RT-specification-unit is EV-dependent 6207 on the second EV-element 6208 in that pair.

Another example is shown in FIG. 63. As indicated by the EV-dependence-indicator 6301, the first EV-element 6302 in that pair is E-equivalent 6303 to another E-element 6304 that is EV-dependent 6305 on that second EV-element 6306. A similar example (not shown) is when that first E-element is EV-dependent on a third E-element that is E-equivalent to that second E-element.

Another example (not shown) of a EV-dependence pair is when there is a sequence of EV-dependence pairs in which that first E-element is E-equivalent to the first E-element in the first pair in that sequence; that second E-element is E-equivalent to the second E-element in the last pair in that sequence; and the second E-element in each pair except the last is E-equivalent to the first E-element in the next pair.

An I-model may not include a circular-EV-dependence pair. That would occur when there is a sequence of EV-dependence pairs as just described, in which the first E-element in the first EV-dependence pair in that sequence is E-equivalent to the second E-element in the last EV-dependence pair in that sequence. Such a sequence would have no useful function in an I-model. FIG. 64 shows a simple case of three such EV-dependence pairs. EV-element 6401 is EV-dependent 6402 on EV-element 6403; EV-element 6403 is EV-dependent 6404 on EV-element 6405; and EV-element 6405 is EV-dependent 6406 on EV-element 6401.

Another example (not shown) is the first E-element in an EV-dependence pair having a CONTRAT-relationship, a DISJT-relationship, or a SUBT-relationship to that second E-element. (CONTRAT-relationships, DISJT-relationships, and SUBT-relationships are explained later.) Joint-T-elements are not EV-dependent on each other.

### 1.4.5.2.6 D-Determinability

A T-element in an I-model in an I-system is D-determinable if that I-model contains (a) a T-specification for that T-element, or (b) a combination of I-components in that I-model that may be employed by operative-components in that I-system to construct a T-specification for that T-element.

There are many types of such combinations of I-components that may exist in an I-model and that may be employed by operative-components in that I-system to construct a T-specification. For example, as described in section 1.4.7, if that I-model includes an ERT-unit in which the RT-indicator is I-equivalent to the RT-indicator in an RT-specification-unit in that I-model, and, if that I-model also includes a T-specification for the RT-element in that RT-specification-unit, then those components may be employed to construct a T-specification for the ERT-element in that ERT-unit.

Another example, described in section 1.4.6.5.2, is the case of a T-element that is specified to have an COMPADDNSUBT-relationship to a combination of other T-elements. If the I-model includes a T-specification for each of those other T-elements, then a T-specification may be constructed for that first T-element. Another example, described in section 1.4.6.3, is the case where a first T-element is specified in an I-model as having a CONTRAT-relationship to a second T-element. If the I-model includes a T-specification for either of those T-elements, then a T-specification may be constructed for that other T-element.

### 1.4.5.2.7 RT-Dependence

An I-model may include one or more T-elements that are RT-dependent on an RT-indicator of a particular type. A T-element is RT-dependent on an RT-indicator if the I-model includes a combination of I-components that indicates that the type-structure for the type-entity represented by that T-element is directly or indirectly dependent on the type-relationship indicated by that RT-indicator.

There are multiple ways that RT-dependence of a T-element on an RT-indicator may be present in an I-model. One example is when a T-component for a T-element includes a TSR-unit in which the P1-component of the TSR-type-indicator is I-equivalent to that RT-indicator. Another example is the case of a T-element being E-equivalent to the ERT-element in an ERT-unit whose RT-indicator is I-equivalent to the RT-indicator in an ERT-unit whose ERT-element is RT-dependent on that RT-indicator. Another example is that of a T-element being E-equivalent to the ERT-element in an ERT-unit in which the RT-indicator is I-equivalent to the RT-indicator in an RT-specification-unit whose RT-element is RT-dependent on that RT-indicator. Another example is that of a T-element being EV-dependent on another T-element that is RT-dependent on that RT-indicator. Another example is the case where that T-element has a CONTRAT-relationship, a DISJT-relationship, or a SUBT-relationship to a T-element that is RT-dependent on that RT-indicator. (CONTRAT-relationships, DISJT-relationships, and SUBT-relationships are explained later, and may be indicated by REV1-components.) Another example is when that T-element is RT-dependent on an RT-indicator that is I-equivalent to that first RT-indicator.

### 1.4.5.2.8 T-Redundancy

A T-specification in an I-model may include redundant T-components. A redundant T-component in a T-specification for a T-element is a maximal-T-component that represents the same things as part or all of another maximal-T-component for that T-element. An example is that of two T-specifications that are T-equivalent. Another related example is that of a T-specification that includes two independent T-components for a T-element such that those T-components are T-identical.

Another example of T-redundancy is a TEVIR-unit in which the P3-component is E-equivalent to the P3-component of another TEVIR-unit in the same I-model. A similar example is that of a TEVTR-unit in which the P3-component is E-equivalent to the P3-component of another TEVTR-unit in the same I-model.

Another example is a T-component that consists of two TIEVB-components in which the initial-E-elements are E-equivalent and the terminal-E-elements are E-equivalent. Another example is a combination of two TREV-components in which the primary-RT-indicators are I-equivalent, the initial-E-elements are E-equivalent, and the terminal-E-elements are E-equivalent.

Another example is that of a T-specification that consists of a TIEV-component in which the TEVTR-unit is a T01SR-unit; the TEVIR-unit is a TJSR-unit; the P3-component in the TEVS-unit in that TIEV-component is an event-occurrence-indicator; and the P3-component of that TEVIR-unit, the P3-component of that TEVTR-unit, and the P1-component of the TEVS-unit are E-equivalent. Such a T-specification has the same representational significance as the P1-component of the T01SR-unit by itself.

Another example is that of a T-specification for a T-element that represents a type-entity in an I-model that includes two or more T-independent T-components for that T-element such that the structure of one of those T-independent T-components represents a part of a type-structure for that type-entity that is a subtype of the part of that type-structure that is represented by that other T-component.

### 1.4.6 Structural Relationships Between I-Components

Structural relationships of various types between the I-components in a pair of combinations of I-components are employed by operative-components in the system in accomplishing various operations, as described in section 3.5. Such structural relationships that may be present in an I-model include T/INST-relationships, EQUIVT-relationships, CONTRAT-relationships, DISJT-relationships, SUBT-relationships of several types, and LOGCON-relationships of several types.

Those structural relationships between I-components represent relationships between the entities represented by the E-elements in those components. Each such structural relationship from one or more I-components in a combination of I-components to one or more I-components in a second combination of I-components consists of a combination of (1) inter-unit structural relationships from I-units in that first combination of I-components to I-units in that second combination of I-components, and (2) inter-element structural relationships from E-elements in those first I-units to E-elements in those second I-units. In such an inter-unit structural relationship from one I-unit to another, that first I-unit is the initial-I-unit in that relationship, and that second I-unit is the terminal-I-unit in that relationship. Similarly, in each inter-element structural relationship from one E-element to another E-element in those structurally-related I-units, that first E-element is the initial-E-element and that second E-element is the terminal-E-element.

A structural relationship of the types described in this section may be indicated by a combination of one or more REV1-components that each link one or more E-elements in the first combination of I-components with one or more E-elements in the second I-component that is structurally-related to those I-components. Such a REV1-component may be determined and constructed by an operative-component in the I-system, or may be specified by an external source. Such a REV1-component may be specified in an I-model whether or not the I-units constituting those I-components are fully specified in that I-model. For example, a subtype-relationship between two type-entities may be represented by a SUBT-relationship between the T-elements representing those type-entities.

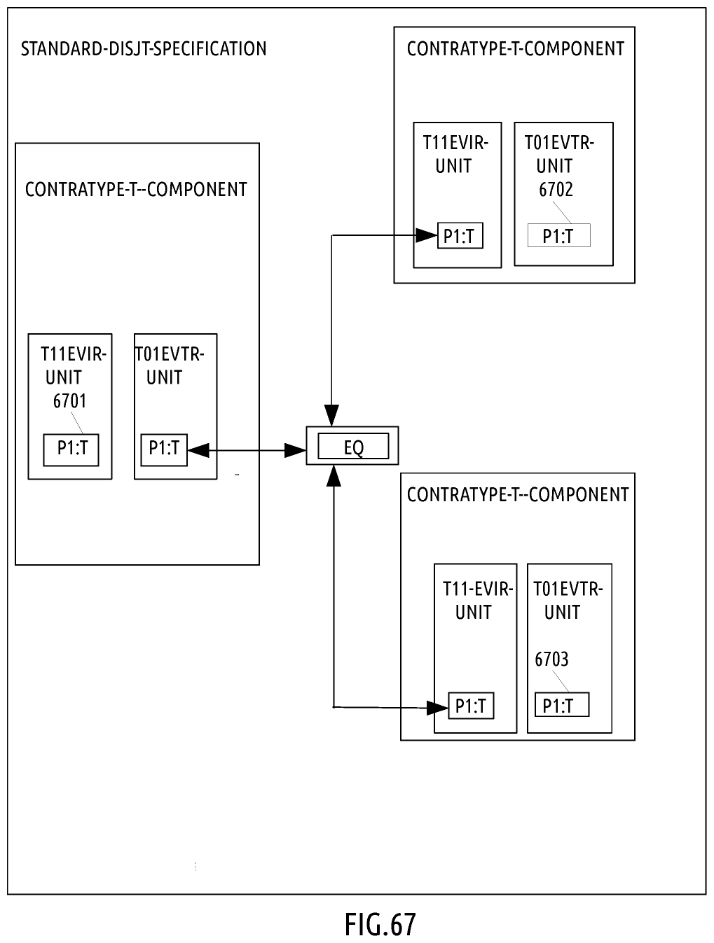

As described in section 1.3.1.1.1.3, two or more structural relationships of any one of the types identified above may be co-related. Those structural relationships are co-related when there is a particular pattern of inter-element structural relationships between the terminal E-elements in those co-relationships such that that pattern has a particular correspondence to the inter-element structural relationships between the initial-E-elements in those co-relationships. As described in section 1.3.1.1.1.3, such a combination of co-relationships is indicated by a combination of co-relationship-indicator-units. As described in that section, a co-relationship-indicator-unit is a base-primary I-unit whose P1-component is a T-element that is a co-relationship-indicator-element. When a combination of such I-units indicates a combination of structural relationships that are co-related, then the T-elements that are the P1-components in those I-units are E-equivalent. In addition, the P2-components in those units are co-relationship-type-indicators that are I-equivalent and that indicate the particular type of those co-related structural relationships. The P3-components in those units are the IEV-elements that represent the instance-events in those co-related structural relationships. FIG. 67, described later, shows an example of a pair of co-related structural relationships.

As described in section 1.3.1.4.2, the I-model may include a T-specification-status-unit that indicates that a particular combination of co-relationship-indicator-units includes a co-relationship-indicator-unit for each of the IEV-elements that represent the co-related instance-events in those co-related relationships.

If the relationships in a particular combination of co-relationships are not invariant, then the co-relationship-indicator-elements in the co-relationship-indicator-units for those relationships may be indicated by a REV1-co-relationship-indicator-component, in which the terminal-E-element in that REV1-component is E-equivalent to each of the co-relationship-indicator-elements that are the P1-components in those co-relationship-indicator-units. The initial-E-element in that REV1-component is E-equivalent to an EV-element with which those co-relationships are associated. An example of such co-relatedness is described in the subsequent section on COMPADDNSUBT-relationships.

The following sections describe several types of structural relationships between I-components. Where applicable, they also describe co-relationships between those structural relationships.

1.4.6.1 T/INST-Component-Relationships from T-Components to I-Components

In an I-model there may be a proto-T/INST-component-relationship from a T-component in that I-model to an I-component in that I-model. A proto-T/INST-component-relationship from a T-component to an I-component is a structural relationship that consists of a combination of proto-T/INST-unit-relationships from the T-units in that T-component to the corresponding base-primary I-units in that I-component. That proto-T/INST-component-relationship may indicate that the collection of entities, and of the relationships between them, represented by that I-component is an instance of the type-structure represented by that T-component.

Specifically, there is a proto-T/INST-component-relationship (‘type-instance-component-relationship’) from a T-component to an I-component in an I-model when (1) each base-primary I-unit in that I-component is the terminal-I-unit in one or more proto-T/INST-unit-relationships from T-units in that T-component; (2) each T-unit in that T-component is the initial-I-unit in a proto-T/INST-unit-relationship to one of those base-primary I-units; and (3) for each E-equivalence relationship between two T-elements in that T-component, that I-model indicates a corresponding E-equivalence relationship between the E-elements in that I-component that are the terminal-E-elements in proto-T/INST-element-relationships whose initial-E-elements are those two T-elements in that T-component.

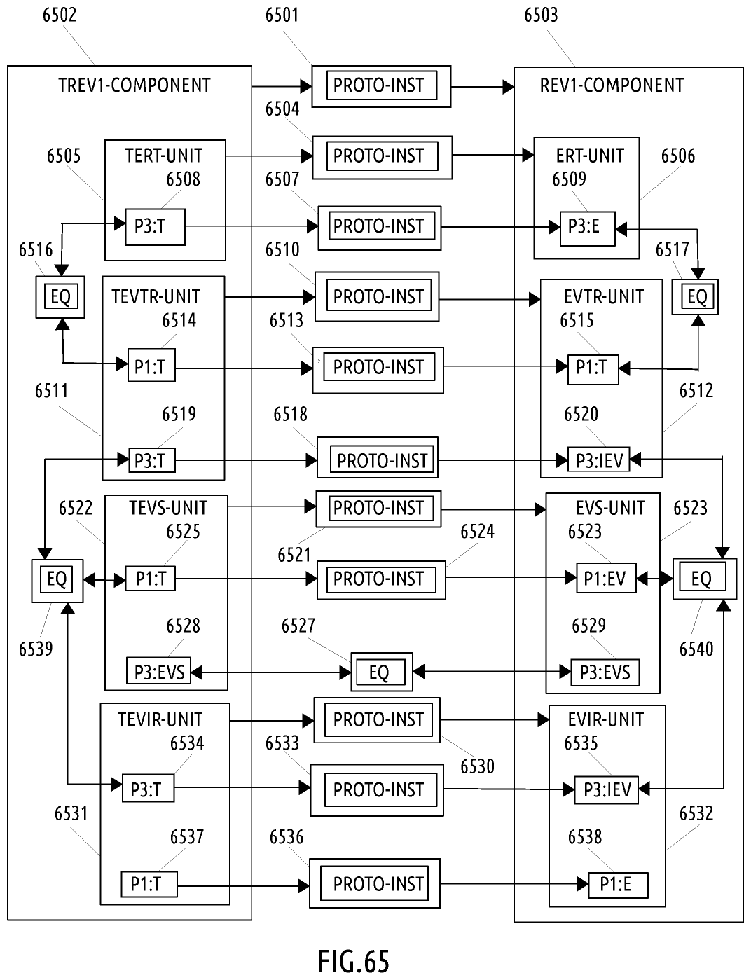

Thus, a proto-T/INST-component-relationship consists of a very simple correspondence between the T-component and the I-component in that relationship. FIG. 65 shows an example of a proto-T/INST-component-relationship 6501 in which the T-component 6502 is a TREV-component and the I-component 6503 is an REV-component. The only significant structural difference between the TREV-component and the REV-component is that the TSR-type-indicator in each of the TSR-units in that TREV-component has a P2-component that indicates the type of that TSR-unit, whereas the corresponding component in the corresponding SR-unit in that I-component has only a single component, consisting of an SR-type-indicator that is I-equivalent to the P1-component of the corresponding TSR-type-indicator in that TSR-unit.

FIG. 65 also shows the proto-T/INST-unit-relationships and some of the proto-T/INST-element-relationships between corresponding components of that TREV-component and that REV-component. Proto-T/INST-unit-relationships shown are as follows: proto-INST-indicator 6504 indicates a proto-T/INST-unit-relationship from TERT-unit 6505 to ERT-unit 6506; proto-INST-indicator 6510 indicates a proto-T/INST-unit-relationship from TEVTR-unit 6511 to EVTR-unit 6512; proto-INST-indicator 6521 indicates a proto-T/INST-unit-relationship from TEVS-unit 6522 to EVS-unit 6523; and proto-INST-indicator 6530 indicates a proto-T/INST-unit-relationship from TEVIR-unit 6531 to EVIR-unit 6532. Those proto-T/INST-unit-relationships include proto-T/INST-element-relationships such as the following: proto-INST-indicator 6507 indicates a proto-T/INST-unit-relationship from T-element 6508 to E-element 6509; proto-INST-indicator 6513 indicates a proto-T/INST-element-relationship from T-element 6514 to E-element 6515; proto-INST-indicator 6518 indicates a proto-T/INST-element-relationship from T-element 6519 to E-element 6520; proto-INST-indicator 6524 indicates a proto-T/INST-element-relationship from T-element 6525 to E-element 6526; proto-INST-indicator 6533 indicates a proto-T/INST-element-relationship from T-element 6534 to E-element 6535; and proto-INST-indicator 6536 indicates a proto-T/INST-element-relationship from T-element 6537 to E-element 6538. The proto-T/INST-component-relationship 6501 also includes an equivalence-relationship 6527 between the EVS-indicator that is the P3-component 6528 of the TEVS-unit in the TREV-component and the EVS-indicator that is the P3-component 6529 of the EVS-unit in the REV-component. There are also pairwise-correspondences between the equivalence-relationships between elements in the TREV-component and equivalence-relationships between elements in the REV-component. For example, the equivalence-relationship 6514 between E-elements in the REV-component corresponds to the equivalence-relationship 6513 between E-elements in the TREV-component; the equivalence-relationship 6540 between E-elements in the REV-component corresponds to the equivalence-relationship 6539 between E-elements in the TREV-component.

If the initial-component in a proto-T/INST-component-relationship in an I-model is a T-specification for a T-element in that I-model, then the terminal-I-component in that relationship represents a structure that is an instance of the complete type-structure for the type-entity represented by that T-element. In that case, that proto-T/INST-component-relationship is a T/INST-component-relationship, and each proto-T/INST-element-relationship in that proto-T/INST-component-relationship is a T/INST-element-relationship. Also, in each T/INST-element-relationship in that T/INST-component-relationship, if the initial-E-element in that T/INST-element-relationship is a primary-T-element in that T-specification, then the entity represented by the terminal-E-element in that T/INST-element-relationship is an instance of the type-entity represented by that primary-T-element. In that case, all those T/INST-element-relationships are co-related.

Those co-relationships may be indicated by a combination of co-relationship-indicator-units whose P1-components are co-relationship-indicator-elements that are E-equivalent. In addition, the P2-components of those units are co-relationship-type-indicators that are co-related-type-instance-relationship-type-indicators. Those indicators indicate that those co-related relationships are type-instance relationships. The P3-components of those co-relationship-indicator-units are the IEV-elements in the IEVB-components that represent those type-instance relationships. All co-related-type-instance-relationship-type-indicators are I-equivalent and are not I-equivalent to any I-element of any other type.

An example is a case in which a T-specification for a T-element represents the type-structure indicated by ‘residents of cities’. In the fact indicated by ‘Tom Smith is a resident of Chicago’, the type-instance relationship between the type-entity indicated by ‘residents’ and the entity indicated by ‘Tom Smith’ is co-related with the type-instance relationship between the type-entity indicated by ‘cities’ and the entity indicated by ‘Chicago’. Similarly, in the fact indicated by ‘Mary Jones is a resident of New York’, the type-instance relationship between the type-entity indicated by ‘cities’ and the entity indicated by ‘Mary Jones’ is co-related with the type-instance relationship between the type-entity indicated by ‘cities’ and the entity indicated by ‘New York’. In contrast, the type-instance relationship between the type-entity indicated by ‘cities’ and the entity indicated by ‘Mary Jones’ is not co-related with the type-instance relationship between the type-entity indicated by ‘cities’ and the entity indicated by ‘Chicago’.

As indicated in that example, there may be more than one combination of co-related type-instance-relationships for the same type-entity. Thus, ‘residents of cities’ may have many separate combinations of co-related type-instance relationships, and each of those combinations may be indicated in an I-model by a separate combination of co-relationship-indicator-units. In addition, if those type-instance-relationships are not invariant, then the conditions when that co-relationship occurs may be indicated by REV1-components as described at the beginning of this section (1.4.6).

In an I-model containing a T-specification and multiple I-components that each have a T/INST-component-relationship with that T-specification, the combination of co-related T/INST-element-relationships in each of those T/INST-component-relationships may be specified in the I-model by a combination of co-relationship-indicator-units.

Such co-relationship combinations may be specified in an I-model by tabular configurational forms. Specifically, each of the T-elements in those T/INST-element-relationships is a cell of the first row of that table. Each of those T-elements is indicated to be E-equivalent to a T-element in that T-specification, which may have a non-tabular configurational form. Each of the rows of that table contains a combination of E-elements that are E-equivalent to the E-elements in a combination of co-related T/INST-element-relationships for one of those I-components. Each of those E-elements in that row of that table is in the same column as the T-element in that first row that is E-equivalent to the T-element from which there is a T/INST-element-relationship to the E-element that is E-equivalent that E-element in that column. The co-relationship-indicator-elements in that table are those configurational components that indicate adjacent E-elements in each row of that table. The co-relationship-indicator-units consist of those components of that table that link each E-element in one of those other rows with the T-element in the first row of the column containing that E-element.

### 1.4.6.2 EQUIVT-Relationships Between T-Specifications

An I-model may include pairs of T-elements that are inter-related by EQUIVT-relationships. An EQUIVT-relationship (‘equivalent-types-relationship’) between two T-elements indicates that the type-entity represented by one of those T-elements has a type-structure that is equivalent to the type-structure of the type-entity represented by that other T-element. The type-structures for two or more type-entities are equivalent if those type-structures specify the same requirements for the instances of those types. Those type-structures may have different configurations but indicate the same required properties for those instances.

An example of equivalent type-entities is the type-entity indicated by ‘residents of cities or towns’ and the type-entity indicated by ‘people who live in urban areas’. Equivalence relationships between type-entities are symmetric: for each equivalence relationship from a type-entity to another type-entity, there is also an equivalence relationship in the opposite direction, from that second type-entity to that first type-entity.

An example of an EQUIVT-relationship between two T-elements is that of the terminal-E-elements in a TEVTR-unit and a TEVIR-unit that are both TJSR-units that are separate T-specifications. The instances of both of the type-entities represented by those terminal-E-elements are all instance-events. Note, however, that the initial-E-elements in those units do not have an EQUIVT-relationship, since the instances of the type-entity represented by the initial-E-element in that TEVIR-unit consist of all entities, whereas the instances of the type-entity represented by the initial-E-element in that TEVTR-unit consist of all type-entities. Thus, that second type-entity is a subtype of that first type-entity since its instances are more restricted.

In an I-model, an equivalence-relationship between the type-entities represented by two T-elements may be represented by an REV1-equivalent-types-component in which the primary-RT-indicator is an equivalent-types-RT-indicator, the initial-E-element is a T-element, and the terminal-E-element is a T-element. In an I-model, an REV1-equivalent-types-component indicates that the terminal-E-element in that component represents a type-entity whose type-structure is equivalent to the type-structure for the type-entity represented by the initial-E-element in that component.

There may be more two or more co-related EQUIVT-relationships from joint-T-elements in one T-specification to joint-T-elements in another T-specification. Those co-relationships may be indicated by a combination of co-relationship-indicator-units whose P1-components are co-relationship-indicator-elements that are E-equivalent. In addition, the P2-components of those units are E-equivalent. Those P2-components indicate that those co-relationships are EQUIVT-relationships. The P3-components of those co-relationship-indicator-units are the IEV-elements in the IEVB-components that represent those equivalent-types relationships.

### 1.4.6.3 CONTRAT-Relationships Between T-Specifications

An I-model may include two or more T-elements that are inter-related by CONTRAT-relationships. A CONTRAT-relationship (‘contratype-relationship’) between two T-elements indicates that the type-entity represented by one of those T-elements is a contratype of the type-entity represented by that other T-element. One type-entity is a contratype of another type-entity if the type-structure for one of those type-entities indicates that the instances of that type-entity are all those entities that are not instances of that other type-entity.

A simple example of a contratype is the case where the type-structure for the type-entity, ‘manufacturing company’, indicates that its instances are all manufacturing companies, while the type-structure for the corresponding contratype-entity indicates that its instances are all entities that are not manufacturing companies. A contratype-relationship between two type-entities is symmetric in that, if one is a contratype of the other, then the other is also a contratype of that first type-entity.

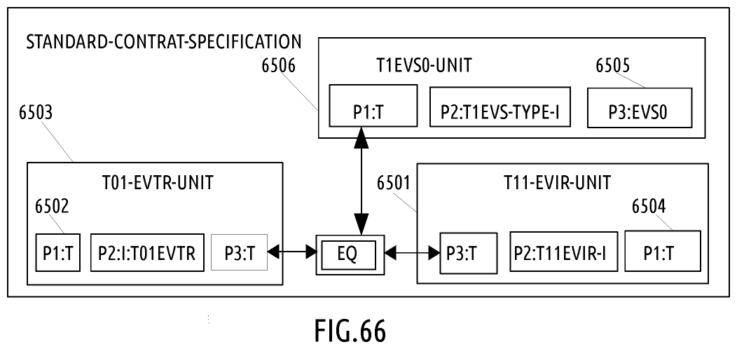

As shown in FIG. 66, the standard-CONTRAT-specification for a T-element is a T-specification that consists of a TIEV-component in which (1) the TEVIR-unit 6601 is a TJSR-unit; (2) the initial-E-element 6602 is that T-element; (3) the TEVTR-unit 6603 is a T01SR-unit; (4) the terminal-E-element 6604 is a second T-element; and (5) the P3-component 6605 of the TEVS-unit 6606 in that TIEV-component is an event-non-occurrence-indicator. That second T-element is a fixed-E-element in that specification. A standard-CONTRAT-specification for a T-element constitutes a CONTRAT-relationship from the terminal-E-element in that standard-CONTRAT-specification to that initial-E-element. That standard-CONTRAT-specification for that first T-element indicates that the type-entity represented by that first T-element is a contratype of the type-entity represented by the terminal-E-element in that T-specification. The type-entity represented by that terminal-E-element is a fixed-entity in the type-structure for the type-entity represented by that first T-element.

If a T-specification for the terminal-E-element in a standard-CONTRAT-specification for the initial-E-element has more than one independent T-component, then that standard-CONTRAT-specification indicates that the entities that are instances of that initial-E-element are those entities that are not instances of all the type-structures represented by those independent T-components. Thus, they are the entities that are not instances of at least one of those type-structures. An example of such is that of a type-structure for a type-entity that indicates that its instances are all entities that are employed persons and live in Chicago. The type-structure for the corresponding contratype-entity indicates that its instances are all entities that are not both employed persons and living in Chicago. That is equivalent to the type-structure that indicates that its instances are all entities that are not employed persons or are not living in Chicago. Thus, the type-structure for a contratype-entity specifies alternative negated possibilities for the instances of that contratype-entity. However, although those alternatives are disjunctive, they may or may not be mutually-exclusive.

As described in section 1.4.2.7, in an I-model, a contratype-relationship between the type-entities represented by two T-elements may be represented by an REV1-type-contratype-component for one of those T-elements.

### 1.4.6.4 DISJT-Relationships Between T-Specifications

An I-model may contain T-elements that are inter-related by DISJT-relationships. A DISJT-relationship (‘disjunctive-type-relationship’) between two T-elements indicates that the type-entity represented by one of those T-elements is a disjunction of the type-entity represented by that other T-element. One type-entity is a disjunction of another type-entity if the type-structure for that first type-entity indicates that its instances are all those entities that are instances of one or more, but not necessarily all, of the independent components of the type-structure for that second type-entity.

Thus, for example, if the type-structure for a type-entity consists of two independent components that indicate that the instances of that type-entity are all entities that are not manufacturing companies and are not located in Chicago, then the type-structure for the contratype-entity for that first type-entity indicates that its instances are all entities that are manufacturing companies or that are located in Chicago. Thus, independent properties indicated by a type-structure are in disjuncted form in the contratype of a contratype of that type-structure.

A standard-DISJT-specification for a T-element consists of a standard-CONTRAT-specification for that T-element such that the T-specification for the terminal-E-element in that standard-CONTRAT-specification consists of a combination of independent T-components, each of which is T-identical to a standard-CONTRAT-specification for some T-element. The terminal-E-elements in those latter standard-CONTRAT-specifications are the secondary-terminal-E-elements in that standard-DISJT-specification. That standard-CONTRAT-specification for that first T-element indicates that the instances of the type-entity represented by that T-element are those entities that are instances of at least one, though not necessarily all, of the type-entities represented by those secondary-terminal-E-elements. Thus, the T-specifications for those secondary-terminal-E-elements indicate alternative possibilities for the instances of the type-entity represented by that first T-element. FIG. 67 shows a standard-DISJT-specification for a T-element 6701 with two secondary-terminal-E-elements 6702 and 6703.

### 1.4.6.5 SUBT-Relationships Between T-Elements

An I-model may include T-elements that are inter-related by SUBT-relationships. A SUBT-relationship (‘subtype-relationship’) from one T-element to another T-element indicates that the type-entity represented by the second of those T-elements is a subtype of the type-entity represented by that first T-element. In that situation, the type-structure of the type-entity that is the subtype restricts the range of possible instances of that type-entity more than does the type-structure of the type-entity that is the supertype. In an I-model, a subtype-relationship between the type-entities represented by two T-elements may be represented by a REV1-subtype-component, described in section 1.4.2.5.

There may be more two or more co-related SUBT-relationships from joint-T-elements in one T-component to joint-T-elements in another T-component. Those co-relationships may be indicated by a combination of co-relationship-indicator-units whose initial-E-elements are co-relationship-indicator-elements that are E-equivalent. In addition, the SR-type-indicators in those units are co-related-subtype-relationship-type-indicators. Those indicators indicate that those co-relationships are SUBT-relationships. The terminal-E-elements in those co-relationship-indicator-units are the IEV-elements in the REV1-subtype-components that indicate those SUBT-relationships.

In an I-model, there may be more than one combination of co-related SUBT-relationships for the same T-element, and each of those combinations may be indicated by a separate combination of co-relationship-indicator-units.

A group of subtypes for a type-entity is comprehensive if the properties specified in the type-specifications for those subtypes are such that every possible instance of that type-entity must be an instance of at least one of those subtypes. Such a comprehensive group of subtypes for a type-entity may be indicated by a combination of co-relationship-indicator-units. An I-model may include indications of two or more different comprehensive groups of subtypes of the same type-entity.

A collection of subtypes for a type-entity is mutually-exclusive if the properties specified in the type-specifications for those subtypes are such that no possible instance of any one of those subtypes may be an instance of any of those other subtypes. A mutually-exclusive of subtypes for a type-entity may be indicated by a combination of co-relationship-indicator-units. An I-model may include indications of two or more different groups of mutually-exclusive subtypes of the same type-entity.

If a first T-element has a SUBT-relationship to second T-element, and that second T-element has a SUBT-relationship to a third T-element, then that first T-element has a SUBT-relationship to that third T-element. That corresponds to the fact that, if one type-entity is a subtype of a second type-entity, and that second type-entity is a subtype of a third type-entity, then that first type-entity is also a subtype of that third type-entity.

The following are some types of SUBT-relationships that may exist in an I-model: ADDNSUBT-relationships, DISJSUBT-relationships, MERGESUBT-relationships, SPECNSUBT-relationships, CONTRASUBT-relationships, and combinations of those.

### 1.4.6.5.1 ADDNSUBT-Relationships Between T-Elements

A T-element has an ADDNSUBT-relationship (‘addition-subtype-relationship’) to another T-element if the T-specification for that first T-element includes a T-component that is T-identical to the T-specification for that second T-element. If that first T-specification also includes one or more additional T-components for any of its primary-T-elements, then those additional T-components render that first T-specification more restrictive than that second T-specification.

ADDNSUBT-subtype-relationships and co-related ADDNSUBT-subtype relationships may be specified in an I-model by means of REV1-components and combinations of co-relationship-indicator-units.

### 1.4.6.5.2 COMPADDNSUBT-Relationships Between T-Elements

If a combination of co-related ADDNSUBT-relationships have terminal-E-elements that represent the same type-entity, and if every component of the type-specification for that type-entity is identical to a combination of components of the type-specifications for the type-entities represented by the initial-E-elements in those ADDNSUBT-relationships, then that combination of co-related ADDNSUBT-relationships is a COMPADDNSUBT-relationship (‘comprehensive type-addition-subtype’). Every component of the type-specification for that first type-entity is accounted for by a combination of components of those second type-entities. COMPADDNSUBT-relationships may be specified in an I-model by means of REV1-components.

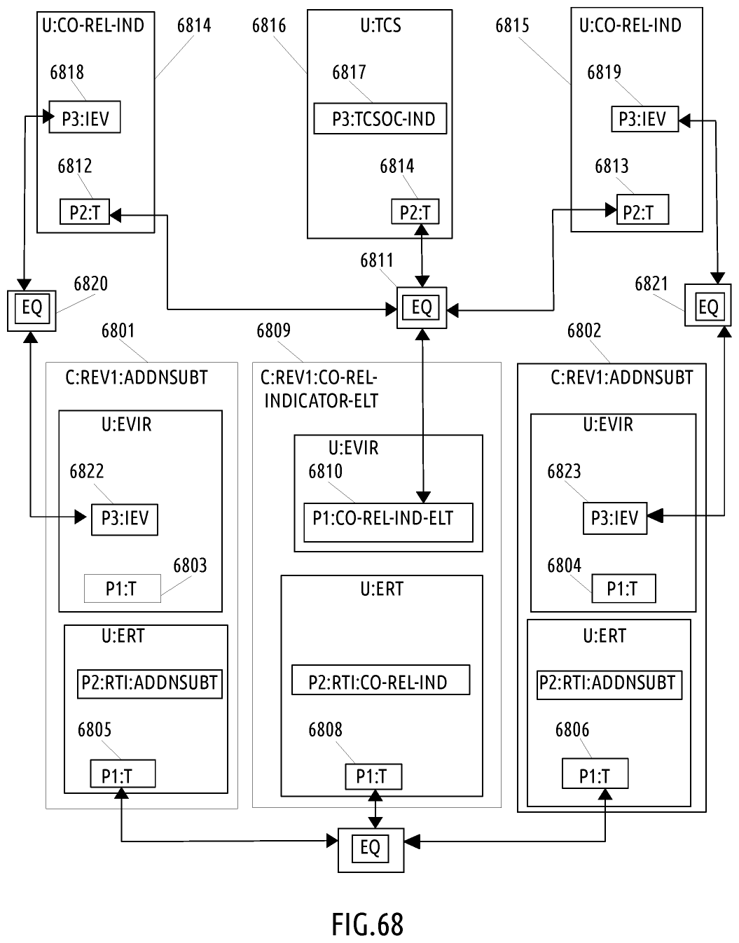

A combination of co-related COMPADDNSUBT-relationships may be specified in an I-model by means of a REV1-co-relationship-indicator-component and a combination of co-relationship-indicator-units. As shown in an example of two co-related COMPADDNSUBT-relationships in FIG. 68, the REV1-addition-subtype-components 6801 and 6802 show the two ADDNSUBT-relationships that constitute those two co-related COMPADDNSUBT-relationships. The P1-components 6803 and 6804 in the EVIR-units in those REV1-components represent the two subtypes of the type-entity represented by the E-equivalent 6807 P1-components 6805 and 6806 in the ERT-units in those REV1-relationships. Those two E-equivalent P1-components are also E-equivalent 6807 to the P1-component 6808 in the ERT-unit in the REV1-co-relationship-indicator component 6809. The P1-component 6810 in the EVIR-unit in that REV1-co-relationship-indicator component is E-equivalent 6811 to the P1-components 6812 and 6813 in the two co-relationship-indicator-units 6814 and 6815. Those P1-components 6810, 6812, and 6813 are also E-equivalent 6811 to the P2-component 6814 in the T-specification-status-unit 6816. The T-specification-status-indicator 6817 in that T-specification-status-unit is a T-specification-completeness-indicator. It indicates that the two P3-components 6818 and 6819 constitute a complete set of co-related IEV-elements for the two REV1-addition-subtype-components that indicate the two co-related COMPADDNSUBT-relationships. Those two co-related IEV-elements are separately E-equivalent 6820 and 6821 to the IEV-elements 6822 and 6823, respectively, in the REV1-addition-subtype-components.

### 1.4.6.5.3 DISJSUBT-Relationships Between T-Elements

As described in section 1.4.6.4, a type-entity whose type-structure indicates that the instances of that type-entity are those entities that are instances of any one or more of a specified combination of other type-entities may be indicated in an I-model by a standard-DISJT-specification for the T-element that represents that first type-entity and whose secondary-terminal-E-elements for that T-element represent the type-entities in that specified combination.

Each of the type-entities represented by one of those secondary-terminal-E-elements is a subtype of the type-entity represented by that first T-element. That first T-element has a DISJSUBT-relationship (‘disjunction-subtype-relationship’) to each of those secondary-terminal-E-elements, whether or not their standard-T-specifications are represented in that I-model. In the example of a standard-DISJT-specification shown in FIG. 66, each of the secondary-terminal-T-elements 6602 and 6603 represents a subtype of the type-entity represented by T-element 6601.

DISJSUBT-relationships and co-related DISJSUBT-relationships may be indicated in an I-model by means of REV1-components and combinations of co-relationship-indicator-units.

### 1.4.6.5.4 MERGESUBT-Relationships Between T-Elements

A T-element has a MERGESUBT-relationship (‘merge-subtype-relationship’ to another T-element if the T-specification for that first T-element is T-identical to the T-specification for that second T-element except that some primary-T-elements in that first T-specification are indicated to be E-equivalent but the corresponding primary-T-elements in that second T-specification are not indicated to be E-equivalent.

Merge-subtype-relationships may be indicated in an I-model by means of REV1-components and combinations of co-relationship-indicator-units.

### 1.4.6.5.5 SPECNSUBT-Relationships Between T-Elements

A T-element has a SPECNSUBT-relationship (‘specialization-subtype relationship’ to another T-element if the T-specification for that first T-element is T-identical to the T-specification for that second T-element except that one or more TJSR-units in that second T-specification are replaced in that first T-specification by T10SR-units or T01SR-units. The P1-component of the TSR-type-indicator in each such T10SR-unit or T01SR-unit is I-equivalent to the TSR-type-indicator in the TJSR-unit that it replaces. In addition, in each such T10SR-unit, the P2-component of the TSR-type-indicator is a T10SR-level-indicator and the terminal-E-element is not E-equivalent to terminal-E-element in the TJSR-unit that it replaces. Similarly, in each such T01SR-unit, the P2-component of the TSR-type-indicator is a T01SR-level-indicator and the initial-E-element is not E-equivalent to the initial-E-element in the TJSR-unit that it replaces.

SPECNSUBT-relationships between T-elements indicate specialization-subtype relationships between the type-entities represented by those T-elements. For example, one specialization of the type-entity indicated by ‘buildings located in large cities and occupied by manufacturing companies’ is the type-entity indicated by ‘buildings located in Chicago and occupied by manufacturing companies’. In that example, ‘Chicago’ is a fixed-entity in the type-structure for that second type-entity, and specializes the type-entity indicated by ‘large cities’ in the type-structure for that first type-entity. The type-entity indicated by ‘buildings located in Detroit and occupied by manufacturing companies’ is another specialization-subtype of the type-entity indicated by ‘large cities’.

Specialization-subtype relationships may be indicated in an I-model by means of REV1-components and combinations of co-relationship-indicator-units.

### 1.4.6.5.6 Standard-CONTRASUBT-Relationships Between T-Elements

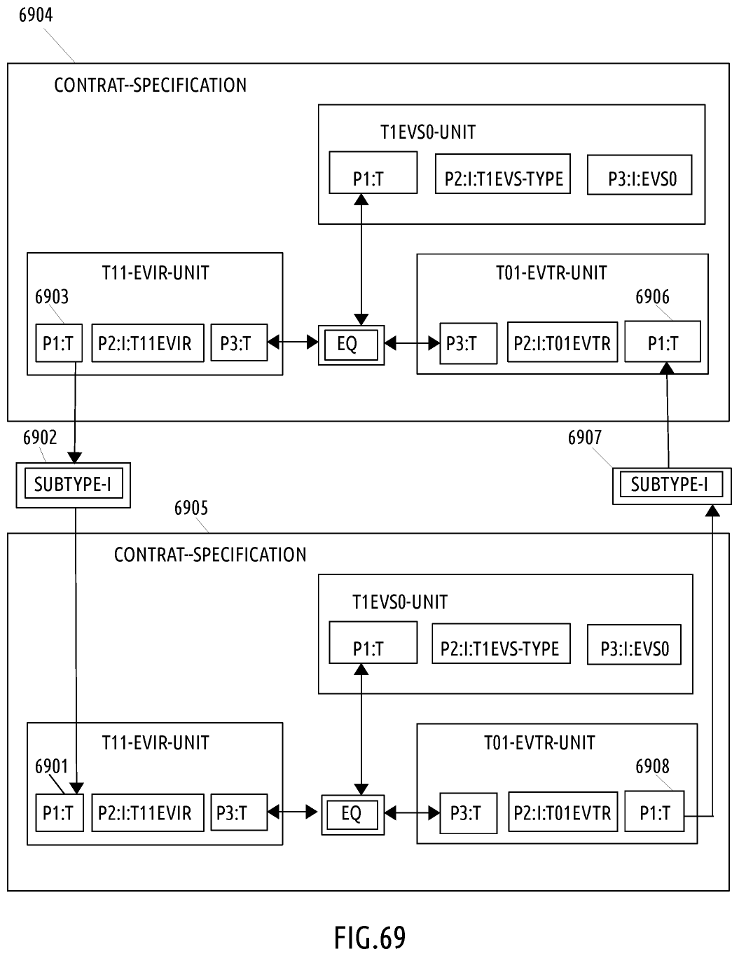

As shown in FIG. 69, a T-element 6901 has a standard-CONTRASUBT-relationship (‘standard-contrasubtype-relationship’) 6902 to another T-element 6903 if (1) the T-specifications 6904 and 6905 for those two T-elements are standard-CONTRAT-specifications, and (2) the terminal-E-element 6906 in that first standard-CONTRAT-specification 6904 has a SUBT-relationship 6907 to the terminal-E-element 6908 in that second standard-CONTRAT-specification 6905.

That standard-CONTRASUBT-relationship represents the relationship between the type-entity represented by that first T-element and the type-entity represented by that second T-element such that that first entity is a contratype of a third type-entity that is a subtype of a fourth type-entity and that second type-entity is a contratype of that fourth type-entity. For example, if that second terminal-E-element represents the type-entity, ‘truck’, and the first terminal-E-element represents the type-entity, ‘vehicle’, then the first T-element in that CONTRASUBT-relationship above represents the type-entity indicated by ‘things that are not vehicles’, and the second T-element in that CONTRASUBT-relationship represents the type-entity indicated by ‘things that are not trucks’.

Such relationships may be indicated in an I-model by means of REV1-components and combinations of co-relationship-indicator-units.

### 1.4.6.5.7 LOGCON-Relationships Between I-Components

There may be a LOGCON-relationship between a combination of I-components in an I-model and another combination of I-components that may be constructed and added to that I-model. A LOGCON-relationship (‘logical-consequence-relationship’) from a first combination of I-components in an I-model to a second combination of I-components is a structural relationship between primary components of the I-components in those combinations that indicates that that second combination is a logical consequence of that first combination and, hence, also represents aspects of the subject of that I-model. Consequently, a copy of that second combination of I-components may be added to that I-model. In addition, no combination of I-components that is inconsistent with any part of that second combination may be added to that I-model. There may be one or more E-equivalences between one or more E-elements in the I-components in that first combination and one or more E-elements in the I-components in that second combination.

A LOGCON-relationship-pair is a pair of combinations of I-components such that there is a LOGCON-relationship from that first combination to that second combination. There is an unlimited range of types of LOGCON-relationships that may be specified in I-models. Some examples follow.

### 1.4.6.5.7.1 Event-Occurrence-Implication-LOGCON-Relationships

An event-occurrence-implication-LOGCON-relationship is a LOGCON-relationship-pair in which the first combination of I-components consists of an REV1-event-occurrence-implication-component and an EVS-unit whose EV-element is E-equivalent to the initial-E-element in that REV1-event-occurrence-implication-component. The second combination consists of an EVS-unit whose EV-element is E-equivalent to the terminal-E-element in that REV1-event-occurrence-implication-component.

That LOGCON-relationship indicates that the occurrence-state of the event represented by the initial-E-element in that REV1-event-occurrence-implication-component implies a particular occurrence-state of the event represented by the terminal-E-element in that component.

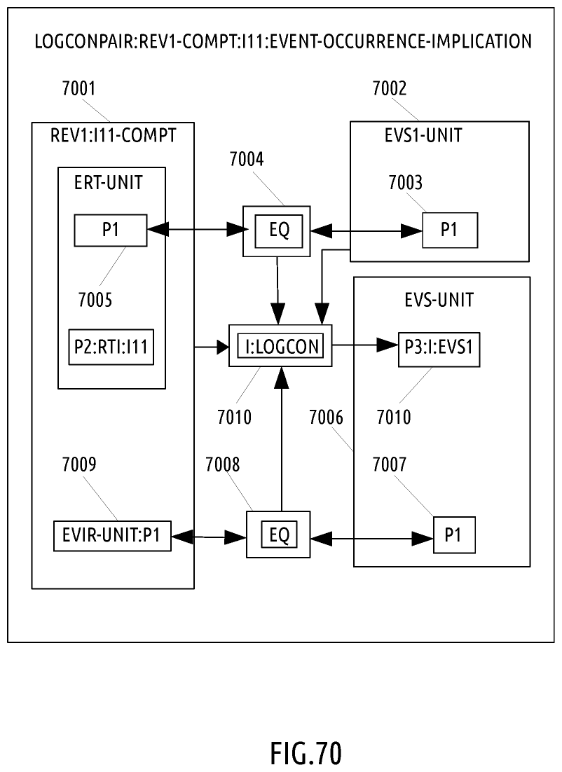

In the LOGCON-relationship-pair shown in FIG. 70, the first combination of I-components consists of (1) an REV1-I11-event-occurrence-implication-component 7001, and (2) an EVS1-unit 7002 whose P1-component 7003 is E-equivalent 7004 to the initial-E-element 7005 in that REV1-I11-event-occurrence-implication-component. The second combination of components in that pair consists of an EVS1-unit 7006 whose P1-component 7007 is E-equivalent 7008 to the terminal-E-element 7009 in that REV1-I11-event-occurrence-implication-component. That second combination is a LOGCON-implication of that first combination and that implication is indicated by the LOGCON-indicator 7010. That LOGCON-indication indicates the components that are the inputs and outputs of the LOGCON-operations that identify that LOGCON-relationship.

Similarly, if that event-occurrence-implication-RT-indicator is a 10-event-occurrence-implication-RT-indicator and that first EVS-unit is an EVS1-unit, then that implies that that second EVS-unit is an EVS0-unit. If that event-occurrence-implication-RT-indicator is a 01-event-occurrence-implication-RT-indicator and that first EVS-unit is an EVS0-unit, then that implies that that second EVS-unit is an EVS1-unit. If that event-occurrence-implication-RT-indicator is a 00-event-occurrence-implication-RT-indicator and that first EVS-unit is an EVS0-unit, then that implies that that second EVS-unit is an EVS0-unit.

### 1.4.6.5.7.2 EV-Dependence-LOGCON-Relationships

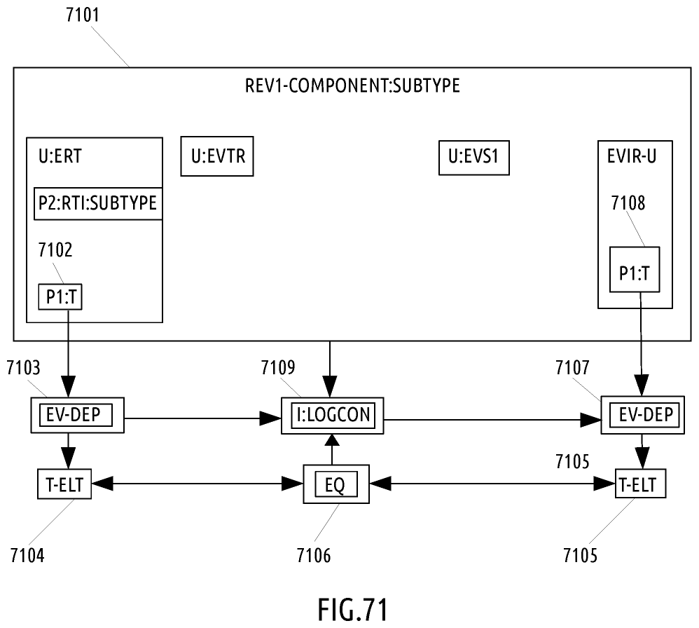

A EV-dependence-relationship may be indicated by a LOGCON-relationship. For example, FIG. 71 shows a LOGCON-relationship-pair in which the first combination of components consists of a REV1-subtype-component 7101 in which the initial-E-element 7102 is EV-dependent 7103 on an EV-element 7104. The second combination of components in that pair consists of an EV-element 7105 that is E-equivalent 7106 to that first EV-element 7104. The EV-dependence 7107 of the terminal-E-element 7108 in that REV1-subtype-component 7101 is indicated by the LOGCON-implication 7109.

### 1.4.6.5.7.3 T/SUBT-LOGCON-Relationships

A T/SUBT-LOGCON-relationship-pair (‘type/subtype-logical-consequence-relationship’) is a LOGCON-relationship-pair in which the first combination of I-components consists of an REV1-component in which the primary-RT-indicator indicates a specific type of subtype, such as one of the types described above. The second combination of I-components in that relationship consists of an REV1-component in which the primary-RT-indicator is a subtype-RT-indicator, the initial-E-element is E-equivalent to the initial-E-element in that first REV1-component, and the terminal-E-element is E-equivalent to the terminal-E-element in that first REV1-component.

That T/SUBT-LOGCON-relationship indicates that, since the type-entity represented by the terminal-E-elements in those REV1-components is indicated by that first REV1-component to be a subtype of the type-entity represented by the initial-E-elements in those REV1-components, and that subtype-relationship is of the specific type indicated by the primary-RT-indicator in that first REV1-component, then that type-entity represented by those terminal-E-elements is a general subtype of the type-entity represented by those initial-E-elements in those REV1-components.

### 1.4.6.5.7.4 T/SUBT/SUBT-LOGCON-Relationships

A T/SUBT/SUBT-LOGCON-relationship-pair (‘type-subtype-subtype-logical-consequence-relationship’) is a LOGCON-relationship-pair in which the first combination of I-components consists of two REV1-components in which the primary-RT-indicators are subtype-RT-indicators, and in which the terminal-E-element of the first of those REV1-components is E-equivalent to the initial-E-element of that second REV1-component. The second combination of I-components consists of an REV1-component in which the RT-indicator is a subtype-RT-indicator, the initial-E-element is E-equivalent to the initial-E-element in the second REV1-component in that first combination, and the terminal-E-element is E-equivalent to the terminal-E-element in the first REV1-component in that first combination.

That LOGCON-relationship indicates that, since the type-entity represented by the terminal-E-element in that second REV1-component is a subtype of the type-entity represented by the initial-E-element in that second REV1-component, and, since that second type-entity is a subtype of the type-entity represented by the in initial-E-element in that first REV1-component, then that type-entity represented by the terminal-E-element in that second REV1-component is also a subtype of the type-entity represented by the initial-E-element in that first REV1-component.

### 1.4.6.5.7.5 T/INST-LOGCON-Relationships

A T/INST-LOGCON-relationship-pair (‘type-instance-logical-consequence-relationship’) is a LOGCON-relationship-pair in which the first combination of I-components consists of a T-specification and an I-component, and the second combination consists of one or more IEV1-components. That T-specification is the first component in a T/INST-component-relationship, and that I-component is the second component in that T/INST-component-relationship. In each of those IEV1-components, the primary-T-element is E-equivalent to the first T-element in a T/INST-element-relationship in that T/INST-component-relationship, and the INST-element is E-equivalent to the second E-element in that T/INST-element-relationship.

That LOGCON-relationship indicates that each entity represented by the second E-element in a T/INST-element-relationship in that T/INST-component-relationship is an instance of the type-entity represented by the first E-element in that T/INST-element-relationship, and that those T/INST-element-relationships are co-related.

### 1.4.6.5.7.6 INSTEV/TYPEV-LOGCON-Relationships

An INSTEV1/TYPEV1-LOGCON-relationship-pair (‘occurrent-instance-event/occurrent-type-event-logical-consequence-relationship’) is a LOGCON-relationship-pair in which the first combination of I-components consists of an IEV1-component, and the second combination consists of an EVS1-unit whose EV-element is E-equivalent to the primary-T-element in that IEV1-component. This LOGCON-relationship indicates that, since that IEV1-component indicates that the type-entity represented by the initial-T-element in that IEV1-component has an instance, then that initial-E-element represents an occurrent type-event.

A TYPEV0/INSTEV0-LOGCON-relationship-pair (‘non-occurrent-type-event/non-occurrent-instance-event-logical-consequence-relationship’) is a LOGCON-relationship-pair in which the first combination of I-components consists of an EVS0-unit, and the second combination consists of an IEV0-component whose primary-T-element is E-equivalent to the EV-element in that EVS0-unit and whose INST-element represents any entity. That LOGCON-relationship indicates that, since that EVS0-unit indicates that the type-entity represented by the EV-element in that unit is not occurrent, then the INST-element in that IEV0-component is not an instance of that type-entity.

### 1.4.6.5.7.7 SUBT/SUPT-INST-LOGCON-Relationships

A SUBT/SUPT-INST1-LOGCON-relationship-pair (‘subtype-supertype-instance-logical-consequence-relationship’ is a LOGCON-relationship-pair in which the first combination of I-components consists of an IEV1-component and an REV1-component in which the primary-RT-indicator is a subtype-RT-indicator or an RT-indicator for one of the specific types of subtype-relationship described above. The primary-T-element in that IEV1-component is E-equivalent to the terminal-E-element in that REV1-component. The second combination in that pair consists of an IEV1-component whose primary-T-element is E-equivalent to the initial-E-element in that REV1-component, and whose INST-element is E-equivalent to the INST-element in that first IEV1-component.

That LOGCON-relationship indicates that, since the type-entity represented by the terminal-E-element in that REV1-component is a subtype of the type-entity represented by the initial-E-element in that REV1-component, and, since that INST-element represents an entity that is an instance of the type-entity represented by that terminal-E-element, then that entity is also an instance of the type-entity represented by that initial-E-element.

A SUPT/SUBT-INST0-LOGCON-relationship-pair (‘supertype-subtype-non-instance-logical-consequence-relationship’) is a LOGCON-relationship-pair in which the first combination in that pair consists of an IEV0-unit and an REV1-component in which the primary-RT-indicator is a subtype-RT-indicator, or an RT-indicator for one of the specific types of subtype-relationship described above. The primary-T-element in that first IEV0-component is E-equivalent to the initial-E-element in that REV1-component. The second combination of I-components consists of an IEV0-component whose primary-T-element is E-equivalent to the terminal-E-element in that REV1-component, and whose INST-element is E-equivalent to the INST-element in that first IEV0-component. That LOGCON-relationship indicates that, since the type-entity represented by the terminal-E-element in that REV1-component is a subtype of the type-entity represented by the initial-E-element in that REV1-component, and, since the INST-element in that first IEV0-component represents an entity that is not an instance of the type-entity represented by that initial-E-element, then that entity is also not an instance of the type-entity represented by that terminal-E-element.

### 1.4.6.5.7.8 EQUIV-LOGCON-Relationships

An EQUIV-LOGCON-relationship-pair (‘equivalent-I-components-relationship’) in an I-model is a LOGCON-relationship-pair in which the first combination of I-components in that pair represents exactly the same things about the subject of that I-model as the second combination of I-components in that pair.

### 1.4.6.5.7.9 CONTRAT-LOGCON-Relationships

A CONTRAT-LOGCON-relationship-pair (‘contratype-instance-relationship’) is a LOGCON-relationship-pair in which the first combination of I-components consists of an IEV1-component and an REV1-type-contratype-component in which the initial-E-element is E-equivalent to the initial-E-element in that IEV1-component. The second combination of I-components consists of IEV0-component in which the initial-E-element is E-equivalent to the terminal-E-element in that REV1-component and the terminal-E-element is E-equivalent to the terminal-E-element in that IEV1-component.

That LOGCON-relationship indicates that, since the type-entity represented by the terminal-E-element in that REV1-component is a contratype of the type-entity represented by the initial-E-element in that REV1-component, and since the entity represented by the terminal-E-element in that IEV1-component is an instance of that second type-entity, then that entity is not an instance of that first type-entity.

### 1.4.6.6 Inconsistency-Pairs

An inconsistency-pair is a pair of combinations of I-components such that one of those combinations indicates something about the subject of the I-model containing it that is inconsistent with what is indicated by that other combination. For example, if an I-model contains two or more EVS-units whose P1-components are E-equivalent while the P3-components indicate different occurrence-states for the event represented by those P1-components, then that difference is an inconsistency. As described in section 1.3.1.1.1.4.1, such inconsistencies have to be resolved before that I-model can function as a consistent source of information. Another type of inconsistency-pair consists of cases where one of the combinations of I-components is the first combination in a LOGCON-relationship-pair, and the second component of that pair includes an EVS-unit that is inconsistent with an EVS-unit in the second combination of components in that LOGCON-relationship-pair.

### 1.4.7 RT-Specifications

As explained in section 1.3.1.4.1, the RT-indicator in an RT-specification-unit in an I-model indicates a particular type-relationship between two joint type-entities in the type-structure for those type-entities represented in that I-model. The entirety of that type-structure constitutes that type-relationship. The initial-T-element in that RT-specification-unit represents the initial-type-entity in that type-relationship. The terminal-E-element in that RT-specification-unit is the RT-element in that unit and represents the terminal-type-entity in that type-relationship. A T-specification for that initial-T-element has only one independent T-component. That same T-specification may have more than one independent T-component for the RT-element. The name of the type-entity represented by that RT-element may be translationally-equivalent to that RT-indicator.

The pairs of joint-instances of that initial-type-entity and that terminal-type-entity are the initial- and terminal-entities of each relationship that is an instance of that type-relationship: the initial-entity in one of those relationships is the instance of the initial-type-entity, and the terminal-entity in that relationship is the co-related instance of the terminal-type-entity.

Some examples of names of type-relationships are ‘weight’, ‘price’, ‘name’, ‘supervisor’, ‘component’, ‘build’, ‘buy’, ‘teach’, ‘produce, ‘location’, and ‘operational-state (of a machine)’. Specifically, in the type-structure specified by ‘plastic items produced by manufacturing companies’, the joint type-entities, ‘plastic items’ and ‘manufacturing companies’, are related via the type-relationship, ‘produced by’.

In some records, a specification of the type-structure for a type-relationship may not include separate specifications of that relationship-type and of either or both of the initial-type-entity and the terminal-type-entity. That is the case with many relationship-types that are commonly considered to be types of attributes or measurements. For example, ‘weight (of entities)’, ‘price (of items for sale)’, ‘location (of entities)’, and ‘operational state (of machines)’. In such cases, the nature of that type-relationship is indicated by the same name that also identifies the terminal-type-entity. Thus, for example, ‘weight’ indicates both the terminal-type-entity and the nature of the type-relationship between the initial-type-entity and that terminal-type-entity. In an I-model, the T-specification of such a type-relationship includes T-elements that represent the initial- and terminal-type-entities in that type-relationship that are separate from the components of that T-specification that specify the nature of that type-relationship between those type-entities.

As explained in section 1.3.1.1.1.1, an ERT-unit indicates a structural-relationship of a particular type between a type-entity and a fixed-entity in the type-structure for that type-entity. In such a relationship, that fixed-entity is the initial-fixed-entity in that relationship and that type-entity is the terminal-type-entity in that relationship. That relationship-type is a fixed-entity-relationship-type. Each instance of that relationship consists of a corresponding relationship between that same initial-fixed-entity and an instance of that terminal-type-entity. Thus, for example, in the type-specification, ‘plastic items produced by manufacturing company ABC’, the fixed-entity is indicated by ‘manufacturing company ABC’, the terminal-type-entity is indicated by ‘plastic items’, and the relationship-type is indicated by ‘produced by’.

Two or more such relationships may have type-structures that differ only in the identities of their fixed-entities. In that situation the general nature of the type of relationship is the same in each case; for example, ‘size of Company A’, ‘size of Company B’ and ‘size of Company C’. Furthermore, each of those is a specialization-subtype of the type-relationship, ‘sizes of companies’. The only difference between the type-structure of that type-relationship and the type-structures of those fixed-entity-relationship-types is that ‘companies’ is replaced in each case by the name of a specific company. Because each of those fixed-entity-relationship-types is more restrictive than that type-relationship, each of those fixed-entity-relationship-types is a subtype of that type-relationship. Such a subtype-relationship between a type-relationship and a fixed-entity-relationship-type related to it by that kind of difference in their type-structures is a specialization-subtype relationship.

All the instance-entities for the terminal-type-entity in the type-structure of a fixed-entity-relationship-type are related to the fixed-entity via exactly the same structural type of relationship. Thus, for example, if the price of item X is $10, then ‘$10’ is an instance of the fixed-entity-relationship-type, ‘price of item X’. There may be multiple such instances. For example, the type-entity, ‘employees’, in the fixed-entity-relationship-type, ‘employees of company A’, may have many instance-entities, each of which is an employee of company A. Also, those instance-entities may change over time; for example, company A may have different employees at different times.

Correspondingly, for each RT-specification-unit that indicates a particular type-relationship, there may be many ERT-units in which the RT-indicator is I-equivalent to the RT-indicator in that RT-specification-unit. Each such ERT-unit indicates a fixed-entity-relationship-type that is a specialization-subtype of the type-relationship indicated by that RT-specification-unit.

If an I-model includes a T-specification for a T-element that is E-equivalent to the RT-element in an RT-specification-unit in that I-model, then that T-specification is an RT-specification (‘relationship-type-specification’) for that T-element. That T-specification may, in turn, be employed by an operative-component in the I-system to construct a T-specification for the ERT-element in each ERT-unit in which the RT-indicator is I-equivalent to the RT-indicator in that RT-specification-unit. That construction is possible because of the SPECNSUBT-relationship between that first T-specification and that second T-specification; that SPECNSUBT-relationship indicates that second T-specification may be constructed by first forming a T-component that is identical to that first T-specification, and then replacing all the TJSR-units in that RT-specification whose initial-E-elements are E-equivalent to the initial-T-element in that RT-specification-unit by a combination of T10SR-units and T01SR-units in the manner described in section 1.4.6.5.5 for SPECNSUBT-relationships. The terminal-E-elements in those T10SR-units and the initial-E-elements in those T01SR-units are E-equivalent to the initial-E-element in that ERT-unit.

Being able to construct that T-specification for the ERT-element in an ERT-unit only when required for the operations in the I-system simplifies that I-model since it avoids the need to include in that I-model a separate T-specification for every ERT-element in every ERT-unit.

The relationship between a T-specification for the RT-element in an RT-specification-unit and the T-specification for the ERT-element in an ERT-unit whose RT-indicator is I-equivalent to the RT-indicator in that RT-specification-unit may be represented by an REV1-component.

In addition, that relationship is the basis for an RT/ERT-LOGCON-relationship-pair (‘relationship-type/entity-relationship-type’), which is a LOGCON-relationship-pair in which the first combination of I-components consists of that RT-specification-unit, that ERT-unit, and that first T-specification, and the second combination of I-components consists of that second T-specification.

In an I-model, the general structural forms of the RT-specifications for the RT-elements in RT-specification-units may be restricted to a few specified standard forms. That results in simpler I-models and simpler operations on those RT-specifications. Examples of such structural forms include simple-primitive RT-specifications, partial-primitive RT-specifications, and non-primitive RT-specifications, described in the following subsections.

### 1.4.7.1 Simple-Primitive RT-Specifications

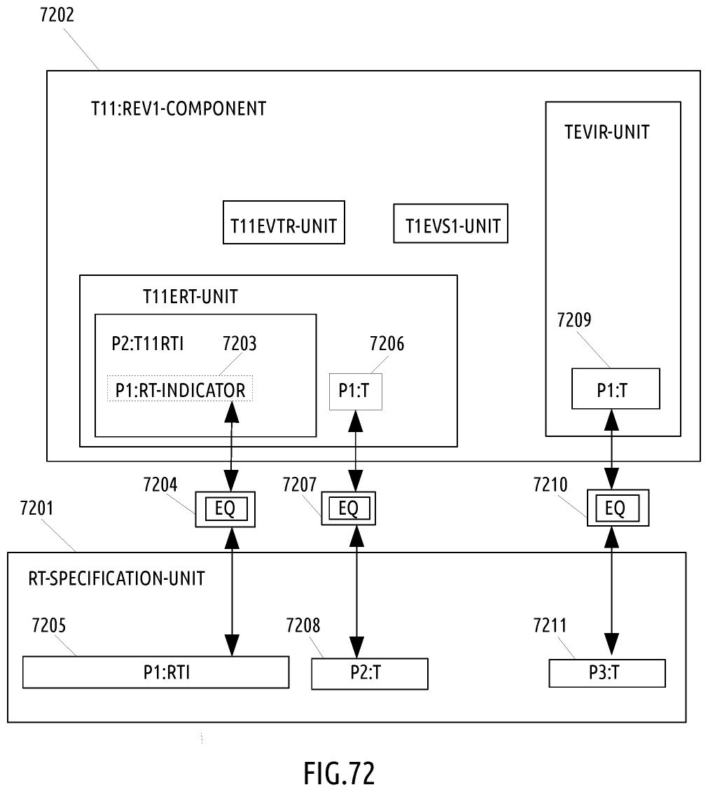

As shown in FIG. 72, a simple-primitive RT-specification for the RT-element in an RT-specification-unit 7201 is an RT-specification whose primary component consists of a T11REV1-component 7202 whose primary-RT-indicator 7203 is I-equivalent 7204 to the RT-indicator 7205 in that RT-specification-unit. The initial-T-element 7206 in that T11REV1-component is E-equivalent 7207 to the P2-component 7208 in that RT-specification-unit. The terminal-T-element 7209 in that TREV1-component is E-equivalent 7210 to the P3-component 7211 in that RT-specification-unit.

That RT-specification is primitive because it involves no other RT-indicators and hence the type-structure for the type-entity represented by the RT-element in that RT-specification-unit is not specified in terms of more-fundamental types of relationships.

### 1.4.7.2 Partial-Primitive RT-Specifications

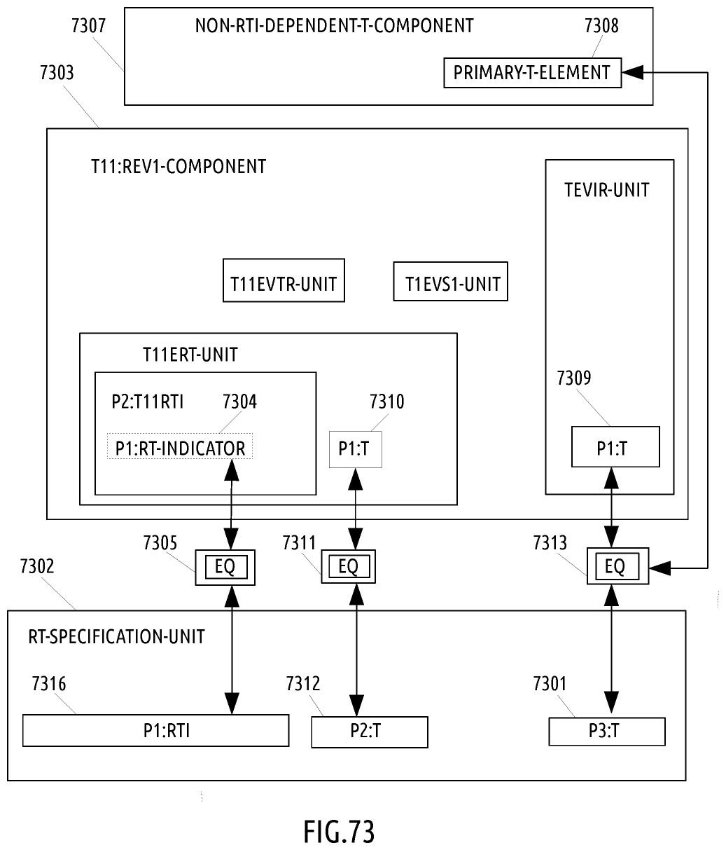

A partial-primitive RT-specification indicates a type-relationship whose type-structure is partially-primitive and partially non-primitive. A partial-primitive RT-specification consists of two T-components: a TREV1-component that has the form of a primitive RT-specification, as described above, and a second T-component. That second T-component is not RT-dependent on the RT-indicator in that TREV1-component. Specifically, as shown in FIG. 73, a partial-primitive RT-specification for the RT-element 7301 in an RT-specification-unit 7302 is an RT-specification whose primary component consists of (1) a TREV1-component 7303 whose primary-RT-indicator 7304 is I-equivalent 7305 to the RT-indicator 7306 in that RT-specification-unit, and (2) a second T-component 7307 that includes a primary-T-element 7308 that is E-equivalent to the terminal-E-element 7309 in that TREV1-component and is not RT-dependent on the RT-indicator in that RT-specification-unit 7302. The initial-E-element 7310 in that TREV1-component is E-equivalent 7311 to the initial-T-element 7312 in that RT-specification-unit, and the terminal-E-element 7309 in that TREV1-component is E-equivalent 7313 to the RT-element 7301 in that RT-specification-unit. That terminal-E-element 7309 is also E-equivalent 7313 to that primary-T-element 7309 in that second T-component 7307. That initial-T-element 7310 may be E-equivalent to a primary-T-element in that second T-component. No other T-element in that TREV1-component may be E-equivalent to any T-element in that second T-component other than those two cases just described. That initial-T-element 7310 has only one independent T-component.

A partial-primitive RT-specification indicates a type-relationship whose type-structure is partially primitive and partially non-primitive: the TREV1-component is the primitive component, and the other T-component is the non-primitive component.

### 1.4.7.3 Non-Primitive RT-Specifications

A non-primitive RT-specification for the RT-element in an RT-specification-unit is an RT-specification for that RT-element such that that RT-element is not RT-dependent on the initial-T-element in that RT-specification-unit.

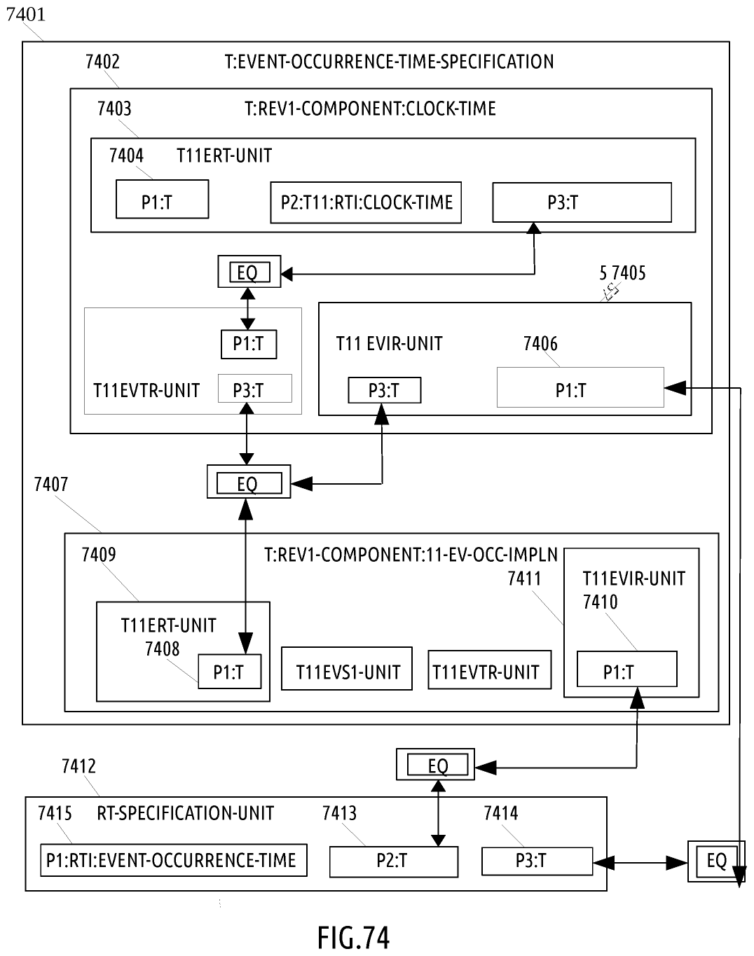

FIG. 74 shows an example of a non-primitive RT-specification that is an event-occurrence-time-specification 7401. That specification indicates occurrence-times of events where those occurrence-times are determined by clock-times that occur at the same times as those events. The T:REV1-clock-time-component 7402 of that specification indicates the relationship between the ‘clock’ type-entity and the ‘clock-time’ type-entity. In that T:REV1-clock-time component, the ‘clock’ type-entity is represented by the P1-component 7404 in the T11ERT-unit 7403, and the ‘clock-time’ type-entity is represented by the P1-component 7406 in the T11EVIR-unit 7405.

The T:REV1-11-event-occurrence-implication component 7407 specifies the relationship between the ‘clock-time-occurrence’ type-entity and the ‘event’ type-entity. In that T:REV1-11-event-occurrence-implication component, the ‘clock-time-occurrence’ type-entity is represented by the P1-component 7408 in the T11-ERT-unit 7409, and the ‘event’ type-entity is represented by the P1-component 7410 in the T11-EVIR-unit 7411.

The combination of the T:REV1-clock-time-component and the T:REV1-11-event-occurrence-implication component specifies that, when a particular clock-time is an instance of the type-entity represented by the P1-component 7406, and a particular event that is an instance of the type-entity represented by the P1-component 7410 also occurs, then that particular clock-time is an occurrence-time of that event.

The RT-specification-unit 7412 indicates the relationship between the ‘event’ type-entity represented by the P2-component 7413 and the ‘clock-time’ type-entity represented by the P3-component 7411. The combination of the T:REV1-clock-time-component and the T:REV1-11-event-occurrence-implication component constitutes the RT-specification for the RT-element comprising that P3-component 7414.

### 1.4.8 T-Networks

An I-model may include a T-network. A T-network (‘type-entity-network’) is an I-component consisting of a combination of T-elements, T-components for some or all of those T-elements, and I-components that indicate structural properties and structural relationships of some or all of those T-elements. Those structural properties and relationships may include any of the types described earlier, such as SUBT-relationships and co-relationship-indicator-units, as well as structural properties and relationships of other types that may be specified in that I-model by means of I-components.

A T-network may include all the T-elements in an I-model. A T-network may be employed by operative-components that perform subject-related operations in the I-system containing that I-model, such as searching that I-model.

An I-model may include a T/INST-network. A T/INST-network (‘type-instance network)’ is a combination of a T-network and one or more IEV-components each of whose primary-T-element is E-equivalent to one or more T-elements in that T-network.

T-networks and T/INST-networks may be further expanded to include I-components of additional types such as co-relationship-indicator-units, REV1-name-components whose initial-E-elements are E-equivalent to various E-elements in those networks, and record-indicator-units whose P2-components are E-equivalent to various E-elements in those networks. Such a T-network or T/INST-network may constitute an entire I-model.

The T-specifications for each of the top T-elements in a T-network may be restricted to having only one T-independent T-component. In that T-network, more-complex T-specifications may be indicated by a combination of relationships between those top T-elements and T-elements in those more-complex T-specifications. Such relationships include, for example, EQUIVT-relationships, CONTRAT-relationships, DISJT-relationships, and the various types of SUBT-relationships described in section 1.4.6.5.

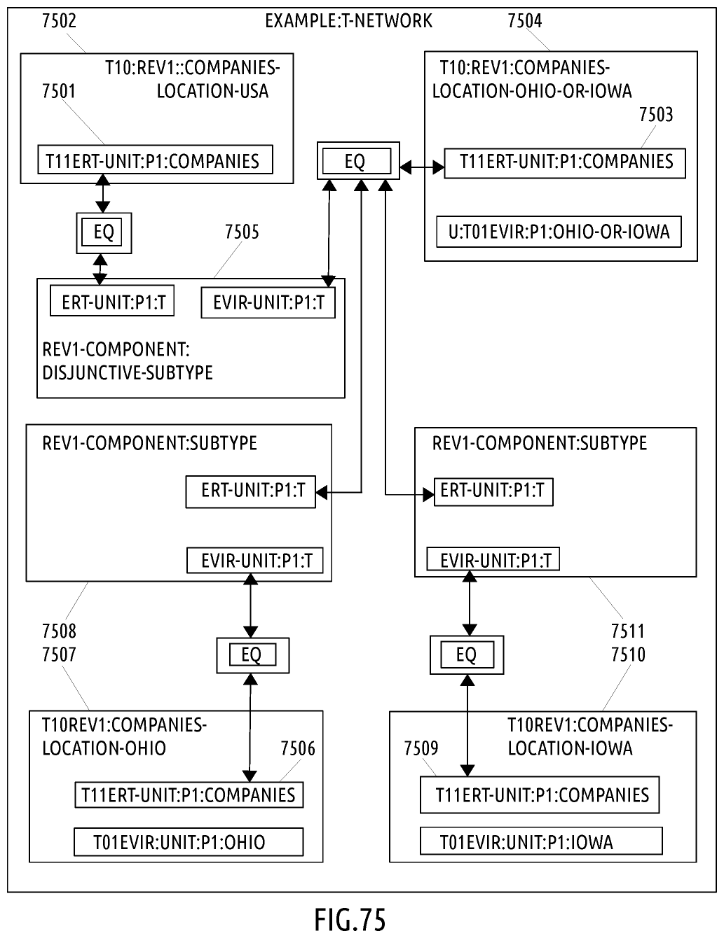

FIG. 75 shows an example of a very simple T-network. The top T-element 7501 represents the type-entity, ‘companies located in the USA’. That T-element is the P1-component of the T11ERT-unit in the T10: REV1:companies-located-in-USA-component 7502. The network represents three subtypes of the type-entity, ‘companies located in USA’. A disjunctive subtype shown for that type-entity is ‘companies located in Ohio or Iowa’, represented by the T-element that is the P1-component 7503 of the T11ERT-unit in the T11:REV1-component 7504. That disjunctive-subtype relationship is represented by the REV1:disjunctive-subtype-component 7505. One general subtype shown for that type-entity is ‘companies located in Ohio’, represented by the T-element that is the P1-component 7506 of the T11ERT-unit in the T11:REV1-component 7507. That subtype relationship is represented by the REV1:subtype-component 7508. A second general subtype shown for that type-entity is ‘companies located in Iowa’, represented by the T-element that is the P1-component 7509 of the T11ERT-unit in the T11:REV1-component 7510. That subtype relationship is represented by the REV1:subtype-component 7511.

### 2.0 I-MODELS

As previously described, an I-model is a computer-operative record whose primary component consists of a combination of one or more I-components. Each I-model includes at least one of the following: an ERT-unit, a TERT-unit, an EVS-unit, a TEVS-unit, an IEVB-component, a TIEVB-component, an IEV-component, or a TIEV-component.

### 2.1 Composition and Function of I-Models

An I-model is a representational, or semi-representational, model of a subject consisting of some entities and some relationships of those entities. The subject of an I-model may be of any type about which records in general are constructed. That includes, for example, events that occur under specified conditions, as described in section 1.3.1.1.1.4.2. The subject of an I-model may consist of a scenario of possible events that may occur in the future that is used as a basis for planning. The subject may consist of actual or possible past events. The subject may consist of events that occur in some hypothetical or fictional situation. An I-model may be a model of a static or dynamic system of any type, such as a machine, a factory, a process of any type, an organization, a city, a human being, or the universe. A dynamic system may be represented by a dynamic time-based I-model, such as is employed in a simulation system. The I-model may be of a type that has a particular role or function, such as, for example, a plan, a calendar of events, a schedule, an assignment, or a report. As described below, an I-model may be an index to information in other records. The I-system may include one or more computer-operative records of graphical images with index links between components of those images and I-elements or I-components in one or more I-models in that I-system. An I-model may be included in an I-system that is included in a larger computer-system where it indicates information about aspects of that system or the records contained in it. For example, as described in section 2.5, that I-model may be an improved schema for a relational-database system.

Each I-model has an existential modality or a normative modality. Normative and existential modalities for an I-model may be specified in secondary-records in that I-model. Such records may also indicate any circumstantial conditions under which those modalities apply. Those circumstantial conditions may include constraints and enabling factors.

The primary component of an I-model may be of any structural type that can be employed to specify the I-components in an I-model. For example, it may be a purely representational network. It may be a linear sequence of I-units. Part or all of it may be tabular, such as a relational-database structural form. An I-model may include configuration-identification-components that indicate or distinguish particular components of I-units and I-components in that I-model. Such configuration-identification-components are employed by operative-components in the I-system containing that I-model in performing operations on those I-units and I-components. The primary component of an I-model may include a combination of records that differ in structural details for specifying I-components that have different general forms.

An I-model may include secondary-records that are not components of the primary component of that I-model. A secondary-record in an I-model may also be a secondary-record in one or more other I-models in the I-system containing them.

For example, a secondary-record may be an audio or video record, or a specification of a name, or a description, of an entity that is represented in that I-model, and that secondary-record may be indicated in the primary component of that I-model by a record-indicator-unit. Names that are so employed may have standard structural forms that have components that are individually identifiable by operative-components in the I-system that operate on those names to accomplish operations such as searching that I-model in cases where the structure of those names determines aspects of the performance of those operations.

Those secondary-records of names having standard structural forms may indicate aspects of the entities whose names they are. For example, such names of base-entities may have components that indicate the languages in which those names are specified, or that indicate specific components of names that have multiple components, such as first and last names of persons. Names of type-entities may have components that indicate whether the instances of those type-entities are events, base-entities, or type-entities. Names of terminal-type-entities in type-relationships may have components that indicate the formal types of those entities, such as assignments, measurements, cardinal or ordinal measurements, and symmetry or asymmetry of the relationships of those types.

An I-model may include a secondary-record that is an index that specifies equivalence-correspondences between specified I-components or E-elements in that I-model and specified components in another record.

An I-model may not include I-components that indicate the same name for different type-entities, whether such indications are provided by REV1-name-components or I-components of other types. That avoids problems with various operations on I-models, such as searching. Some I-models may be further restricted in such a manner that they do not have I-components that indicate two or more different names for the same type-entity.

An I-model may include other secondary-records that indicate information about that I-model and various I-components in that I-model. For example, such a record may specify the source(s) of the information represented by an I-component in that I-model, the reliability of that information, the dates of construction of that I-component, and the persons or systems that determined the construction of that I-component. That I-model may include a secondary-record that specifies the modality of that I-model. That I-model may include a secondary-record that is translationally-equivalent to that I-model.

An I-model may be a distributed I-model, that has components that are contained in different, inter-connected I-systems. Such a combination of inter-connected I-systems is itself an I-system.

The information and I-components in an I-model in an I-system may be specified by, or received from, a variety of sources, including system-developers, system-users, other I-models in the I-system, automatic inputs from external systems, automatic calculations, and automatic LOGCON operations performed by the I-system.

### 2.1.1 Restrictions on Some Types of Combinations of I-Components in Some I-Models

Particular types of combinations of I-components in an I-model may be restricted in several ways. That I-model may be restricted to not having particular types of combinations of I-components. That I-model may also be restricted to having particular aspects of their subjects being represented by I-components of particular pre-determined types. Such restrictions result in greater simplicity and uniformity within and between I-models, and in greater simplicity in their processing during search-operations and other types of operations that are performed on those I-models by the I-system. Such restrictions are determined by the system-developers on the basis of standard practical considerations. Some examples of such restrictions follow.

### 2.1.1.1 REVB-Event-Occurrence-Conjunction-Components

A particular restriction may apply to an REVB-event-occurrence-conjunction-component whose initial-E-element is E-equivalent to the IEV-elements in the EVTR- and EVIR-units in another REVB-event-occurrence-conjunction-component or in an REVB-event-occurrence-implication-component. In such cases, that first REVB-component may be restricted to being an REVB-11-event-occurrence-conjunction-component, or an REVB-11-event-occurrence-conjunction-component, or being replaced by an REVB-01-event-occurrence-implication-component, or an REVB-00-event-occurrence-implication-component. Such a restriction simplifies I-models and subject-related operations on them.

### 2.1.1.2 REVB-Event-Occurrence-Implication-Components

A related example is that of an REVB-event-occurrence-implication-component or an REVB-event-occurrence-conjunction-component whose terminal-E-element is E-equivalent to the IEV-elements in the EVTR- and EVIR-units in another REVB-event-occurrence-conjunction-component or an REVB-event-occurrence-implication-component. In such cases, that first REVB-component may be restricted to being an REVB-11-event-occurrence-conjunction-component, or an REVB-01-event-occurrence-conjunction-component, an REVB-10-event-occurrence-implication-component, or an REVB-11-event-occurrence-implication-component. Such a restriction simplifies I-models and subject-related operations on them.

### 2.1.1.3 REV0-Event-Occurrence-Conjunction-Components

Another example is that of an REV0-event-occurrence-conjunction-component of the four types described in section 1.4.2.2. In place of that component may be an REV1-event-occurrence-implication-component that represents the same thing, as described in section 1.4.2.2. Similarly, in place of an REV0-event-occurrence-implication-component may be an REV1-event-occurrence-conjunction-component, also as described in that section.

### 2.1.1.4 TEVTR-Units and TEVIR-Units

In an I-model, TEVTR-units and TEVIR-units may be restricted as follows: (1) in each TEVTR-unit that is a T01SR-unit, the P1-component is not E-equivalent to the P1-component of any TEVIR-unit; (2) in each TEVTR-unit that is a T01SR-unit, the P1-component is not E-equivalent to the P3-component of any EVTR-unit or EVIR-unit in that I-model; and (3) in each TEVTR-unit, the P1-component is not E-equivalent to the P3-component of any TEVTR-unit or TEVIR-unit in that I-model.

### 2.1.1.5 Structural Forms of I-Components

The structural forms of I-components of various types in an I-model may be restricted in such a manner that that I-model does not include redundant I-components of particular types that would unnecessarily complicate the storage and subject-related processing of those I-models. One simple form of such redundancy is the case of two separate I-components that are I-equivalent. Another type of redundancy is T-redundancy of T-components, as described in section 1.4.5.2.8. Such redundancy adds nothing to what the other I-components represent. However, in some cases there may be practical functions that benefit from particular redundancies. That is determined by the system-developers on the basis of practical considerations.

### 2.1.1.6 REV1-Components

REV1-components of one or more particular types may be replaced by I-units of additional types not described earlier but that are specified as being equivalent to the types of components that they replace. Such REV1-components, may include, for example, REV1-subtype-components and REV1-type-contratype-components. Relationships of those types are the same under all conditions, and this type of replacement simplifies that I-model. On the other hand it may complicate the processing of such I-models, particularly those including TREV-components whose primary-RT-indicators are the same as any of those in the replaced REV1-components.

### 2.2 Incremental Development of I-Models Over Time

An I-model may be incrementally modified over time in various ways that expand that I-model to indicate more information. Also, additional T-components may be added to T-elements and T-components that are not components of T-specifications; that more fully accounts for the type-structures indicated by those T-components. In particular, a simple-primitive RT-specification of a general-relationship-type may have T-components added that convert that specification to a partial-primitive RT-specification, and subsequently or directly to a non-primitive RT-specification. Such changes allow more comprehensive searching and improved operations for identifying LOGCON-relationships.

Incremental developments may also include the addition of new types of RT-indicators and RT-specifications; that expands the representational capability of that I-model.

Such changes in an I-model do not necessitate any other concomitant adjustments in other I-components in that I-model, which is a major advantage of I-models.

### 2.3 Representation of Circumstantial-Conditions in I-Models

An I-model may include specifications of one or more primary-circumstantial-conditions, such as, for example, the time and location of all the other events represented in that I-model. As described in section 1.3.1.1.1.4.3, a primary-circumstantial-condition may be represented in that I-model by means of an EVS-unit whose P2-component is a primary-circumstantial-condition-indicator, and whose P1-component is I-equivalent to the T-element or EV-element that represents that primary-circumstantial-condition. For example, an I-model may include a representation of a particular time, or time-period, as a primary-circumstantial-time-period. Such a representation indicates that the occurrences and non-occurrences of all other events represented by EVS-units in that I-model continue throughout that time-period. For example, that particular time may be the current time. The primary-circumstantial-conditions for an I-model may also be specified in a secondary-record for that I-model. A primary-circumstantial-condition other that a primary-circumstantial-time-period may itself be restricted to occurring during a primary-circumstantial-time-period.

Some I-models may not include time as a primary-circumstantial-condition. For example, an I-model that represents only a combination of invariant-events may not include a circumstantial-condition of any type, since that would be irrelevant.

In an I-model, the occurrence (or non-occurrence) of some events may also be represented as being relative to the occurrence (or non-occurrence) of other particular events that are not primary-circumstantial-conditions. For example, ‘the earthquake occurred in 1957’. If that time of ‘1957’ is not a primary-circumstantial-condition in that I-model, then that relative occurrence-time relationship-event between that earthquake and ‘1957’ is occurrent at all times, even though those separate events by themselves do not occur at all times. For example, such relative occurrence-time relationship-events may be represented generally by REV1-event-occurrence-implication-components, or, more specifically, by REV1-event-occurrence-time-components or other REV1-components that indicate other types of occurrence-times for events, such as non-occurrence-times, inclusive-occurrence-times, inclusive-non-occurrence-times, beginning-occurrence-times, ending-occurrence-times, beginning-non-occurrence-times, or ending-non-occurrence-times.

Thus, the occurrence of events under different circumstances that are not compatible with the primary-circumstantial-conditions represented in an I-model may be represented in a relative form in that I-model by means of REV1-event-occurrence-implication-components, or other REV1-components that indicate those occurrence-relationships between those events and the circumstantial-conditions relative to which they occur.

In addition, some EVS-components in an I-model that indicate events that occur (or are non-occurrent) under the primary-circumstantial-conditions may also be replaced by REV1-event-occurrence-components. For example, an I-model that includes EVS-units that indicate the occurrence (or non-occurrence) of various events at ‘current-time’ as a primary-circumstantial-condition may be replaced by an I-model that is constructed by replacing those EVS-units in that first I-model with event-time-components that indicate the occurrence-relationships between those events and that current time. If all EVS-components other than those that indicate invariant occurrence-states are replaced in that manner, then the specifications of some events as being primary-circumstantial-conditions may be eliminated from that I-model, since they are redundant.

### 2.4 Dynamic-I-Models

An I-model of a subject may be periodically adjusted to account for changes in that subject that occur at different times. That results in a sequence of I-models that represent states of that subject at those different times. For example, the states of various aspects of an organization may change from day to day, and those daily changes may be represented by a time-based sequence of I-models of that organization. Such a time-based sequence of I-models is a dynamic-I-model.

### 2.4.1 Primary-Circumstantial-Time-Periods

In each I-model in a sequence of I-models that constitutes a dynamic-I-model, a particular time-period is indicated as a primary-circumstantial-time-period. That indication may be specified by the P2-component of an EVS-unit whose P1-component represents that particular time-period. That P2-component is a primary-circumstantial-condition-indicator. A different primary-circumstantial-time-period is specified in each I-model in that sequence, and the sequential order of those I-models corresponds to the natural sequence of those primary-circumstantial-time-periods.

### 2.4.2 Continuously-Updated Real-Time Dynamic-I-Models

In a continuously-updated real-time dynamic-I-model, the subject is one that exists at the same times as the I-models in the sequence. Instead of new I-models being added to that sequence at regular time-intervals, a new I-model may be added at any time as information about one or more changes in that subject is provided to the I-system containing that dynamic-I-model. In that case, the primary-circumstantial-time-period for the most recent I-model in that sequence is the time when that new I-model is constructed.

### 2.4.3 Historic-Dynamic-I-Models and Predictive-Dynamic-I-Models

Alternatively, an historic-dynamic-I-model represents sequential states of a subject that existed at historical times prior to the existence of that dynamic-I-model. A predictive-dynamic-I-model represents predicted sequential states of a subject that may exist at some future times subsequent to the existence of that dynamic-I-model. An historic-dynamic-I-model and a predictive-dynamic-I-model may be combined to form a single dynamic-I-model for a subject over a time-period that extends from the past into the future.

### 2.4.4 Difference Between Dynamic I-Models and Incrementally-Developed I-Models

Note that a dynamic I-model is not per se the same type of thing as an I-model that is developed incrementally over time in various ways as described in section 2.2, such as by the addition of more I-components. However, a dynamic I-model may also be developed incrementally in that manner. Also, a dynamic I-model may include specifications of primary-circumstantial-conditions of other types in addition to the time-period that is a primary-circumstantial-time-period. For example, location may be such an additional primary-circumstantial-condition. The specifications of such other primary-circumstantial-conditions may remain the same in all the I-models constituting that dynamic-I-model.

### 2.4.5 Changes in Occurrence-States in Dynamic I-Models

Corresponding to the changes in the specifications of the primary-circumstantial-conditions in the sequence of I-models in a dynamic-I-model, there may be changes in the occurrence-states of one or more other events represented in those I-models. Those changes in those other occurrence-states may be indicated in those I-models by corresponding changes in the event-occurrence-state-indicators that are the P3-components of EVS-units whose P1-components represent those other events. Each such change consists of the replacement of the P3-component in an EVS-unit by an event-occurrence-state-indicator that indicates the occurrence-state of the opposite type; that is, event-occurrence-indicators are replaced by event-non-occurrence-indicators, and event-non-occurrence-indicators are replaced by event-occurrence-indicators.

### 2.4.5.1 Specification of Circumstances for Changes in Occurrence-States

The particular factors that determine the specific circumstances under which the indications of such occurrence-states are changed may be specified in the P3-components of EVS-units in that dynamic-I-model. Alternatively, they may be accounted for in the design and operation of the operative-components that construct those dynamic-I-models. Some examples of such factors are described in the following paragraphs.

As described in section 1.3.1.1.1.4.2, the occurrence-states of events of some types are invariant, and consequently are the same for different primary-circumstantial-conditions. That invariance may be indicated by the P2-components of the EVS-units that represent such events in the I-models constituting a dynamic-I-model. Such P2-components are invariant-occurrence-indicators. Thus, the P2-components in those EVS-units are all I-equivalent, since they all represent the same occurrence-state for that event.

A change in the occurrence-state of an event represented in the sequence of I-models constituting a dynamic-I-model may be specified by an external source. That changed occurrence-state may be indicated by the P2-component of an EVS-unit whose P1-component represents that event in the next I-model in that sequence. That P2-component is an external-source-occurrence-indicator.

A change in the occurrence-state of an event represented in an I-model in the sequence of I-models constituting a dynamic-I-model may be specified by a LOGCON operative-component. That changed occurrence-state may be indicated by the P2-component of an EVS-unit whose P1-component represents that event in the next I-model in that sequence. That P2-component is a logical-consequence-indicator.

A change in the occurrence-state of an event represented in an I-model in the sequence of I-models constituting a dynamic-I-model may result from a sequence of changes in the occurrence-states of various other events represented in that I-model. Those other changes may result from a sequence of changes resulting from a combination of LOGCON-identification-operations and specifications provided by external sources.

Some specifications of changes in occurrence-states of some events may invalidate the results of previous LOGCON-identification-operations that determined the previous occurrence-states of those events. That invalidation may be indicated by changes in the occurrence-state-indicators in EVS-units whose P1-components represent those events.

If an indication in the preceding I-model of the occurrence-state of an event is indicated to be no longer applicable by an external source or by invalidation of a previous LOGCON-identification-operation, and no new occurrence-state is indicated by an external source or a new LOGCON-identification-operation, then the previous EVS-unit that indicated that previous occurrence-state may be eliminated from the next I-model and not replaced by any other indication of the occurrence-state of that event in the next time-period.

The changes described above may be made to a copy of the preceding I-model in the sequence. In that case, the preceding I-models in the sequence may be retained in the I-system for future use. Alternatively, in each of those preceding I-models, only those changed EVS-units may be retained in the next I-model in the sequence. That reduces the quantity of storage space required.

Another alternative is that, instead of changing the occurrence-state-indicator in an EVS-unit to an occurrence-state-indicator of the opposite type, that EVS-unit may be replaced in the next I-model by an I-component that indicates that the event represented by the P1-component of that previous EVS-unit has the occurrence-state indicated by that EVS-unit in the time-period indicated by the primary-circumstantial-time-period represented in the preceding I-model. That I-component indicates a relative-occurrence relationship between those two events, and may be represented in that next I-model. Such an I-component may be an REV1-event-occurrence-implication-component. In that manner, information about previous occurrence-states of events may be retained in that next I-model.

Alternatively, the I-components that indicate those relative-occurrence relationships may be added to a single comprehensive I-model that is separate from the I-models in that sequence. In that case, the preceding I-models in the sequence may be eliminated, since all the information they provide is consolidated in the I-components in that comprehensive I-model. In that case, that next I-model in the sequence may contain only those EVS-units that indicate the occurrence-states of events during the primary-circumstantial-time-period for that next I-model. Then the combination of that next I-model and that comprehensive I-model constitutes an I-model that is employed by operative-components for operations such as searching for information.

### 2.4.5.2 Automatic Changes in I-Components in Purely-Representational Systems

In a purely representational I-model, as explained earlier, the addition of, or changes to, I-components that indicate logical-consequences may be automatic. In that case, no additional adjustments due to changes of the above-described types are needed in dynamic-I-models of that type.

### 2.5 I-Indexes

An I-model may include an I-index. The basic component of an I-index is a T-network or a T/INST-network, as described in section 1.4.8. In particular, that I-index may include REV1-name-components whose initial-E-elements are E-equivalent to T-elements included in that network. That I-index functions as an index to various E-elements and I-components contained in that I-model.

The I-system that includes an I-index to that I-model may also include a secondary-record whose primary component is an alpha-numeric index of the names of entities represented by E-elements in that I-model, including the names of type-entities in a T-network in that I-model. That alpha-numeric index may include secondary-records that indicate those E-elements in that I-model that represent those named entities. Alternatively, the I-model may include I-components that represent the structures of those names, by representing the sequential relationships of the individual letters, numerals, and other symbols that constitute those names. In that case, that alpha-numeric index may index those components of those names.

An I-model may be an I-index to other I-models contained in the same I-system or in other I-systems. That I-index thus constitutes a subject-index to those other I-models.

An I-index may be a subject-index to other records and collections of records that are not I-models, but may be computer-operative records or external human-readable records. For example, such a computer-operative record may be a database of any type. Those records may be located anywhere and may or may not be located in the same computer-system as that I-index. The I-model containing that I-index may be an I-model of those other records and collections of records.

Alternatively, the I-system may contain a separate I-model of those other records and collections of records, and that I-index may indicate the E-elements in that other I-model that represent those other records and collections of records.

An I-index may function as the schema for a database, such as a relational database. In that case, the headings of the columns of each table in that database are some or all of the T-elements in a T-specification. The entries in each row of such a table are the terminal-E-elements in a combination of co-related T/INST-element-relationships in which the initial-E-elements are the T-elements in the table-heading.

### 2.6 Relationships Between I-Models

An I-model may be related to another I-model in one or more of several different ways. That includes the ways described in sections 2.1, 2.2, 2.4, and 2.5 above, such as time-sequencing of I-models and dynamic I-models. Examples of some other basic types of such relationships follow.

### 2.6.1 Same Types of Structural Forms

The I-components in a combination of I-models may have the same types of restrictions on their structural forms in each of those I-models. Examples of various types of such restrictions are described in section 2.1. That enables more-efficient integrated processing of that combination of I-models.

### 2.6.2 Relationships Between the Subjects of I-Models

There may be relationships between the subjects of two I-models, such as the inclusion of the subject of one I-model within the subject of another, or the subjects of both being included in a more general subject. There may be relationships between the RT-specification-type-units of two different I-models, such as each RT-specification-unit in one being I-equivalent to an RT-specification-unit in the other. This is one aspect of compatibility of those I-models.

2.6.3 I-Models that are Subjects of Other I-Models

The subject of an I-model may be one or more other I-models. That first I-model indicates information of various types about those other I-models. For example, that may include information about the subjects and purposes of those other I-models; the sources of the information represented in those I-models; the reliability of that information; the dates of construction of those I-models; the persons or systems that specified or constructed those I-models; and the sizes and locations of those I-models.

### 2.6.4 Equivalent I-Models

As with records in general, two I-models may be equivalent. Equivalent I-models have the same subject and specify the same things about that subject, although their specific structural configurations may be different.

### 2.6.5 I-Equivalence of I-Models

Two I-models may be I-equivalent. Two I-models are I-equivalent if every I-component in each I-model is I-equivalent to an I-component in the other I-model. I-models that are I-equivalent are equivalent, but equivalent I-models may or may not be I-equivalent.

### 2.6.6 Name-I-Equivalence

Two I-models may be name-I-equivalent. Two I-models are name-I-equivalent if they are I-equivalent except that some or all of the names of entities represented in those two I-models may differ. That includes the names of type-entities and the names and RT-indicators for general-relationship-types. Those different names may derive from different natural languages. In that case, the primary components of those I-models have the same general form and differ only in the names of various entities. That means that translation of I-models between different natural-language forms is very simple, consisting of simply replacing some or all of such names in one I-model by the corresponding names in the other I-model. That very simple translation process is a major advantage of I-models. Such name-correspondences may be specified in secondary-records in the I-systems containing those I-models.

### 2.6.7 Inconsistent I-Models

Two I-models may be inconsistent. Two I-models are inconsistent if the combination of those two I-models is not an I-model, because they indicate inconsistent information about the same or different events or type-entities. For example, a company making plans for future activities may consider two or more different scenarios for possible future economic conditions that will affect the company; in that case, the I-model of the current state of the company and other current and past events will be included in each of the I-models of those different future scenarios, which are inconsistent even though those I-models have some parts that are I-equivalent or E-equivalent. In that example, the inconsistencies between those two I-models are intentional, and there is no intention to combine those two I-models to form a single I-model. Consequently, those inconsistencies are not a problem for users of those I-models.

### 2.6.7.1 Problematic Inconsistencies

However, due to problems with the information provided to the I-system, other types of inconsistencies may occur within, or between, I-models that are intended to represent the same subject, or different parts of the same subject. An example of such an inconsistency is that of indications by different EVS-units that a particular event is both occurrent and non-occurrent under the same conditions. Another type of inconsistency may occur when two REV1-components have RT-indicators that are I-equivalent, and terminal-E-elements that are I-equivalent, while the initial-E-elements are not specified as being I-equivalent and the instances of RT-entities are specified to be unique. An example of that might be the case of each large company having a CEO who is not the CEO of any other large company.

Other examples include inconsistent T-specifications for the same type-entity, and the related case of those I-models including RT-specification-units whose P1-components are I-equivalent but their P2- or P3-components are not E-equivalent. Those latter two situations involve indications of inconsistent specifications for the same type-entity or relationship-type.

### 2.7 Additional Types of I-Units in Some I-Models

As described in section 1.3.1.4.5, an I-model may include some I-units of additional types not specifically described in this specification. The forms and specifications of such I-units are determined by systems-developers on the basis of practical considerations. The following are some examples of such types of I-units. Some other examples are provided in the section on I-systems.

### 2.7.1 Invariant Relationships

An invariant relationship between T-elements may be specified by a simgle I-unit rather than a REV1-component. Invariant relationships include, for example, EQUIVT-relationships, standard-CONTRAT-specifications, DISJT-relationships, and the various types of SUBT-relationships described in section 1.4.6.5.

### 2.7.2 Non-Invariant Relationships

Even I-components that represent relationships that are non-invariant in general but are relatively complex and frequently-specified may be replaced I-units that indicate the same information if those relationships do not vary within the circumstantial-conditions for the I-model containing them. Such an I-unit includes one or two E-elements that are E-equivalent to E-elements in a replaced I-component. It also has a component that is an I-indicator that indicates the structural-type of that relationship between those E-elements that is indicated by that I-unit. For example, an IEVB-component may be replaced by an I-unit having four components: a P1-component that is E-equivalent to the P1-component of the EVTR-unit in that IEVB-component: a P2-component that is E-equivalent to the P3-components in the EVTR-unit and the EVIR-unit in that IEVB-component; a P3-component that is E-equivalent to the P1-component in that EVIR-unit; and a fourth component that indicates the type of that I-unit.

If all the I-units in that replaced I-component are primary I-units, then a T-unit may be specified that has a T/INST-unit-relationship to that replacement I-unit. That T-unit has a component that has a P1-component that is I-equivalent to the above-described I-indicator, and a P2-component that is a T-level-indicator. If the replacement I-unit for that replaced I-component has only one component that is an E-element, then that T-unit has a component that is a T-element and a component that is a TEVS-indicator. If that replacement I-unit has two components that are E-elements, then that T-unit has two components that are T-elements and a component that is a TSR-level-indicator. That T-unit represents a component of the type-structure for the type-entities represented by the T-elements in that T-unit.

### 2.7.3 Higher-Order T-Units

Second-order, and higher-order, T-units may be employed to specify higher-order type-entities whose instances are type-entities with specified type-structures. For example, a ‘three-level type-entity’ is a type-entity whose instances are indicated to be type-entities whose instances are type-entities. In that alternative structure for T-units, the primary configuration of the P2-component of the P2-component of a T-unit consists of a multi-T-level-indicator that consists of a sequence of one or more T-level-indicators, each of which represents an additional level of type-entities.

However, such T-units result in significant complications for the storage and processing of T-components, and any significant practical benefit of such may usually be achieved in much simpler ways using the types of T-units and I-components previously described. One exception in some I-models is the use of T-2-level-indicators, that restrict T-units to a maximum of two T-levels. Such T-2-level-indicators may be employed in specifying non-primitive RT-specifications for types of RT-entities that would otherwise be restricted to simple-primitive RT-specifications that do not indicate the actual specifications of those RT-entities.

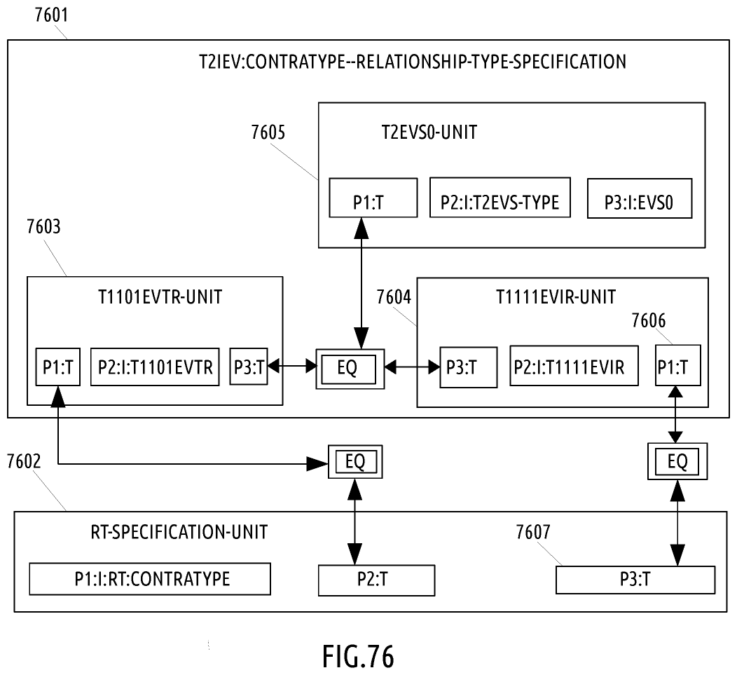

FIGS. 76, 77 and 78 show an example of a non-primitive RT-specification for the standard-contratype-relationship. In the example, the T-2-level-indicators have the form TI1I2I3I4 in which I1I2 is a TSR-indicator for the second-level and I3I4 is a TSR-indicator for the first. In the T2EVS-units, the P2-components indicate that those units are second-level T-components.

FIG. 76 shows the relationship between a non-primitive RT-specification 7601 for the contratype-relationship and the corresponding RT-specification-unit 7602. In the T-2-level-indicator ‘T1101’ in the T1101-EVTR-unit 7603, the ‘11’ is the TSR-indicator for the second-level, and the ‘01’ is the TSR-indicator for the first-level. In the T-2-level-indicator ‘T1111’ in the T111-EVIR-unit 7604, the ‘11’ is the TSR-indicator for the second-level, and the ‘11’ is the TSR-indicator for the first-level. In the T2EVS0-unit 7605, the ‘2’ indicates that that unit is second-level. The P1-component 7606 in that T1111-EVIR-unit is equivalent to the RT-element 7607 in that RT-specification-unit.

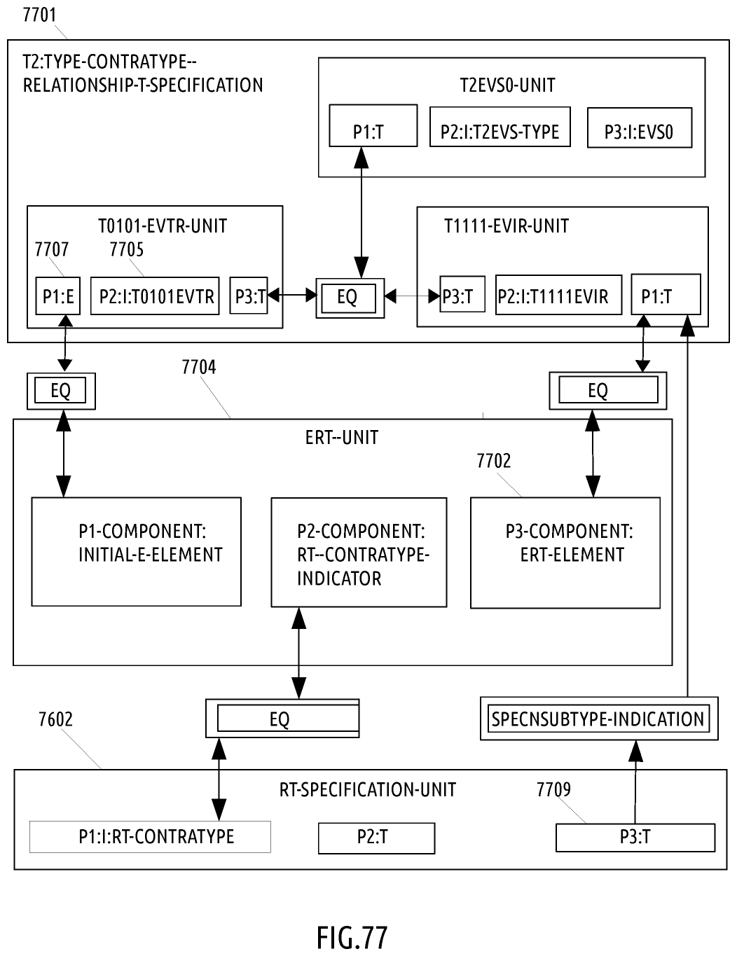

FIG. 77 shows the relationship between the RT-specification-unit 7602 shown in FIG. 76 and a T-specification 7701 for a contratype-relationship ERT-element 7702 derived from the RT-element in that RT-specification-unit. That ERT-element 7702 is the P3-component in the corresponding ERT-unit 7704. The level-indicator, ‘0101’, in the P2-component 7705 in the T0101-EVTR-unit 7706 indicates that the P1-component 7707 in that T0101-EVTR-unit is a fixed-E-element in that T-specification. The SPECN-SUBT indicator 7708 indicates that the type-entity represented by the ERT-element 7702 is a specialization-subtype of the type-entity represented by the P3-component 7607 in that RT-specification-unit.

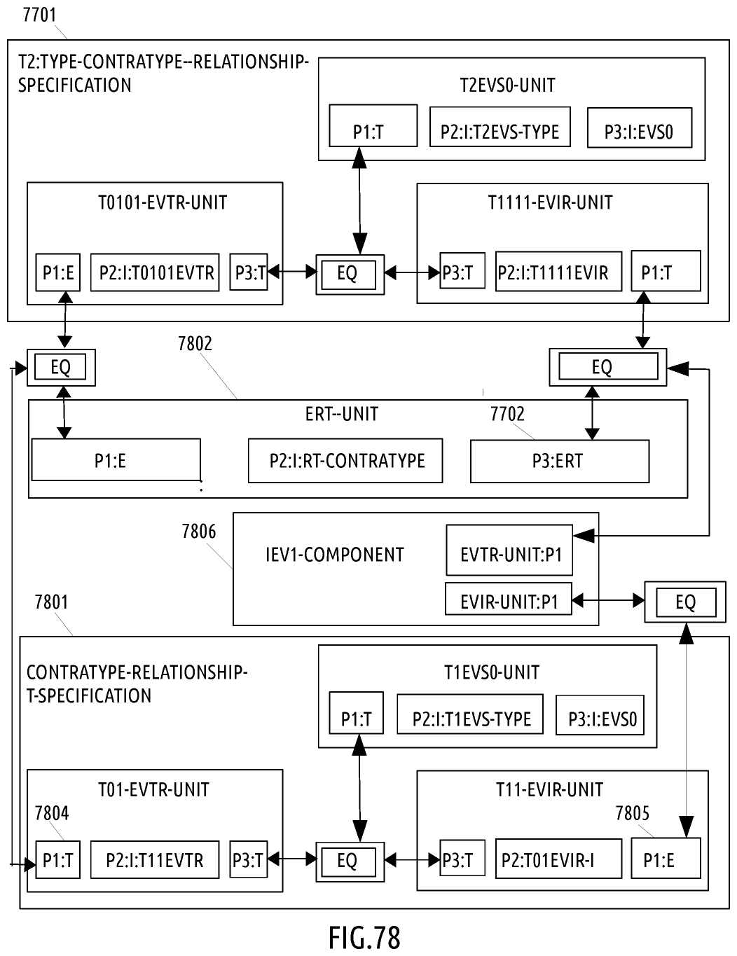

FIG. 78 shows the relationship between the T-specification 7701 for the ERT-element 7702 shown in FIG. 77 and a T-specification 7801 that represents an instance of that ERT-specification. That second T-specification 7801 indicates the relationship, as described earlier, between a T-element 7804 and a T-element 7805 that represents a standard-contratype of that T-element 7804. That instance-relationship between the type-entity represented by that ERT-element 7702 and that corresponding standard-contratype type-entity is indicated by the IEV1-component 7806.

### 2.7.4 Names as E-Elements

If an E-element in an I-model represents an entity for which only a single permanent name is to be specified in that I-model, then that name, or a translated-equivalent, may be employed in that I-model as the primary component of that E-element, instead of, or in addition to, indicating that name via a REV1-component or a record-indicator-unit.

### 2.8 Constructing I-Models

I-models are constructed by operative-components in I-systems. Those operative-components function in the manner determined by the developers of those I-systems. The primary-configuration of a specific I-model is constructed by those operative-components operating on some combination of inputs to the I-system provided by external sources such as humans or other systems or devices, or by other operative-components in the I-system that perform operations such as LOGCON-construction and mathematical calculations on previously-specified components of that I-model. Dynamic I-models are constructed or modified progressively over time with intermittent periods of use of those I-models during that same time.

The general forms of an I-model and the operative-components that construct it are dependent on the type of computer system or device in which that I-model is constructed and stored. That may be a standard digital computer, or a computer system or device of any other type used for storing information in computer-operative records and operating upon those records. That particularly includes systems that store records in a representational form that corresponds to the structure of the things represented by those records or of the information-content of those records. In such systems there may be no need for indicating E-equivalences between E-elements in an I-model, since each entity represented in that I-model will be represented by only one E-element. In some types of such systems the occurrence-states of events are represented by the states of components that represent events and that are capable of being in different states at different times, such as electrical states.

An example of such a representational system is a computer that stores information in the configuration of a physical network of components that corresponds to the general form of human neural networks and in which new connections between those components may be added incrementally as additional information is supplied to that system. For example, in an I-model, the nodes in such networks may be E-elements and some of the connections between those nodes may represent the relationships indicated by RT-indicators. Another example is an FPGA-based system in which the FPGAs (‘field-programmable gate arrays’) are arranged in a network and perform automatic logic operations on their internal components that are E-elements in I-models. Another example, is the use of memristors to represent probabilities of events in I-models.

It should be understood that the details of the specific structure of an I-model in a specific I-system, and of the operative-components that construct it, can be determined and specified by any person with standard skill in using the general methods and practices as are employed in the specification of computer-operative records of other types in that type of system or device.

### 2.9 Using I-Models

An I-model that is not a component of an I-system is a computer-operative record that is being used as a means for storing or transmitting information. That I-model originated in an I-system and is incorporated in an I-system when operative use is subsequently made of that I-model. An input-record is received by the I-system containing that I-model; that input-record indicates what operations are to be performed by the I-system relative to that I-model. As a result of those ensuing operations by the I-system on that I-model, the I-system may also provide an output-record of particular results of those operations. The method of using an I-model in an I-system is determined by the form and capabilities of the I-system containing it, as described in the subsequent section on I-systems.

### 2.10 Advantages of I-Models

I-models have many advantages. They have simple structural forms. They are constructed using a very small number of basic types of representational units. They can function collectively as precise specifications of any aspects of any subject, at any level of specificity and irrespective of their complexity. They are flexible in being able to represent different levels of specificity for different aspects of a subject in the same I-model. They are searchable in response to search-requests of a simple uniform structural type. They may be subject to an unlimited range of subject-related operations performed by operative components in the I-systems containing them. They are fully integrated with each other with respect to the various types of subject-related operations that may be performed on combinations of those records. They are practical with respect their implementation and functioning within computer systems. Some specific advantages are discussed in the following sub-sections.

### 2.10.1 Comprehensive Universal Type of Computer-Operative Record

An I-model may be constructed as a model of any aspects of any subject, of any degree of complexity, rather than being restricted to specifying only certain pre-determined simple types and structural forms of some aspects of some subjects. For example, T-components may be specified in the same I-model as other types of I-components. Thus, I-models constitute the basis for a single comprehensive universal type of computer-operative record for representing any aspects of any and all subjects. Thus, although a particular I-model may represent only some aspects of a particular subject, a combination of multiple I-models may also constitute an I-model that represents a much larger combination of aspects and subjects. Since all aspects of all subjects are inter-related directly or indirectly in various ways, that representational capability of I-models means that there are no artificial separations between I-models that represent different aspects of the same subject in the same I-system, where those separations would otherwise be necessitated by the use of records of different configurational types for representing subjects, or aspects of subjects, of different types.

For example, the occurrence and non-occurrence of events may be represented in the same I-model absolutely (if they are co-related), or relative to the occurrence of various conditions and events, or some combination of both forms. Alternatively, all non-invariant occurrences and non-occurrences of events may be represented relatively, which allows such I-models to be indefinitely expanded by the progressive addition of specifications of events of any form and the circumstances of their occurrence (or non-occurrence). Moreover, the conversion of I-models between absolute and relative forms is a simple process that may not require any major redesign and reconstruction of those I-models.

### 2.10.2 EV-Elements

An event is represented by an EV-element, rather than by a complex structure of components. That enables the simple representation of attributes and conditions for events, including relationships between events. Also, rather than being vaguely and imprecisely indicated, the specific natures of events are clearly specified via EV-elements and the I-units and I-components associated with those EV-elements.

### 2.10.3 EVS-Units

By representing the occurrence-state of events, EVS-units enable I-models to indicate that a particular type-entity does, or does not, have any instances, without specifying the identities of those instances. In particular, the combination of an ERT-unit and an EVS-unit enables an I-model to indicate that there are, or are not, any entities that are related in a specified way to a particular entity, again without specifying the identities of those entities. Also, IEV-components in an I-model provide the means for indicating the circumstances under which a particular type-entity does, or does not, have a particular entity as an instance.

2.10.4 Separation of the Representation of the Nature of an Event from the Representation of its Occurrence

In I-models, the separation of the representation of the nature of an event from the representation of its occurrence and non-occurrence under various conditions enables the representation of any number and combination of those occurrences and non-occurrences with only a single representation of the nature of that event in that I-model, thus achieving even more simplicity and reduction in the size of I-models, particularly in representing events that have complex structures.

### 2.10.5 Representation of Type-Entities and Type-Structures

The employment of T-elements and T-components to represent type-entities and type-structures within I-models, rather than accounting for such aspects of a subject in a different type of computer-based record, simplifies the I-system and the subject-related operations that may be performed in them.

### 2.10.6 RT-Specification-Units and RT-Indicators

I-models are simplified by the use of RT-specification-units and RT-indicators. That enables the T-specification of a relationship-type to be specified only once in an I-model, in conjunction with the applicable RT-specification-unit. The use of the corresponding RT-indicators in different ERT-units to indicate different types of relationships then avoids the need in that I-model for a separate T-specification for each of those ERT-elements, since those T-specifications can be constructed by the system if and when needed, rather than being permanent components of the I-model. A similar kind of repetition is also avoided by the use of RT-indicators in T-components. Thus, I-models may achieve significant economies of size compared to many prior-art records.

### 2.10.7 Varying Levels of Generality of Aspects of Subjects

An I-model may represent various aspects of its subject at different levels of generality, and can subsequently have more specificity added over time, without the need to modify prior components of that I-model. On the other hand, the RT-element in an RT-specification-unit for a particular RT-indicator may be replaced with a T-element that has a more-detailed, more-specific T-specification for that same type of relationship. That simple change in the specification of the RT-element in that RT-specification-unit is a very minor modification that permits greater specificity and precision in what is represented by that I-model.

### 2.10.8 Different Levels of Specificity of Representations of Instantiation of Type-Entities

Another advantage of I-models is that they may indicate instantiation of type-entities at different levels of specificity. For example, in an I-model, an EVS1-unit whose P1-component is a T-element indicates that the type-entity represented by that T-element has at least one instance that may or may not be represented in that I-model. An EVS0-unit whose P1-component is a T-element indicates that the type-entity represented by that T-element has no instances.

The next level of instance-specificity is indicated by IEV-components. An IEV1-component indicates that the entity-represented by the INST-element in that EV1-component is an instance of the type-entity represented by the primary-T-element in that IEV1-component. An IEV0-component indicates that the entity represented by the primary-T-element in that IEV0-component is not an instance of the type-entity represented by the INST-element in that IEV0-component.

The most detailed level of specificity is indicated by combinations of co-related T/INST-element-relationships and co-relationship-type-instance-relationship-type-indicators.

### 2.10.9 IEV1-Components

Another advantage of I-models is the ability, via IEV1-components, to indicate that a particular entity is an instance of a particular type-entity, and hence has the properties indicated in the type-structure for that type-entity, without having to represent those properties for that entity.

Thus, great economies of scale are achieved by simply indicating that particular entities are instances of a particular type-entity for which a T-specification is specified and may be employed, as needed, to determine the corresponding properties of those instance-entities via LOGCON-identification-operations, rather than all those properties of those instance-entities being represented in those I-models at all times.

That is one of the benefits of I-models having a form of representation that is amenable to LOGCON-identification-operations of various types: instead of permanently occupying storage space in an I-system, various I-components may be inferred via LOGCON-identification-operations when needed for the accomplishment of other subject-related operations on that I-model.

### 2.10.10 REV-Components

The use of REV-components to specify relationships between entities enables the specification of aspects of those relationships that is either impossible or complicated to specify in a simple form in prior-art types of representational systems, such as, for example, the standard ‘data triples’ employed in semantic networks. Such aspects include specifications of conditions under which a specified relationship exists or does not exist. Another such aspect is the specification of whether or not a specified entity does or does not have a relationship of a specified type.

### 2.10.11 T-Components

T-components constitute a simple precise means for representing type-structures, and can be specified in the same I-models as the other types of I-components, rather than requiring a different type of configurational form for the records containing them. Also, the very simple, close structural correspondence between T-units and base-primary I-units enables very simple and efficient subject-related operations on I-models for identifying instances of type-entities. In particular, a T-network in an I-model may function as the basic component of a T-index that is a subject-index to the I-components in that I-model. Furthermore, an I-model may be constructed in such a way that it functions as a subject-index to other records of any combination of types.

Moreover, various aspects of the subject of an I-model may be represented in that I-model with any desired degrees of precision, including minimization of any ambiguity that may otherwise occur due to the use of a name instead of a T-specification to specify a type-entity or a relationship-type. Also, I-models avoid the confusion that otherwise results from failing to differentiate between record-types and records that are instances of those types. In particular, I-models distinguish names as record-types from records (of names) that are instances of those of types.

### 2.10.12 No Ambiguities in the Subject-Related Significance of Structural Forms

There are no ambiguities within I-models arising from the representational significance of the configurational forms of I-units and I-components. There may be ambiguity in an I-model due to the specification of natural-language names for type-entities and primitive relationship-types, as manifested in natural-language dictionary definitions of common nouns. However, those ambiguities can be reduced or eliminated. For example, that can be achieved by the use of modified names for two or more type-entities that were initially identified by means of the same name. In that case a separate T-specification may be specified for each of those type-entities, with a different name being specified for each of those type-entities. Another approach is to include the representations of the different type-structures for the same-named type-entities as disjunctive-components of a single T-specification, as is often done in natural-language dictionaries by specifying alternative meanings of such names.

There may be ambiguities in an I-model concerning the correspondence between some E-elements in that I-model and the entities that they represent in the subject of that I-model. Such ambiguities are not related to the internal configurational forms of I-models, but to the general issue, for records of all types, that there is not enough specificity in those records for their users to be able to identify those correspondences with complete precision. Such ambiguities may be resolved in I-models by adding additional I-components that specify information that enables unambiguous identification of those correspondences.

### 2.10.13 Structurally-Simple Primary Components

The primary components of I-components that represent aspects of the subjects of those I-models are structurally-simple, being composed of primary I-units of only six general types, plus T-units that correspond to those six types and differ from them in form only by the addition of T-level-indicators. Thus, there is a very simple structural relationship between a T-specification that represents a type-structure and the I-components that represent those aspects of the subject that are instances of that type-structure.

### 2.10.14 Modularity

I-models are very modular in their structural-configurations. Their primary components are comprised of I-units that are small structures that are not restricted to having particular structural-configuration relationships between those I-units, except in cases when such restrictions are required by the particular configurational forms used in specifying those I-units and I-components, such as in a relational database. The only structural relationships that are necessary for representational purposes are the very simple ones between the primary components within I-units and the E-equivalences between E-elements in different I-units. There are no required grouping structures, such as parentheses, or other sequencing indicators, between I-units or I-components except as determined by system-developers for particular I-models for practical reasons.

Thus, that modularity results in great flexibility in determining the specific structural relationships of the primary components in particular I-models. There is also great flexibility for determining the specific types of structural-forms in different I-models of the I-elements that are the primary components of I-units.

Thus, combinations of I-units that form I-components may have specific sequencing and structural arrangements between those I-units that are determined by the system-developers. That means that there is great freedom to determine the particular structural arrangements of I-components in I-models that are the most efficient for storage and for the performance of operations by I-systems on those I-models. That includes, for example, having records of different specific structural forms for different types of I-components within an I-model; for example, grouping all REV1-components in an I-model in a table. While the general structure of I-units having three primary components and being inter-related by E-equivalences between E-elements in different I-units is the same for all I-models, the specific forms of the details of those structures, and of the structures of I-components in general, are of an unlimited possible variety, being determined by the system-developers for each I-model and for particular structural types of I-components within those I-models. For example, possible specific structural forms include tables, linear sequences, and networks. Thus, I-models are versatile and adaptable.

### 2.10.15 Permanence and Stability in the Types of Basic Representational Structures

Furthermore, those basic types of primary I-units are sufficient for all representational purposes, for which there should be no subsequent need to specify additional basic general representational types to account for types of aspects of subjects not previously represented in I-models. That gives permanence and stability to the types of basic representational structures in I-models.

### 2.10.16 Physical-Network Forms

Because of their basic structural form, I-models may be specified in physical-network forms. Hence they can be employed to specify records not only in digital systems but also in various non-digital computer-systems whose records have a physical-network form.

### 2.10.17 Incremental Development

I-models can be developed incrementally over time by progressively increasing the specificity of the representations of various aspects of the subject of an I-model, as described in section 2.2. Also, representations of more entities and events, including T-specifications and new RT-types, may be progressively added over time without requiring any major restructuring of the existing I-components. That accelerates the process of expanding I-models and decreasing their cost, compared to other types of computer-operative records such as relational databases. Furthermore, that simplicity means that, where appropriate, the addition of representations of new types and forms of combinations of events and relationships can be specified by users of I-models without requiring any special expertise. Moreover, in general, an I-model can accomodate differing levels of specificity in the representation of different aspects of the subject.

### 2.10.18 Simpler and More Precise Forms of Automatic Subject-Related Processing

The simple basic form of the representational components of I-models enables much simpler and more precise forms of automatic subject-related processing, such as indexing, searching, and logical-consequence-identification. It also enables much simpler automatic translation processes between I-models and other types of records than for translating between other records of different types. Also, due to their precision and simplicity, the subject-related processing supported by I-models can be much more precise than for many other types of computer-operative records that attempt to represent complex combinations of aspects of a subject.

### 2.10.19 More-Efficient Subject-Related Operations on Combinations of I-Models

Moreover, the uniformity of the general types of base-primary I-units across different I-models enables more-efficient subject-related operations on combinations of I-models, even when those I-models have differences in the details of their specific structural forms. That also means that I-systems that operate on a variety of I-models are simpler and more efficient than other types of computer-based record-systems that perform comparable operations on combinations of records of disparate forms that collectively specify the same things as those I-models.

### 2.10.20 Wide Variety of Types of Computer-Systems

Also, because of their relative simplicity, I-models can be constructed and stored in computer-systems of a wide variety of types, including both digital and non-digital types. I-models are particularly compatible with computer-systems whose physical record-configuration structures are in the form of a network.

### 2.10.21 Fundamental Record-Infrastructure for Computing

By providing a single uniform comprehensive permanent basis for such functions as subject-indexing, simple uniform search-requesting, automatic translation between computer-based records of all types, and logical-consequence-identification, I-models can provide a fundamental record-infrastructure for computing that integrates all computer-operative records into a single coordinated computer-based record-system that specifies information while minimizing the need for human involvement.

### 3.0 I-SYSTEMS

I-models may serve as external records for information storage separate from a computer system. They may also be present in general computer-systems that perform non-subject-related operations on those I-models. However, the construction, and the subject-related functions, of I-models occur within computer-based record-systems referred to here as ‘I-systems’. This section describes aspects of that functioning and the advantages of such systems compared to other types of computer-based record-systems. Specifically, an I-system is a computer-based record-system in which the primary-records are I-models and the primary-operative-components in that system perform subject-related operations on those I-models. One or more of those I-models may be a dynamic-I-model. Also, one or more of those I-models may be a distributed-I-model within the I-system, or one of the I-models in a distributed-I-model located in a combination of operatively-inter-connected I-systems. The following subsections describe the construction and functioning of I-models in I-systems.

### 3.1 General Structure and Functioning of I-Systems

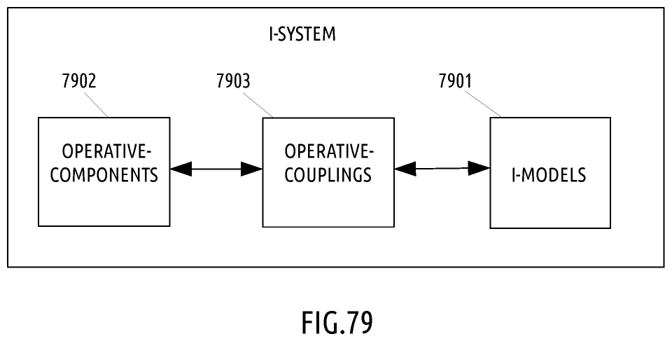

As described earlier, FIG. 4 shows the general structure of an I-system. FIG. 79 shows the essential elements of an I-system that distinguish it from other computer-based record-systems. Specifically, the I-system contains one or more I-models 7901 and one or more operative-components 7902 that are constructed to operate on those I-models. Those operative-components are operatively-connected with those I-models by means of operative-couplings 7903. Some of those operative-couplings between the I-models and the operative-components may be indirect in that they are intermediated by other operative-components in the I-system. That also is the case with operative-couplings between operative-components and records of other types in the I-system. Also, some operative-couplings between operative-components may include temporary intermediate records that contain or indicate records to be operated on in subsequent operations.

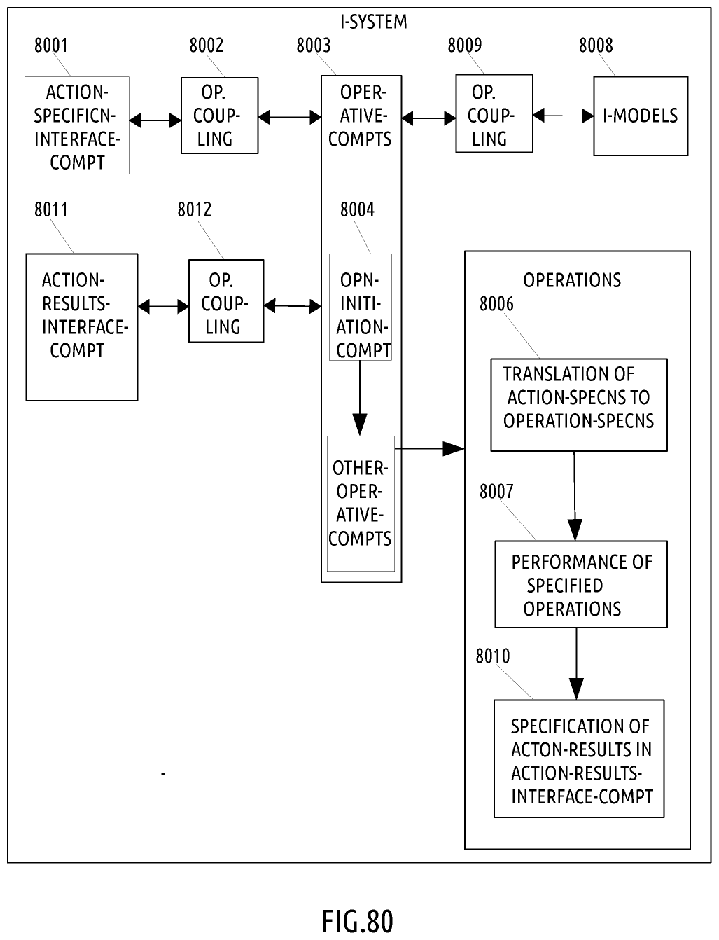

FIG. 80 shows the action-specification interface-component 8001 which receives the specifications of actions to be performed by the I-system. That interface-component is operatively-coupled 8002 with the operative-components 8003. The operation-initiation component 8004 determines which other operative-components 8005 are to be initiated in response to those action-specifications and then initiates the performance of those operations by those other operative-components. One or more of those operative-components translates 8006 those action-specifications to specifications of operations to be performed and then performs 8007 those operations on one or more I-models 8008 that are operatively-coupled 8009 with the operative-components in the I-system. Those operative-components 8005 then specify 8010 the results of those actions in the action-results interface-component 8011 that is operatively-coupled 8012 with the operative-components in the I-system.

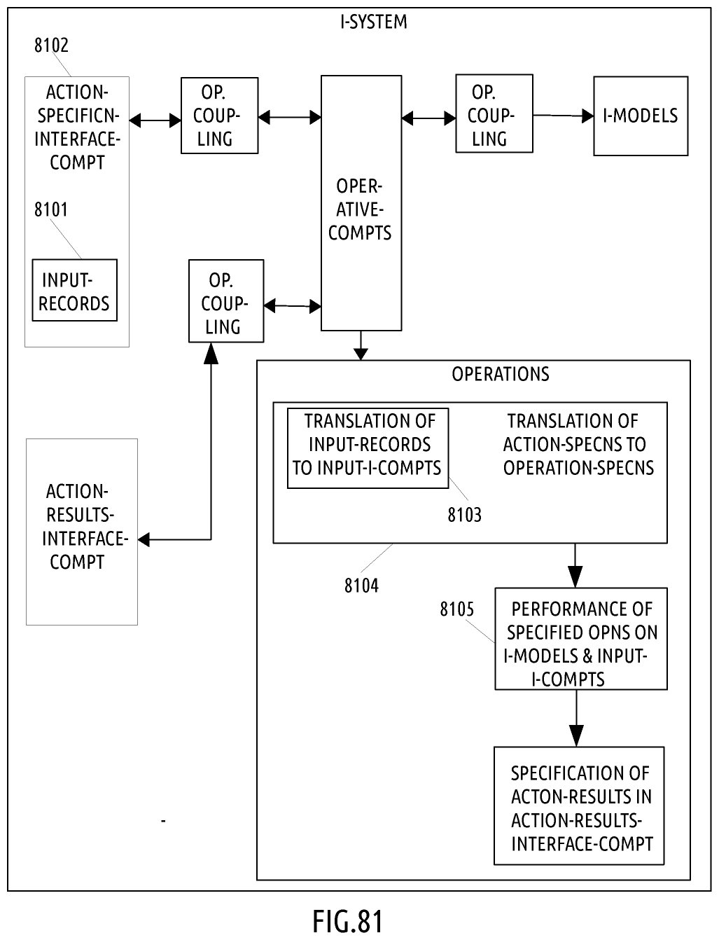

FIG. 81 shows an I-system of the same basic form as that shown in FIG. 80 with the additional indication of input-records 8101 that are components of action-specifications received in the action-specification interface-component 8102. As part of the process of translating 8103 those actions-specifications to operation-specifications, those records are translated 8104 to I-components. Those I-components are operated on as part of the performance 8105 of those specified operations.

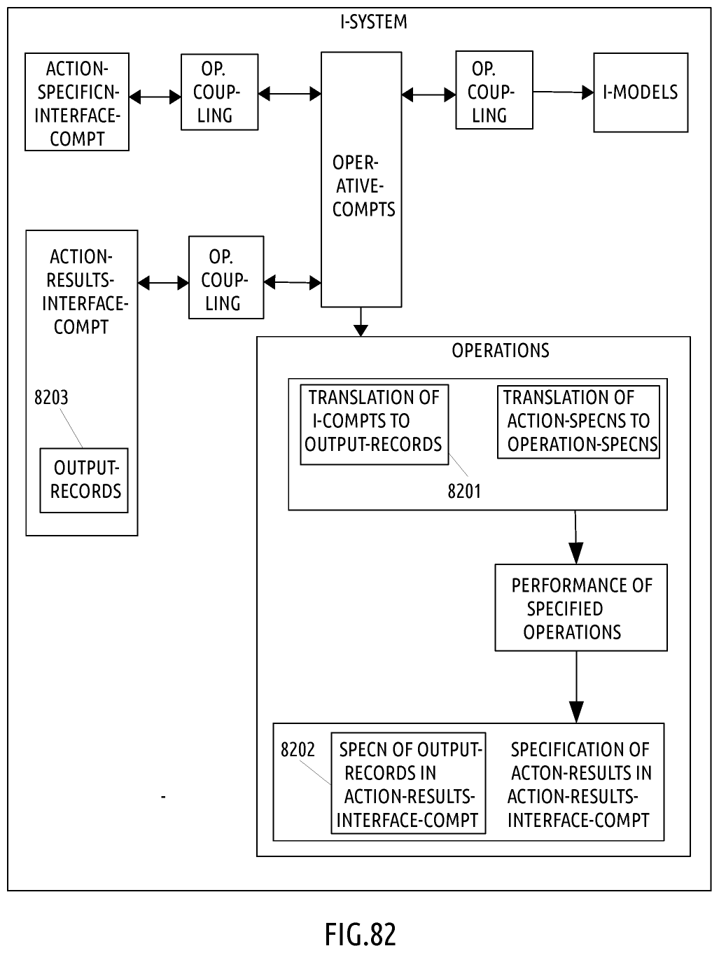

FIG. 82 shows an I-system of the same basic form as that shown in FIG. 80 with the additional indication of the translation 8201 of I-components in the system to output-records that are then specified 8202 as output-records 8203 in the action-results interface-component.

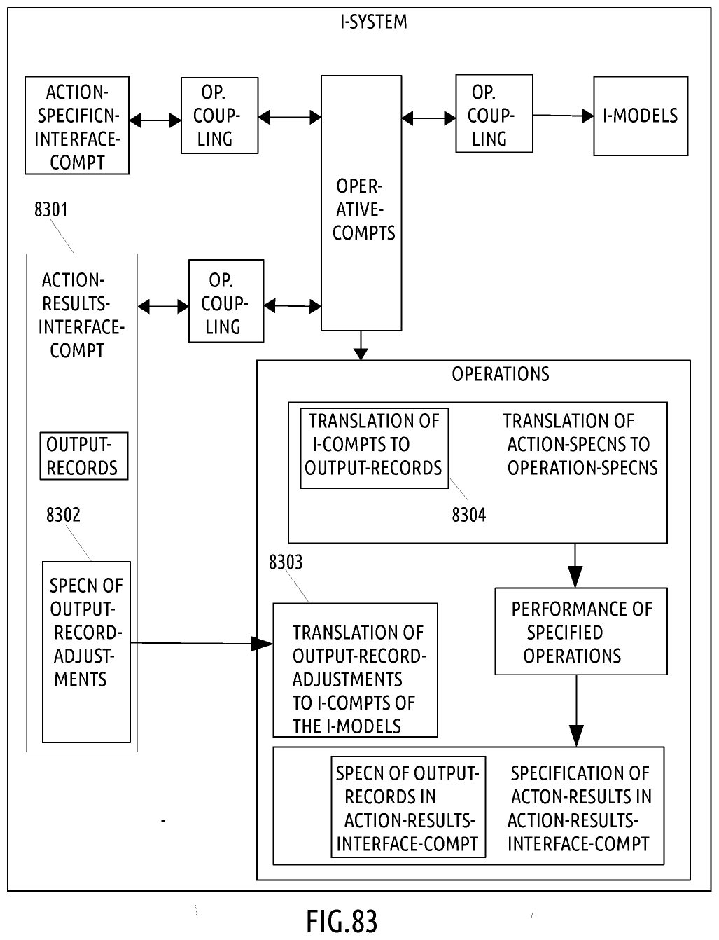

FIG. 83 shows an I-system of the same basic form as that shown in FIG. 82 with the additional indication in the action-specification interface-component 8301 of adjustments 8302 to be made to previous output-records. Those specified adjustments are translated 8303 to I-components that replace the existing I-components from which those previous output-records were translated 8304.

### 3.2 Secondary-Records in I-Systems

In addition to one or more I-models, an I-system may also include one or more secondary-records of various aspects of the I-models contained in that system. Such other aspects of an I-model may include, for example, significant primary-circumstantial-conditions in that I-model, its modality, its source, date and reliability, its intended use, intended system-users, operations that may be performed on that I-model at the request of such system-users, and access rights to that I-model for various potential system-users. Some of those secondary-records may themselves be I-models.

The I-system may include secondary-records of E-equivalences between E-elements in the same I-model or different I-models in the system. Such secondary-records may include components that are directly linked to E-elements in the I-units to which they apply. The I-system may also include a secondary-record that indicates equivalence-relationships between E-elements in an I-model and equivalent representatives of the same entities in records of other types.

If there is more than one I-model in an I-system, then that system may contain secondary-records that indicate various types of relationships between those I-models, such as relationships of those types described in the previous section on I-models. Those secondary-records may be contained in one or more I-models in the I-system.

A secondary-record in an I-system may also contain specifications of various T-elements employed in each I-model in the system. Those specifications may also include indications of the natural-language names that correspond translationally to the RT-indicators for T-elements that are RT-elements or ERT-elements. It may also include an indication for a T-element of the possible instances of the type-entity represented by that T-element in cases where the range of those possible instances is restricted.

A secondary-record in an I-system may include one or more subject-indexes to I-models in the I-system. The system may include a separate subject-index for each I-model or group of I-models. One or more of those subject-indexes may be I-indexes. That secondary-record may also include one or more indexes that indicate the locations of other computer-based records in a computer-system containing that I-system, or in external computer-systems, external records of other types, and external collections of records. If any of those indexes is an I-index, then the I-system may include a secondary-record that is an alpha-numeric index to the natural-language names that correspond translationally to the names of entities indicated in that I-index. Such indexes may be used in the standard way such indexes are used, such as in searching for I-elements that represent specific entities, including type-entities, and events. Users of such an index may include, for example, that I-system, human system-users, or other computer-systems.

An I-system may include one or more secondary-records that are translations of natural-language dictionaries and that are employed in that I-system as input-records to operative-components that construct T-specifications for T-elements that represent type-entities that are identified by names in both that I-model and one of those dictionaries.

### 3.3 I-System-Models

An I-system may contain an I-system-model. An I-system-model is a secondary-record that is an I-model of the I-system containing that I-model and of one or more other I-models that are the primary-records in that I-system. That I-system-model may specify information that is received from system-users or that is developed by operative-components in the system. That I-system-model is a dynamic-I-model that indicates information about the current state of the I-system, including information about I-models contained in the I-system. It may also specify information about past events in the I-system and planned future events in the I-system. It may also indicate information about other I-models in other I-systems, or that are stored outside of an I-system. For example, those aspects may include attributes of I-models and I-components in the I-system, such as those attributes described in the earlier section on I-models. That I-system-model may also specify aspects of other records in the computer-system containing that I-system. I-system-models are employed by operative-components in the I-systems containing them to accomplish operations such as system-monitoring and control.

### 3.4 I-Templates

A primary-operative-component in an I-system may employ one or more I-templates in performing its operations. An I-template in an I-system is a computer-based record that is not part of an I-model in that I-system but that has a primary-configuration that corresponds in general structural form to the primary-configuration of a combination of one or more I-components that may be constructed in an I-model in that I-system. I-templates in an I-system are constructed by one or more primary-operative-components in that I-system and are employed in performing operations of various types on I-models and I-components, such as searching an I-model for an I-component that matches a specified I-template.

### 3.4.1 Structure of I-Templates

Similarly to I-components, the primary component of such an I-template consists of a combination of I-unit-templates of various types whose primary-configurations correspond structurally to the primary-configurations of I-units that may be constructed in an I-model in that I-system. Each of the primary components of each I-unit-template is, in turn, an I-element-template or an I-element. I-element-templates are of two general structural types: E-element-templates and I-indicator-templates. E-element-templates are of four general structural types: basic-entity-element-templates, T-element-templates, ERT-element-templates; and IEV-element-templates. I-indicator-templates are of three general structural types: generic-RT-indicator-templates, generic-occurrence-state-indicator-templates, and event-state-determinant-indicator-templates.

In addition, an I-template may include one or more I-element-template-equivalence-indicators. An I-element-template-equivalence-indicator indicates that two specific I-element-templates are template-equivalent. Such indicators are employed by operative-components that perform template-matching operations, as described below. Specifically, an I-element-template-equivalence-indicator may indicate template-equivalences between two or more basic-entity-element-templates; between two or more T-element-templates; between two or more ERT-element-templates; between two or more IEV-element-templates; between two or more generic-RT-indicator-templates; between two or more generic-occurrence-state-indicator-templates, or between two or more event-state-determinant-indicator-templates.

Also, for each E-element in an I-template in an I-system, that system includes either or both of an E-equivalence between that E-element and an E-element in an I-model in that I-system, or a secondary-record that indicates an equivalence between that E-element and a representative in another record in the system of the entity represented by that E-element.

An I-template may also include secondary-records that indicate other restrictions on I-element-templates, such as, for example, a specification of a name for the entities represented by the E-elements that match an I-element-template.

Some I-templates in an I-system may consist of a single I-element or a single template-element. Some I-templates may not contain any template-elements and, consequently, are identical to I-components that may be specified in an I-model in that I-system.

Similarly to the above types of I-unit-templates corresponding to primary I-units, I-unit-templates may be specified that correspond to secondary I-units.

In addition to the I-templates that may be maintained in the I-system for repeated use, more-complex I-templates may be constructed for temporary use by an I-system by combining simpler I-templates. Such more-complex I-templates may be used in that I-system only a small number of times on an ad-hoc, short-term basis.

The specific details of the structural forms of I-templates, I-unit-templates, and I-element-templates are determined by the systems designers on the basis of practical considerations. For example, E-element-templates and E-elements may have identical structures that are differentiated by E-elements having specified E-equivalences and E-element-templates not having E-equivalences, although the latter may have I-element-equivalence-template-indications.

### 3.4.2 Example of an I-Template

An example of an I-template that may be present in an I-system is an I-template that corresponds to I-components that, if present in an I-model in that I-system, would T/INST-correspond to the T-specification for a T-element in that I-model. Such an I-template may have a primary-configuration that has the same structural form as the primary-configuration of that T-specification, with the following exceptions: (1) the T-level-indicators in that T-specification are omitted from that I-template; (2) each E-element that is a terminal-E-element in a T10SR-unit in that T-specification is specified to be E-equivalent to an E-element in an I-model in that I-system, or to be equivalent to the representative of a specified entity in a record in that I-system; (3) each E-element that is an initial-E-element in a T01SR-unit in that T-specification is specified to be E-equivalent to an E-element in an I-model in that I-system, or to be equivalent to the representative of a specified entity in a record in that I-system; (5) all other T-elements in that T-specification are replaced by T-element-templates; (6) all other IEV-elements in that T-specification are replaced by IEV-element-templates; (7) each specification of an E-equivalence between E-elements that are not fixed-E-elements in that T-specification is replaced by a specification of an I-element-template-equivalence between the corresponding I-element-templates in that I-template; and (8) except for the T-level-indicators, each I-indicator in that T-specification is I-equivalent to the I-indicator in the corresponding location in that I-template.

### 3.4.3 Template-Matching

A combination of I-components in an I-model matches an I-template in the I-system containing that I-model if that combination has a primary-configuration that has a one-to-one structural correspondence in the following ways to the primary-configuration of that I-template. Specifically, there is a one-to-one structural correspondence between the I-unit-templates in that I-template and the I-units in that combination. That structural correspondence between an I-unit-template and an I-unit includes a one-to-one correspondence between their P1-components, between their P2-components, and between their P3-components. A basic-entity-element in that I-model matches an I-element-template in the corresponding location in an I-unit-template in that I-template if (1) that I-element-template is a basic-entity-element-template, and (2) if that I-element-template is indicated by an I-element-template-equivalence-indicator to be I-element-template-equivalent to another I-element-template in that I-template, then that basic-entity-element is specified in that I-model to be E-equivalent to the basic-entity-element that matches that second I-element-template. The same type of correspondence applies to T-elements matching T-element-templates; RT-elements matching RT-element-templates; IEV-elements matching IEV-element-templates; and event-state-determinant-indicators matching event-state-determinant-indicator-templates.

In addition, an RT-indicator in that I-model matches a generic-RT-indicator-template in the corresponding location in an I-unit-template in that I-template if that generic-RT-indicator-template is indicated by an I-element-template-equivalence-indicator to be I-element-template-equivalent to another generic-RT-indicator-template in that I-template, and that RT-indicator is I-equivalent to the RT-indicator that matches that second generic-RT-indicator-template. The same type of correspondence applies to generic-occurrence-state-indicators matching generic-occurrence-state-indicator-templates.

In addition, an E-element in that I-model matches an E-element in the corresponding location in an I-unit-template in that I-template if that second E-element is specified by an E-equivalence in that I-template to be E-equivalent to that first I-element, or if both of those E-elements are indicated in another record in that I-system to be E-equivalent to the representative of the same entity. Each I-indicator in that combination of I-components matches an I-indicator in the corresponding location in an I-unit-template if those I-indicators are specified or indicated to be I-equivalent.

An I-template that includes at least one I-element-template may be matched by two or more different I-components that are similar in structural form but that are not I-equivalent.

It should be noted that the one-to-one structural-correspondence between a combination of I-components and an I-template matched by that combination means in particular that no pair of E-elements in that combination may be E-equivalent unless the corresponding E-element-templates are I-element-template-equivalent.

An I-template that does not include any I-element-templates may be fully identical to a combination of I-components that may be constructed in an I-model in that I-system. Such an I-template may be employed by an operative-component in the I-system to determine whether or not that I-model includes an I-component whose primary-configuration is identical to the primary-configuration of that I-template.

An I-system may contain I-templates that would be matched by various combinations of I-components in an I-model but that are restricted from being present in that I-model by restrictions of any of the types previously described. Those templates may be used by an operative-component in the I-system to identify such restricted combinations that are either already in an I-model or that are presented to that I-system for inclusion in that I-model.

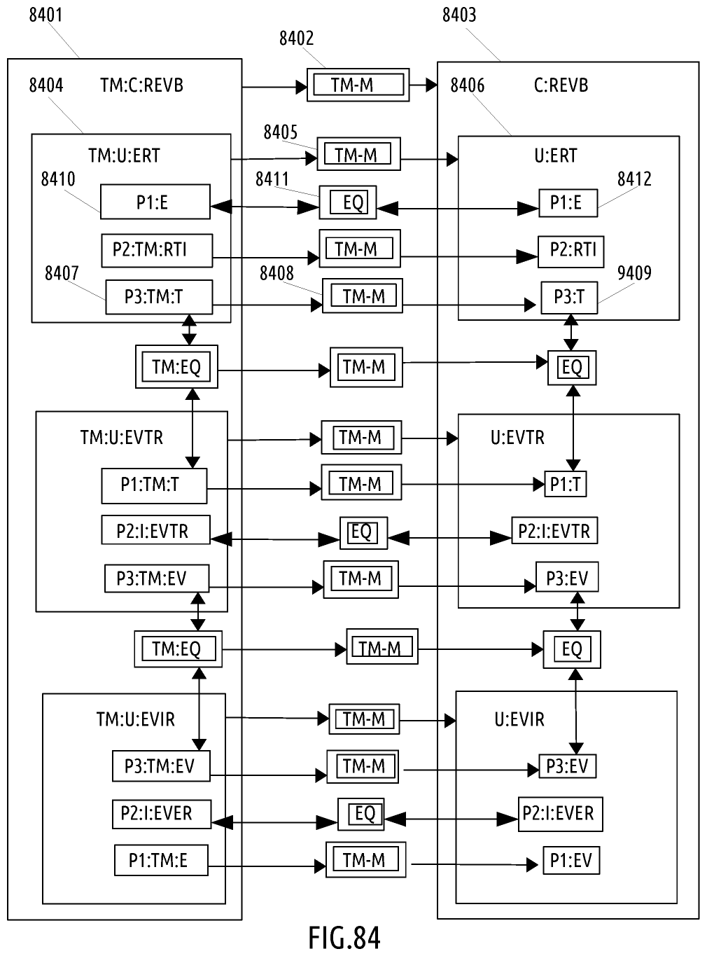

FIG. 84 shows a simple example of an I-template match with an REVB-component. In the drawing, ‘TM’ indicates a template of the type indicated after the colon following ‘TM’. The template 8401 is matched 8402 by the REVB-component 8403. Each component of the template is matched by a corresponding component of the REVB-component, as indicated by a secondary record identified by ‘TM-M’. Within those two components are shown the template-matches between the I-unit-templates and the corresponding I-units, and the template-matches between the I-element-templates and the corresponding I-elements. For example, indicator 8405 indicates a template-match between the ERT-unit-template 8404 and the ERT-unit 8406. Indicator 8411 indicates a template-match between the ERT-unit-template 8410 and the ERT-unit 8412. Indicator 8408 indicates a template-match between the T-element-template 8407 and the T-element 8409.

### 3.4.4 I-Template-Correspondence-Pairs

The I-system may include one or more I-template-correspondence-pairs of one or more types. An I-template-correspondence-pair is a pair of I-templates for which the I-system contains one or more I-element-template-correspondence-indicators. An I-element-template-correspondence-indicator is a record that indicates a correspondence of a specified type between I-elements in a pair of combinations of I-components that match that I-template-correspondence-pair. Some of those types of correspondences are described below.

In addition to the I-template-correspondence-pairs that may be maintained in the I-system for repeated use, more-complex I-template-correspondence-pairs may be constructed in an I-system by combining simpler I-template-correspondence-pairs.

A pair of combinations of I-components matches an I-template-correspondence-pair if the first combination of I-components in that pair matches the first I-template in that I-template-correspondence-pair, and that second combination of I-components matches the second I-template in that I-template-correspondence-pair. In addition, there is a correspondence between the I-elements in each pair of I-elements that matches a pair of I-element-templates for which there is an I-element-template-correspondence-indicator, and those correspondences between those I-elements are of the type specified in those I-element-template-correspondence-indicators.

### 3.4.5 I-Template-LOGCON-Correspondence-Pairs

For example, the I-system may include one or more I-template-LOGCON-correspondence-pairs. An I-template-LOGCON-correspondence-pair is an I-template-correspondence-pair such that the I-component pairs that match that I-template-correspondence-pair are LOGCON-relationship-pairs of a specified type of LOGCON-relationship, such as any of the types described in section 1.4.6.5.7. Thus, that second combination of I-components represents one or more events whose occurrence (or non-occurrence) is a logical consequence of the events represented by the first combination of I-components in that LOGCON-relationship-pair.

### 3.4.6 Complex-I-Template/Simple-I-Template-EQUIV-Correspondence-Pairs

The I-system may include one or more complex-I-template/simple-I-template-EQUIV-correspondence-pairs. A complex-I-template/simple-I-template-EQUIV-correspondence-pair is an I-template-correspondence-pair such that the second I-component in an I-component-correspondence-pair that matches that I-template-correspondence-pair is I-equivalent to, but structurally-simpler than, the first I-component in that pair. That corresponds to the first template in that I-template-correspondence-pair being more complex than the second template in that correspondence-pair.

### 3.4.7 I-Template-TRANS-Correspondence-Pairs

The I-system may include one or more I-template-TRANS-correspondence-pairs. An I-template-TRANS-correspondence-pair is an I-template-correspondence-pair such that the combinations of I-components in the I-component pairs that jointly match that I-template-correspondence-pair are translations of each other. Thus, they are equivalent. I-template-TRANS-correspondence-pairs may be employed in an I-system for translating between components of the same or different I-models that have differences in the details of their specific structural forms. An example is the case of T-elements that have different T-specifications but are T-equivalent. Multiple I-template-TRANS-correspondence-pairs may be combined to form more complex I-template-TRANS-correspondence-pairs. An I-template-TRANS-correspondence-pair may specify equivalence.

### 3.4.8 Other Types of Record-Templates and I/R-Template-TRANS-Correspondence-Pairs

Some additional types of record-templates and I/R-template-TRANS-correspondence-pairs that may be employed are described in the following subsections.

### 3.4.8.1 R-Templates

An R-template is a template for a combination of primary components of a record of some type other than an I-model. That R-template has the same general function in the computer-system containing it as the function of an I-template in an I-system. Thus, that R-template may be employed by that computer-system to compare it with other records in that system, as part of various operations being performed on those other records. An example of such an operation is searching a record for components that match a particular template, to determine whether that record includes such a component, or to locate such a component within that record.

Consequently, the nature of the matching relationship between the structural form of the primary component of that R-template and the structural form of a combination of components of that record that match that R-template is the same as the nature of the matching relationship between the structural form of an I-template and a combination of I-components that match that I-template. The specific type of structural form of that R-template, and of the nature of that matching relationship, is determined by the structural form of those primary components of that record.

Since there is an unlimited range of possible structural types of records, there is a corresponding unlimited range of possible structural forms for R-templates.

In addition to the R-templates that may be maintained in the I-system for repeated use, more-complex R-templates may be constructed in an I-system by combining simpler R-templates.

The primary component of an R-template may have a configuration that exactly matches a component that may be specified in a record, so that an exact match is required. Alternatively, the exact forms of some parts of that configuration may be left unspecified, so that, while the fully-specified parts are exactly matched, the other parts of that R-template may be matched by any components of that record that have the appropriate general forms in corresponding locations in the configuration of that record.

### 3.4.8.2 I/R-Template-TRANS-Correspondence-Pairs

The I-system may include one or more I/R-template-TRANS-correspondence-pairs that are similar in function to I-template-TRANS-correspondence-pairs. An I/R-template-TRANS-correspondence-pair is a pair of templates of which the first is an I-template and the second is an R-template, and there is a translational-correspondence between the combination of record-components in each pair consisting of a combination of I-components and a combination of record-components that jointly match that I/R-template-TRANS-correspondence-pair.

In addition to the I/R-template-TRANS-correspondence-pairs that may be maintained in the I-system for repeated use, more-complex I/R-template-TRANS-correspondence-pairs may be constructed in an I-system by combining simpler I/R-template-TRANS-correspondence-pairs.

### 3.5 Primary-Operative-Components in I-Systems

The general functioning in I-systems of operative-components of various general types is as described in the glossary entry for computer-systems. This section describes operative-components of particular significance in I-systems.

### 3.5.1 Functional Linkages Between Primary-Operative-Components and I-Components

In I-systems in which one or more of the I-models are purely representational, some of the primary-operative-components may be closely and continuously linked with the components that constitute individual I-units or I-components in those I-models, such as, for example, in records comprised of field-programmable gate-arrays. In such cases, particular aspects of the functioning of those operative-components may be determined by particular aspects of those I-units and I-components, such as those aspects of those I-units that indicate the occurrence-status of particular events. Changes to such I-units may initiate or change aspects of the functioning of those operative-components. Such changes may then induce a propagating sequence of spreading changes in other operative-components and in the indications of the occurrence-status of various events represented by EV-elements or T-elements in I-units in that system until that propagating process terminates. The resulting states of some of those operative-components and I-units are then identified by other operative-components in the system.

### 3.5.2 Scheduling Operations

The I-system may include an indication of when an operation of a specified type is to be performed, such as, for example, at the current time, a specific future time, or all future times when an event of a specified type occurs. That event may be an event that is indicated in a dynamic I-model to be occurrent; it may be an event in the I-system; or it may be an event external to the I-system whose occurrence is indicated in a system-input-interface-component. In such cases, another operative-component in the I-system may identify the occurrence of that event and initiate the operation of an operative-component of the type that performs operations of that type. Alternatively, the operation of some operative-components may be initiated by a system-user, or by another operative-component in the I-system.

### 3.5.3 Types of Operative-Components

An I-system may include many different operative-components that perform operations of different types, as exemplified in the following sub-sections.

### 3.5.3.1 System-User/I-Model-Interaction-Components

An I-system may include one or more system-user/I-model-interaction-components. A system-user/I-model-interaction-component is an operative-component that includes a combination of one or more operative-components whose input-records are system-input-records and whose output-records include one or more I-models or I-components in the I-system; that system-user/I-model-interaction-component also includes one or more system-output-interface-operative-components whose input-records include those I-models and I-components and whose output-records are presented to one or more system-users in system-output-interface-components. That system-user/I-model-interaction-component initiates and coordinates the operations of those interface-operative-components. It may also initiate the operation of other primary-operative-components, such as I-model-constructing-components.

### 3.5.3.2 I-Model-Constructing-Components

An I-system may include one or more I-model-constructing-components. An I-model-constructing-component is an operative-component that performs an I-model-construction-operation that produces one or more new I-models, or adds newly-constructed I-components to existing I-models in the I-system. Those new or expanded I-models are the output-records from that operation.

One or more of the input-records to such an operation may be provided by a system-user/I-model-interaction-component, which may also initiate the operation of that constructing-component. That constructing-component may initiate the operation of a translating-component that translates those input-records to I-components of the I-model to be constructed, or added to, by that construction-operation. One or more of the input-records to the construction-operation may be the I-components that are the output-records from one or more LOGCON-construction operations, which also may be initiated by that constructing-component. Those I-components are the second combinations of I-components in one or more LOGCON-relationship-pairs identified by those LOGCON-construction operations. In particular, one or more of those second combinations of I-components may be added to a T-network or a T/INST-network in that I-model.

The construction of an I-model may continue incrementally and intermittently over a period of time, as additional I-components are added. In particular, a T-component that represents part of the definition of a type-entity may be incrementally expanded over time until it is a complete T-specification that represents the complete definition of that type-entity. Also, that constructing-component may examine a dictionary in the I-system to identify a definition for an type-entity for which a name but no definition, or only an incomplete definition, is represented in the I-model. If such a definition is found, then that operative-component may construct a translation of that definition and add that translation to that I-model.

An I-model-constructing-component, or other operative-component in the I-system, may also initiate one or more operations that identify possible problems or improvements in new or expanded I-models. Such operations may include, for example, configuration-incompatibility-detecting-operations, inconsistency-detecting-operations, E-equivalence-detecting-operations, complex-I-component-detecting-operations, or circular-EV-dependence-detecting-operations on intermediate-products of that construction-operation. (Those operations are described later in this section 3.5.3.) If any of those operations identifies a possible problem or improvement, then the constructing-component, or other operative-component in the I-system, may initiate predetermined operations that resolve such cases. Such predetermined operations may include notifying the system-user or system-developer of the problems found. That constructing-component, or other operative-component, may also initiate an index-construction-operation that constructs an index, or adds to an existing index, components that index the new I-model, or the additions to the existing I-model.

An I-model may be constructed by means of the operations described above with the input-records to those operations being two or more I-models, and the output-record being an I-model that is a combination of those input I-models.

Alternatively, an I-model may be constructed by means of the operations described above, with the input-record to those operations being an I-model that is accompanied by a specification of those parts of that I-model to be copied to a new I-model that is the output-record. That new I-model represents only some of the things represented in the input-record.

### 3.5.3.3 Dynamic-I-Model-Constructing-Components

The I-system may include one or more dynamic-I-model-constructing-components. A dynamic-I-model-constructing-component is an operative-component that constructs a dynamic-I-model. That component sequentially constructs a sequence of I-models that are related in the manner described in section 2.4 for dynamic-I-models.

### 3.5.3.4 Translating-Components

As specified by the system-user or by predetermined specifications in the I-system, a translating-component may translate an operation-input-record to one or more operation-output-records that are stored in that I-system. A translating-component is an operative-component that translates an operation-input-record to an operation-output-record that is of a different record-configuration-type or structural form but whose primary component is translationally-equivalent to the primary component of that operation-input-record. That operation-output-record may be stored as a separate record in that I-system, or as a new component added to an existing record in that I-system.

The operation-output-record of that translation-operation may be a new I-model, or a combination of one or more I-components that is to be added to one or more existing I-models in the I-system. The operation-input-record to that translation-operation may also be an I-model, or a combination of one or more I-components. The translating-component may also add links between specified E-elements in the output-record and the corresponding components of the input-record. Those links may be specified by means of secondary I-units, or by secondary-records in the I-model(s) in that output-record. They may also, or alternatively, be specified as additions to the input-record. Those links may subsequently be employed by operative-components in the I-system to identify equivalence-relationships between various parts of the input- and output-records.

If that operation-input-record and that operation-output-record are both I-models, or combinations of I-components, but have different configurational forms, then that input-record and that output-record may have a one-to-one I-equivalence correspondence between their I-units, and also between the P1-components, between the P2-components, and between the P3-components in those corresponding I-units, such that those corresponding components are representationally-equivalent. However, the specific details of the configurations of those two records may be different, and, hence, incompatible, in which case the translation-operation includes the operation of translating the details of the configurational form of that input-record to the form employed in that output-record.

If that operation-output-record is an I-model, or a combination of I-components, that is to be added to an existing I-model in the I-system, then the I-system may initiate the operation of a configuration-incompatibility-detecting-component on those two records.

If that operation-output-record is an I-model, or a combination of I-components, that is to be added to an existing I-model in the I-system, then the I-system may initiate the operation of an inconsistency-detecting-component on the combination of that output-record and that existing I-model.

That translation-operation may include an operation by an E-equivalence-detecting-component on the combination of I-components and I-models produced by that translation-operation.

The input-record to a translation-operation may be a record that is not an I-model but has a simple primary-configurational structure, such as, for example, a tabular record, or a diagrammatic graphical record provided in a system-input-interface-component by a system-user. In that situation, the translating-component may first construct a combination of R-templates that is matched by that input-record. Then that operative-component may construct an I/R-template-TRANS-correspondence-pair in which the second template is that combination of R-templates. Then that operative-component constructs a collection of I-components that matches the I-template in that I/R-template-TRANS-correspondence-pair. The combination of I-components that matches that I-template is translationally-equivalent to that input-record and is the operation-output-record resulting from that operation. Alternatively, that operative-component may perform that translation-operation in multiple sequential translation-operations, by repeating the above operation for each component in a combination of components that constitutes the primary-configuration of that input-record, and progressively combining the operation-output-records of each of those operations to produce the combined operation-output-record of that whole sequence of operations.

The system may include one or more translating-components of different types that perform translation-operations on records that are not configurationally-simple. Such records may include, for example, spoken or written natural-language records, artificial-language-records, visual images, and audio-recordings. In such a case, that translating-component may include an operative-component that first performs a parsing-operation, or a preliminary translation-operation of some other type, on that input-record, that produces an output-record that is configurationally-simple and is representationally-equivalent to that input-record. If that input-record is a natural-language record that includes references to named type-entities, then that operative-component may examine a dictionary in the I-system to identify a definition for that named type-entity. If such a definition is found, then that operative-component may construct a translation of that definition and add that translation to that output-record. Then that translating-component may perform a translation-operation on that output-record, as described above. That first translation-operation may be accomplished by an operative-component that performs those translations or parsing operations by means of an artificial-intelligence method based on machine-learning processes. The operation-input-record to that first translation-operation may include ambiguities in the information it contains. That is particularly the case with records that are not configurationally-simple, such as natural-language records, but may also be the case with many records of some types that are configurationally-simple. Consequently, that first operation-output-record of that translation-operation will also include corresponding ambiguities. The translating-component that performs that first translation-operation may notify a system-user of those ambiguities, and that system-user may correct some or all of them. That first translating-component may include indications of the uncorrected ambiguities in that first operation-output-record.

The input-record to a translation-operation may be part or all of an I-model, and the output-record from that translation-operation may be a configurationally-simple record that is not an I-model, such as, for example, a tabular record, or a diagrammatic graphical record provided in a system-output-interface-component to a system-user. That translation-operation may be a reverse-translation-operation that translates that output-record in the reverse direction of the translation of the user-input-record described in the preceding paragraphs for translating in the opposite direction.

The initial output-record from a translation-operation may contain one or more complex combinations of I-components that may be replaced by simpler combinations of I-components that are I-equivalent to those first combinations. To resolve that problem, the translating-component may initiate the operation of one or more complex-I-component-detecting-components on that initial output-record. If that operative-component identifies any such complex I-component, it may then identify a complex-I-template/simple-I-template-EQUIV-correspondence-pair in which the first I-template is matched by that I-component. That operative-component may then construct an I-component that matches the second I-template in that correspondence-pair. The translating-component may then replace that more-complex I-component by that configurationally-simpler I-component in that initial output-record.

The I-system may include two or more translating-components of different types. In such a system, separate copies of a record may be subject to translation-operations by those different translating-components. The I-models or I-components that are the operation-output-records from those separate translation-operations may each then be operated upon by operative-components that identify problems in those output-records, such as inconsistencies and ambiguities. According to predetermined specifications and the results of the above-described problem-identification operations, the translating-component may then identify one of those output-records as the one to be the output-record from the overall translation-operation. Alternatively, the translating-component may notify the system-user or system-developer, who specifies which of those multiple alternative output-records is to be the output-record for the overall operation.

### 3.5.3.4.1 Reverse-Translating-Components

The I-system may include one or more reverse-translating-components. A reverse-translating-component is an operative-component that translates part or all of an I-model to an output-record, which may be of a different configurational type from that I-model. Such an output-record may be of any of the configurational types described above for the input-records to the translation-operations described above. Such operative-components function in the reverse direction to those translating-components.

### 3.5.3.4.2 Incremental Sequential Specification of Input-Records

Components of an input-record to a translation-operation may be specified incrementally and sequentially in a system-input-interface-component by a system-user or system-developer. The translating-component that performs that operation may separately translate each such component when it is specified, and add the output-record from each such translation-operation to the output-records from the preceding translation-operations in that sequence. The translating-component may also initiate a system-user-review-operation that enables a system-user to check the translation for correctness. System-user-review-components are described later. A copy of that input-record may also be maintained in a computer-system containing that I-system. That is the case, for example, when the record provided by the system-user in the system-interface-input-component is a document prepared by that system-user by means of a word-processing operative-component in that computer-system.

### 3.5.3.4.3 General-Translating-Components

The I-system may include a general-translating-component. A general-translating-component is an operative-component that translates an operation-input-record of one configurational type to an I-model, and then translates that I-model to an operation-output-record of a different configurational type. That I-model is an intermediate I-model in that general-translation operation. That operative-component employs a translating-component and then a reverse-translating-component to accomplish that overall operation. That translation-operation may proceed progressively and incrementally, as described above for a sequential-translation operation.

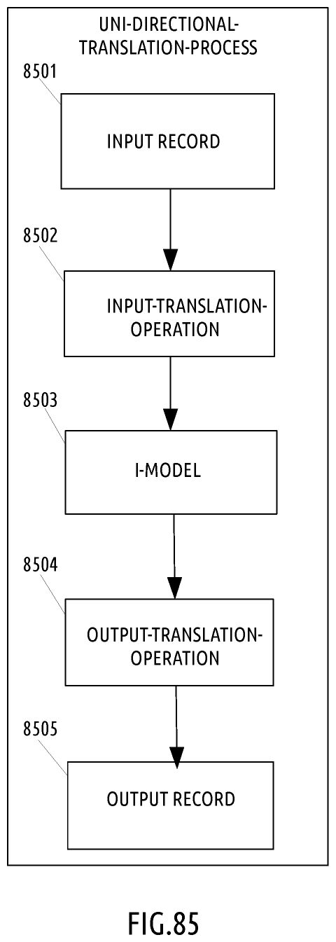

FIG. 85 shows a general translation process in an I-system. The input-record 8501 is operated on by an input-translation operation 8502. The output-record from that operation is part or all of an I-model 8503. Part or all of that I-model is the input-record to an output-translation operation 8504. That output-translation operation results in the production of an output-record 8505.

### 3.5.3.4.4 Bidirectional-Translating-Components

The I-system may include a bidirectional-translating-component. A bidirectional-translating-component is an operative-component that employs a general-translating-component to translate a system-input-record of a first configurational type to a system-output-record of a second configurational type. That operative-component also employs another general-translating-component that translates a system-input-record of that second configurational type to a system-output-record of that first configurational type. Those two general-translating-components may employ the same intermediate I-model. Such translation operations may proceed sequentially, alternating between those two translation operations as new inputs are received in those system-input-interface-components.

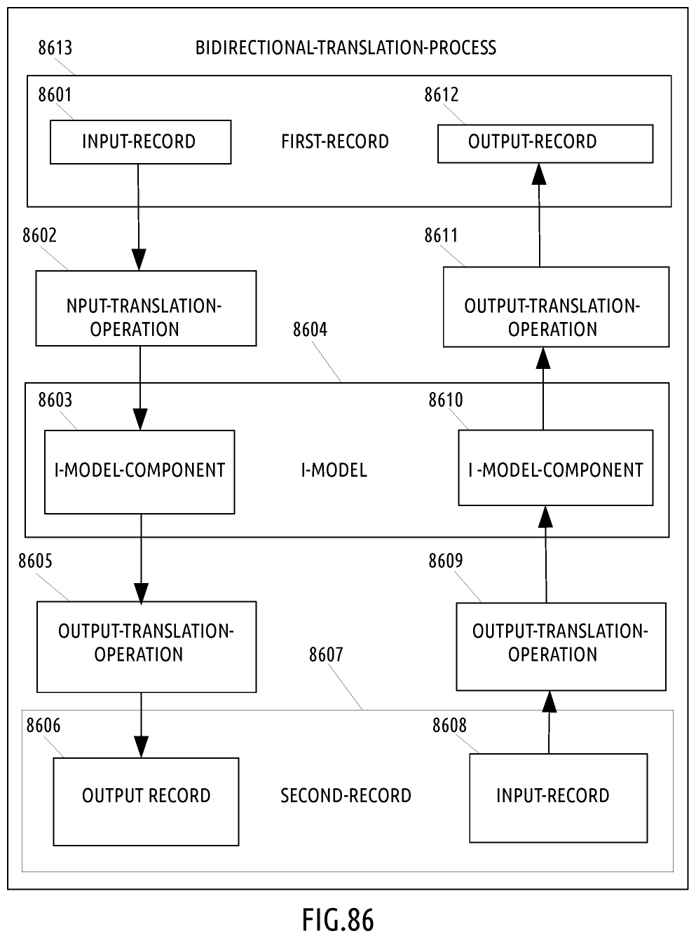

FIG. 86 shows a bidirectional-translation process comprising two general-translation processes. The input-record 8601 is operated on by an input-translation operation 8602. The output-record 8603 from that operation is part or all of an I-model 8604. Part or all of that I-model is the input-record to an output-translation operation 8605. That operation results in the production of an output-record 8606. That output-record is part of a record 8607. Part of that record is the input-record 8808 to an input-translation operation 8609 whose output is an I-component 8610 that comprises part or all of the I-model 8604. That part of that I-model is then translated 8611 to an output-record 8612 that is part of the same record 8613 in which the first input-record 8601 was incorporated.

### 3.5.3.4.5 Multiple-Output-Translating-Components

The I-system may include a multiple-output-translating-component. A multiple-output-translating-component is an operative-component that employs two or more general-translating-components to translate a system-input-record to separate system-output-records of differing configurational types. Those general-translation operations may employ the same intermediate I-model.

### 3.5.3.4.6 Multi-Directional-Translating-Components

The I-system may include a multi-directional-translating-component. A multi-directional-translating-component is an operative-component that employs two or more bidirectional-translating-components to translate system-input-records of two or more different configurational types to system-output-records of two or more different configurational types. Those bidirectional-translation operations may employ the same intermediate I-model. Those translating operations may proceed incrementally and sequentially, thereby, for example, enabling multiple system-users to communicate interactively.

### 3.5.3.4.7 Intermediate I-Models in Translation-Operations

In a translation-operation of any of the preceding four types between records that are not I-models, the translating-component may also maintain a copy of the intermediate I-model as a permanent record in the I-system. In addition, that translating-component may initiate the operation of one or more operative-components that detect configuration-incompatibilities and inconsistencies in that intermediate I-model.

### 3.5.3.4.8 Specialized Translation-Components

The I-system may include one or more translating-components that perform specialized translation operations on records of very specific types. One example is that of an operative-component that translates measurements from one measurement scale to another by means of arithmetic calculations; for example, translations between Fahrenheit temperatures and Centigrade temperatures. Another example is that of components that transduce system-input-records from sensing devices (e.g., devices that sense temperature and pressure) to computer-based records. Another example is that of an operative-component that employs artificial-intelligence image- or voice-recognition methods to recognize entities, relationships and events represented in system-input-records of visual-images or voice inputs. Another example is that of a translating-component that translates between I-models specified in different natural-languages; in those situations the translation-operation may consist simply of replacing the natural-language names for entities, events and type-entities that are represented in one of those I-models with the names for those same entities in the other natural-language.

### 3.5.3.4.9 Absolute-Relative-Translating-Components

Another example is an absolute-relative-translating-component that translates I-components in an I-model that represent absolute occurrences (or non-occurrences) of specified events to I-components that indicate that same information in relative form. Specifically, that translation-operation may be accomplished by replacing a non-invariant EVS-unit by an REV1-component that indicates the occurrence-relationship between the event represented by the P1-component of that EVS-unit and the primary-circumstantial-conditions in that I-model. For example, that component may translate an EVS-unit that indicates that the absolute event represented by P1-component of that unit occurs in a primary-circumstantial-time-period indicated by the P2-component of that EVS-unit. The translation of that may be the relative event represented by an event-time-component whose initial-E-element represents that event and whose terminal-E-element represents that time-period. Translation operations of that type may replace all non-invariant EVS-units in that I-model by such components.

### 3.5.3.4.10 Relative-Absolute-Translating-Components

The I-system may also include a relative-absolute-translating-component that translates I-components in the opposite direction, from I-components that represent the occurrences (or non-occurrences) of events in relative form to I-components that indicate the same information in absolute form. However, a translation of the latter type may only occur if the conditions for those relative events are compatible with the absolute occurrence of all other events already represented in absolute form in that I-model.

### 3.5.3.4.11 Translation-Review-Components

The I-system may include one or more translation-review-components. A translation-review-component is an operative-component that sequentially translates the output-records from a translation-operation to a configurationally-simple human-readable record that is progressively presented in a system-output-interface-component for review by a system-user or system-developer. That enables that person to check that that translation is correct, and to indicate corrections that are needed. The translation-component may then correct that initial translation as specified by that person. That operation may occur incrementally as a system-user incrementally provides additional input-records or components of input-records that are correspondingly incrementally translated by the system as they are provided to the system. Alternatively, that input-record may be fully provided to the system at some time preceding the translation operation. That user-review-operation may occur after that input-record has been completely translated. The person, or persons, who perform that review may not be the same as the system-users who provide the initial input-record to the I-system.

### 3.5.3.5 Ambiguity-Resolving-Components

The I-system may include one or more ambiguity-resolving-components. As described above, a translating-component may identify ambiguities in the first operation-output-record from the initial translation-operation on an input-record, as one aspect of performing that translation-operation. Each ambiguity consists of a group of two or more alternative possible combinations of I-components that are the initial translations of a component of that input-record. Those ambiguities may be resolved by one or more ambiguity-resolving-components in that I-system. An ambiguity-resolving-component is an operative-component that performs operations to reduce or eliminate ambiguities indicated in an initial translation-output-record. For each of those ambiguities, that operative-component may construct a separate combination of I-components, resulting in a group of alternative I-components corresponding to those alternative ambiguous initial translations for that original ambiguous input-record-component. That ambiguity-resolving-component may then provide indications in the I-system that those are alternative translations of that input-record. That component may also notify a system-user or system-developer of those alternatives. That system-user or system-developer may then specify to the I-system that one or more of those alternative I-components are incorrect, and then, as predetermined, the ambiguity-resolving-component may delete those particular I-components.

Alternatively, or in conjunction with the above actions, the ambiguity-resolving-component may separately add each of those alternative I-components to an I-model consisting of a translation of the unambiguous parts of the original input-record, resulting in an alternative I-model for each of those alternative I-components. The ambiguity-resolving-component may also combine each of those alternative I-models temporarily with an existing I-model whose subject is compatible with the subject of those alternative I-models, so that each resulting combination may itself be an I-model. The ambiguity-resolving-component may initiate the operation of a LOGCON-constructing-component that performs one or more sequences of LOGCON-construction operations on each of those alternative I-models. The output-records from each of those sequences of LOGCON-constructing-operations are then added to the alternative I-model that was the subject of that sequence of operations. The ambiguity-resolving-component may then initiate the operation of one or more inconsistency-detection-operations on each of the resulting alternative I-models. If any inconsistencies are identified in any of those resulting alternative I-models, then, as predetermined, that ambiguity-resolving-component may delete the alternative I-model that was the subject of the sequence of LOGCON-constructing-operations that resulted in the detection of those inconsistencies. Alternatively, the I-system may notify a system-user or system-developer of that problem and receive from that source a specification of the action to be taken by the I-system to eliminate the problem.

If that input-record is only one in a continuing sequence of input-records to be translated and added to the same I-model, then, as predetermined, that ambiguity-resolving-component may continue adding copies of those subsequent translation-output-records to each of those alternative I-models until that sequence of additions is completed, or until the cumulative additions are sufficient to indicate which of the alternative translations are incorrect due to inconsistencies.

Alternatively, instead of constructing a separate alternative I-model for each of the detected ambiguities, the ambiguity-resolving-component may incorporate all those alternative I-components in a single I-model. In that case, each of those alternative I-components are indicated in that I-model to be alternatives, and that indication includes indications of the other alternative I-components that are alternatives to that I-component. For example, those indications may be specified by means of REV1-event-occurrence-implication-components. In addition, all those alternative I-components that were the initial output-records from those translation-operations are indicated to be such in that I-model. Those indications may be specified in the P2-components of EVS-units in those I-components, or they may be specified by some other means, such as secondary-records in that I-model. Those indications are used to identify the added I-components to be removed from that I-model when the origins of those inconsistencies in that I-model are traced by means of those indications to one or more of those initial alternative ambiguous I-components.

### 3.5.3.6 Configuration-Incompatibility-Detecting-Components

The I-system may include configuration-incompatibility-detecting-components of one or more types that identify configuration-incompatibilities between collections of I-components. A configuration-incompatibility-detecting-component is an operative-component that identifies structural incompatibilities between two collections of I-components that are constructed in accordance with the same general configurational form. Such incompatibilities mean that the combination of those two collections is out of compliance with the restrictions in that general configurational-form on the types of I-components that may be combined in a single I-model; for example, the previously-described restrictions on particular combinations of EVIR- and EVTR-units. If any such problems are detected, then that operative-component may correct those problems in that combination, such as by adding indications that various E-elements in I-components in those separate collections are I-equivalent, or by eliminating redundant I-components. Alternatively, that operative-component may notify the system-user or system-developers of those problems.

### 3.5.3.7 LOGCON-Constructing-Components

In addition to constructing I-models and their I-components by translating system-input-records, some I-components in an I-model in an I-system may be copies of operation-output-records from LOGCON-construction operations performed by LOGCON-constructing-components in that I-system. A LOGCON-constructing-component in an I-system is an operative-component that performs one or more LOGCON-construction operations. A LOGCON-construction operation is an operation that consists of constructing or identifying in an I-model in that I-system an I-template-LOGCON-correspondence-pair whose first component is matched by a combination of I-components in that I-model. Then the operative-component performing that operation constructs an output-record that is the second component of a LOGCON-relationship-pair that matches that I-template-LOGCON-correspondence-pair and whose first component is that first combination of I-components. That operative-component may then add a copy of that second combination of I-components to that I-model.

Alternatively, a LOGCON-constructing-component may search for a particular combination of I-components and then construct a combination of I-components that is the second component of a LOGCON-relationship-pair in which the first component is that first combination of I-components, i.e., without using I-template-LOGCON-correspondence-pairs. Such an operation may be restricted to a very specific type of LOGCON-relationship-pairs, such as, for example, T/INST-LOGCON-relationship-pairs, or event-occurrence-implication-LOGCON-relationship-pairs.

The I-system may include a LOGCON-constructing-component that performs a sequence of LOGCON-construction operations in which the input-record for each of those operations after the first includes a copy of the output-record from the previous operation. The I-system may also include one or more operative-components that determine the sequence in which those LOGCON-construction operations are initiated. That determination may include the identification of sequences that are more efficient in their use of the resources of the I-system and in the times required for those operations to be performed. A LOGCON-construction operation may be initiated by different operating-components as part of their performance of operations of various types, for example. as part of a search-operation, as described later.

In a purely representational I-model, the I-units and I-components may be constructed in such a way that the LOGCON-constructing-components are permanent components of the same components in which the I-units and I-components are located. Each such operative-component is closely interconnected with the components of that combination of I-units or I-components upon which it operates. In such systems, the LOGCON-constructing-components may be continuously operative, with their input-records consisting of the configurational states of those components with which they are interconnected. The output-records of such an operative-component consist of new I-components or additions to existing I-components. For example, such an addition may consist of the indication of an occurrence-state for a T-element or EV-element, and thus is a new EVS-unit. In such systems, if such an output-record is inconsistent with an existing I-component, then the system-component containing that existing I-component may automatically produce a signal that initiates a notification of the system-user or system-developer of that conflict, or that signal may initiate the operation of a component that resolves that problem. Such a LOGCON-constructing-operation may be performed by a machine-learning operative-component by means of a network of interconnected components whose configurational states indicate LOGCON-relationships.

The I-system may initiate a LOGCON-construction operation after a new I-model has been constructed, or new I-components have been added to an existing I-model. The input-records to that operation include copies of one or more of those new I-components, as well as one or more of any previously-existing I-components. Similarly to the TRANS-construction-operations described in the earlier section, a LOGCON-construction operation may result in the addition to an I-model of a new I-component that results in one or more problems, such as inconsistency with an existing I-component in that I-model. In order to detect and resolve such problems, the I-system may initiate an operation of one or more of the types described in that earlier section.

As part of its operation in constructing a LOGCON-relationship-pair, a LOGCON-constructing-component may also construct a LOGCON-type-indicator in each of one or more EVS-units in the second combination of I-components in that LOGCON-relationship-pair. Those LOGCON-type-indicators indicate the type of that LOGCON-relationship-pair.

Mathematical calculations are specialized types of LOGCON-construction-operations, and some LOGCON-constructing-components may perform such calculation operations. Some of those operative-components may calculate measurements that are instances of a fixed-entity-relationship-type that is a type of measurement of the fixed-entity in the definition of that relationship-type. Some of those operative-components may determine statistical information, such as the number of instances of a specified type-entity that are indicated in an I-model. Some of those operative-components may calculate probabilities of one or more events represented in an I-model. Those operative-components may specify those calculated probabilities in the P3-components of the EVS-units that represent those events.

If a T-element in an I-model is D-determinable, then the I-system containing that I-model may include LOGCON-construction-components that operate on one or more I-components in that I-model to automatically determine a T-specification for that T-element.

### 3.5.3.8 Inconsistency-Detecting-Components

The I-system may include one or more inconsistency-detecting-components. An inconsistency-detecting-component is an operative-component that identifies inconsistencies between what two collections of I-components represent about the subject of the I-model containing those I-components. The range of different possible types of inconsistencies is unlimited. For example, one type of possible inconsistency is that of two T-specifications that specify different, incompatible type-structures for the same type-entity. Another possible inconsistency is that of EVS-units for the sane EV-element that specify conflicting occurrence-states for the event represented by that EV-element. If any such problems are detected, then that operative-component may correct those problems in that I-model, or may notify the system-user or system-developers of those problems. For example, if any of those inconsistencies consists of indications by different EVS-units that an event is both occurrent and non-occurrent, then that operative-component may correct that inconsistency by replacing either or both of those EVS-units by REV1-components that indicate that that specified occurrence- or non-occurrence-state of that event is relative to the information from a specified source, or is relative to the belief or opinion of some person.

In some I-models, inconsistent EVS-units for the same event may be maintained in those I-models. In such cases, LOGCON-operations may not be performed on I-components in those I-models. Alternatively, separate LOGCON-operations of the same type may be performed for each of those inconsistent EVS-units. If those LOGCON-operations produce the same results, then those results may be added to the I-model. If those LOGCON-operations produce new conflicting EVS-units, then those may also be added to that I-model. The system-developers determine the procedures to be followed by the I-system in such cases; those procedures are determined by practical considerations such as efficiency and the particular uses to be made of that I-model.

### 3.5.3.9 Circular-EV-Dependency-Detecting-Components

An I-system may include a circular-EV-dependency-detecting-component that can automatically check for circular-EV-dependencies and notify the persons responsible for that I-model when any such circular chains are found, so that they may be corrected. Such an automatic check may be incomplete if some of the T-elements in an I-model are not D-determinable, in which case the system-developers who specified that I-model may manually check for circular-EV-dependencies.

### 3.5.3.10 E-Equivalence-Detecting-Components

The I-system may include one or more E-equivalence-detecting-components. An E-equivalence-detecting-component is an operative-component that performs a combination of operations that may result in a determination that two specified E-elements in the same, or different, I-models may be, are, or are not, E-equivalent and, hence, correspondingly, may, do, or do not, represent the same entity. That operation may proceed as follows. The input-record for that operation consists of copies of those E-elements that represent those entities. First, if those E-elements are in different I-models, then that operative-component initiates an I-model-construction-operation that combines those two I-models and specifies that those E-elements are E-equivalent. Then that E-equivalence-detecting-component may initiate the operation of a LOGCON-constructing-component on that combined I-model. That LOGCON-constructing-component may construct combinations of I-components that, in combination with the other I-components in that combined I-model, may contain inconsistencies due to those E-elements being specified as E-equivalent. Then that E-equivalence-detecting-component then initiates an inconsistency-detection-operation on that combined I-model. If any inconsistencies are found, then those E-elements are re-specified as being not E-equivalent. If no inconsistencies are detected, then the specification of those E-elements as being E-equivalent is removed from that combined I-model. Then a LOGCON-construction operation may be initiated that may result in those E-elements being determined to be E-equivalent. If so, then the inconsistency-detecting-operation is terminated and that E-equivalence-detecting-component adds to that I-model a specification that those E-elements are E-equivalent.

### 3.5.3.11 Complex-I-Component-Detecting-Components

The I-system may include one or more complex-I-component-detecting-components. A complex-I-component-detecting-component is an operative-component that examines a collection of I-components in an I-model and identifies I-components that are relatively complex and can be replaced by I-components that are structurally-simpler but are I-equivalent to those first I-components. That operative-component may employ one or more complex-I-template/simple-I-template-EQUIV-correspondence-pairs in performing that operation. In that case, that operative-component first identifies an I-component in that collection of I-components such that that I-component matches that first I-template, and then constructs a second I-component such that that first-I-component/second-I-component pair matches that complex-I-template/simple-I-template translational-correspondence-pair.

### 3.5.3.12 Index-Constructing-Components

The I-system may include an index-constructing-component. An index-constructing-component is an operative-component that performs an index-construction-operation on an I-model, or on additions to an I-model that has previously been indexed. That operative-component constructs, or adds to, a secondary-record that is an index to that I-model. That secondary-record may consist of an alphanumeric index to names of entities indicated by REV1-name-components, or other means, in that I-model. That index indicates the locations in that I-model of the E-elements that represent those named entities.

### 3.5.3.13 Record-Comparing-Components

An I-system may include one or more record-comparing-components. A record-comparing-component is an operative-component that compares two records and identifies pairs of components of those records that indicate the same things, or inconsistent things, about the subject of those records. If either or both of those records is not an I-model, then the I-system first translates it to an I-model before performing the comparison operation.

### 3.5.3.14 I-Model-Searching-Components

An I-system may include one or more I-model-searching-components. An I-model-searching-component is an operative-component that searches an I-model to determine if that I-model includes one or more particular combinations of I-components. The input-record for that search-operation is a search-specification-record. A search-specification-record indicates the structural form of the I-components that are the object of the search-operation. In addition, if there is more than one I-model in the I-system, then that input-record may indicate which of those I-models are to be searched. That input-record may also indicate additional determinations to be made by the operative-component that performs that search-operation. That input-record may also indicate the types and forms of the output-records for that operation. That input-record may be specified by another operative-component in the I-system, or it may be a translation of a system-input-record provided to the I-system by an external system-user.

The range of possibilities for such operation-output-records is determined by the types of search-operation-components that are available, or may be constructed, in that I-system. In general, there is an unlimited range of possible types and forms of search-operation output-records, of which the following are a few examples.

A search-operation output-record may indicate that one or more I-components of the form specified in the search-specification-record are, or are not, present in the I-models that are searched. That output-record may also include copies of those I-components that have been found. It may also include an indication of the number of I-components that have been found that each have the specified form.

The specific operations performed by a search-operation-component in performing a search-operation are those that are designed to efficiently find the I-components that are the object of that search-operation. The specific forms of those operations may vary according to the types of I-components to be found.

In performing such a search-operation, a search-operation-component may examine one or more I-indexes and secondary-indexes present in the I-system to identify the locations of particular I-elements, such as E-elements, T-elements, and RT-indicators of particular types. That search-operation-component may use secondary-records that indicate I-equivalences between I-elements, each of which may be examined by that search-operation-component. That search-operation-component may initiate the operation of one or more LOGCON-constructing-components that may construct new I-components in the I-model that are subsequently employed in that search-operation. That search-operation-component may initiate a combination of multiple search-operations by different search-operation-components that each perform a particular type of search-operation whose output-components are used by that first search-operation-component in performing additional operations.

That search-operation-component may employ one or more templates that indicate the structural form or the configurational type of the I-components to be searched for. Those templates may be translated from the component of the search-specification-record that indicates the structural form or configurational-type of those I-components. Those templates may include components that indicate specific components of those I-components that are to be included in the search-operation output-record, since not all components of the I-components that are found may be needed for the intended use of that output-record. That search-operation-component searches the I-model for combinations of I-components that match those templates.

A system-input-record that indicates a search-specification may also include one or more additional I-components of which copies are to be added temporarily to the I-model while the search-operation is being performed. An example of such additional I-components is one or more EVS-units that indicate various occurrence-states that are not currently included in the I-model.

A search-operation-component may be guided by a system-user in performing a search-operation. That search-operation-component may present in the system-input-interface a representation of part of the I-model to be searched. That representation may be graphical. The system-user adjusts the position of a cursor in that representation. The search-operation-component translates that position to the corresponding location of one or more E-elements in that I-model. That component then identifies the I-components in that I-model that include E-elements that are E-equivalent to those first E-elements. That component then adjusts the representation in the system-input-interface to include representations of those I-components. That process is repeated as the system-user repeatedly adjusts the position of the cursor.

In addition to searching one or more I-models in the I-system, the search-operation-component may also initiate searches of I-models in other I-systems, and searches of records of other types in other record-systems. The search-operation-component may combine the results of those searches.

There is an unlimited range of types of possible types of search objectives that may be specified in a search-specification-record and for which the I-system includes an I-model-searching-component. The following are some examples of such search objectives:
(A) all I-components that include an E-element that is E-equivalent to a specified E-element;
(B) all REV-components that have an initial- or terminal-E-element that is E-equivalent to a specified E-element;
(C) a measurement of a specified type of a specified entity;
(D) all IEV-components that have a primary-T-element that represents a specified type-entity;
(E) all E-elements that represent instances of a specified type-entity; that search may include the operation of finding all E-elements that are indicated to be the INST-elements in IEV1-components whose primary-T-elements represent that type-entity;
(F) E-elements that represent a specified number of instances of a specified type-entity;
(G) whether or not a specified type-entity represented in an I-model has any instances;
(H) the type-entities of which a specified entity represented in an I-model is an instance;
(I) all relationships of a specified type of a specified entity represented in the I-model;
(J) all relationships of a specified entity represented in the I-model;
(K) all entities having a specified measurement of a specified type that are represented in the I-model;
(L) determine if an entity described in the search-specification-record is represented by any E-element in the I-model;
(M) conditions for the occurrence, or the non-occurrence, of a specified event represented in the I-model;
(N) conditions under which a specified event represented in the I-model does not occur;
(O) whether or not a specified event is indicated in the I-model to be occurrent;
(P) events that occur, or do not occur, if a specified event represented in the I-model occurs; and,
(Q) the entity represented in the I-model that most closely matches a particular entity described in the search-specification-component.

The I-system may include one or more search-operation-components that each perform searches having as objectives one or more of the above-listed types, or other types not listed above.

### 3.5.3.15 Actions on External Computer-Based Records

An I-system may be operatively-coupled with one or more other computer-based record-systems. That I-system may initiate actions by such systems and receive records that indicate the results of those actions. Such actions may include search-operations on those records. One or more of those other computer-based record-systems may be I-systems in which the records to be operated on are I-models.

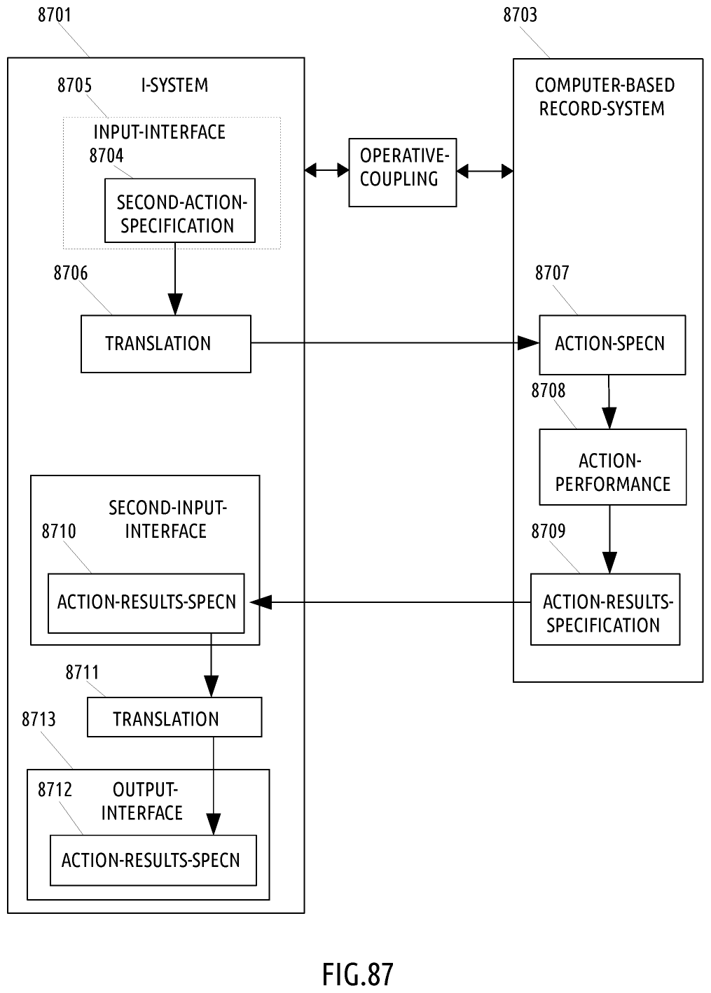

FIG. 87 shows such a combination of an I-system 8701 operatively-coupled 8702 with one other computer-based record-system 8703. The I-system receives action-specifications 8704 in an input-interface 8705. Such an action-specification may be a specification for a search of one of the same types previously-described for search-operations on I-models. That I-system translates 8706 that action-specification to one or more operational forms 8707 that are employed by the operative-components in that other system. That other system performs 8708 the specified actions and then specifies the results in an action-results specification 8709 a copy 8710 of which is communicated to the I-system. The I-system translates 8711 that action-results specification to a form 8712 employed by that I-system in its output-interface 8713. The I-system may also initiate the performance of additional operations on that received action-results-specification, such as aggregating them into a single I-model and initiating the operation of operative-components that check for problems of the types described previously for I-models, such as inconsistencies.

The action-specification may include an indication of the specific computer-based-records in that other system to be searched or operated upon. Alternatively, the I-system may determine the identities of the particular records to be operated upon in the other system. In making that determination, that component may use an I-index, or indexes of other types in that I-system, that are indexes to those other computer-based records.

### 3.5.3.16 Dynamic-I-Model-Monitoring-Components

The I-system may include one or more dynamic-I-model-monitoring-components. A dynamic-I-model-monitoring-component is an operative-component that identifies changes of specified types to an I-model in a specified sequence of I-models in a dynamic-I-model. That dynamic-I-model, and the types of changes to be identified, are specified by system-users. Such changes may include, for example, changes in the occurrence-states of specified events, or the addition to that I-model of new I-components of a specified type. When such a change is identified, that operative-component performs one or more operations of types that were previously specified by system-users to be performed in that situation. Such operations may include notifying those system-users, or other specified persons or computer-systems.

### 3.5.3.17 Reporting-Components

The I-system may include one or more reporting-components. A reporting-component is an operative-component that constructs a report for specified system-users when a specified event occurs, as indicated by a change in some aspect of what is represented in a dynamic-I-model. Such events may include, for example, the occurrence of regular times previously specified by system-users, the occurrence of an event identified by a dynamic-I-model-monitoring-component, or the addition of new information to an I-model. The types of information to be included in such reports are also previously specified by system-users. Such information may include information of specified types that is represented in that dynamic-I-model.

### 3.6 Types of I-Systems

The functional-capabilities of a particular I-system are determined by a number of different factors. Those include the range of functional types of the primary-operative-components in that I-system; the particular subjects, and aspects of those subjects, that are represented in the I-models in that I-system; and the functional capabilities of the system-user/I-model-interaction-components in that I-system. In particular, the range and types of the available LOGCON-operative-components and translating-components may very significantly affect the range of functional-capabilities of the I-system.

A general-purpose I-system may include all of the operative-components described above, as well as others that perform the basic standard operations that are employed in other computer-based record-systems. Alternatively, a particular I-system may be a special-purpose I-system that is constructed to efficiently perform a restricted range of operations on I-models having a restricted range of subjects, or of aspects of those subjects. Some examples of such specific types of specialized I-systems are:
(A) an information system that is restricted to constructing, storing and searching I-models, and does not perform any LOGCON-operations;
(B) a static-systems-modelling system; such static systems may include any systems whose basic structures remain fundamentally unchanged over time, such as a buildings, machines, and many organizations;
(C) a dynamic-systems-modelling system; such dynamic systems may include any systems whose attributes change over time;
(D) a systems-analysis system for static- or dynamic-systems; that I-system performs LOGCON-construction operations on an I-model that represents that static- or dynamic-system, to identify aspects of that system of the types specified by those system-users, such as, for example, the estimated cost of constructing a system represented in that I-model;
(E) an event-analysis system; that I-system employs LOGCON-operations to identify causes and consequences of events represented in an I-model contained in that I-system.
(F) a cost/benefit-analysis system that identifies costs and benefits of actions that may be performed by a person or an organization;
(G) a decision-analysis system that provides a means for system-users to analyze decisions between two or more possible alternative actions or events. Those possible alternatives may be identified in a variety of ways. For example, they may be specified by the system-users. Alternatively, those system-users may specify a possible event to be induced, and the decision-analysis-component may initiate an event-analysis-operation to identify possible alternative actions and events that may induce that possible event. After those possible alternatives are identified, the decision-analysis system initiates an event-analysis-operation for each of those possible alternative actions or events. That event-analysis-operation may include a cost-benefit-analysis-operation.
(H) a planning system, that identifies objectives and the events that potentially result in those objectives;
(I) an expert system, whose I-models are restricted to particular subjects and whose operative-components include particular types of LOGCON-constructing-components;
(J) an index and query-system, or portal, for other types of computer-based record-systems, including, for example, the Internet/World-Wide-Web;
(K) a word-processing system that automatically translates the text provided by a system-user to an I-model, while that system-user progressively inputs that text, and simultaneously checks the resulting I-model; alternatively, the I-system may simultaneously translate that I-model to a record that has a simple structured form that is human-readable and can be easily checked by the user for accuracy; that user may notify the system of any problems found and the system may then correct that I-model;
(L) an integration-system that integrates disparate computer-based record-systems, by means of translation between records in those systems and a single uniform system-user/I-model-interaction-component;
(M) an access-system or portal that provides a single simple means of access to records of various types other than I-models in various subsystems of the computer-system; that access-system may translate action-specifications and outputs to and from the forms employed by those subsystems;
(N) a translation system, that translates between records of different configurational types, including different natural languages;
(O) a supporting-information system in a device/machine that performs other functions, such as a robotic manufacturing line;
(P) an audio-visual-pattern-identification system in which the I-model specifies the information that supports and enables those pattern-matching processes; or,
(Q) an artificial-intelligence system for an autonomous system such as a robot. That is an I-system with a dynamic-I-model in which operative-components monitor changes in that I-model and initiate responses by that autonomous system; such responses may be predetermined responses or as determined by a decision-analysis sub-system of the I-system; that decision-analysis sub-system may also include a consequence-analysis sub-system that identifies consequences of changes in the I-model and compares those with I-components in that I-model that indicate the objectives of the autonomous system to identify successes, failures, or incomplete actions.

### 3.7 Constructing I-Systems

I-systems, including the I-models that they contain, are constructed by operative-components in computer-systems, as directed by systems-developers, in the same general manner as computer-based record-systems of other types within computer-systems of those same types. Alternatively, an I-system may be a computer-system that is designed and constructed to function specifically as an I-system, as determined by systems-designers employing the same general methods as for designing computer-systems in general. The construction of an I-system may proceed incrementally over time during its period of use, particularly as I-models and primary-operative-components are added or expanded in that I-system. I-systems may be designed and constructed by systems-designers and systems-developers employing the same general skills as for computer-systems and computer-based record-systems in general.

An I-system of a specialized type, such as a cost-benefit-analysis system, is developed by the system-developers by first determining what specific types of information are needed as outputs by that system to system-users. Then the types of information that need to be provided as inputs to that system in order for the system to be able to produce the specified outputs are determined. Then the operations that are needed to be performed by the system on the records of those inputs in order to produce those required output-records are determined. The I-system is then developed to receive such inputs, operate upon them, and provide the specified outputs to the system-users.

### 3.8 Using I-Systems

I-systems are used by system-users in the same general manner as computer-based record-systems in general. Specifically, a system-user provides an input-record to the I-system that indicates what actions are to be performed by that I-system. That input-record may include, or be accompanied by, one or more records, or indications of records to be used by the I-system in performing those specified actions. The I-system may also provide one or more output-records to the system-user; those output-records may specify the results of those actions.

### 3.9 Advantages of I-Systems Compared to Other Computer-Based Record Systems

Since I-systems have I-models as their primary-records, those I-models provide within those I-systems all the advantages described earlier for I-models compared to primary-records of other types in other computer-based record-systems. For example, those I-models enable simpler and more comprehensive automatic operations to construct subject-indexes and logical-consequences and to translate between records of various types, including I-models. Such capabilities enable I-systems to be the foundation of integrated computer-based record-systems, with greatly simplified access by system-users.

### 3.9.1 General-Purpose Computer-Based Record-Systems

By means of the use in I-systems of I-models for specifying any aspects of any subject, and the employment of operative-components that perform various subject-related operations of an unlimited range of types on those I-models, an I-system may function as a general-purpose computer-based record-system whose capabilities can be expanded incrementally over time.

3.9.2 I-Systems that are Components of Larger Systems

Alternatively, an I-system may be constructed to function within a larger computer-system, or computer-based record-system, as the means by which that larger system functions as a fully-integrated record-system. That is accomplished in various ways such as: that I-system containing the user-interface components for the larger system; that I-system providing translation between different structural-types of records in that larger system and also between that system and the user-interfaces; that I-system including one or more I-models that are subject-indexes to the records in that larger system; and that I-system translating user-requests for operations to be performed by operative-components on various records in that larger system, including logical-consequence operations and search operations. By such uses of I-systems, any combination of any number of different types of computer-based record-systems can be converted to what is, in effect, a single universal computer-based record-system, thereby greatly simplifying the use of such a combination of systems.

### 3.9.3 Specialized Functions

I-systems may alternatively be constructed to have specialized functions of an unlimited ranges of types, as described in section 3.6. Such specialized I-systems may be included in larger I-systems or other computer-systems. An example is that of I-system whose primary-record is an I-system-model within a larger I-system or other computer-system.

### 3.9.4 Purely Representational I-Models

I-systems also have the advantage that the primary components of the I-models in them may be of such configurational forms that those I-models can be stored and processed in computer-systems in which the underlying memory and processing components are of a form that permits those I-models to be purely representational in their structures, thus eliminating the need for I-equivalences between E-elements; for example, in computer-systems whose memory components are connected in a physical network structure. That enables much faster and more effective searching. Also, if the basic logical-consequence-constructing-components are directly interconnected with those memory components (e.g., in an FPGA-based system), then that logical-consequence-construction can function much more rapidly.

### 3.9.5 Enable More Effective and Efficient Design and Use of Computer-Based Records

I-systems enable organizations and individuals to function more effectively and efficiently in designing and using computer-based records; that also reduces the costs of constructing and modifying those records and the systems containing them.

### 4.0 I-IMPROVEMENTS

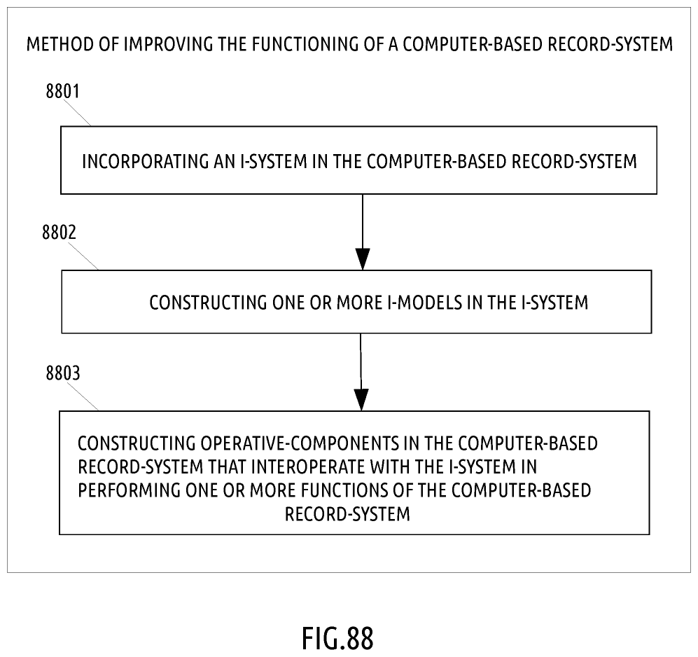

As described in section 1.0, and as shown in FIG. 88, an I-improvement to a computer-based record-system comprises the inclusion in that record-system of one or more I-systems 8801 in which are constructed 8802 I-models that supplement or replace one or more existing primary-records in that record-system. Operative-components are added 8803 to that computer-based record-system that interoperate with those I-systems in performing one or more operations in that record-system.

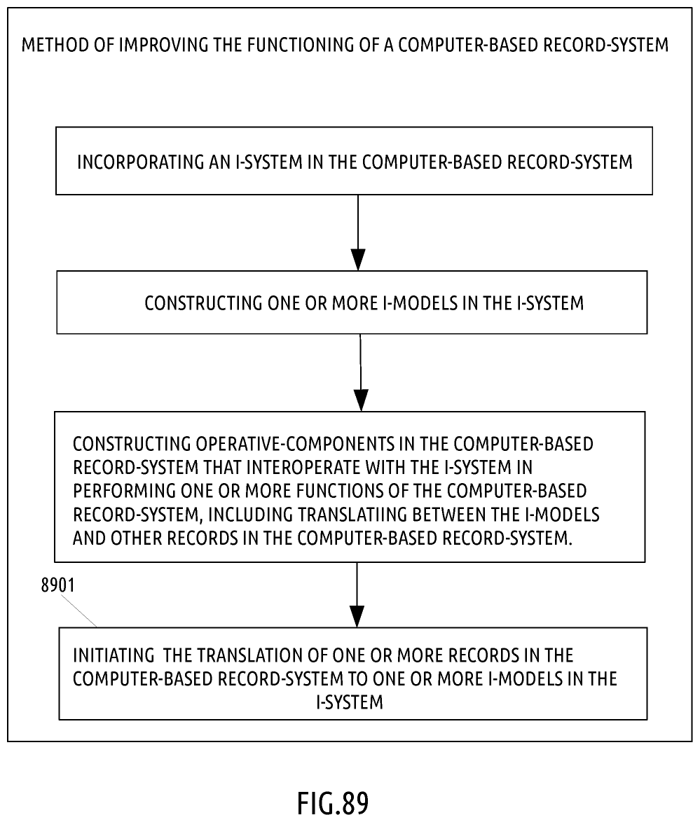

As shown in FIG. 89, such an improvement may also include translating 8901 one or more of the records in that record-system to one or more I-models in that I-system. In a case where all such records are translated to I-models in that I-system, then that I-system may replace that other record-system. Alternatively, that I-system may replace one or more subsystems of that record-system, such as the input- and output-interfaces, as described in section 3.1 and shown in FIG. 80.

The construction, use, and advantages of I-improvements are as described earlier for I-models and I-systems.

### 5.0 CONCLUSION

Thus, the reader will understand that some embodiments of I-models provide a more universal, comprehensive, simpler, amd more useful type of record for storing information, and for performing subject-related operations on such records in computer-systems.

The above description of embodiments is specific enough to enable a person with skill in the art to determine the additional details for constructing those embodiments.

While the above description contains many specifics, these should not be construed as limitations on the scope of possible embodiments, but rather as examplifications of several embodiments thereof. For example, the description includes examples of some types of possible components of I-models that may not be present in some embodiments. The description also includes examples of additional features that may be present in some embodiments. The description also includes examples of possible variations between different embodiments in the structures of various types of components of I-models, such as I-units and I-components. However, those examples of some differences between embodiments should not be construed as a complete listing of such possible differences between embodiments, including variations in the types of computer-based records, and also in the types of computer-based record-systems and computer-systems containing the embodiments.

Accordingly, the scope of the disclosure should be determined not by the embodiments illustrated, but by the appended claims and their legal equivalents. Those with skill in the art will identify many other possible variations between embodiments.

### 6.0 GLOSSARY OF TERMS DEFINED IN THIS SPECIFICATION

Most of the entries in the following glossary are followed by the number of the section where the applicable term is defined. Where there is no such reference, the glossary entry constitutes the definition of that term. In some cases, the glossary entry repeats the definition previously described in the main part of this document.

Absolute-relative-translating-component: (3.5.3.4.9).

Action-specification-records: An ‘action-specification-record’ is a record that indicates one or more operations to be performed by the computer-system on records in that system, such as the construction of particular records to be presented in system-output-interface-components.

ADDNSUBT-relationship: An ‘ADDNSUBT-relationship’ from one T-element to another exists when that second T-element has a T-specification that includes a T-component that is identical to the T-specification of that first T-element.

Ambiguity-resolving-component: (3.5.3.5).

Base-primary I-component: A ‘base-primary I-component’ is an I-component in which all the I-units are base-primary I-units.

Base-primary I-unit: A ‘base-primary I-unit’ in an I-model directly indicates a state or relationship of a particular entity in the subject of that I-model.

Basic-entity: A ‘basic-entity’ is any entity other than a type-entity or an event.

Basic-entity-element-template: (3.4.1 and 3.4.3).

Bidirectional-translating-component: (3.5.3.4.4).

Circular-EV-dependence: A ‘circular-EV-dependence’ between two EV-elements is a combination of I-components that indicates that each of those EV-elements is EV-dependent on the other.

Clock-time-RT-indicator: A ‘clock-time-RT-indicator’ is the RT-indicator in an REV1-clock-time-component.

COMPADDNSUBT-relationship: A ‘COMPADDNSUBT-relationship’ consists of a combination of co-related ADDNSUBT-relationships for which every T-component for the terminal-E-elements is identical to a combination of one or more T-components of the initial-E-elements in those relationships.

Complex-I-component-detecting-component: (3.5.3.11).

Complex-I-template/simple-I-template-EQUIV-correspondence-pair: (3.4.6).

Component: A ‘component’ of an entity, as that term is employed throughout this specification, may be all, or any part, of that entity. Thus, for example, the whole entity is a component of itself, and any combination of components of that entity is a component of that entity, whether or not those components overlap, or are structurally demarcated, or are physically separated from each other by other components of the entity. In some cases there is no clearly-demarcated boundary between a component and adjacent components. In most cases, components themselves have components. Furthermore, one or more components of an entity may be temporary components of that entity, in which case the composition of that entity varies over time.

Each component of an entity may itself consist of a combination of two or more components that have structural relationships between those components. In addition, there may be structural relationships between the structures of different components of that entity.

Comprehensive subtypes: A group of subtypes for a type-entity is ‘comprehensive’ if the properties specified in the type-specifications for those subtypes are such that every possible instance of that type-entity must be an instance of at least one of those subtypes.

Computer-based record: A ‘computer-based record’ is a computer-operative record that is stored in a computer-system and may be directly operated upon by one or more of the operative-components in that system.

The primary-configuration of a computer-based record may contain one or more combinations of components whose structural inter-relationships are an integral part of the specification contained in that record. Such inter-related components may be linked by physical adjacency or by indicators that indicate their relative locations within that record.

Computer-based record-system: A ‘computer-based record-system’ in a computer-system is a system whose primary function is to operate on one or more computer-based records in that computer-system. That computer-based record-system may be the entire computer-system, in which case the primary function of that computer-system is to construct, store, and operate on the records it contains. Alternatively, that computer-based record-system may be a sub-system of that computer-system, in which case that computer-based record-system performs a supporting role within that computer-system. Operations performed on records by operative-components in computer-based record-systems may be subject-related or non-subject-related.

Types of computer-based record-systems include, for example, flat-file systems, database-management systems, information systems, knowledge-base systems, inferential database systems, expert systems, artificial-intelligence systems, and new types that may be developed. Some of those may be developed specifically for storing and operating on records that are I-models.

A computer-based record-system may be a component of a larger computer-based record-system that consists of multiple operatively-connected computer-based record-systems, such as, for example, the World-Wide-Web. In some cases, a computer-system may be a component of a larger computer-system that includes components that can operate on records of different configurational types.

Computer-operative record: A ‘computer-operative record’ is a record that is constructed by a computer-system. Such records may be present temporarily or stored permanently in computer-systems, or in separate storage devices of various types. A computer-system constructs a computer-operative record by configuring the record-configurable-component for that record.

Computer-system: A ‘computer-system’ is a physical device or machine whose primary functions are to receive records as inputs in one or more system-input-interface-components, translate those records to computer-operative records that may be stored in that system, store (perhaps temporarily) those computer-operative records, operate in various ways upon the configurations of those records by means of one or more operative-components in that system, and, as determined by the results of those operations, construct or modify system-output-records in one or more system-output-interface-components. Computer-systems range in size from very large combinations of many operatively-interconnected computers down to very simple processors that receive inputs from external devices and translate those inputs to records that are transmitted to other devices for storage or further processing.

A computer-system may include operative-components that perform various operations that manage, support, and enable the maintenance of records in the system and the operation of primary-operative-components upon those records. Examples of such supporting operative-components include those that manage, initiate, monitor, and terminate the operation of the system; those that control the overall operation of the system by managing which operative-components may be functioning at a particular time; those that perform initial operations on system-input-records to determine what operations should be taken in response to those inputs, including any action-specification-records in those inputs; and those that enforce the security of computer-based records including rights of various system-users to access those records.

Some operations performed by computer-systems are performed in response to requests by human users of those systems. Others are performed in response to requests from external computer-systems. Other operations are performed automatically when predetermined events occur within the system, such as updating a record with new information. The computer-system may also include a record that identifies those operative-components in the system that may be initiated, or otherwise directed, in their functioning by human or non-human users of the system.

A computer-system may have various components added or removed at various times, so that its structure changes over time. For example, a record-configurable-component may be operationally-connected with an operative-component that configures that record-configurable-component, thereby resulting in a computer-operative record. Subsequently, that record may be disconnected from that operative-component, and may subsequently be connected to another operative-component that copies the configuration of that record to a system-output-interface component for access by system-users.

A computer-system may be a component of a larger computer-system, either temporarily or permanently. A computer-system may have components that are computer-systems that are in different locations but are interconnected in a network. Computer-systems range from very simple ones that perform a single operation on a single record, to very complex systems that consist of many operatively-connected computer-systems; for example, the World-Wide-Web, with all the computers, storage devices, and other devices and systems connected to it at any given time.

Some computer-systems control processes such as production lines or the operation of various machines, devices, and other physical systems, including those involving human actions, such as, for example, package-delivery systems. A computer-system may be located in a machine or device that performs a particular function. An example is that of an electronic measurement-device that contains a computer-system that records or transmits the measurements made by that device. Many computer-systems are computer-based record-systems whose primary function is to store and process records for system-users to access.

Computer-systems may be contained in various types of devices, such as, for example, general-purpose digital-computer-systems, special-purpose computer-systems, electronic processors, measurement devices, ASIC-based systems (‘application-specific-integrated-circuit’), FPGA-based systems (‘field-programmable-gate-arrays’, and computer-systems containing networked components designed to function similarly to human cognitive neural-networks. Computer-systems may be of any combination of current or future physical types, such as electronic, electro-magnetic, optical, and quantum-mechanical. Some computer-systems may be hybrid combinations of sub-systems of different types that perform different coordinated functions within those overall systems. In computer-systems that include record-storage components that have a network structure, the records stored in those components may be purely representational, while others in the same system may be typical non-representational, or hybrid, digital-computer records that are translated to or from those purely representational records.

The specific forms and methods of functioning of the operative-components in a computer-system are determined partly by the nature of the functions performed by those components and partly by the type of underlying system. For example, the operative-components in an artificial-intelligence system may have quite different forms and methods of operation compared to those in a typical digital-computer system.

Configuration: The ‘configuration’ of a record consists of the combination of the configurations of its primary component, its configuration-identification components, and its secondary-record components, if it has such. The configuration of that primary component determines the specification contained in that record; that ‘specification’ indicates, or specifies, the information about the subject of that record.

Configuration-incompatibility-detecting-component: (3.5.3.6).

Configurational type: The ‘configurational type’ of one or more records consists of a specification of the particular type of configurational form employed in constructing those records. For example, all records constructed using the same human language are of the same configurational type. However, two records of the same configurational type may be of different subtypes of that configurational type. For example, all relational databases in computer-systems have the same general form, and, hence, are of the same general configurational type. However, specific details of the structures of those databases may vary, so that they are of different specific subtypes of that general configurational type.

Configurational types of records may be developed and specified in different ways. Some configurational types employed in computer-based record-systems may be formally specified by standards organizations. At the other extreme, the particular configuration-type for a particular computer-based record may be determined informally and uniquely by the system-developers for that particular record.

Configuration-identification component: A ‘configuration-identification component’ of a record is a record that indicates information about the internal structural configuration of the primary component of that first record. Examples of such information include indications of the sizes or relative locations within the primary component of various components of that primary component; for example, the table of contents of a book. Blanks in natural-language text are configuration-identification components that enable readers to identify separate words. In electronic computers, some parts of the configuration-identification components are interspersed with the components of the primary record. Such information is used by the system or person accessing the record to identify, distinguish, or locate various components of the primary component.

Since a configuration-identification component of a record is itself a record, it may have a primary component, configuration-identification components, secondary-record components, and supporting components.

CONTRAT-relationship: A ‘CONTRAT-relationship’ between two T-elements indicates that the type-entity represented by one of those T-elements is a contratype of the type-entity represented by that other T-element.

Contratype: A ‘contratype’ for a type-entity is a type-entity whose type-structure specifies that the instances of that contratype are all those entities that are not instances of that first type-entity.

Co-relationship-specification-completeness-indicator: A ‘co-relationship-specification-completeness-indicator’ is a T-specification-status-indicator in a T-specification-status-unit that indicates that the I-model includes a co-relationship-indicator-unit for each instance-event in a combination of co-related instance-events such that every instance-event that is co-related with the instance-events in that combination is included in that combination.

Co-relationship-indicator-element: A ‘co-relationship-indicator-element’ is a T-element that is the P1-component of a co-relationship-indicator-unit.

Co-relationship-indicator-units: A ‘co-relationship-indicator-unit’ is an I-unit that indicates a relationship of a particular type that is co-related with one or more other relationships of that same type, as indicated by a particular combination of co-relationship-indicator-units.

Co-relationships: ‘Co-relationships’ are co-incident relationships, that is, they occur together under the applicable specified circumstantial-conditions. In some cases, some relationships may be co-related under all circumstantial-conditions.

Co-relationship-type-indicator: A ‘co-relationship-type-indicator’ is the P2-component of a co-relationship-indicator-unit; it indicates a particular type of co-relationship.

Co-related-type-instance-relationship-type-indicator: A ‘co-related-type-instance-relationship-type-indicator’ is a co-related-relationship-type-indicator that indicates that the specified co-relationships are events consisting of specified entities being instances of specified type-entities in a specified type-structure.

Correspondence-pair: The ‘correspondence-pair’ for a particular relationship between two entities consists of the pair of entities in which the first entity in that pair is the initial-entity in that relationship, and the second entity in that pair is the terminal-entity in that relationship.

D-determinability: A T-element in an I-model in an I-system is ‘D-determinable’ if that I-model contains a T-specification for that T-element or if there is a combination of I-components in that I-model that may be employed by operative-components in that I-system to construct a T-specification for that T-element.

Definitional-dependence: An event is ‘definitionally-dependent’ on another event if the definition of that first event includes the definition of that second event.

Descriptive record: A record is ‘descriptive’ if it specifies information by means of encoded symbols, such as text in natural-language documents. For example, a printed text document without any diagrams or illustrations is a descriptive record, while a photograph is a representational record.

Determinable-T-specification-indicator: A ‘determinable-T-specification-indicator’ is a T-specification-status-indicator in a T-specification-status-unit that indicates that the complete type-structure for the type-entity represented by the P2-component of that unit can be determined by means of automatic LOGCON-construction operations performed by the I-system on a combination of T-components in the I-model that contains that unit.

DISJT-relationship: A ‘DISJT-relationship’ from one T-element to another indicates that the type-entity represented by that second T-element is a disjunction of the type-entity represented by that first T-element.

DISJSUBT-relationship: A ‘DISJSUBT-relationship’ is a relationship from a T-element to another T-element such that that second T-element represents a type-entity whose type-specification is identical to one of the disjunctive components of a disjunctive type-entity represented by that first T-element.

Disjunction: One type-entity is a ‘disjunction’ of another type-entity if the type-structure for that first type-entity indicates that its instances are all those entities that are instances of any one or more, but not necessarily all, of the independent components of the type-structure for that second type-entity.

Dynamic-I-model: A ‘dynamic-I-model’ is a time-based sequence of I-models.

Dynamic-I-model-constructing-component: (3.5.3.3).

Dynamic-I-model-monitoring-component: (3.5.3.16).

EB-element: An ‘EB-element’ (‘basic-entity element’) in an I-model is an E-element that represents a basic-entity in the subject of that I-model.

E-element: An ‘E-element’ (‘entity-element’) in an I-model is a representative of an entity in the subject of that I-model. There are three types of E-elements: T-elements, IEV-elements, and EB-elements.

E-element-template: (3.4.1 and 3.4.3).

E-equivalence: Two or more E-elements are ‘E-equivalent’ if they indicate or represent exactly the same entity. Every E-element is E-equivalent to itself.

E-equivalence-detecting-component: (3.5.3.10).

E-equivalence-indicator: In an I-model, an ‘E-equivalence-indicator’ is a component that indicates that two particular E-elements are E-equivalent.

E-equivalence-record: An ‘E-equivalence-record’ is a secondary-record in an I-model; that record contains the E-equivalence-indicators for that I-model.

Entity: An ‘entity’ is any thing of any type in the subject of a record. There are three general types of entities: basic-entities, type-entities, and events.

Equivalent records: Two records are ‘equivalent’ if they have the same subject and specify the same things about that subject, even though their configurational forms may be quite different, such as being written in different languages. There are usually ‘translational-correspondences’ between records that are equivalent. Also, two or more particular components of different records have ‘equivalence-correspondences’ if they indicate the same things about a particular aspect of the same subject.

Equivalent type-structures: The type-structures for two or more type-entities are ‘equivalent’ if those type-structures specify the same requirements for an entity to be an instance of the type-entities.

EQUIVT-relationship: An ‘EQUIVT-relationship’ between two T-elements indicates that the type-entity represented by one of those T-elements has a type-structure that is equivalent to the type-structure of the type-entity represented by that other T-element.

ERT-element: An ‘ERT-element’ is the P3-component of an ERT-unit. It represents a type-entity.

ERT-element-template: (3.4.1).

ERT-unit: An ‘ERT-unit’ (‘entity-relationship-type-unit’) is an I-unit that indicates a structural-relationship of a particular type between (1) a fixed-entity in a type-structure for a particular type-entity in that type-structure, and (2) the instances of that type-entity that is represented by the ERT-element in that structure.

EV-dependence: An EV-element is ‘EV-dependent’ on another EV-element if there is a combination of I-units that indicates that the event represented by that first EV-element is definitionally-dependent on the event represented by that second EV-element.

EV-element: An ‘EV-element’ is either an IEV-element or a T-element. An EV-element represents an event that is either occurrent or non-occurrent.

Event: An ‘event’ consists of the occurrence, or non-occurrence, of a combination of one or more relationships between some entities, possibly including relationships of some entities to themselves. Each event has two aspects: the nature, or type, of that event, and its occurrence-state. An event may consist of a combination of events of the same, or different, types that occur under separate conditions. Relative to a particular subject, the occurrence or non-occurrence of an event in that subject may be unconditional, or it may be conditional relative to the occurrence or non-occurrence of one or more other events. An event may occur (or not occur) multiple times under different circumstances. For example, the event indicated by ‘rain’ may occur at many different times in a given location and time period.

Event-included-occurrence-indicator: An ‘event-included-occurrence-indicator’ is one of the four types of occurrence-state-indicators that are P3-components of EVS-units.

Event-non-occurrence-indicator: An ‘event-non-occurrence-indicator’ is one of four types of occurrence-state-indicators that are P3-components of EVS-units.

Event-occurrence-implication-LOGCON-relationship: An ‘event-occurrence-implication-LOGCON-relationship’ is a LOGCON-relationship that represents the occurrence-state of one event being implied by a particular occurrence-state for another event.

Event-occurrence-indicator: An ‘event-occurrence-indicator’ is one of the four types of occurrence-state-indicators that are P3-components of EVS-units.

Event-occurrence-state-indicator: An ‘event-occurrence-state-indicator’ is the P2-component of an EVS-unit. It indicates the occurrence-state of the event represented by the P1-component of that EVS-unit. The following are four general types of event-occurrence-state-indicators that may be specified in EVS-units: event-occurrence-indicators, event-non-occurrence-indicators, event-probability-indicators, and event-included-occurrence-indicators.

Event-occurrence-time-RT-indicator: An ‘event-occurrence-time-RT-indicator’ is the RT-indicator in an REV1-event-occurrence-time-component.

Event-probability-indicator: An ‘event-probability-indicator’ is one of four types of occurrence-state-indicators that are P3-components of EVS-units.

Event-state-determinant-indicator: An ‘event-state-determinant-indicator’ is the P2-component of an EVS-unit. That indicator indicates the type of factor that determined the event-state that is indicated by the P3-component of that EVS-unit.

Event-state-determinant-indicator-template: (3.4.1 and 3.4.3).

EVIR-indicator: An ‘EVIR-indicator’ is the P2-component in an EVIR-unit. It indicates that the terminal-E-element in that EVIR-unit is an IEV-element that represents an instance-event while the initial-E-element in that unit represents the instance-entity (or non-instance-entity) for that instance-event.

EVS-unit: An ‘EVS-unit’ indicates the occurrence-state of a particular type-event or instance-event.

EVS1-unit: An ‘EVS1-unit’ is an EVS-unit in which the event-occurrence-state-indicator is an event-occurrence-indicator.

EVS0-unit: An ‘EVS0-unit’ is an EVS-unit in which the event-occurrence-state-indicator is an event-non-occurrence-indicator.

EVSP-unit: An ‘EVSP-unit’ is an EVS-unit in which the event-occurrence-state-indicator is an event-occurrence-probability-indicator.

EVSIN-unit: An ‘EVSIN-unit’ is an EVS-unit in which the event-occurrence-state-indicator is an event-included-occurrence-indicator.

EVTR-indicator: An ‘EVTR-indicator’ is the P2-component in an EVTR-unit. It indicates that the terminal-E-element in that EVTR-unit is an IEV-element that represents an instance-event for the type-entity represented by the initial-E-element in that EVTR-unit.

EVTR-unit: An ‘EVTR-unit’ (‘instance-event/type-entity-relationship unit’) represents the relationship between an instance-event and the type-entity for that instance-event.

Existential modality: An ‘existential modality’ of a representation of an event is an indication of the intended role of what is specified by a record containing that representation relative to its potential occurrence in the subject of that record, such as, for example, belief, knowledge, certainty, doubt, prediction, expectation, or assumption, assumption, expectation, belief, possibility, necessity, prediction, probability, actuality, and impossibility.

External-source-indicator: An ‘external-source-indicator’ is one type of event-state-determinant-indicator specified as the P2-component of an EVS-unit in an I-model. It indicates that the occurrence-state of the event represented by the P1-component in that EVS-unit was determined by an external source.

Fixed-E-element: A ‘fixed-E-element’ in a T-component is either the terminal-E-element in a T10SR-unit in that T-component, or the initial-E-element in a T01SR-unit in that T-component. Fixed-E-elements in a T-component represent entities that are fixed-entities in the type-structure represented by that T-component.

Fixed-entity: A ‘fixed-entity’ in a type-structure is an entity that is the same entity in all the corresponding locations in the structures that are the instances of that type-structure. Thus, for example, the type-structure indicated by ‘names, number of employees, and product-types of manufacturing companies located in Michigan’ includes one fixed-entity, indicated by ‘Michigan’. Every company that is an instance of the type-entity indicated by ‘manufacturing companies’ is located in Michigan. Thus, fixed-entities in a type-structure are not instantiated when the type-entities in that structure that are not fixed-entities in that structure are instantiated.

Type-entities may be fixed-entities in the type-structures for other type-entities. For example, ‘names, locations, and number of employees, of manufacturing companies that produce refrigerators’ indicates a type-structure in which the type-entity indicated by ‘refrigerators’ is a fixed-entity: all the manufacturing companies that are instances of the type-entity indicated by ‘manufacturing companies’ produce refrigerators.

Fixed-entity-relationship-type: (1.4.7).

General-translating-component: (3.5.3.4.3).

Generic-occurrence-state-indicator-template: (3.4.1 and 3.4.3).

Generic-RT-indicator-template: (3.4.1 and 3.4.3).

Hybrid record: A ‘hybrid’ record is a record that has both representational and descriptive components. For example, an illustrated book is fundamentally descriptive, with illustrations as supplementary representational components. On the other hand, maps and annotated diagrams are fundamentally representational, with descriptive annotations, such as the names of various things that are represented in those maps and diagrams.

I-component: An ‘I-component’ is a record that is a component of an I-model. The primary component of an I-model consists of one or more I-components. Each I-component consists of one or more I-units.

I-element: An ‘I-element’ is a record that is a component of an I-unit. Each I-unit consists of several I-elements.

I-element-template: (3.4.1 and 3.4.3).

I-element-template-correspondence-indicator: (3.4.4).

I-element-template-equivalence-indicator: (3.4.1).

I-equivalence: Two I-components in the same, or different I-models, are ‘I-equivalent’ if every I-unit in each of those components is I-equivalent to an I-unit in the other I-component. Two or more I-indicators are ‘I-equivalent’ if they indicate or represent exactly the same thing. Two I-models are ‘I-equivalent’ if every I-component in each I-model is I-equivalent to an I-component in the other I-model.

I-equivalence-indicator: In an I-model, an ‘I-equivalence-indicator’ indicates that two particular I-indicators are I-equivalent.

IEV-component: An ‘IEV-component’ is an I-component whose primary component consists of an IEVB-component and an EVS-unit whose EV-element is E-equivalent to the IEV-elements in the EVTR- and EVIR-units in that IEVB-component.

IEV-element-template: (3.4.1, 3.4.2, and 3.4.3).

IEV0-component: An ‘IEV0-component’ is an IEV-component in which the event-occurrence-state-indicator is an event-non-occurrence-indicator.

IEV1-component: An ‘IEV1-component’ is an IEV-component in which the event-occurrence-state-indicator is an event-occurrence-indicator.

IEVB-component: An ‘IEVB-component’ is an I-component whose primary component consists of an EVTR-unit and an EVIR-unit whose P3-component is an IEV-element that is E-equivalent to the P3-component of that EVTR-unit.

IEV-element: An ‘IEV-element’ (‘instance-event element’) in an I-model is an E-element that represents an instance-event in the subject of that I-model.

I-improvement: An ‘I-improvement’ is an improvement in a computer-based record-system or computer-system where that improvement consists of the use of one or more I-models and I-systems in that system to supplement or replace one or more records or subsystems of other types.

Inconsistency-detecting-component: (3.5.3.8).

I-index: An ‘I-index’ is a T-network or a T/INST-network in an I-model, with the possible addition of one or more REV1-entity-name-components.

I-indicator: An ‘I-indicator’ is a component of an I-unit that indicates a particular thing about a particular aspect of that I-unit or about particular I-elements or I-components in the I-model containing them.

I-indicator-template: (3.4.1).

I-model: An ‘I-model’ is a computer-operative record of the type described in this specification. Its primary component consists of one or more I-components.

I-model-constructing-component: (3.5.3.2).

I-model-searching-component: (3.5.3.14).

Inconsistent: Two I-models are ‘inconsistent’ if the combination of those two I-models is not an I-model, because they indicate inconsistent information about the same or different events or type-entities.

Index-constructing-component: (3.5.3.12).

Initial-E-element: The ‘initial-E-element’ in an SR-unit is the P1-component in that unit. The ‘initial-E-element’ in an RT-specification-unit is the P2-component of that unit. The ‘initial-E-element’ in a TSR-unit is the P1-component in that unit. The ‘initial-E-element’ in an REVB-component is the initial-E-element in the ERT-unit in that REVB-component. The ‘initial-E-element’ in an REV-component is the initial-E-element in the REVB-component in that REV-component. The ‘initial-E-element’ in a TIEVB-component is the initial-E-element in the TEVTR-unit in that TIEVB-component. The ‘initial-E-element’ in a TIEV-component is the initial-E-element in the TIEVB-component in that TIEV-component. The ‘initial-E-element’ in a TREV-component is the initial-E-element in the TIEV-component in that TREV-component. The ‘initial-E-element’ in an inter-element structural relationship from one E-element to another E-element is the first E-element in that relationship.

Initial-entity: The ‘initial-entity’ in a binary-relationship is the entity from which that relationship proceeds. A symmetric relationship between two entities may be specified as consisting of two relationships of the same type and opposite directions.

Thus, all relationships between two entities may be specified as having a direction ‘from’ one of those entities (the initial-entity) ‘to’ the other entity (the terminal-entity). Thus, whether or not a binary-relationship is symmetric, one of the related entities in that relationship may be specified as the initial-entity of that relationship and the other related entity as the terminal-entity in that relationship.

Initial-I-unit: The ‘initial-I-unit’ in an inter-unit structural relationship from one I-unit to another is the first I-unit in that relationship.

INST-element: The ‘INST-element’ in an IEVB-component is the P1-component in the EVIR-unit in that IEVB-component.

Instance-entity: An ‘instance-entity’ for a type-entity is an entity that has attributes and relationships of all the types indicated by the type-structure for that type-entity. Given any entity and any type-entity, then that entity is either an instance-entity or a non-instance-entity for that type-entity. A type-entity may have one or more instance-entities under some conditions and not others. Similarly, a specific entity may be an instance-entity for a particular type-entity under some conditions, and not others. For every type-entity, every entity is either an instance-entity or a non-instance-entity for that type-entity.

Joint type-entities are simultaneously instantiated or simultaneously non-instantiated; that is, when one of those joint type-entities has an instance, then so do all the others, and the relationships between those instances correspond to the type-relationships between those joint type-entities in that type-structure; that is, those relationships between the instances of those type-entities are themselves instances of the type-relationships between those type-entities in that type-structure. Thus, corresponding to those joint type-entities, the simultaneous instances of those joint type-entities are co-related joint-instances of those type-entities.

For example, in the type-structure indicated by ‘residents of cities with over one million residents’, ‘residents’ and ‘cities’ are joint type-entities, and, if Fred Smith is a resident of Chicago, then Fred Smith is a co-related joint-instance with Chicago relative to that type-structure. Similarly, if Mary Jones is a resident of New York, then Mary Jones is a co-related joint-instance with New York relative to that type-structure. On the other hand, although Fred Smith is an instance of the type-entity, ‘residents’, and New York is an instance of the type-entity, ‘cities’, Fred Smith and New York are not co-related joint-instances of those joint type-entities.

Instance-event: An ‘instance-event’ is an event consisting of a particular entity being either an instance-entity or a non-instance-entity for a particular type-entity.

INST-completeness-indicator: An ‘INST-completeness-indicator’ is a P3-component of an INST-completeness-status-unit that indicates that all the instance-entities for a type-entity represented by the P2-component of that unit are indicated by a combination of I-components in that I-model.

INST-completeness-status-unit-indicator: An ‘INST-completeness-status-unit-indicator’ is the P1-component of an INST-completeness-status-unit. It indicates that that I-unit is an INST-completeness-status-unit.

INST-completeness-status-unit: An ‘INST-completeness-status-unit’ in an I-model indicates whether or not all the instance-entities for the type-entity represented by the P2-component of that unit are indicated by a combination of I-components in that I-model.

INST-incompleteness-indicator: An ‘INST-incompleteness-indicator’ is a P3-component of an INST-completeness-status-unit that indicates that not all the instance-entities for the type-entity represented by the P2-component of that unit are indicated by a combination of I-components in that I-model.

Intermediate I-model: (3.5.3.4.3).

Invariant-occurrence-indicator: An ‘invariant-occurrence-indicator’ is one type of event-state-determinant-indicator specified as the P2-component of an EVS-unit in an I-model. It indicates that the occurrence-state of the event represented by the P1-component in that EVS-unit is invariant in the subject of that I-model.

I-primary-indicator: An ‘I-primary-indicator’ is a component of an I-unit that indicates information about one or more entities represented by E-elements in that I-unit.

I/R-template-TRANS-correspondence-pair: (3.4.8.2).

I-secondary-indicator: An ‘I-secondary-indicator’ is a secondary component of an I-unit that indicates information about aspects of the I-model containing that I-unit.

I-system: An ‘I-system’ is a computer-based record-system of the type described in this specification.

I-system-model: An ‘I-system-model’ is an I-model of the I-system containing that I-system-model and of one or more other I-models that are the primary-records in that I-system.

I-template: An ‘I-template’ in an I-system is a computer-based record that is not part of an I-model in that I-system but that has a primary-configuration that corresponds structurally to the primary-configuration of a combination of one or more I-components that may be constructed in an I-model in that I-system.

I-template-correspondence-pair: (3.4.4).

I-template-LOGCON-correspondence-pair: (3.4.5).

I-template-TRANS-correspondence-pair: (3.4.7).

I-unit: An ‘I-unit’ is a record that is a component of an I-component. Each I-component consists of one or more I-units. Each I-unit consists of several I-elements.

I-unit-template: (3.4.1 and 3.4.3).

I-unit-type-indicator: An ‘I-unit-type-indicator’ is a component of an I-unit that indicates the type, or nature, of that I-unit.

Joint-instances: Two or more entities are ‘joint-instances’, or co-related instances, of a corresponding combination of joint type-entities in a type-structure if those entities have inter-relationships that are instances of the corresponding type-relationships between those joint type-entities in that type-structure.

Joint-T-elements: ‘Joint-T-elements’ in a T-component that includes more than one primary-T-element are all the primary-T-elements in that T-component that are not fixed-E-elements in that T-component. Those joint-T-elements represent joint type-entities in the type-structure represented by that T-component.

Joint type-entity: A ‘joint type-entity’ in a type-structure is a type-entity in that structure if that type-entity is not a fixed-entity in that type-structure and that type-structure also contains at least one other non-fixed type-entity. All those non-fixed type-entities are joint type-entities relative to each other in that type-structure.

LOGCON-constructing-component: (3.5.3.7).

LOGCON-indicator: A ‘LOGCON-indicator’ is one type of event-state-determinant-indicator specified as the P2-component of an EVS-unit in an I-model. It indicates that the occurrence-state of the event represented by the P1-component in that EVS-unit was determined by a combination of LOGCON-construction operations performed by one or more operative-components on one or more I-models in the I-system containing that EVS-unit.

LOGCON-relationship: A ‘LOGCON-relationship’ between a combination of I-components in an I-model and another combination of I-components that may be constructed and added to that I-model consists of that second combination being a logical consequence of that first combination.

LOGCON-relationship-pair: A ‘LOGCON-relationship-pair’ is a pair of combinations of I-components such that there is a LOGCON-relationship from that first combination to that second combination.

LOGCON-type-indicator: (1.3.1.1.1.4.2).

Matching of I-templates and I-components: (3.4.3).

Measurement: A ‘measurement’ of an entity is a particular type of relationship of that entity such that that relationship consists of a sequence of events consisting of: (1) the relationship between that entity and a measurement process of some kind applied to that entity by some kind of measurement device or means; (2) the relationship between that measurement process and its outcome; (3) the relationship between that outcome and a type-entity whose instances consist of a range of closely-related outcomes; and (4) the relationship between that type-entity and its name, which is the measurement. For example, the name that identifies a particular point (e.g., ‘15 inches’) on a tape measure whose tape is aligned with an entity whose length is being measured thereby is a measurement of a particular type (‘length’) of that entity. There are generally a range of measurement-process outcomes with very minor differences between them that are identified as being of that same type and, consequently, as having the same name, or measurement-value. In each such case, the measurement process constitutes a relationship between the entity being measured and the resulting measurement.

Some measurement-values are numerical while others are non-numerical, such as names of types of relationships employed as relative-measurements, for example, ‘larger than’.

Some measurements have several components, each corresponding to a separate component of the output-record of the applicable measurement devices. For example, the primary component of the output-record of a clock may have three components, one of which indicates a number of hours, a second component that indicates a number of minutes, and a third component that indicates a number of seconds, and the combination of those three numbers constitutes a composite time-measurement. Each of those components corresponds to a component of the output-state of the measurement device.

Measurement-devices include subjective human-sense mechanisms; for example, color-perceptions experienced by persons and whose types are assigned names such as ‘red’, ‘green’, and ‘blue’. Some measurements are relative; for example, ‘larger than’. Measurement processes range from very informal subjective human judgements to very precise objective technical measurements performed using physical measurement-devices. Measurement processes also include numerical and mathematical calculations.

MERGESUBT-relationship: A ‘MERGESUBT-relationship’ from one T-element to another indicates that the type-structure for the type-entity represented by that second T-element is identical to the type-structure for the type-entity represented by that first T-element except that some of the type-entities in that second type-structure are merged.

Multi-directional-translating-component: (3.5.3.4.6).

Multiple-output-translating-component: (3.5.3.4.5).

Mutually-exclusive subtypes: A group of subtypes for a type-entity is ‘mutually-exclusive’ if the properties specified in the type-specifications for those subtypes are such that no possible instance of any one of those subtypes may be an instance of any of those other subtypes.

Non-instance-entity: A ‘non-instance-entity’ for a type-entity is an entity that is not an instance of that type-entity.

Non-primitive RT-specification: (1.4.7.3).

Non-subject-related operation: A ‘non-subject-related operation’ in a computer-based record-system is an operation on a record that is not related to the subject of that record. That includes, for example, such operations as constructing records, determining the structural-type, size or location of a record, specifying the source or date of a record, disaggregating records into smaller records, combining records to form larger records, and copying the configurations of records to form identical records in different locations within the system.

Normative modality: A ‘normative modality’ of a representation of an event is an indication of the intended role of what is specified in that representation with respect to human intentions relative to the subject of that representation. Normative modalities include, for example, permission, obligation, volition, law, requirement, rule, plan, objective, or need.

Occurrence-relationship: An ‘occurrence-relationship’ between events is a relationship between the occurrences or non-occurrences of those events. An example of an occurrence-relationship between two events is: ‘if the red light is on, then the machine is operating’. Mote that that the whole of that occurrence-relationship is itself an unconditional occurrent event.

However, instead of being unconditional, an occurrence-relationship may instead itself be one of the events in another occurrence-relationship; for example, ‘under normal conditions, if the red light is on, then the machine is operating’. In that example the occurrence-relationship, ‘if the red light is on, then the machine is operating’, is itself the second event in a second occurrence-relationship between normal conditions and that second event. That second occurrence-relationship may itself be unconditional or may be one of the events in a third occurrence-relationship.

Occurrence-state: An ‘occurrence-state’ of an event consists of either its occurrence or non-occurrence. That occurrence-state may change under different circumstantial-conditions. Circumstantial-conditions are events. In the example, ‘the accident occurred in 2017’, the event consisting of the accident occurred at some time within the occurrence of the circumstantial-condition consisting of the year being 2017. Alternatively, an event may occur throughout a particular time-period; that is, that event coincides with, or is co-related with, that time-period.

More generally, there may be many circumstantial-conditions relative to one or more other events. Those circumstantial-conditions may be purely coincidental with those other events and thus may not have any causal relationship to the occurrence or non-occurrence of those events. Each of any two events may be a circumstantial-condition for the other event. There may be separate occurrences of an event under different conditions, such as an event that recurs at many different times.

Operation-input-record: An ‘operation-input-record’ for an operation in a computer-system is a record that is operated upon by an operative-component in performing its operative function within that system. Some of those operation-input-records may be system-input-records.

Operation-output-record: An ‘operation-output-record’ for an operation in a computer-system is a record that is constructed by an operative-component as the result of that component's performance of its operative function within that system. That operation-output-record may be the operation-input-record for another operation, or it may be a system-output-record.

Operative-component: An ‘operative-component’ in a computer system is a component that performs operations of one or more types in that system. An operation performed by an operative-component may have one or more operation-input-records and one or more operation-output-records that are the products of that operation.

In performing an operation, each operative-component operates on one or more records that are the ‘input-records’ for that operation, and produces one or more records, or parts of records, that are the ‘output-records’ for that operation. In performing that operation, that operative-component may also produce some intermediate records that it uses in its subsequent operations; such records are ‘intermediate-products’ of that operation.

That operative-component may include a combination of operative-components each of which performs one or more operations that, in combination, constitute that overall operation. That operative-component may also initiate the operation of other operative-components in the computer-system as part of performing the overall operation. One or more of those other operative-components may produce records that are used by that first operative-component in performing its operation.

In some computer-systems, one or more of the operative-components are permanent components of the system containing it. Such an operative-component operates actively when its operation is initiated by particular inputs to it. In other cases, various operative-components are constructed by the computer-system for temporary operation under predetermined conditions, and are subsequently terminated by the system during or after those temporary operations.

P1-component: A ‘P1-component’ is a particular component of an I-unit. It consists of a combination of one or more I-elements.

P2-component: A ‘P2-component’ is a particular component of an I-unit. It consists of a combination of one or more I-elements.

P3-component: A ‘P3-component’ is a particular component of an I-unit. It consists of a combination of one or more I-elements.

Partial-primitive RT-specification: (1.4.7.2).

Primary-circumstantial-condition: A ‘primary-circumstantial-condition’ in the subject of an I-model is an event relative to which the occurrence-states of all other events indicated by EVS-units in that I-model are determined and fixed. A primary-circumstantial-condition in the subject of an I-model is indicated by the P2-components of one or more EVS-units in that I-model.

Primary-circumstantial-condition-indicator: A ‘primary-circumstantial-condition-indicator’ is one type of event-state-determinant-indicator specified as the P2-component of an EVS-unit in an I-model. It indicates that the event represented by the P1-component in that EVS-unit is a primary-circumstantial-condition in the subject of that I-model.

Primary-circumstantial-time-period: A ‘primary-circumstantial-time-period’ in the subject of an I-model is a primary-circumstantial-condition that is a time-period.

Primary component of a record: The ‘primary component’ of a record is that part of that record that specifies or represents one or more aspects of one or more subjects whose specification or representation is the primary function of that record.

Primary-IEV-element in an IEVB-component: (1.4.1.1)

Primary I-unit: A ‘primary I-unit’ in an I-model represents aspects of the subject of that I-model. There are two types of primary I-unit: base-primary I-units and T-units.

Primary-operative-component: A ‘primary-operative-component’ in a computer-system is an operative-component that operates on one or more computer-based records in that system and, as a result of that operation, constructs, or modifies, one or more computer-based-records in the system. Such operation-output records may be directly or indirectly used by a system-user or by another primary-operative-component in the system. That contrasts with other operative-components in that system that manage and support the operation of those primary-operative-components in various ways.

Primary-RT-indicator: The ‘primary-RT-indicator’ in an REVB-component is the RT-indicator in the ERT-unit in that REVB-component.

Primary-T-element: The ‘primary-T-element’ in an IEVB-component is the P1-component in the EVTR-unit in that IEVB-component. A ‘primary-T-element’ in a T-component is a T-element that is not a fixed-E-element in that T-component.

Proto-T01SR/INST-unit-pair: (1.3.1.2.3).

Proto-T10SR/INST-unit-pair: (1.3.1.2.3).

Proto-T/INST-element-relationship: (1.3.1.2).

Proto-TJSR/INST-unit-pair: (1.3.1.2.3).

Record: A ‘record’ is a physical object constructed in such a way that it has a primary component whose configuration specifies or represents one or more aspects of one or more subjects whose specification or representation is the primary function of that record. It should be understood that the term, ‘record’, as used in this document, is not restricted in this specification to the very narrow technical usage in which that term is frequently employed in the computing field.

Records vary greatly in size, and may be components of larger records. For example, a specification of a single language symbol may be the primary component of a record which may itself be a component of a record of a sentence, which in turn may be a component of a book. At the other extreme, the combination of the primary components of all records accessible via the Internet can be characterized as the primary component of a single, widely-dispersed record.

Some records are kept and used because it is the configurations per se of their primary components that are of primary significance to the users of those records, and it is essential to preserve those precise configurations; for example, literature, works of art, and legal documents. In other cases, however, it is the information specified by the primary components of records, not the specific configurations of those components, that is of primary significance to the users of those records. In such cases, it is the information that must be preserved, and the specific configurations of those records are not of primary importance as long as the information-content is retained for future use.

Most human records have several components of different types that serve different purposes. In addition to its primary component, a record may have components of other functional types such as configuration-identification components, secondary-record components, and supporting components.

The configuration of the primary component of a record consists of a combination of the structural forms, states, and physical relationships of the components of that primary component. An example of a record in which the states of components of that record are an integral part of that configuration are variations in the colors of various parts of topographical maps. Another example is that of the magnetic or electrical states of components of various types of computer systems in which records are stored. The primary-configurations of many records are symbol-based in whole or in part. Others may have a configurational form of some other type, such as, for example, audio and visual records.

The form of the specification in a record may be descriptive, representational, or a hybrid combination of components of both of those types. Some records may be have fixed primary-configurations, such as a printed book. Other records may be dynamic, having primary-configurations that change over time; for example, computer databases that maintain records of the current state of a company, such as the identities and roles of employees.

Record-comparing-component: (3.5.3.13).

Record-configurable-component: The ‘record-configurable-component’ for a computer-operative record is the initial computer-system component that has configurable components that are configured by that computer-system to constitute that record.

Record-indicator-unit: A ‘record-indicator-unit’ in an I-model indicates a record that is not part of the primary component of that I-model.

Record-indicator-unit-indicator: A ‘record-indicator-unit-indicator’ is the P1-component of a record-indicator-unit; it indicates that that unit is a record-indicator-unit.

Record-type: A ‘record-type’ is a type-entity whose instances are records of the type indicated by the type-structure of that type-entity. Some record-types may be very specific, such as a record-type whose instances are all copies of a particular document or book.

Relationship: A ‘relationship’ consists of a pair of entities and the occurrence, or non-occurrence, of some kind of association or connection between those entities. More complex relationships consist of combinations of those simple relationships. Relationships are of a very wide variety of types. For example, the relationship between an entity and a measurement of that entity consists of a sequence of events or relationships constituting a measurement process. Other examples of types of relationships include those between: (A) an entity and a state of that entity; (B) an entity and a name of that entity; (C) an action by one entity on another entity; (D) an entity and an attribute of that entity; (E) a comparison between some aspect of two entities; and (F) between an event and a time or location of that event.

Relationships may be comparative or non-comparative. Some comparative relationships may be specified in terms of numerical measurements of comparative properties of the related entities; for example, relative numerical sizes of two entities (e.g., ‘three feet longer’). Other comparative relationships may be specified non-numerically; for example, ‘longer than’. Non-comparative relationships may consist of joint states of the related entities; for example, ‘co-workers’. An action by an entity on entities are another type of non-comparative relationship between that entity and the event constituting that action.

Some relationships are symmetric in that their names or definitions indicate the same role in the relationship for both of the related entities, although there may be variations in specific aspects of those respective roles; for example, ‘spouse’, ‘adjacent to’, ‘close to’, ‘association’, and ‘relationship’. However, most binary-relationships are not symmetric.

Some relationships may be may be assigned. For example, a name of an entity, and the status of a person being an employee of a company are assigned relationships. However, such relationships, once assigned, have the same general form and function as ‘natural’ relationships that are not the results of assignment processes. The results of some types of assignment processes have the same forms as measurements and function similarly in specifications of information. Thus, for example, the price of an item for sale is a measurement-value that is determined by a price-determination process that results in the assignment of that price to that item.

Relationship-event: A ‘relationship-event’ is an event consisting of the occurrence or non-occurrence of a relationship between two entities.

Relationship-type: A ‘relationship-type’ is a type-entity whose type-structure indicates that its instances are structural relationships of a particular type between the entities that are the co-related instances of the joint-type-entities in that type-structure.

Relative-absolute-translating-component: (3.5.3.4.10).

Reporting-component: (3.5.3.17).

Representational record: A record is ‘representational’ if there is a one-to-one correspondence between the configurational components of the primary component of that record and the corresponding components of the things represented by those components; for example, physical models, photographs, and audio-visual recordings are purely representational records. Hybrid records that are fundamentally representational are semi-representational.

REV0-component: An ‘REV0-component’ is an REV-component in which the event-occurrence-state-indicator is an event-non-occurrence-indicator.

REV0-event-occurrence-conjunction-component: An ‘event-occurrence-conjunction-REV0-component’ is an I-component that represents a non-conjunction-relationship between the occurrences of two specified events.

REV0-event-occurrence-implication-component: An ‘event-occurrence-implication-REV0-component’ is an I-component that represents a non-implication-relationship between the occurrences of two specified events.

REV1-00-event-occurrence-conjunction-component: A ‘REV1-00-event-occurrence-conjunction-component’ is an REV1-event-occurrence-conjunction-component that indicates that two specified events occur together.

REV1-00-event-occurrence-implication-component: A ‘REV1-00-event-occurrence-implication-component’ is an REV1-event-occurrence-implication-component that indicates that the non-occurrence of a specified event implies the non-occurrence of another specified event.

REV1-01-event-occurrence-conjunction-component: A ‘REV1-01-event-occurrence-conjunction-component’ is an REV1-event-occurrence-conjunction-component that indicates that the non-occurrence of a specified event and the occurrence of another specified event occur together.

REV1-01-event-occurrence-implication-component: A ‘REV1-01-event-occurrence-implication-component’ is an REV1-event-occurrence-implication-component that indicates that the non-occurrence of a specified event implies the occurrence of another specified event.

REV1-10-event-occurrence-conjunction-component: A ‘REV1-10-event-occurrence-conjunction-component’ is an REV1-event-occurrence-conjunction-component that indicates that the occurrence of a specified event and the non-occurrence of another specified event occur together.

REV1-10-event-occurrence-implication-component: A ‘REV1-10-event-occurrence-implication-component’ is an REV1-event-occurrence-implication-component that indicates that the occurrence of a specified event implies the non-occurrence of another specified event.

REV1-11-event-occurrence-conjunction-component: A ‘REV1-11-event-occurrence-conjunction-component’ is an REV1-event-occurrence-conjunction-component that indicates that two specified events occur together.

REV1-11-event-occurrence-implication-component: A ‘REV1-11-event-occurrence-implication-component’ is an REV1-event-occurrence-implication-component that indicates that the occurrence of a specified event implies the occurrence of another specified event.

REV1-clock-time-component: A ‘REV1-clock-time-component’ is an REV1-component whose terminal-E-element represents a time-measurement by the time-measurement-device represented by the initial-E-element in that component.

REV1-component: An ‘REV1-component’ is an REV-component in which the event-occurrence-state-indicator is an event-occurrence-indicator.

REV1-event-inclusive-time-component: An ‘REV1-event-inclusive-time-component’ is an REV1-component whose terminal-E-element indicates a time within which the event represented by the initial-E-element occurs.

REV1-event-occurrence-conjunction-component: An ‘REV1-event-occurrence-conjunction-component’ is an I-component that represents a conjunction-relationship between the occurrences of two events.

REV1-event-occurrence-implication-component: An ‘REV1-event-occurrence-implication-component’ is an I-component that represents an implication-relationship between the occurrences of two events.

REV1-event-occurrence-time-component: An ‘REV1-event-occurrence-time-component’ is an REV1-component in which the terminal-E-element represents a particular occurrence-time of the event represented by the initial-E-element.

REV1-event-probability-component: An ‘REV1-event-probability-component’ is a REV1-component whose terminal-E-element represents a probability of the occurrence of the event represented by the initial-E-element.

REV1-name-component: An ‘REV1-name-component’ is a REV1-component in which the terminal-E-element represents a name of the entity represented by the initial-E-element.

REV1-subtype-component: A ‘REV1-subtype-component’ is an REV1-component whose terminal-E-element represents a type-entity that is a subtype of the type-entity represented by the initial-E-element.

REV1-type-contratype-component: A ‘REV1-type-contratype-component’ is an REV1-component that specifies that the terminal-E-element in that component represents a type-entity that is a contratype of the type-entity represented by the T-element that is the initial-E-element in that component.

REV1-type-instance-number-component: An ‘REV1-type-instance-number-component’ is an REV1-component whose terminal-E-element indicates the number of instances of the type-entity represented by the initial-E-element in that component.

REVB-component: An ‘REVB-component’ is an I-component whose primary component consists of an ERT-unit and an IEVB-component whose primary-T-element is E-equivalent to the ERT-element in that ERT-unit.

REVB-event-occurrence-conjunction-component: An ‘REVB-event-occurrence-conjunction-component’ is an I-component that represents a type of a possible conjunction-relationship between the occurrences of two events.

REVB-event-occurrence-implication-component: An ‘REVB-event-occurrence-implication-component’ is an I-component that represents a type of a possible implication-relationship between the occurrences of two events.

REVB-expansion-component: An ‘REVB-expansion-component’ is an I-component consisting of an ERT-unit combined with two or more different IEVB-components whose primary-T-elements are all E-equivalent to the ERT-element in that ERT-unit.

REV-component: An ‘REV-component’ (‘relationship-event-component’) is an I-component whose primary component consists of an REVB-component and an EVS-unit whose EV-element is E-equivalent to the IEV-elements in the EVTR- and EVIR-units in that REVB-component.

Reverse-translation-operation: (3.5.3.4).

REV-expansion-component: An ‘REV-expansion-component’ is a REV-component in which the REVB-component is replaced by an REVB-expansion-component.

RT-dependence: A T-element in an I-model is ‘RT-dependent’ on an RT-indicator if that I-model includes a combination of I-components that indicates that the type-structure for the type-entity represented by that T-element is directly or indirectly dependent on the type-relationship indicated by that RT-indicator.

RT-element: An ‘RT-element’ is a T-element that is the terminal-E-element in an RT-specification-unit.

R-template: (3.4.8.1).

RT-indicator: An ‘RT-indicator’ is the P2-component of an ERT-unit. It indicates a type of relationship between the P1- and P3-components of that ERT-unit. It may be translationally-equivalent to a name for that type of relationship.

RT-specification: An ‘RT-specification’ is a T-specification that represents a type-structure for a particular type of relationship between entities.

RT-specification-unit: An ‘RT-specification-unit’ is a secondary I-unit whose P2-component and P3-component are joint-T-elements in a T-specification and whose P1-component is an RT-indicator. In that T-specification, the structural relationship between those joint-T-elements represents a corresponding structural relationship between the type-entities in the type-structure represented by that T-specification.

Search-specification-record: (3.5.3.14).

Secondary I-unit: A ‘secondary I-unit’ in an I-model indicates various aspects of various components of that I-model.

Secondary-record: A ‘secondary-record’ in a record is a record that is a component of that first record and that indicates information about aspects of that first record, or about the information indicated by the primary component of that record. Examples of secondary-record components are those that indicate the authorship and date of creation of a record, or the source or reliability of the information indicated by the primary component of a record.

Secondary-terminal-E-elements: The ‘secondary-terminal-E-elements’ in a standard-DISJT-specification are the terminal-E-elements in the components corresponding to CONTRAT-specifications whose initial-E-elements are E-equivalent to the terminal-E-element in the first CONTRAT-specification in that standard-DISJT-specification.

Semi-representational record: Due to the particular structural forms of some types of devices or media in which records of some types are located, the primary components of those records cannot be purely representational. For example, in typical digital computers, the computer memories are structured in such a way that the basic configurational components of those memories are treated in the functioning of the system containing them as if they are arranged in a linear sequence. That is much more compatible with linear descriptive records than with representational records.

Consequently, if the information to be accounted for in such records is fundamentally representational in nature, then such representations may need to be translated to a form that permits the resulting record to have a linear structure. In particular, that means that an entity for which there is more than one item of information to be represented in the primary component of such a record may need to be represented in that primary component by a separate component for each such item of information. Such records are ‘semi-representational’. In contrast to those, some non-digital computer systems, such as FPGA-based (‘field programmable gate array’) computers and those designed to mimic human neural networks, can accomodate fully-representational records and hybrid semi-representational records.

Simple-primitive RT-specification: (1.4.7.1).

SPECNSUBT-relationship: A T-element has a SPECNSUBT-relationship to another T-element if the T-specification for that first T-element is T-identical to the T-specification for that second T-element except that one or more TJSR-units in that second T-specification are replaced in that first T-specification by T10SR-units or T01SR-units. That corresponds to one or more type-entities in the type-structure for the type-entity represented by that first T-element being replaced by fixed-entities in the type-structure for the type-entity represented by that second T-element.

SR-type-indicator: An ‘SR-type-indicator’ in an SR-unit is an I-indicator that indicates a particular type of structural relationship between the entities represented by the P1- and P3-components of that unit.

SR-unit: An ‘SR-unit’ is a type of base-primary I-unit. SR-units represent simple structural-relationships of particular types between entities. There are four general types of SR-unit: ERT-units, EVTR-units, EVIR-units, and co-relationship-indicator-units.

Standard-CONTRASUBT-relationship: A ‘standard-CONTRASUBT-relationship’ from one T-element to another represents the relationship between the type-entity represented by that first T-element and the type-entity represented by that second T-element such that that first entity is a contratype of a third type-entity that is a subtype of a fourth type-entity and that second type-entity is a contratype of that fourth type-entity.

Standard-CONTRAT-specification: A ‘standard-CONTRAT-specification’ for a T-element is a CONTRAT-specification that is a TIEV-component in which the terminal-E-element is a fixed-E-element that is E-equivalent to that T-element.

Standard-DISJT-specification: A ‘standard-DISJT-specification’ for a T-element is a standard-CONTRAT-specification for that T-element such that the T-specification for the terminal-E-element in that standard-CONTRAT-specification consists of a combination of independent T-components, each of which is T-identical to a standard-CONTRAT-specification for some T-element.

Subject: A ‘subject’ of a record consists of one or more entities and, in many cases, one or more relationships between some or all of those entities. A record may indicate information about more than one subject, and those subjects may or may not be inter-related.

Subject-related operation: A ‘subject-related operation’ in a computer-based record-system is an operation on a record that is related to the subject of that record. That includes, for example, operations such as subject-indexing, searching, logical-inferencing, translating records to, from, or between human-readable records, detecting inconsistencies in records, monitoring records for changes in what is specified, determining logical consequences of what is specified in a record about the subject, and translating records to or from records of different configurational types within computer-systems.

SUBT-relationship: A ‘SUBT-relationship’ from one T-element to another T-element indicates that the type-entity represented by the second of those T-elements is a subtype of the type-entity represented by that first T-element.

Subtype: One type-entity is a ‘subtype’ of a type-entity if (a) those to type-entities are the same entity, or (b) the specification of the type-structure for that first type-entity is more restrictive than the specification of the type-structure for that second type-entity. For example, the type-structure for the type-entity indicated by ‘companies located in Michigan with more than 1,000 employees’ is a subtype of the type-entity whose type-structure is indicated by ‘companies located in Michigan’, and that latter type-entity is, in turn, a subtype of the type-entity whose type-structure is indicated by ‘companies’.

Supertype: A type-entity is a ‘supertype’ of another type-entity if that second type-entity is a subtype of that first type-entity. Thus, ‘supertype’ is the opposite of ‘subtype’.

Supporting-component: A ‘supporting component’ of a record is a component that provides physical or operational support to the other components of the record. An example is the cover and binding of a book. Another example is a component that supplies electrical power to the electronic circuits that maintain the configuration of that record in an electronic computer.

System-developer: A ‘system-developer’ is a person who develops, or contributes to the development of, a computer-based system or computer-based record.

System-input-interface-component: A ‘system-input-interface-component’ of a computer-system is a component of that system that is constructed to receive records from sources external to that system; for example, a keyboard in that system employed by human users of that system. The records received in system-input-interface-components may include action-specification-records.

A computer-system may have different system-input-interface-components that receive system-input-records from external sources of different types. A system-input-record may be presented to a system-input-interface-component by one or more means such as, for example, electrical, optical, or audio transmissions, transmission from a sensing device of some type, connection to a device that stores computer-operative records, or a record that is typed, graphically-specified, or spoken in that system-input-interface-component by a system-user. Some system-interface components may function as both system-input-interface-components and system-output-interface-components; for example, a computer monitor may serve both functions.

System-input-record: A ‘system-input-record’ in a computer-system is a record received by that system in a system-input-interface component. System-input-records include, for example, human-readable records, computer-operative records, and records of configured electrical, electro-magnetic, and optical transmissions received by the computer-system or by another device or system that transmits those records to the computer-system. The configurations of the primary components of human-readable system-input-records may be of various configurational types, such as, for example, natural-language, simple well-structured partial natural-language, tables, graphical images, voice records, or combinations of those.

The configuration of the primary component of a system-input-record or a system-output-record may be ‘configurationally-simple’. Such a record may, for example, be a record produced by a natural-language parser, by a knowledge-base system, or by a database-management system such as a relational-database management system. Alternatively, that primary component may be a human-usable record, a record of a visual image, or a record of some other non-configurationally-simple type. Similarly, the primary configuration of a system-input-record received by transmission to the system may or may not be configurationally-simple.

System-output-interface-component: A ‘system-output-interface-component’ of a computer-system is a component of that system that is constructed to receive records from other components of that system and present or transmit them to external system-users including other computer-systems. A computer-system may have different system-output-interface-components that present system-output-records in different forms to various system-users.

System-output-record: A ‘system-output-record’ in a computer-system is a record constructed by that system in a system-output-interface-component. System-output-records may be of one or more types, such as those described above for system-output-records.

System-user: A ‘system-user’ is an entity that accesses a computer-based record-system and requests actions by that system on those records, such as retrieving copies of specified parts of those records. In some computer-based record-systems, including I-systems, some or all of the system-users may also specify all or parts of the primary records in those systems. In other cases, the system-developers perform that role. System-users may be of various types, such as, for example, humans, operative-components in that system, the computer-system containing that computer-based record-system, other computer-based record-systems, and various machines and devices having automatic access to that computer-based record-system.

System-user/I-model-interaction-component: (3.5.3.1).

T01ERT-unit: A ‘T01ERT-unit’ is a TERT-unit that is a T01SR-unit.

T01EVIR-unit: A ‘T01EVIR-unit’ is a TEVIR-unit that is a T01SR-unit.

T01EVTR-unit: A ‘T01EVTR-unit’ is a TEVTR-unit that is a T01SR-unit.

T01SR-level-indicator: A ‘T01SR-level-indicator’ is a TSR-level-indicator of one of the three basic types.

T01SR-unit: A ‘T01SR-unit’ is a TSR-unit in which the TSR-level-indicator is a T01SR-level-indicator.

T10ERT-unit: A ‘T10ERT-unit’ is a TERT-unit that is a T10SR-unit.

T10EVIR-unit: A ‘T10EVIR-unit’ is a TEVIR-unit that is a T10SR-unit.

T10EVTR-unit: A ‘T10EVTR-unit’ is a TEVTR-unit that is a T10SR-unit.

T10SR-level-indicator: A ‘T10SR-level-indicator’ is a TSR-level-indicator of one of the three basic types.

T10SR-unit: A ‘T10SR-unit’ is a TSR-unit in which the TSR-level-indicator is a T10SR-level-indicator.

T-component: A ‘T-component’ is an I-component that consists of one or more T-units that are inter-related by E-equivalence-indicators that indicate E-equivalences between T-elements in those T-units. That T-component represents part or all of a type-structure for the type-entities represented by those T-element.

T-element: A ‘T-element’ (‘type-element’) in an I-model is an E-element that represents a type-entity in the subject of that I-model.

T-element-template: (3.4.1).

Template-equivalence: (3.4.1 and 3.4.2).

T-equivalence: (1.4.5.2.2).

Terminal-E-element: The ‘terminal-E-element’ in an SR-unit is the P3-component in that unit. The ‘terminal-E-element’ in an RT-specification-unit is the P3-component of that unit. The ‘terminal-E-element’ in a TSR-unit is the P3-component in that unit. The ‘terminal-E-element’ in an REVB-component is the INST-element in the IEVB-component in that REVB-component. The ‘terminal-E-element’ in an REV-component is the terminal-E-element in the REVB-component in that REV-component. The ‘terminal-E-element’ in an TIEVB-component is the initial-E-element in the TEVIR-unit in that component. The ‘terminal-E-element’ in a TIEV-component is the terminal-E-element in the TIEVB-component in that TIEV-component. The ‘terminal-E-element’ in a TREV-component is the terminal-E-element in the TIEV-component in that TREV-component. The ‘terminal-E-element’ in an inter-element structural relationship from one E-element to another is the second E-element in that relationship.

Terminal-entity: The ‘terminal-entity’ in a binary-relationship is the entity at which the relationship terminates. Even a symmetric relationship between two entities may be specified as consisting of two relationships of the same type and opposite directions. Thus, all relationships between two entities may be specified as having a direction ‘from’ one of those entities (the initial-entity) ‘to’ the other entity (the terminal-entity).

Terminal-I-unit: The ‘terminal-I-unit’ in an inter-unit structural relationship from one I-unit to another is the second I-unit in that relationship.

TERT-unit: A ‘TERT-unit’ is a TSR-unit in which the P1-component of the TSR-type-indicator is an RT-type-indicator.

TEVIR-unit: A ‘TEVIR-unit’ is a TSR-unit in which the P1-component of the TSR-type-indicator is an EVIR-indicator.

TEVS-indicator: A ‘TEVS-indicator’ is an I-indicator that indicates that the I-unit containing that TEVS-indicator is a TEVS-unit.

TEVS-unit: A ‘TEVS-unit’ is an I-unit represents a component of a type-structure that indicates the occurrence-state of events that are the instances of the type-entity represented by the

P1-component of that TEVS-unit.

TEVTR-unit: A ‘TEVTR-unit’ is a TSR-unit in which the P1-component of the TSR-type-indicator is an EVTR-indicator.

T-identical: Two T-components are ‘T-identical’ if they have identical structures. T-components that are T-identical represent the same type-structures.

TIEVB-component: A ‘TIEVB-component’ is a T-component whose primary component consists of a TEVIR-unit and a TEVTR-unit that are connected by E-equivalent T-elements. TIEVB-components represent components of type-structures whose instances are represented by IEVB-components.

TIEV-component: A ‘TIEV-component’ is a T-component whose primary component consists of a TIEVB-component and a TEVS-unit. TIEV-components represent components of type-structures whose instances are represented by IEV-components.

T-independence: ‘T-independent’ T-components for a T-element are T-components that represent independent components of the type-structure for the type-entity represented by that T-element.

T/INST-component-relationship: A ‘T/INST-component-relationship’ from a T-component to an I-component indicates a type-instance correspondence between that T-component and that I-component.

T/INST-component-relationship: A ‘T/INST-component-relationship’ is pair of I-components in which the first component is a T-component and the second is an I-component that includes a combination of T/INST-unit-relationships and a combination of T/INST-element-relationships that indicates that the collection of entities, and of the relationships between them, represented by that I-component is an instance of the type-structure represented by that T-component.

T/INST-element-relationship: A ‘T/INST-element-relationship’ from a T-element to an E-element indicates a type-instance correspondence between that T-element and that E-element. T/INST-LOGCON-relationship: (1.4.6.5.7.5)

T/INST-network: A ‘T/INST-network’ is a combination of a T-network and one or more IEV-components each of whose primary-T-element is E-equivalent to one or more T-elements in that T-network.

T/INST-unit-relationship: A ‘T/INST-unit-relationship’ from a T-unit to a base-primary I-unit indicates a type-instance correspondence from that T-unit to that base-primary I-unit.

TJERT-unit: A ‘TJERT-unit’ is a TERT-unit that is a TJSR-unit.

TJEVIR-unit: A ‘TJEVIR-unit’ is a TEVIR-unit that is a TJSR-unit.

TJEVTR-unit: A ‘TJEVTR-unit’ is a TEVTR-unit that is a TJSR-unit.

TJSR-level-indicator: A ‘TJSR-level-indicator’ is a TSR-level-indicator of one of the three basic types.

TJSR-unit: A ‘TJSR-unit’ is a TSR-unit in which the TSR-level-indicator is a TJSR-level-indicator.

T-level-indicator: (2.7.2 and 2.7.3).

T-maximality: A ‘T-maximal T-component’ in an I-model is a T-component that includes a T-component that is identical to every T-component for that T-element in that I-model.

T-network: A ‘T-network’ is an I-component consisting of a combination of T-elements, T-components for some or all of those T-elements, and I-components that indicate structural properties and structural relationships of some or all of those T-elements, particularly SUBT-relationships.

Translating-component: (3.5.3.4).

T-redundancy: A ‘T-redundancy’ exists in an I-model when that I-model includes a maximal-T-component that represents the same things as part or all of another maximal-T-component for a T-element that is E-equivalent to the T-element for that maximal-T-component.

Translational-correspondence: A ‘translational-correspondence’ between two records is a correspondence between the configurational components of their primary components. Such a correspondence exists when the primary components of those two records indicate, or represent, exactly the same things about the same subjects. In that case, the primary component of each of those records can be translated to the primary component of that other record. Such a correspondence may be a one-to-one correspondence between the components of those primary-configurations, or it may be more complex, such as a translational-correspondence between the primary components of records specified in different human languages.

Translation-review-component: (3.5.3.4.11).

TREV1-component: A ‘TREV1-component’ is a TREV-component in which the P3-component in the TEVS-unit in that TREV-component is an event-occurrence-indicator.

T-specification: A ‘T-specification’ for a T-element is a T-component that represents the entirety of the type-structure for the type-entity represented by that T-element.

T-specification-status-unit: A ‘T-specification-status-unit’ is a secondary I-unit that indicates the completeness status of the T-specification for the T-element that is the P2-component of that unit.

T-specification-status-unit-indicator: A ‘T-specification-status-unit-indicator’ is the P1-component of a T-specification-status-unit; it indicates that that I-unit is a T-specification-status-unit.

TSR-level-indicator: (1.3.1.2.1).

TSR-type-indicator: A ‘TSR-type-indicator’ indicates the type of a simple structural relationship between a T-element and another E-element in a TSR-unit. It has a P1-component that is a TSR-type-indicator and a P2-component that is a TSR-level-indicator.

TSR-level-indicator: A ‘TSR-level-indicator is a component of a TSR-type-indicator. That TSR-level-indicator indicates the general form of that TSR-type-indicator.

TSR-unit: A ‘TSR-unit’ is a T-unit that represents a simple structural relationship between a T-element and another E-element in an I-unit that represents a component of a type-structure for the type-entity represented by that T-element.

T-specification-incompleteness-indicator: A ‘T-specification-incompleteness-indicator’ is a T-specification-status-indicator in a T-specification-status-unit that indicates that the complete type-structure for the type-entity represented by the P2-component of that unit is not represented in that I-model by a T-specification.

T-specification-completeness-indicator: A ‘T-specification-completeness-indicator’ is a T-specification-status-indicator in a T-specification-status-unit that indicates that the complete type-structure for the type-entity represented by the P2-component of that unit is represented in that I-model by a T-specification.

Type-completeness-status-indicator: A ‘T-specification-status-indicator’ is the P3-component of a T-specification-status-unit; that indicator indicates the completeness status of the T-specification for the T-element that is the P2-component of that unit.

Type-entity: A ‘type-entity’ is a type, or category, or class of entities. For example, in English, common nouns and noun phrases are names of type-entities. Some type-entities may not have names assigned to them. Examples of type-entities include ‘company’, ‘machine’, and ‘city’. Some type-entities are event-types; for example, ‘relationship’, ‘action’, ‘process’, ‘accident’, and ‘meeting’.

Each type-entity has a type-structure associated with it that indicates one or more attributes, or relationships, of various types of the entities that are the instances of that type-entity. Two or more type-entities may have different type-structures that are equivalent, and thus they have the same instances.

Type-event: A ‘type-event’ consists of a type-entity being either occurrent or non-occurrent. It is occurrent if it has at least one instance. It is non-occurrent if it has no instances.

Type-relationship: A ‘type-relationship’ is a structural relationship between type-entities in a type-structure.

Type-structure: A ‘type-structure’ consists of (1) one or more type-entities, (2) in some cases, one or more fixed-entities, and (3) some ‘type-relationships’ that are structural relationships between those type-entities. Those type-relationships indicate particular types of relationships that must exist between entities in order for those entities to be instances of the corresponding type-entities in that type-structure.

For example, the following indicates a type-structure: ‘names, locations, number of employees, and product-types of manufacturing companies’. In that structure, each of ‘name’, ‘location’, ‘number of employees’, ‘product-type’, and ‘manufacturing company’ corresponds to a type-entity. There are no fixed-entities in that structure. The type-relationships between the type-entities in that type-structure may be specified as follows: (1) the type-relationship, ‘has name’ between the type-entity indicated by ‘company’ and the type-entity indicated by ‘name’; (2) the type-relationship, ‘is located in’ between the type-entity indicated by ‘company’ and the type-entity indicated by ‘location’; (3) the type-relationship, ‘number of employees is’ between the type-entity indicated by ‘company’ and the type-entity indicated by ‘number of employees’; and (4) the type-relationship, ‘product-type is’ between the type-entity indicated by ‘company’ and the type-entity indicated by ‘product-type’. Thus, for example, in the specification, ‘Company X is located in Michigan, has three thousand employees, and produces refrigerators’, the entity, Company X, is an instance of the type-entity indicated by ‘company’; the entity, ‘Company X’, is an instance of the type-entity indicated by ‘name’; the entity, ‘Michigan’, is an instance of the type-entity indicated by ‘location’; the entity, ‘three thousand’, is an instance of the type-entity indicated by ‘number of employees’; and the entity, ‘refrigerators’ is an instance of the type-entity indicated by ‘product-type’. Furthermore, in that example those five entities are ‘joint-instances’ of those corresponding five joint-type-entities, and the relationships between those entities are instances of the type-relationships between those type-entities.

When a type-entity does not have a standard name, a brief specification of the type-structure for that type-entity may be used as an ad-hoc name for that type-entity; for example, ‘cities with populations over a million’ is an ad-hoc name for a particular type-entity. Also, in most cases, a type-relationship in a type-structure does not have a specific individual name; instead, its nature may be indicated by the name or specification that is the same in structural form as a relationship that is an instance of that type-relationship. In the example, ‘Fred Smith is a resident of Chicago’, the relationship between Fred Smith and Chicago is indicated by a component, ‘is a resident of’, that is identical to the component that indicates the relationship between Mary Jones and New York in the structure ‘Mary Jones is a resident of New York’.

T-unit: A ‘T-unit’ in an I-model is an I-unit that represents a component of a type-structure for a particular type-entity.

I claim:

1. A computer-operative record, said computer-operative record comprising an I-model, said I-model representing aspects of one or more subjects, whereby is increased the comprehensiveness, simplicity, uniformity, and precision in the specification of said aspects of said subjects in said computer-operative record, and whereby is increased the scope, effectiveness, and efficiency of subject-related operations that may be performed on said computer-operative record by operative-components in a computer-system containing said computer-operative record.

2. The computer-operative record of claim 1, wherein said I-model comprises a combination of one or more primary I-units, each of said primary I-units comprising:
one or more E-elements, each of said E-elements representing an entity; and,
one or more I-indicators, each of said I-indicators indicating a particular aspect of said E-elements.

3. The computer-operative record of claim 2, wherein each of said primary I-units is selected from the group comprising:
ERT-units;
EVTR-units;
EVIR-units;
co-relationship-indicator-units;
EVS-units; and,
T-units.

4. The computer-operative record of claim 2, wherein said I-model further comprises one or more secondary I-units, each of said secondary I-units indicating an aspect of a combination of one or more E-elements in one or more of said primary I-units.

5. The computer-operative record of claim 2, wherein said I-model further comprises one or more E-equivalence-records, each of said E-equivalence-records indicating that the E-elements in a specified group of said E-elements represent the same entity.

6. The computer-operative record of claim 2, wherein said I-model further comprises one or more secondary-records, each of said secondary-records specifying one or more aspects of said computer-operative record.

7. The computer-operative record of claim 1, wherein said I-model comprises a subject-index to one or more records.

8. The computer-operative record of claim 1, wherein said I-model comprises a plurality of I-models.

9. The computer-operative record of claim 1, wherein said I-model is a component of a second I-model.

10. The computer-operative record of claim 1, said computer-operative record comprising a computer-based record in a computer-system.

11. The computer-operative record of claim 10, wherein said I-model comprises a model of said computer-system.

12. The computer-operative record of claim 10, said computer-operative record comprising a component of a computer-based record-system in said computer-system, said computer-based record-system comprising an I-system, said I-system comprising said I-model.

13. The computer-operative record of claim 12, wherein said I-model:
comprises a model of a dynamic system; and,
is adjusted by said I-system when said I-system receives a specification of a change in an aspect of said dynamic system, said adjustment indicating, in said I-model, said change.

14. In a computer system, a computer-based record-system, said computer-based record-system comprising an I-system, said I-system comprising:
one or more I-models; and,
a combination of one or more first operative-components, said first operative-components being operatively-connected with one or more of said I-models and constructed to perform operations on said I-models.

15. The computer-based record-system of claim 14, said computer-based record-system further comprising:
an action-specification-interface component, said action-specification-interface component:
receiving action-specifications that indicate actions to be performed on said I-models and being operatively-coupled with one or more of said operative-components;
an action-results-interface component, said action-results-interface component being operatively-coupled with one or more of said operative-components and indicating results of said actions; and,
an operation-initiation component, said component:
being operatively-coupled with said action-specification-interface component;
being operatively-coupled with one or more of said operative-components; and,
initiating operations by said operative-components, said operations comprising:
translating said action-specifications to specifications of operations to be performed on said I-models by said operative-components;
performing said specified operations; and,
indicating the results of said operations in said action-results-interface component;
whereby said I-models increase the comprehensiveness, simplicity, uniformity, and precision of the specifications, in records in said computer-system, of aspects of one or more subjects, and said I-models also increase the scope, effectiveness, and efficiency of subject-related operations that may be performed on said records by operative-components in said computer-based record-system.

16. The computer-based record-system of claim 15, wherein said combination of operative-components comprises one or more operative-components constructed to perform subject-related operations on one or more of said I-models.

17. The computer-based record-system of claim 15, said computer-based record-system further comprising:
a record-input component, said record-input-component receiving records; and,
a record-translating component, said record-translating-component translating said received records to components of one or more I-models in said system.

18. The computer-based record-system of claim 15, said computer-based record-system further comprising a second record-translating component, said second record-translating-component translating components of one or more I-models in said system to output records in said action-results-interface component.

19. The computer-based record-system of claim 18, said computer-based record-system:
receiving indications of adjustments to be made in said output records; and,
translating said adjustments to components of said I-models.

20. The computer-based record-system of claim 16, wherein:
said computer-based record-system further comprises one or more second computer-based record-systems operatively-coupled with said I-system;
said first action-specification-interface component further receiving second action-specifications that indicate operations to be performed on one or more records in said second computer-based record-systems;
said I-system translating said second action-specifications to third action-specifications that specify third operations to be performed by one or more of said second computer-based record-systems;
said I-system indicating, to said second computer-based record-systems, said third action-specifications;
said second computer-based record-systems performing said third operations;
said second computer-based record-systems indicating to said I-system the results of said third operations;
said I-system translating said results; and,
said I-system indicating said translated results in said first action-results-interface component.

21. A method for improving the functional capabilities of a computer-based record-system, said method comprising:
providing, in said computer-based record-system, an I-system;
providing, said I-system, one or more I-models; and,
providing, in said I-system, one or more operative-components, each of said operative-components operatively-connected with one or more of said I-models and constructed to perform operations on said I-models, said operations comprising one or more subject-related operations;
whereby said I-models increase the comprehensiveness, simplicity, uniformity, and precision of the specifications, in records in said computer-based record-system, of aspects of one or more subjects, and said I-models also increase the scope, effectiveness, and efficiency of subject-related operations that may be performed on said records by operative-components in said computer-based record-system.

22. The method of claim 21, further comprising providing, in said computer-based record-system, one or more operative-components operatively-connected with one or more of said I-models and constructed to perform subject-related operations on one or more of said I-models.

23. The method of claim 22, further comprising providing, in said computer-based record-system, a combination of translating-components, each of said translating-components operatively-connected with one or more of said I-models and constructed to translate between said I-models and one or more other records in said computer-based record-system.

24. The method of claim 23, further comprising initiating the translation, by one or more of said translating-components, of one or more other records in said computer-based record-system to one or more I-models in said computer-based record-system.

25. The method of claim 23 further comprising:
providing, in said I-system, an action-specification-interface component, said action-specification-interface component operatively-coupled with one or more of said operative-components and constructed to receive action-specifications that indicate actions to be performed on records in said computer-based record-system;
providing, in said I-system, an action-results-interface component, said action-results-interface component operatively-coupled with one or more of said operative-components and constructed to indicate results of said actions; and,
providing, in said I-system, an operation-initiation component, said operation-initiation component being:
operatively-coupled with said action-specification-interface component;
operatively-coupled with one or more operative-components in said computer-based record-system; and,
constructed to initiate operations by said operative-components, said operations comprising:
translating said action-specifications to specifications of operations to be performed on records in said system by said operative-components;
performing said specified operations; and,
indicating the results of said operations in said action-results-interface component.

26. The method of claim 25, said method further comprising providing, in said I-system, an I-model comprising a subject-index to records in said computer-based record-system, said subject-index being employed by one or more of said operative-components in identifying records in said computer-based record-system to be operated upon by said operative-components in performing said operations.
